(19) United States
(12) Patent Application Publication
(10) Pub. No.: US 2026/0073739 A1
(43) Pub. Date: Mar. 12, 2026

(54) SYSTEM, METHOD, AND APPARATUS FOR VEHICLE TESTING AND DIAGNOSTICS

(71) Applicant: Sonatus, Inc., Sunnyvale, CA (US)

(72) Inventors: Yu Fang, Palo Alto, CA (US); Xuanran Zong, Sunnyvale, CA (US); Som Neema, Fremont, CA (US); Yixiang Chen, Palo Alto, CA (US)

(21) Appl. No.: 19/390,083

(22) Filed: Nov. 14, 2025

Related U.S. Application Data
(63) Continuation of application No. PCT/US2024/029686, filed on May 16, 2024.
(60) Provisional application No. 63/467,235, filed on May 17, 2023.

(51) Int. Cl. G07C 5/00; G07C 5/08

(52) U.S. Cl. CPC G07C 5/008; G07C 5/0808; G07C 5/0825

(57) ABSTRACT

A method including: interpreting a user input; generating, based on the user input, a first agnostic vehicle diagnostic command; translating the first agnostic vehicle diagnostic command to a first adapted vehicle diagnostic command; interpreting a first adapted vehicle diagnostic data generated in response to executing the first adapted vehicle diagnostic command; translating the first adapted vehicle diagnostic data to first agnostic vehicle diagnostic data; generating a second agnostic vehicle diagnostic command based at least in part on the first adapted vehicle diagnostic data; translating the second agnostic vehicle diagnostic command to a second adapted vehicle diagnostic command; interpreting second adapted vehicle diagnostic data generated in response to executing the second adapted vehicle diagnostic command; translating the second adapted vehicle diagnostic data to second agnostic vehicle diagnostic data; and generating a state value for the vehicle based at least in part on the second adapted vehicle diagnostic data.

### CROSS-REFERENCE TO RELATED APPLICATIONS

This application claims priority to and is a bypass continuation of International Patent Application No. PCT/US2024/029686, filed May 16, 2024, and entitled “SYSTEM, METHOD, AND APPARATUS FOR MOBILE SYSTEM TESTING AND DIAGNOSTICS” (SONA-0014-WO), published as WO 2024/238789.

International Patent Application No. PCT/US2024/029686 claims the benefit of priority to U.S. Provisional Patent Application Ser. No. 63/467,235, filed May 17, 2023, and entitled “SYSTEM, METHOD, AND APPARATUS FOR MOBILE SYSTEM TESTING AND DIAGNOSTICS” (SONA-0014-P01).

All of the foregoing applications and/or patents are incorporated herein by reference in their entirety for all purposes.

The following applications and/or patents are also incorporated by reference in their entirety for all purposes: U.S. patent application Ser. No. 17/195,589, filed Mar. 8, 2021, entitled “SYSTEM, METHOD, AND APPARATUS FOR MANAGING VEHICLE DATA COLLECTION” (SONA-0010-U01), published as US20210192867 A1, and issued as U.S. Pat. No. 11,538,287.

### BACKGROUND

Vehicle communication networks are utilized to connect various vehicle systems and/or components, e.g., sensors, actuators, controllers, user interfaces, rider personal devices, trailers, and communication devices, throughout a vehicle. Recent trends have been increasing the burden on these vehicle communication networks, with more devices being connected, more data passing between devices, lower latency requirements to meet vehicle performance, safety, and emissions requirements, and added vehicle features. Additionally, consumers expect increasing connectivity, reduced driver burden, and features that increase the burdens on vehicle communication networks. These trends are expected to continue, and to accelerate, for the foreseeable future.

Vehicle diagnostic and/or testing systems are utilized to detect/determine the status of a vehicle's systems and/or components. Traditional vehicle diagnostic and/or testing systems suffer from a number of drawbacks and challenges. For example, traditional vehicle diagnostic and/or testing systems are limited to use with specific vendors, makes, and/or models as they use vendor specific protocols. Further, many traditional vehicle diagnostic and/or testing systems are limited to executing predefined tests stored in the firmware of embedded processors onboard a vehicle. As such, executing a new test of a vehicle's systems and/or components requires updating the firmware of one or more embedded processors, which, in turn, requires re-certification of the firmware. Re-certification of a vehicle's embedded firmware is an expensive and time-consuming processes. Additionally, the limitations of traditional vehicle diagnostic and/or testing systems limit the development, deployment, and execution of diagnostics and testing to a limited group of people and entities having the skill set and access for deploying these, increasing costs and distancing the process from experts in the diagnostics, testing, or aspects of the vehicle being tested.

Traditional vehicle diagnostic and/or testing systems are data collection intensive processes. Data collection from vehicles includes a number of additional challenges. For example, data collection operations are subject to regulation and liability risks, especially with data collection that may include private or personally identifiable information. Data collectors, including entities that may have ownership or possession of sensitive data are subject to risk while holding data, for example in the event of inadvertent or malicious access to the data. With regard to vehicle data being collected, a large amount of data may be collected, and a large number of purposes for collecting the data may be present, increasing the risks relative to other general data storage applications. Accordingly, it may be desirable to control data collection, storage, and access, to reduce risks, and it may further be desirable to include verification of data access, partitioning or other exclusion of data when the data is not being used, and the like.

Data collection for vehicles is further complicated by the amount and type of data to be communicated between the vehicle and external devices, where the network system of the vehicle is limited by constraints of a mobile application, expenses and/or bandwidth limitations incurred by high data rates and large data transfers. Even in light of the foregoing, customer demands, market expectations, increasing requirements for efficiency of vehicle operations, and the increase of functional capability for data related applications are continuing to proliferate the aggregate amount of data to be transferred, the number of off-vehicle applications utilizing transferred data, the number of purposes that the data may be utilized for, and the number of users or entities having a legitimate need for portions of the transferred data. Additionally, applications utilizing the data continue to increase in sophistication and capability, increasing the data demand for the limited available transfer resources, and increasing the cost and complexity of logistical control and storage of the transferred data. For example, higher capability pathing or operation algorithms related to the vehicle, increasing automation of vehicle functions, increasing demand for prognostic determinations and/or maintenance support, and increasing media streams (both the number of media streams and the quality of those media streams) all drive for increased demand in data rates, stored data amounts, and the number of entities or applications accessing the stored data.

The complexities and other challenges set forth preceding have synergistic effects that cause the complexity of the vehicle data environment to be even greater than the sum of the individual contributions from each challenge.

As one example, the increasing number of entities or applications accessing the data increases the likelihood that individual data requests will overlap—for example with multiple entities requesting the same or similar data. Further, the increasing number of entities or applications accessing the data increases the likelihood that members of the accessing group will share similar authorization levels, such that the data access for individual members of the entity or application group require data management.

In another example, regulations regarding sensitive data are increasing, which increases the data management requirements of the system generally, but also increases the likelihood that data management may be subjected to multiple constraints at a given time, and/or changing constraints over time as regulations change.

In yet another example, the complex environment of presently known and transitioning vehicle network architectures—for example vehicles having mixed network types and/or partitioned networks—increase the complexity of data access for individual entities that, without certain aspects of the present disclosure, may otherwise be required to determine requesting parameter specifications for particular data elements, and to update those requesting parameters as vehicle network architectures evolve. In view of the increasing number of entities requesting data access, the aggregate cost to the automotive support market increases non-linearly, as each of the entities incurs the costs to track requesting parameter specifications. Additionally, the trajectory of additional entities requesting data access is moving toward entities that are positioned further away in the technological knowledge space from core automotive functions, and accordingly the intricacies and idiosyncrasies of vehicle and/or automotive applications, including on-vehicle network configurations, specific data descriptions, data requesting and communication protocols, industry standards or customs for presenting information, and the like, are becoming less well known on average for each incremental new entity, further increasing the cost volume function (e.g., the cost over time for a given entity to meet desired data collection deliverables, where the given entity may be an automotive manufacturer, and/or a vehicle market, a geographic market, and/or an industry such as the automotive industry, the passenger car industry, etc.). For example, consider a notional cost volume function such as:

COST=# of entities*basic learning cost*adapting to transition cost trajectory*data trajectory cost*regulatory adaptation cost*data access/storage liability cost

The described COST function is a non-limiting notional example to demonstrate how various challenges and complications with regard to presently known systems interact and synergize to increase the costs to meet future data collection functions for vehicle applications. The cost parameters described are not intended to cover all costs related to the challenges present for the automotive data collection industry or presently known systems. Parameters may be averages or other complex functions, and the values of particular parameters will generally not be known with specificity. In addition, the units of the COST may be expressed in monetary values, as a resource (e.g., engineering hours, computation time, etc.) to meet data collection targets over time, as another non-monetary unit such as equivalent emissions, customer satisfaction, risk incurred, public perception losses or gains, etc. The # of entities parameter reflects generally the number of entities accessing vehicle data over time; the basic learning cost reflects the costs for new entities to learn the specifics of data collection requirements and protocols for a specific vehicle, vehicle type, market, etc.; the adapting to transition cost trajectory reflects the costs to adapt to changing vehicle network configurations, including network types and organization; the data trajectory cost reflects the increasing demand for data collection from relevant vehicles over time, including data communication, storage, and resulting functional consequences such as not being able to support a desired application or costs to enhance data communication infrastructure; the regulatory adaptation cost reflects the costs associated with an increasing number of regulations, an increasing number of regulatory frameworks, and/or an increasing number of regulating entities; and the data access/storage liability cost reflects the costs incurred for compliance and security of data, and/or losses incurred due to data breaches, unauthorized use, or the like.

### SUMMARY

Embodiments of the current disclosure may provide for a system that includes a server and a mobile system interface device. The server is structured to interpret agnostic mobile system data. The mobile system interface device is structured to: interpret adapted mobile system data from one or more endpoints of one or more network zones of a mobile system; generate the agnostic mobile system data based at least in part on the adapted mobile system data; and transmit the agnostic mobile system data to the server.

Embodiments of the current disclosure may provide for a method that includes: interpreting adapted mobile system data from one or more endpoints of one or more network zones of a mobile system; generating agnostic system data based at least in part on the adapted mobile system data; transmitting the agnostic system data to an external device; and determining, based at least in part on the agnostic system data, a state value of the mobile system.

Embodiment of the current disclosure provide for a system that includes a server structured to: interpret agnostic mobile system data; and transmit the agnostic mobile system data to a mobile system interface device. The mobile system interface device is structured to: generate adapted mobile system data responsive to the agnostic mobile system data; and implement at least one of a test or a diagnostic on a mobile system in response to the adapted mobile system data.

Embodiments of the current disclosure provide for a method that includes: interpreting, via a server, agnostic mobile system data; transmitting, via the server, the agnostic mobile system data to a mobile system interface device; generating, via the mobile system interface device, adapted mobile system data responsive to the agnostic mobile system data; and implementing, via the mobile system interface device, at least one of a test or a diagnostic on a mobile system in response to the adapted mobile system data.

Embodiments of the current disclosure provide for an apparatus that includes an agnostic input circuit, a mobile translation circuit, a mobile interface circuit, and a diagnostic circuit. The agnostic input circuit is structured to interpret agnostic mobile system data including at least one of a test instruction, a diagnostic instruction, or a data collection instruction. The mobile translation circuit is structured to generate adapted mobile system data in response to the agnostic mobile system data, the adapted mobile system data including at least a portion of the agnostic mobile system data configured for a target mobile system. The mobile interface circuit is structured to transmit the adapted mobile system data to the target mobile system. The diagnostic circuit is structured to determine a state value of the mobile system based, at least in part, on a result value from the target mobile system.

Embodiments of the current disclosure provide for a method that includes: interpreting, via an agnostic input circuit, agnostic mobile system data including at least one of a test instruction, a diagnostic instruction, or a data collection instruction; generating, via a mobile translation circuit, adapted mobile system data in response to the agnostic mobile system data, the adapted mobile system data including at least a portion of the agnostic mobile system data configured for a target mobile system; transmitting, via a mobile interface circuit, the adapted mobile system data to the target mobile system; and determining, via a diagnostic circuit, a state value of the mobile system based, at least in part, on a result value from the target mobile system.

Embodiments of the current disclosure provide for an apparatus that includes an agnostic input circuit, a mobile translation circuit, a component simulation circuit, a mobile interface circuit, and a testing circuit. The agnostic input circuit is structured to interpret agnostic mobile system data including a test instruction. The mobile translation circuit is structured to generate adapted mobile system data in response to the agnostic mobile system data, the adapted mobile system data including at least a portion of the agnostic mobile system data configured for a target mobile system. The component simulation circuit is structured to generate, in response to the adapted mobile system data, simulated adapted mobile system data including data simulating a mobile system component in response to the adapted mobile system data. The mobile interface circuit is structured to transmit the simulated adapted mobile system data to the target mobile system. The testing circuit is structured to determine a state value of the target mobile system based at least in part on a result value generated by the target mobile system in response to the simulated adapted mobile system data.

Embodiments of the current disclosure provide for a method that includes: interpreting, via an agnostic input circuit, agnostic mobile system data including a test instruction; generating, via a mobile translation circuit and in response to the agnostic mobile system data, adapted mobile system data including at least a portion of the agnostic mobile system data configured for a target mobile system; generating, via a component simulation circuit and in response to the adapted mobile system data, simulated adapted mobile system data including data simulating a mobile system component in response to the adapted mobile system data; transmitting, via a mobile interface circuit, the simulated adapted mobile system data to the target mobile system; and determining, via a testing circuit, a state value of the target mobile system based at least in part on a result value generated by the target mobile system in response to the simulated adapted mobile system data.

Embodiments of the current disclosure provide for a system that includes: a target mobile system having a mobile system component; and a testing apparatus. The testing apparatus is structured to: interpret agnostic mobile system data including a test instruction; generate adapted mobile system data including at least a portion of the agnostic mobile system data configured for the target mobile system; in response to the adapted mobile system data, generate simulated adapted mobile system data including data simulating the mobile system component in response to the adapted mobile system data; transmit the simulated adapted mobile system data to the target mobile system as part of a test of the target mobile system data, wherein the test is based at least in part on the test instruction; and determine a state value of the target mobile system based at least in part on a result value generated by the target mobile system in response to the simulated adapted mobile system data.

### BRIEF DESCRIPTION OF THE FIGURES

FIG. 1 is a schematic diagram of an example data collection system according to certain embodiments of the present disclosure;

FIG. 2 is a schematic diagram of an example vehicle having aspects of a data collection system according to certain embodiments of the present disclosure;

FIG. 3 is a schematic diagram of an example off-vehicle device according to certain embodiments of the present disclosure;

FIG. 4 is a diagram of example internal and/or external applications according to certain embodiments of the present disclosure;

FIGS. 5A and 5B depict a schematic diagram of an example vehicle network infrastructure for a vehicle according to certain embodiments of the present disclosure;

FIG. 6 is a schematic diagram of an example edge gateway according to certain embodiments of the present disclosure;

FIG. 7 is a schematic diagram of an example user consent controller according to certain embodiments of the present disclosure;

FIG. 8 is a schematic diagram of an example data collector controller according to certain embodiments of the present disclosure;

FIG. 9 is a schematic diagram of an example first partition according to certain embodiments of the present disclosure;

FIG. 10 is a schematic diagram of an example second partition according to certain embodiments of the present disclosure;

FIG. 11 is a schematic diagram of an example data collection system according to certain embodiments of the present disclosure;

FIG. 12 is a schematic diagram of an example automation manager according to certain embodiments of the present disclosure;

FIG. 13 is a schematic diagram of an example implementation for a unified IDS manager (ECU) according to certain embodiments of the present disclosure;

FIG. 14 is a schematic diagram of an example shared storage controller according to certain embodiments of the present disclosure;

FIG. 15 is a schematic diagram of another example data collection system according to certain embodiments of the present disclosure;

FIG. 16 is diagram of an example workflow according to certain embodiments of the present disclosure;

FIG. 17 is a flowchart depicting an example procedure for implementing a policy responsive to fault and/or diagnostic values for device(s) in a vehicle system according to certain embodiments of the present disclosure;

FIG. 18 is a schematic diagram of an example apparatus for providing data collection operations in response to a vehicle policy data value according to certain embodiments of the present disclosure;

FIG. 19 is a schematic diagram of an example operation that includes an operation to monitor trigger evaluation data, and to determine an event occurrence based on a trigger condition and the trigger evaluation data, according to certain embodiments of the present disclosure;

FIG. 20 is a schematic diagram of an example apparatus for performing data collection operations implementing a data collection policy according to certain embodiments of the present disclosure;

FIG. 21 is a schematic diagram of an example data collection policy according to certain embodiments of the present disclosure;

FIG. 22 is a schematic diagram of an example cloud system according to certain embodiments of the present disclosure;

FIG. 23 depicts an example cloud system for retrieving selected data from a vehicle according to certain embodiments of the present disclosure;

FIG. 24 depicts an example schematic diagram of an operation that includes an operation for data collection operations from a vehicle according to certain embodiments of the present disclosure;

FIG. 25 depicts an example procedure for separating responsive data to a vehicle data collection operation according to certain embodiments of the present disclosure;

FIG. 26 depicts an example procedure for separating responsive data to a vehicle data collection operation according to certain embodiments of the present disclosure;

FIG. 27 depicts an example system for retrieving selected data from a vehicle according to certain embodiments of the present disclosure;

FIG. 28 depicts an example procedure for identifying data according to certain embodiments of the present disclosure;

FIG. 29 depicts an example cloud system for preparing data collection policies according to certain embodiments of the present disclosure;

FIG. 30 depicts an example policy creator circuit according to certain embodiments of the present disclosure;

FIG. 31 depicts an example request interface according to certain embodiments of the present disclosure;

FIG. 32 depicts an example procedure for operating a request interface according to certain embodiments of the present disclosure;

FIG. 33 depicts an example schematic to provide automated vehicle operations based on data values according to certain embodiments of the present disclosure;

FIG. 34 depicts an example schematic to provide automated vehicle operations based on data values according to certain embodiments of the present disclosure;

FIG. 35 depicts an example schematic to provide automated vehicle operations based on data values according to certain embodiments of the present disclosure;

FIG. 36 depicts an example schematic for performing data collection operations according to certain embodiments of the present disclosure;

FIG. 37 depicts an example schematic for transmission operations of vehicle data with a cloud system and/or an external device according to certain embodiments of the present disclosure;

FIG. 38 depicts an example procedure to manage transmission operations of a vehicle according to certain embodiments of the present disclosure;

FIG. 39 depicts an example procedure for selectively transmitting collected data in response to a selected transmission interval according to certain embodiments of the present disclosure;

FIG. 40 depicts an example procedure for selectively transmitting collected data in response to a selected bandwidth utilization according to certain embodiments of the present disclosure;

FIG. 41 depicts an example procedure for selectively transmitting collected data in response to a data type of the collected data according to certain embodiments of the present disclosure;

FIG. 42 depicts an example procedure for selectively transmitting collected data in response to a vehicle operational impact of transmission operations according to certain embodiments of the present disclosure;

FIG. 43 depicts an example procedure for selectively transmitting collected data in response to a power utilization impact of transmission operations according to certain embodiments of the present disclosure;

FIG. 44 depicts an example procedure for selectively transmitting collected data in response to a data transmission capacity value according to certain embodiments of the present disclosure;

FIG. 45 depicts an example procedure for selectively transmitting collected data in response to a currently available transmission type according to certain embodiments of the present disclosure;

FIG. 46 depicts an example procedure for selectively transmitting collected data in response to a selected data transmission chunk size according to certain embodiments of the present disclosure;

FIG. 47 depicts an example procedure for selectively transmitting collected data in response to a success parameter for transmitting operations according to certain embodiments of the present disclosure;

FIG. 48 depicts an example procedure for selectively transmitting collected data in response to a quality of service value for transmitting operations according to certain embodiments of the present disclosure;

FIG. 49 depicts an example schematic for implementing remote assistance operations for a vehicle according to certain embodiments of the present disclosure;

FIG. 50 depicts an example schematic for a cloud system in communication with a vehicle according to certain embodiments of the present disclosure;

FIG. 51 depicts an example procedure for performing remote operations for a vehicle according to certain embodiments of the present disclosure;

FIG. 52 depicts an example procedure for performing operations for a vehicle including remote assistance operations according to certain embodiments of the present disclosure;

FIG. 53 is a flowchart depicting a method for data collection policy intake and execution according to certain embodiments of the present disclosure;

FIG. 54 is another flowchart depicting the method of FIG. 53 according to certain embodiments of the present disclosure;

FIG. 55 is another flowchart depicting the method of FIG. 53 according to certain embodiments of the present disclosure;

FIG. 56 is another flowchart depicting the method of FIG. 53 according to certain embodiments of the present disclosure;

FIG. 57 is another flowchart depicting the method of FIG. 53 according to certain embodiments of the present disclosure;

FIG. 58 is a schematic diagram of an apparatus for data collection in a mixed network environment according to certain embodiments of the present disclosure;

FIG. 59 is a schematic diagram of another apparatus for data collection in a mixed network environment according to certain embodiments of the present disclosure;

FIG. 60 is a flowchart depicting a method for data collection in a mixed network environment according to certain embodiments of the present disclosure;

FIG. 61 is another flowchart depicting the method of FIG. 60 according to certain embodiments of the present disclosure;

FIG. 62 is a schematic diagram of an apparatus for data collection process management according to certain embodiments of the present disclosure;

FIG. 63 is a schematic diagram of another apparatus for data collection process management according to certain embodiments of the present disclosure;

FIG. 64 is another schematic diagram of the apparatus of FIG. 63 according to certain embodiments of the present disclosure;

FIG. 65 is another schematic diagram of the apparatus of FIG. 63 according to certain embodiments of the present disclosure;

FIG. 66 is a box diagram illustrating an example cloud system according to certain embodiments of the present disclosure;

FIGS. 67-71 are flowcharts illustrating example cloud system-based data collection processes according to certain embodiments of the present disclosure;

FIG. 72 is a box diagram illustrating an example vehicle according to certain embodiments of the present disclosure;

FIGS. 73-76 are flowcharts illustrating example vehicle-based data collection according to certain embodiments of the present disclosure;

FIG. 77 is a box diagram of an example vehicle according to certain embodiments of the present disclosure;

FIG. 78 is a box diagram of an example data collection controller according to certain embodiments of the present disclosure;

FIGS. 79-81 are flowcharts illustrating example data collection processes according to certain embodiments of the present disclosure;

FIG. 82 is a box diagram of an example vehicle according to certain embodiments of the present disclosure;

FIG. 83 is a box diagram of an example data collection controller according to certain embodiments of the present disclosure;

FIGS. 84-86 are flowcharts illustrating example data collection processes according to certain embodiments of the present disclosure.

FIG. 87 is schematic diagram of a system for diagnosing and/or testing a mobile system according to certain embodiments of the present disclosure;

FIG. 88 is another schematic diagram of a system for diagnosing and/or testing a mobile system according to certain embodiments of the present disclosure;

FIG. 89 is a schematic diagram of a mobile system interface device according to certain embodiments of the present disclosure;

FIG. 90 is another schematic diagram of a mobile system interface device according to certain embodiments of the present disclosure;

FIG. 91 is a flowchart illustrating a method for diagnosing and/or testing a mobile system according to certain embodiments of the present disclosure;

FIG. 92 is another flowchart illustrating a method for diagnosing and/or testing a mobile system according to certain embodiments of the present disclosure;

FIG. 93 is another flowchart illustrating a method for diagnosing and/or testing a mobile system according to certain embodiments of the present disclosure;

FIG. 94 is another flowchart illustrating a method for diagnosing and/or testing a mobile system according to certain embodiments of the present disclosure;

FIG. 95 is another flowchart illustrating a method for diagnosing and/or testing a mobile system according to certain embodiments of the present disclosure;

FIG. 96 is another flowchart illustrating a method for diagnosing and/or testing a mobile system according to certain embodiments of the present disclosure;

FIG. 97 is a schematic diagram of an apparatus for diagnosing a mobile system according to certain embodiments of the present disclosure;

FIG. 98 is another schematic diagram of an apparatus for diagnosing a mobile system according to certain embodiments of the present disclosure;

FIG. 99 is a flowchart illustrating a method for diagnosing a mobile system according to certain embodiments of the present disclosure;

FIG. 100 is another flowchart illustrating a method for diagnosing a mobile system according to certain embodiments of the present disclosure;

FIG. 101 is a schematic diagram of an apparatus for testing a mobile system according to certain embodiments of the present disclosure;

FIG. 102 is another schematic diagram of an apparatus for testing a mobile system according to certain embodiments of the present disclosure;

FIG. 103 is a flowchart illustrating a method for testing a mobile system according to certain embodiments of the present disclosure;

FIG. 104 is another flowchart illustrating a method for testing a mobile system according to certain embodiments of the present disclosure;

FIG. 105 is a schematic diagram of a system for testing and/or diagnostic analysis according to certain embodiments of the present disclosure;

FIG. 106 is a schematic diagram of another mobile system interface according to certain embodiments of the present disclosure;

FIG. 107 is flowchart illustrating method for diagnosing a mobile system according to certain embodiments of the present disclosure;

FIG. 108 is flowchart illustrating a method for testing a mobile system according to certain embodiments of the present disclosure;

FIG. 109 is a schematic diagram of an apparatus for testing a target mobile system according to certain embodiments of the present disclosure;

FIG. 110 is another schematic diagram of an apparatus for testing a target mobile system according to certain embodiments of the present disclosure;

FIG. 111 is a flowchart depicting a method for testing a target mobile system according to certain embodiments of the present disclosure; and

FIG. 112 is another flowchart depicting a method for testing a target mobile system according to certain embodiments of the present disclosure.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

The present disclosure describes systems, methods, and apparatuses to perform diagnostics and testing related to a vehicle. Certain embodiments set forth herein reference a mixed vehicle network on a vehicle. Example mixed vehicle networks include a network having one or more CAN buses with a number of devices communicating over the CAN bus(es), and one or more ethernet networks with a number of devices communicating over the ethernet network, and communication that crosses from CAN to ethernet and/or vice-versa. Mixed networks are not limited to CAN and ethernet, and may include, without limitation, any one or more of a local interconnect network (LIN), FlexRay, Media Oriented Systems Transport (MOST), and/or low-voltage differential signaling (LVDS). Currently available ethernet networks are highly capable, having bandwidth ratings between 100 Mbps to 25 Gbps, and latency values between 5 ms to 20 μs (0.02 ms). In certain embodiments, more than one ethernet network (or zone) may be present, and may include mixed capability ethernet networks. Additionally, or alternatively, in certain embodiments, one or more networks present may include wireless networks such as a WiFi network (e.g., an 802.11x standard such as a/b/g; n; and/or ac), a mobile standard network (e.g., 4G and/or 5G), Bluetooth communications, universal serial bus (USB) connections, and/or fiber optic connections. The recited networks are non-limiting examples, and any type of network and/or communication protocol is contemplated herein for a mixed vehicle network.

In certain embodiments, the mixed vehicle network includes one or more low-capability networks combined with one or more high-capability networks. The capability that is considered low-capability depends upon the application, the number of devices that are in communication, the types of communication that are allowed on the network, and the available network management (e.g., registration, addition, or removal of devices, encryption of messages, customization of messages, etc.) for the particular network and communication protocols being utilized. In certain embodiments, the mixed vehicle network includes more than one network, where at least two of the networks present an integration challenge. For example, one of the networks may only allow certain types of communications, require certain types of synchronous or asynchronous communications, only allow connection of certain types of devices, limit the implementation of certain network topologies, or have other differences or limitations that render utilization of a single network (or network type) throughout the vehicle undesirable or impractical.

The description herein utilizing off-vehicle, extra-vehicle, and/or cloud-based interactions references any external network communications of the vehicle, including without limitation wireless-based communications (e.g., mobile data, WiFi, and/or Bluetooth) to external devices. Communications to external devices may be to a general network (e.g., over the internet), a WAN, a LAN, a mobile device in proximity to the vehicle, and/or combinations of these. Certain systems and procedures described herein particularly contemplate run-time operations of the vehicle, for example external communications occurring during operating conditions wherein the vehicle is executing a mission (e.g., moving, performing operations while not moving, etc.). The disclosure herein further contemplates communications that may occur during any period, including during down-time of the vehicle and/or during service events. The disclosure herein further contemplates communications that may occur through wired communication channels, such as when the vehicle network is in communication with a service tool, on-board diagnostics (OBD) instrument, or other physically coupled device.

The description herein references vehicle applications as a non-limiting example and for clarity of the present description. However, embodiments herein are applicable to other applications having similar challenges and/or implementations. Without limitation to any other application, embodiments herein are applicable to any application having multiple end points, including multiple data sources, controllers, sensors, and/or actuators, and which may further include end points present in distinct or distributed network environments, and/or applications having historical or legacy networking or communication systems that may be transitioning (within a given system, as a class of systems, and/or as an industry) to newer and/or more capable networking or communication systems. Example and non-limiting embodiments include one or more of: industrial equipment; robotic systems (including at least mobile robots, autonomous vehicle systems, and/or industrial robots); mobile applications (that may be considered “vehicles”, or not) and/or manufacturing systems. It will be understood that certain features, aspects, and/or benefits of the present disclosure are applicable to any one or more of these applications, not applicable to others of these applications, and the applicability of certain features, aspects, and/or benefits of the present disclosure may vary depending upon the operating conditions, constraints, cost parameters (e.g., operating cost, integration cost, operating cost, data communication and/or storage costs, service costs and/or downtime costs, etc.) of the particular application. Accordingly, wherever the present disclosure references a vehicle, a vehicle system, a mobile application, industrial equipment, robotic system, and/or manufacturing systems, each one of these are also contemplated herein, and may be applicable in certain embodiments, or not applicable in certain other embodiments, as will be understood to one of skill in the art having the benefit of the present disclosure.

A flow, as utilized herein, should be understood broadly. An example flow includes a related group of data (e.g., speed data, temperature data, audio-visual data, navigation data, etc.), a related group of functions (e.g., among vehicle functions, extra-vehicle functions such as service operations and/or data collection, aggregations between related vehicles, and/or combinations of these that are related for a particular system), a related group of devices (e.g., door actuators), and/or a related group of applications. Flows, as used herein, provide an organizing concept that may be utilized to relate certain data, certain end points, certain applications, and/or related functions of the vehicle or apart from the vehicle. In certain embodiments, a controller can utilize a flow to identify a data source, a data destination, permissions available for the flow, priority information related to the flow, or the like, to implement certain data regulating operations here. In certain embodiments, the utilization of the flow allows the controller to perform separate operations that may involve the same end points to support the desired network management. For example, a vehicle speed management application may have a high priority, and a speedometer end point may be associated with the vehicle speed management application. In the example, if the vehicle speed is being communicated to support the vehicle speed management application, then the controller applies a high priority to the vehicle speed message. However, if the vehicle speed is being communicated to support a trip planning flow (e.g., where a trip planning flow is present and does not have a high priority), the controller may apply a lower priority to the vehicle speed message. In a further example, a failure of a vehicle controller, portion of a network, or other off-nominal condition may result in the migration of the vehicle speed management application to another controller in the system, whereby the vehicle speed message is being communicated (e.g., where the backup controller is on another network) to support the vehicle speed management application, and the controller may apply a higher priority to the vehicle speed message. The utilization of flows and applications to organize the components of the system allows for the same or similar information to be regulated by the controller in a differential manner to support various functions, allowing for improvements in the performance and security of network regulation operations (e.g., reducing unnecessary cross-network traffic, and providing information only as needed), and supports additional functionality relative to previously known systems, such as redundancy support, distributed control, and granular cross-network messaging.

A policy, as utilized herein, includes a description of data to be collected, such as data parameters, collection rates, resolution information, priority values (e.g., ordering data collection values for selection in response to off-nominal conditions where not all data collection parameters can be serviced, etc.). In certain embodiments, a policy further includes event information, which may be stipulated as parameter or quantitative based events (e.g., a given data value exceeds a threshold, etc.), and/or categorical events (e.g., a particular fault code, operational condition or state, or vehicle location/jurisdiction occurs). In certain embodiments, a policy further includes an event response, such as data values to be captured in response to the occurrence of the event, and/or other changes in the data collection scheme such as increased or reduced data collection rates, changes in collected resolution, or the like. In certain embodiments, an event response further includes a time frame associated with the event occurrence, for example a time period after the event occurrence to utilize the adjusted data collection scheme, and/or a time period preceding the event occurrence (e.g., utilizing a rolling buffer or other data collection operation, providing temporary information that can subsequently be captured if the event occurs). In certain embodiments, changes to the data collection scheme for an event can include multiple changes—for example changes over a period of time, further changes based upon the progression of the event (e.g., if the event severity gets worse), and/or criteria to determine that an event is cleared. In certain embodiments, changes to a data collection scheme may be implemented based on event related clearance of the same or another event, for example implementing a data collection change until a next shutdown event of the vehicle, until a service technician clears the event, for a selected number of shutdown events occurs, or the like.

The utilization of a policy herein may reference a partial policy, for example the implied policy that would be implemented in response to a single data collection scheme from a single user, wherein the full policy is prepared, verified, and communicated to the vehicle after one or more partial policies are aggregated. The utilization of a policy herein may reference an unverified policy, for example after a policy responsive to a number of users is aggregated, but verification operations of the policy are not yet completed (e.g., before it is determined if the data collection implied by the policy can be performed). The utilization of a policy herein may reference a previously applied policy (e.g., a policy present on a vehicle before an updated version of the policy is communicated to the vehicle and/or implemented on the vehicle). The utilization of a policy herein may reference an updated policy, for example a verified policy that is pending for communication to the vehicle 102 and/or confirmed by the vehicle 102 (e.g., from the data collection controller 202).

A test, as utilized herein, should be understood broadly. A test may be utilized to confirm operations of a feature on the vehicle, operations of an aspect of the vehicle (e.g., response of actuators to commands; response or performance of a network of the vehicle; response of an end point to commands, requests, status communications; confirmation of a safe and/or compatible operation of a feature, for example against operating standards, in view of other features on the vehicle, etc.; ensuring proper operation of a safeguard, operational limit, and/or lockout feature, etc.). In certain embodiments, test operations may be performed during manufacturing (e.g., confirming proper installation of a controller; proper software versions or configurations; proper calibration versions or configurations; proper electrical connections for actuators, end points, or controllers; and/or proper installation of components, etc.); during later installation events (e.g., body building operations, for example to configure a vehicle for a particular application, to install additional features or components on a vehicle, and/or to add customized features or components to the vehicle); and/or during a service event (e.g., utilized to confirm proper operation of components, controllers, end points, features, or flows; to confirm that a service event was performed properly and/or fixed the intended issue; and/or to reset a status of an end point, feature, flow, etc. in response to the completion of the service event). In certain embodiments, test operations may be performed on an entire vehicle as-used in service, for example by providing commands on a network of the vehicle to command set points, actuator positions, state instructions for a flow, or the like, thereby performing the test—in certain embodiments, this type of test may be described as an “active test.” In certain embodiments, test operations may include watching the vehicle for operations of the test to be performed in the normal course of operations of the vehicle, for example a test watching for certain vehicle speeds, power or torque commands, actuator sequences, or the like, including transitions between these, where the test includes observation and/or monitoring of responses of end points, controllers, features, flows, and/or vehicle performance (e.g., speed performance, power performance, triggering of faults, HVAC system response, etc.) to determine the outcome of the test. In certain embodiments, test operations may be performed on a part of the vehicle, for example with one or more controllers, components, end points, flows, or the like removed from the vehicle, where such removed parts either do not form a part of the test (e.g., a part that is not relevant to the test, does not provide data required for the test, etc.), and/or where such removed parts are simulated (e.g., and end point that is removed, where the data, responses, commands, etc. that would be provided by the end point are simulated, such as by a computing device coupled to an appropriate network of the vehicle, injecting data onto the network). In certain embodiments, a test is performed on just a portion of the vehicle, including a single end point of the vehicle (e.g., a main vehicle controller plugged into a test station, where all other aspects of the vehicle are simulated). Accordingly, test operations may be performed on a full vehicle, a single end point of the vehicle, and/or any configuration in between these two extremes.

A diagnostic, as utilized herein, should be understood broadly. A diagnostic may be utilized to determine whether an aspect (e.g., an end point, controller, flow, component, actuator, sensor, etc.) is properly operating, whether the aspect has failed, as a part of a troubleshooting operation (e.g., a sequence of tests and/or diagnostics to determine an underlying cause for a failure, fault code, unexpected or undesired operation, etc.), and/or as a routine check for the aspect (e.g., a periodic check, event driven check such as during vehicle start-up or shut-down, etc.). Diagnostics as set forth herein may be performed in any manner analogous to those set forth with regard to tests, for example by any entity (e.g., service, manufacturer, body builder, dealer, owner, fleet personnel, etc.), at any stage of the vehicle life, and/or with one or more aspects of the vehicle removed, simulated, or ignored.

The description herein referencing tests or diagnostics, as well as active or passive tests or diagnostics, is utilized to clarify aspects of the present disclosure, and is not limiting to embodiments herein. A given operation may be considered to be a test for one purpose, and a diagnostic for another purpose, and/or may be referenced as a test or diagnostic due to the entity performing the operation, according to the purpose of the operation (e.g., troubleshooting versus confirmation), according to conventional terminology, or the like, without regard to whether the operation is fundamentally performing a testing function or a diagnostic function. A given operation may be considered a passive test (or diagnostic) for one purpose, and an active test (or diagnostic) for another purpose, and/or may be referenced as active or passive due to the entity performing the operation (e.g., a given test may be an active test from the perspective of a vehicle operator, but a passive test from the perspective of a service person), according to conventional terminology, according to the operating condition of the vehicle, and/or according to which aspects (e.g., end points, flows, components, controllers, etc.) are being tested or diagnosed, without regard to whether the operation if fundamentally an active or passive operation.

Diagnostic or test operations may be performed using a tool having direct access to the vehicle and/or component(s) to be tested, for example with a tool that couples directly to a network of the vehicle (e.g., hardware connection, WiFi connection, Bluetooth connection, and/or cellular connection), by a dedicated subsystem, such as a testing rig, service rig, or the like (e.g., which may further include simulation of one or more aspects of the vehicle), and/or as a remote or automated operation performed on-vehicle (e.g., passing a test or diagnostic as a separate policy, and/or as a dedicated policy, and which may include one or more of: trigger operations for test/diagnostic initiation; execution operations, if applicable, during the test such as data collection, actuator commands, set point commands, calibration adjustments, etc.; and/or post-test operations such as data storage, data communication, data life cycle management, communication operations such as notifications, or the like). Embodiments herein provide for an improved testing and diagnostic ecosystem for the vehicle, including: allowing for testing and diagnostic operations to be performed by a wide variety of personnel without requiring expertise in the vehicle configuration, end point configuration, network configuration, and/or parameter layout (e.g., network addresses, network names, parameter units, parameter end point associations, etc.); allowing for testing and diagnostic operations to conveniently access any aspect of the vehicle; allowing for testing and diagnostic operations to be performed in response to a robust arrangement of trigger conditions; allowing for testing and diagnostic operations to be provided to the vehicle as a latent test or diagnostics to be performed under selected conditions, broadening the array of tests available and reducing the service time required to interact with the vehicle; allowing for testing and diagnostic operations to be performed on isolated portions of the vehicle configuration (e.g., with irrelevant aspects of the vehicle simulated and/or ignored); and improving security through control of operations available according to the user, entity, and/or access mechanism utilized to provide the test and/or diagnostic. In certain embodiments, herein, the diagnostic and/or test is performed by checking actual vehicle response (e.g., vehicle operational response, the response of certain parameter values, the response of network traffic, including traffic associated with a particular network zone, application, end point, flow, or the like) against an expected response of the same—for example a response determined according to nominal operations, a response entered by a technician or expert, etc. In certain embodiments, the expected response may be determined based on a number of vehicles—for example utilizing historical responses of vehicles, and/or by performing a test or diagnostic on multiple vehicles, and determining the expected response statistically (e.g., based on averages, a distance from the average, grouping of the responses, etc.). In certain embodiments, the diagnostic or test evaluation may be performed by checking the actual response versus the expected response, according to a statistical description of the actual response (e.g., close to the average, distance from the average, determination that the response is an outlier within the data set, etc.). In certain embodiments, these may be combined—for example determining the result of the test or diagnostic in comparison to an expected value, by determining whether the result is an outlier within a set of vehicles, and/or comparing a change or variability in the test or diagnostic (e.g., based on operating the diagnostic or test on a given vehicle more than once) and comparing to an expected change or variability (e.g., where the change or variability may be entered as a design parameter, determined from offset vehicles, and/or determined from a history of the given vehicle).

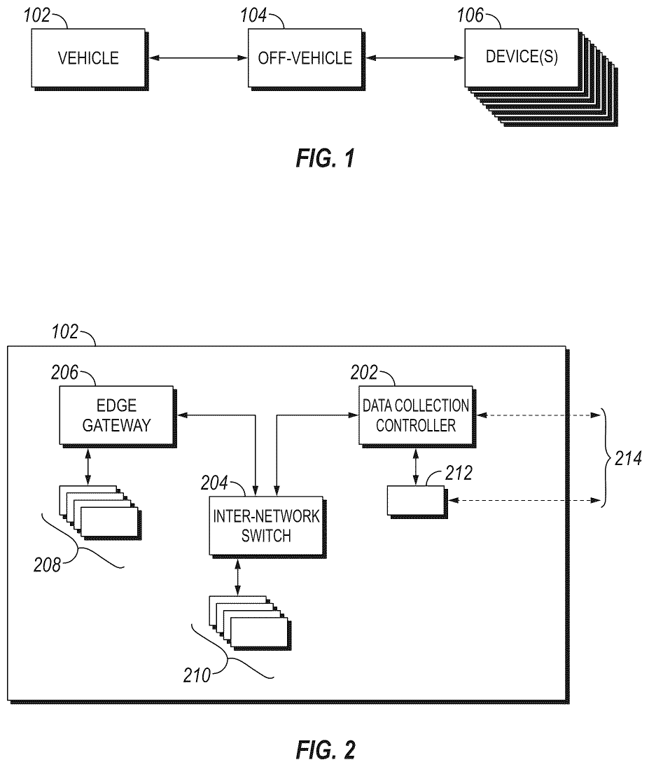

Referencing FIG. 1, an example system is disclosed having a vehicle 102 communicatively coupled to an off-vehicle device 104. The example system includes the off-vehicle 104 device(s) communicatively coupled to one or more user devices 106. For example, the vehicle 102 may include a mixed network having a number of data providing devices coupled to network(s) on the vehicle, for example with one or more devices coupled to a CAN network, and one or more other devices coupled to an ethernet network. The example system allows for users (e.g., application providers, fleet owners, manufacturers, customers, etc.) to access the off-vehicle 104 device, configuring data collection to be implemented from the vehicle 102 to the off-vehicle device 104. In a further example, the system allows for access to at least a portion of the collected data for utilization in an application relating to the vehicle. In certain embodiments, the system provides for authorization control for users and/or applications to ensure that data collection requests are properly made. In certain embodiments, the system provides for data collection control to ensure that requested data communications are achievable, and/or consume reduced data communication resources. In certain embodiments, the system provides for consent implementation to ensure appropriate consent (e.g., from an operator or owner of the vehicle) is provided before relevant data collection is performed. In certain embodiments, the system provides for isolation of specific vehicle information (e.g., data parameter names, communication protocol information, locations and/or ID values of data providers in a mixed network environment of the vehicle) from data requestors and/or users, thereby alleviating the data requestor and/or user from having to learn the specific vehicle information and/or keeping that information updated. In certain embodiments, the system provides for isolation of stored data collected from the vehicle from a system providing requested data to applications utilizing portions of the data. In certain embodiments, the system provides for integrated policy management controlling data collection parameters from a number of simultaneous data requestors, and/or providing enhanced policy management controls to certain users such as policy creators and/or policy controllers. In certain embodiments, the system provides for enhanced policy creation and/or updating, whereby the system communicates with a user in a manner structured to provide the user with high level functionality descriptions, without requiring knowledge from the user about the specific vehicle and/or specific data utilized to support the corresponding high-level functionality. In certain embodiments, the system provides for enhanced data communication to and from the vehicle that is responsive to intermittent network access, and/or intermittent network bandwidth availability, to communicate requested data from the vehicle to an off-vehicle device.

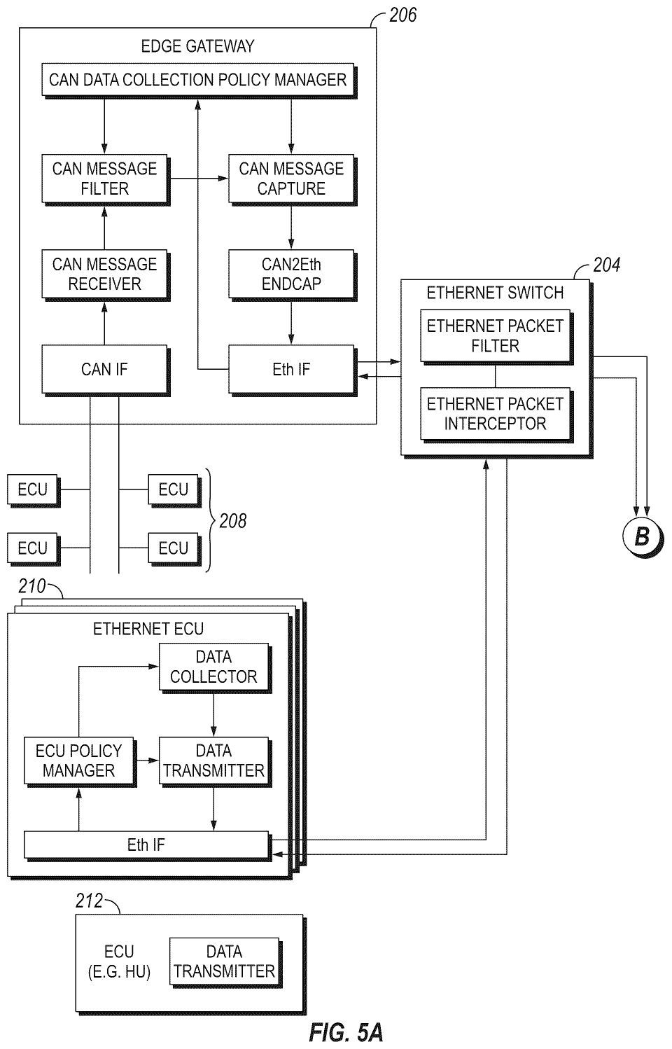

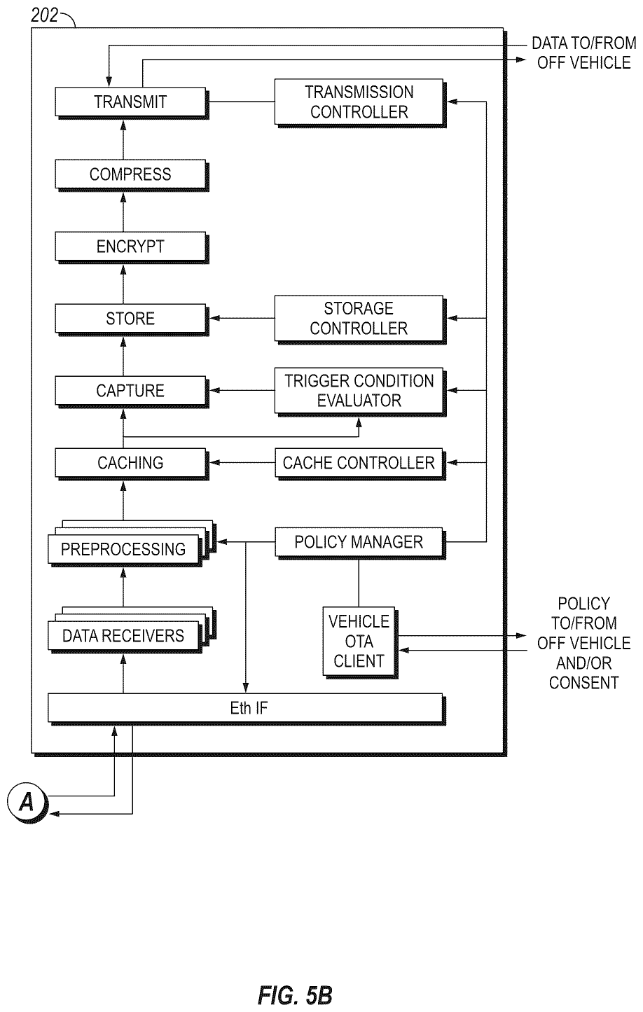

Referencing FIG. 2, an example vehicle 102 is depicted schematically having certain aspects of a data collection system set forth herein. The example vehicle includes a data collection controller 202 that is configured to accept a policy from an off-vehicle device 104, and to propagate functionality in response to the policy to on-vehicle devices to perform appropriate data collection. The example data collection controller 202 further communicates the collected data to the off-vehicle device 104, and/or manages communication in response to intermittent network availability and/or intermittent network bandwidth availability. Certain further and/or more detailed operations of the data collection controller 202 are described in the portion of the disclosure referencing FIGS. 5A-B and 8.

The example vehicle 102 further includes an inter-network switch 204 that is communicatively coupled to at least two networks on the vehicle 102. The example inter-network switch 204 is directly coupled to a number of devices 210 on a first network, and coupled to a second number of devices 208 on a second network, for example via communications with an edge gateway 206. Certain further and/or more detailed operations of the inter-network switch 204 are described in the portion of the disclosure referencing FIGS. 5A-B. Certain further and/or more detailed operations of the devices 210 are described in the portion of the disclosure referencing FIGS. 5A-B. Certain further and/or more detailed operations of the edge gateway 206 are described in the portion of the disclosure referencing FIGS. 5A-B and 6.

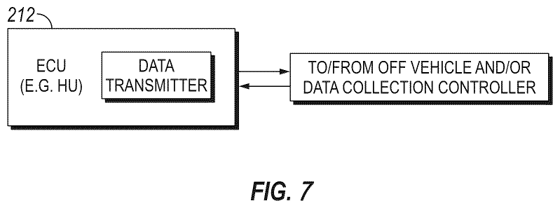

The example vehicle 102 further includes a user consent controller 212 that is communicatively coupled to the data collection controller 202 and/or to the off-vehicle device 104. In certain embodiments, the user consent controller 212 may be an on-vehicle device such as a vehicle display (e.g., a PAD or console device), and/or the user consent controller 212 may be a mobile application (e.g., a mobile device of the user having a consent application operable thereon), a web-based application (e.g., a web application accessible to the user and relating to the vehicle 102), and/or may include more than one of these. Certain further and/or more detailed operations of the user consent controller 212 are described in the portion of the disclosure referencing FIGS. 5A, 5B, and 7. In the example of FIG. 2, external communications 214 are depicted, which may include communications to the off-vehicle device 104. The external communications 214 may be passed wirelessly (e.g., from an available transceiver on the vehicle and in communication with the data collection controller 202 and/or the user consent controller 212), and/or may be passed through a wired communication (e.g., a service tool, OBD device, or the like coupled to a network on the vehicle, for example as a device 210 in communication with the inter-network switch 204).

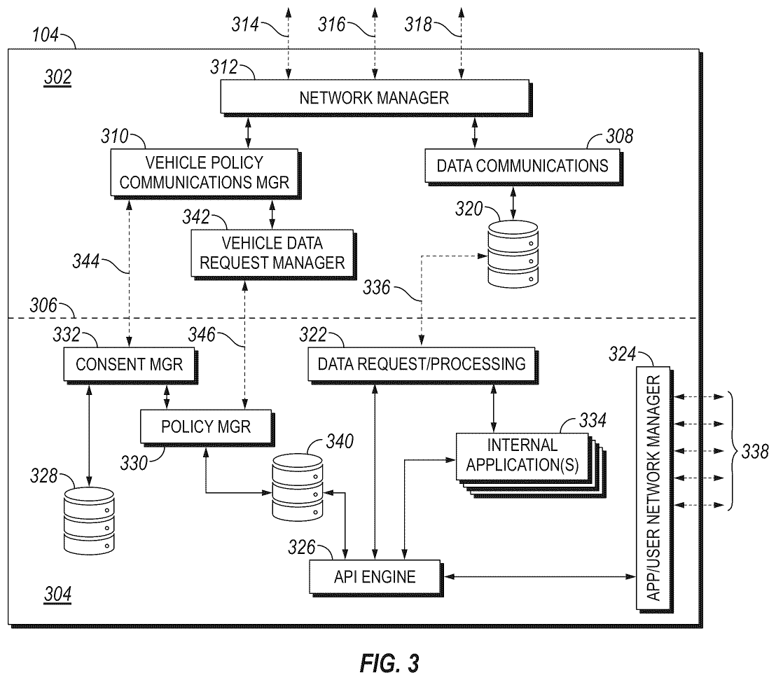

Referencing FIG. 3, an example off-vehicle device 104 is depicted. The example off-vehicle device 104 is depicted schematically as an integrated device having managers and other components depicted thereon to illustrate the interaction of functional elements of the off-vehicle device 104. The off-vehicle device 104 may be a distributed device, having aspects present on a number of controllers, transceivers, servers, or the like. In certain embodiments, the off-vehicle device 104 may be implemented at least partially as a cloud-based device, for example utilizing or communicating with a web-based and/or cloud-based service, such as Amazon Web Services (AWS), Microsoft Azure web services, Cloudflare network services, or the like. In certain embodiments, aspects of the off-vehicle device 104 may be segregated and/or distributed across more than one service, dedicated server, and/or computing device. In the example of FIG. 3, a first partition 302 performs certain operations of the off-vehicle device 104, and interfaces with a second partition 304 that performs certain other operations of the off-vehicle device 104. The example of FIG. 3 depicts a partition boundary 306, where communications across the partition boundary 306 may be configured to an interface specification or other agreed upon or implemented communication scheme.

The example partition 302 includes a network manager 312 that performs load management functions and manages communication with the vehicle 102. The example of FIG. 3 depicts policy communications 316, consent communications 314, and data communications 318 that are at least intermittently communicated with the vehicle 102. The example network manager 312 interfaces with a data communications 308 component, for example passing vehicle data received to the data communications 308 component. The example network manager 312 interfaces with a vehicle policy communications manager 310, for example receiving data collection policies, policy updates, and/or providing consent communications between the vehicle policy communications manager 310 and the vehicle 102. In certain embodiments, the vehicle policy communications manager 310 receives processed policies from a policy manager 330 (and/or from a vehicle data request manager 342) on the second partition 304, makes the policy available to the vehicle 102, and/or determines the timing of when to communicate the policy to the vehicle.

The example vehicle data request manager 342 determines data to be collected in response to a policy provided by the policy manager 330. In certain embodiments, a policy includes a number of data requests from users (e.g., devices 106 and/or internal applications 334), and the vehicle data request manager 342 aggregates the requested data into a set of specific parameters for data collection that meet the data collection needs of all data requests in the policy. In certain embodiments, the policy manager 330 and/or the vehicle data request manager 342 perform policy verification, ensuring that a given policy can be supported (e.g., the requesting user is authorized, the parameter is available on the vehicle, and/or the aggregated data collection to meet the policy can be achieved within the bandwidth limits available) before the vehicle data request manager 342 provides the data requests to the vehicle policy communications manager 310. In certain embodiments, the aggregated data collection set is stored in a data structure, such as an XML structure, a JSON data structure, an HTML data structure, or other selected data structure. In certain embodiments, the aggregated data collection set, including the relevant data structure, comprises the policy to be sent to the vehicle 102. In certain embodiments, the data structure to be sent to the vehicle 102 includes other information, such as event descriptions, priority information, and/or response information to off-nominal conditions such as intermittent network availability, as a part of the policy.

An example policy, as utilized herein, includes a policy provided by an external device that requests a vehicle to collect a set of data over a defined period of time, or short period of time, and to send the data back to the external device. The data may be sent back to the external device within a defined time period stated in the policy, and/or according to a default time period for such policy operations, and may include sending the data back to the external device as soon as the collection of the data is complete. The example policy may be deleted, removed, or otherwise considered complete after the data collection event, and/or after a successive number of data collection events. Such a policy may be referenced as an ad hoc policy, a one-time policy (which may include one or more finite data collection events), an impromptu policy, a single-use policy, an emergency policy, or the like. Example uses of such a policy include rapid response data collection (e.g., handling for an emergency event; information collection to prepare for an update, campaign, or other planned change to a number of vehicles; collection of a data set for training a model or an artificial intelligence component; and/or data collection under any circumstance where the use of the data is expected to be performed within a finite period of time, and ongoing data collection for the policy is not desired).

An example policy, as utilized herein, includes a policy provided by an external device that requests the vehicle to collect a set of data over an extended period of time, and/or on an ongoing basis, where the collected data is sent back to the external device periodically and/or intermittently at intervals that allow for improved utilization of bandwidth by selecting transmission times and/or allowing for compression operations on the data to reduce communicated data volumes. The example policy may be kept for a defined period, kept until removed by the external device, and/or kept until an event occurs (e.g., a research data collection operation, where the event is configured to establish that the vehicle is no longer relevant to the research). The defined period and/or event parameters to delete the policy may be defined within the policy. Example uses of such a policy include research projects, continuous improvement projects (e.g., development of diagnostic or prognostic algorithms for a vehicle or a related group of vehicles, continuous improvement of operational algorithms, etc.), ongoing analysis projects (e.g., analyzing a large data set to detect trends, changes within a related group of vehicles, and/or verify that a change to the related group of vehicles is having an expected effect), and/or projects where a time constant of the project output is long relative to data rates typically received from low utilization data transmission operations. Such a policy may be referenced as a research policy, an analysis policy, a non-urgent data policy, or the like.

An example policy, as utilized herein, includes a policy provided by an external device that requests a vehicle to collect a set of data over an extended period of time, and send the data back to the external device the vehicle as the data is collected, in defined data blocks as each data block is collected, and/or in a streaming fashion. The example policy may be kept for a defined period, kept until removed by the external device, and/or kept until an event occurs (e.g., a change in an algorithm or process utilizing the data, where the data utilized by the algorithm or process changes, where the algorithm or process is discontinued, where the algorithm or process is replaced by an updated algorithm or process, or the like). The defined period and/or event parameters to delete the policy may be defined within the policy. Example uses of such a policy include real-time monitoring of vehicle conditions, implementation of diagnostic or prognostic algorithms for a vehicle or a related group of vehicles, and/or projects where a time constant of the project output is short enough that low utilization data transmission operations are not sufficient to support the project, or to support the project with acceptable performance. Such a policy may be referenced as a real-time monitoring policy, an urgent data policy, an immediate data policy, or the like.

The first partition 302 further includes a data store 320, which may be a raw data store that stores the data provided by the data communications 308 component. The data store 320 keeps the data segregated from the second partition 304 until the collected data is requested, thereby segmenting the risk incurred from data storage. For example, the first partition 302 may be controlled by and/or operated by a first entity, and the second partition 304 may be controlled by and/or operated by a second entity, whereby the partition boundary 306 segments the risk associated with the data storage. In certain embodiments, the data store 320 stores the data in an encrypted format, which may further be configured such that the first entity operating the first partition 302 cannot access the data values of the stored data. In certain embodiments, the data store 320 stores the data associated with metadata values, such as vehicle information, time stamps, data category descriptions, or the like, such that appropriate data can be supplied responsive to a data request by the data request/processing 322 component.

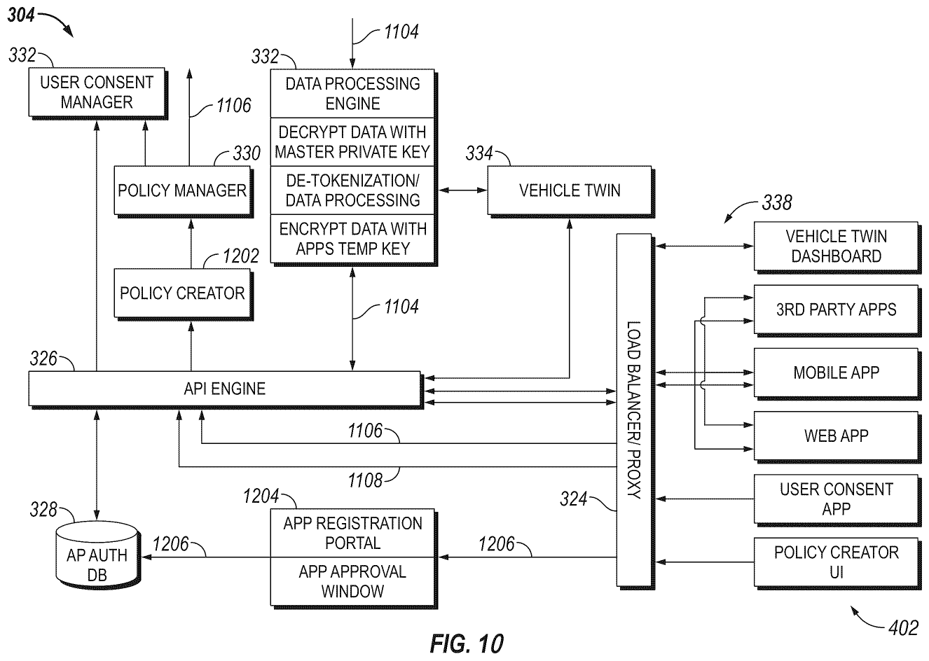

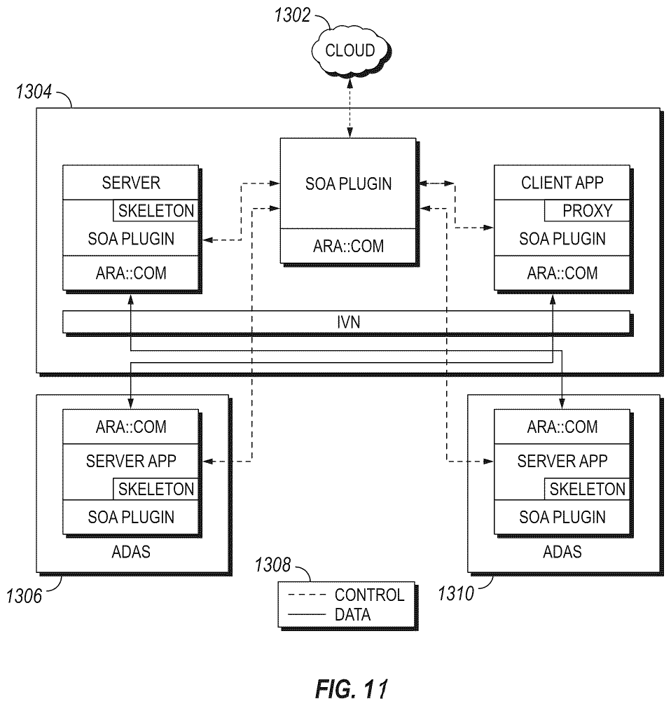

The example second partition 304 further includes a consent manager 332 that determines whether consent for data values in a policy are required and communicates with the user consent controller 212 and/or a consent application 402 (reference FIG. 10, for example a CLI application) to request and receive consent values. In certain embodiments, an application authorization data store 328 is utilized to store consent information, such as consent confirmations for a current policy, pending policy, or the like. The application authorization data store 328 may further be utilized to determine policy aspects (e.g., data parameters, sampling rates, event values, and/or use case values) that are authorized for access by specific users, user roles, applications 402, and/or in accordance with other authorization schemes to be utilized.

The example second partition 304 further includes a policy manager 330 that receives inputs from users and/or applications to determine a requested policy, policy update, policy change, or the like. In certain embodiments, the policy manager 330 interfaces with user devices 106, external applications 402, and/or internal applications 334 via an API engine 326 to determine the requested data collection, events, priorities, etc. to be utilized in determining the policy. In certain embodiments, a user or application may provide a requested policy as a data structure to the policy manager 330, for example a formatted data XML, JSON, HTML, or other data structure that includes formatted descriptions of the requested policy elements.

In certain embodiments, the policy manager 330 provides a user interface to a user or application to provide for rapid, convenient, and/or reliable formatting for policy requests. For example, the policy manager 330 interfacing with an application or user may provide a list of data elements, predetermined event values, and/or predetermined response values, that are available in the system. In certain embodiments, the list may include interface elements such as dropdown lists, check boxes, or other interfaces allowing for rapid selection of requested elements, and ensuring proper formatting of the requested elements. In certain embodiments, user and/or application authorization of requested elements may be performed during construction or entry of the requested policy elements—for example the policy manager 330 may hide unauthorized elements, display unauthorized elements in an alternative format (e.g., grayed out), and/or provide an alert or notification that an unauthorized element is presently contained within the requested policy elements. In certain embodiments, the policy manager 330 may allow unauthorized elements into the policy request (and/or omit pre-screening of authorization), where the policy manager 330 will reject creation of a policy based on the policy request if unauthorized elements are still present at a time of verifying an integrated policy for updating (e.g., integrating a number of policy requests from various users and/or applications into an integrated policy). In certain embodiments, the policy manager 330 may notify a user or application (e.g., a policy creator, policy controller, a super-user, or the like) that a verification of a policy request has failed, whether due to inclusion of an unauthorized data request, due to excessive communication bandwidth requirements, or otherwise. In certain embodiments, the policy manager 330 may identify which element of the policy request caused the verification failure, and/or may provide the notified user or application with options, such as a communication to the user or application making the unauthorized request, an option to authorize the unauthorized request, or the like.

In certain embodiments, operations of the policy manager 330 include operations to compile a number of policy requests from users and/or applications (internal or external) into an integrated policy structure. In certain embodiments, the policy manager 330 (and/or the vehicle data request manager 342) provides the integrated policy structure as a super-set of the data requests (e.g., consolidating data requests for a given parameter), and may further consolidate event requests and/or event responses where those consolidation operations can be made consistent with achieving the events and responses within the individual policy requests. In certain embodiments, the policy manager 330 may include consideration of the data super-set in determining event responses—for example where an event is requesting data to be taken in response to an event, but the data is already being collected for another request within the policy, the event may be omitted and/or the data collected may be reduced to account for the availability of the data.

In certain embodiments, the policy manager 330 includes operations to verify the integrated policy structure, for example to ensure that users and/or applications are only requesting authorized data, to ensure that data parameters requiring consent have the consent available (and/or communicating the consent requirement to the consent manager 332 for appropriate action), and/or to ensure that network bandwidth capabilities of the vehicle, data storage capabilities of the vehicle, or other parameters can meet the requirements of the integrated policy structure. In certain embodiments, the policy manager 330 keeps an updated “live” verification, for example verifying a potential integrated policy structure as policy requests are received from users and/or application. In certain embodiments, the policy manager 330 performs a verification upon request, for example by a policy creator, which may be performed as a “build” of a policy or policy update. In certain embodiments, the policy manager 330 utilizes a default policy, for example when a vehicle is first manufactured.

In certain embodiments, after the policy is verified, the policy manager 330 may communicate the policy to the vehicle policy communications manager 310 for communication to the vehicle 102. Additionally, or alternatively, the policy manager 330 may communicate the policy to the vehicle policy communications manager 310 in response to a request from a policy creator, super-user, or other authorized system user.

In certain embodiments, the policy manager 330 or other system components may access a policy data store 340, which may include previously verified policies, legacy policies, one or more default policies, and/or GUI parameters such as common names for data elements, user role descriptions, application role descriptions (e.g., a set of event values, event responses, and/or data values available based upon an application role such as OEM, Manufacturer, 3^{rd} part, etc.), example event values and/or event responses, and/or vehicle data (e.g., nominal bandwidth descriptions, storage information, etc.).

In certain embodiments, the policy manager 330 provides a high-level description to a user or application, which in certain embodiments may be referenced as a “use case.” A use case may include one or more data collection elements, such as a group of parameters to be collected, and/or may further include one or more associated events and/or event responses. The selection of the use case can thereby be utilized to quickly build a policy request having predetermined information therein. The use case presented to the user may be stored in the data store 340, and/or may depend upon the role and/or authorizations of the user and/or application. In certain embodiments, a use case may have an identifiable or common name, such as “routing application use case,” “passenger car standard use case,” “delivery vehicle use case,” etc. The data store 340 may have default use cases available, and/or may include use cases created or constructed, and/or made available by a policy creator, policy controller, super-user, or the like. In certain embodiments, a user and/or application may have the capability to build a policy request, and save the request as a use case for future implementation as a template, baseline group of data collection parameters, or the like. In certain embodiments, verification operations of the policy manager 330 may utilize the use case (e.g., utilizing a pre-determined value that for a given vehicle, user, application, or the like, that a use case is authorized or unauthorized), and/or verification operations of the policy manager 330 may evaluate the individual elements populated in response to the use case for verification. In certain embodiments, the data values populated by the use case may be displayed to the user and/or application, or may be hidden from the user and/or application.

The example off-vehicle device 104 implements consent communications 344, policy communications 346, and/or data communication 336 to manage communication between the partitions 302, 304. The communications 344, 346, 336 may include standardized interface and/or protocols, for example such that a given partition 302, 304 can be operated independently from updates or changes to the other partition.

The example of FIG. 3 depicts two partitions 302, 304, although in certain embodiments the off-vehicle device 104 may be an integrated device, and/or aspects of the partitions 302, 304 may have additional partitions, and/or a different distribution of components between partitions.

Referencing FIGS. 5A and 5B, an example vehicle network infrastructure for a vehicle 102 is schematically depicted. The example vehicle 102 includes an ethernet switch in communication with a number of ethernet based devices (e.g., sensors, actuators, and/or controllers in communication with an ethernet network), an edge gateway device (e.g., interacting with a second network such as a CAN or second ethernet network, and providing parameters to the first network or ethernet network), a data collection controller, a number of ethernet devices, and a user consent controller.

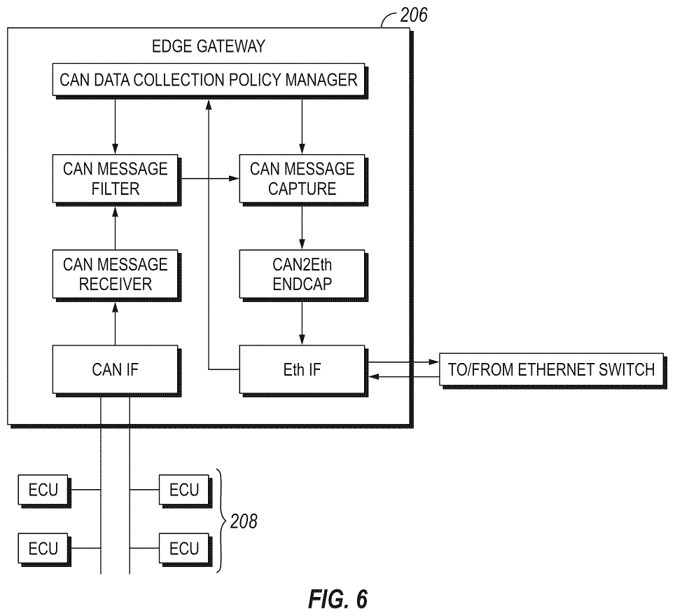

Referencing FIG. 6, an example edge gateway 206 is depicted. The example edge gateway 206 includes a CAN data collection policy manager, which receives data collection commands from the data collection controller. The CAN data collection policy manager instructs CAN data collection from CAN devices 208 to support the data collection commands, and provides ethernet communication parameters to the ethernet switch to support the data collection. The utilization of the edge gateway 206 supports mixed network operation, and in certain embodiments allows the off-vehicle device 104 to operate without requiring knowledge of which devices are present on the CAN, ethernet, or other network. The example edge gateway 206 further includes CAN processing components, such as a CAN IP component that interprets CAN addresses of respective CAN components 208, a CAN message receiver that interprets CAN messages to determine the data values therein, and CAN message filter that supports, for example, down sampling of CAN messages to reduce network traffic within the vehicle network while supporting the policy. For example, if a parameter is provided on the CAN at a 20 ms rate, but the policy requires only a 1 sec sampling rate for the parameter, then the CAN message filter can expunge excess sampling of the message. In certain embodiments, other components may perform down sampling in addition to, or instead of, a CAN message filter. For example, the ethernet switch and/or the data collection controller may perform appropriate down sampling. The location of the down sampling may depend on the specifics of the policy (e.g., if a parameter may occasionally be sampled faster due to an event, then the CAN message filter may provide data at the highest rate that could be required, allowing another component to down sample when the higher rate is not required, and/or the CAN message filter may be responsive to the event, down sampling appropriately based one the circumstances). The example edge gateway 206 additionally includes a CAN message capture, for example passing the CAN sampled data and/or buffering the CAN sampled data until it is passed. The example CAN Gateway further includes a CAN2Eth Encap component, that encapsulates the captured CAN message into an ethernet message (e.g., including leading and/or trailing message data, and/or packaging one or more of the CAN messages into a single ethernet packet). The example CAN Gateway further includes an Eth IP component, which communicates the encapsulated CAN messages to the appropriate address on the ethernet network. In certain embodiments, messages are passed in both directions, for example allowing the CAN data collection policy manager to receive appropriate portions of the current policy, allowing the Edge Gateway to receive event data indicators (e.g., that a given event has occurred), and the like. In certain embodiments, a mixed network may include different network types than a CAN-ethernet mix, and/or may include networks with distinct protocols (e.g., packet sizes, leading/trailing bits, etc.), where the Edge Gateway includes appropriate components therefore.

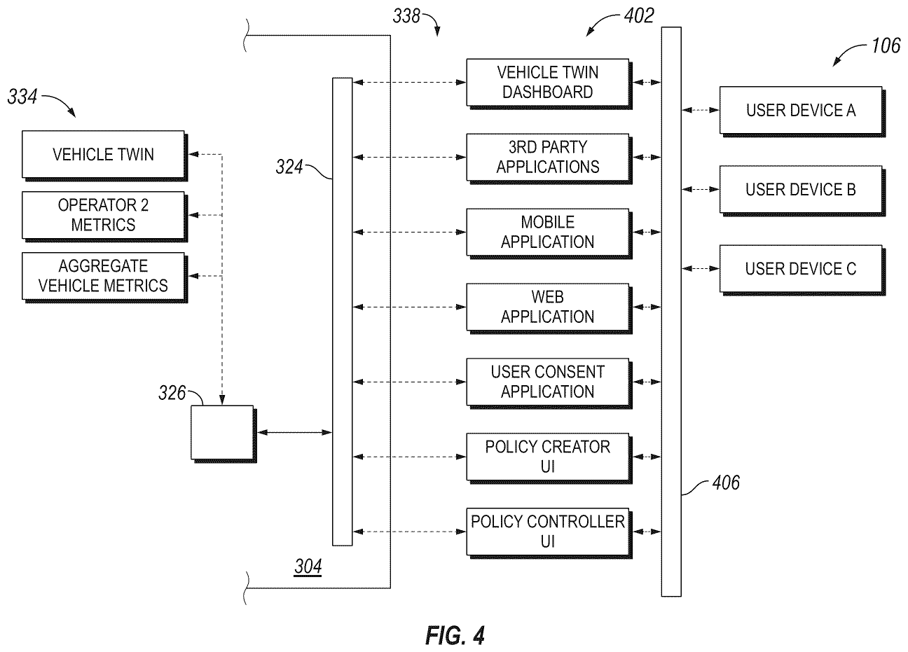

Referencing FIG. 7, an example user consent controller 212 is depicted. The user consent controller 212 may be a part of, and/or may be associated with, an on-vehicle user input device such as a console (e.g., a touch screen interface) accessible to the vehicle operator. In certain embodiments, the user consent controller 212 may be omitted, and/or may be in another part of the system, for example as an application for a mobile device, a web portal or other interface for a connected device, or the like. For example, where the owner of the vehicle and/or associated data is separate from the operator, and/or for the convenience of the operator, an alternate interface may be provided for consent communications. In one example, an operator utilizes a mobile device having an application installed thereon for performing consent operations, for example having a login or authentication operation that confirms the association with the vehicle. In another example, an owner or agent having authority accesses an application or web portal—for example a fleet manager having a web-based access on a computing device and/or a mobile application associated with the vehicle. In certain embodiments, user consent can be provided for multiple vehicles within a single interface (e.g., a web application listing a group of vehicles) and/or with a single action (e.g., approving a policy update for a selected group of vehicles). In certain embodiments, a user consent application (e.g., reference FIG. 4) may be used in conjunction with, or as an alternative to, the user consent controller 212.

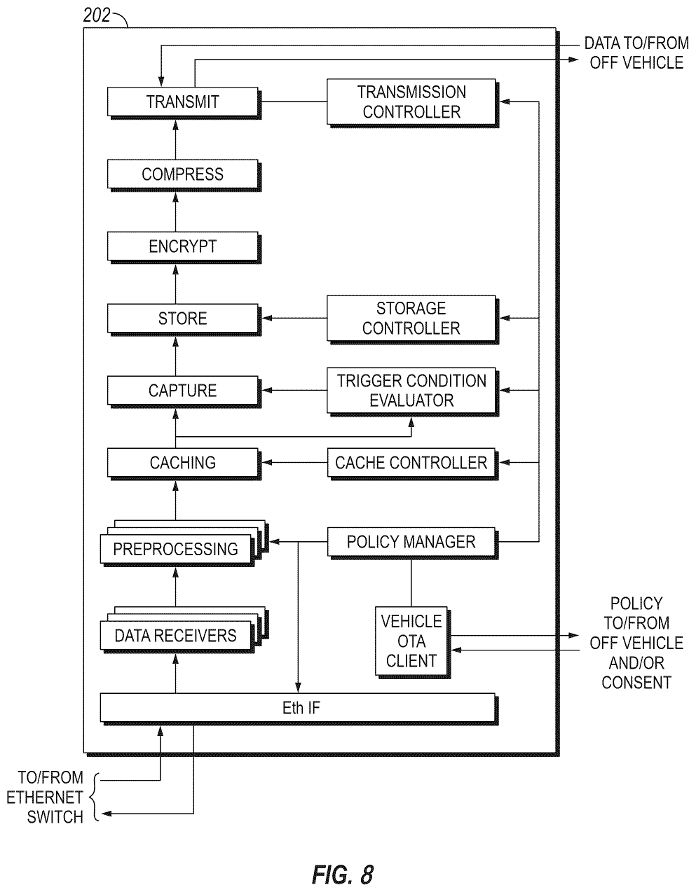

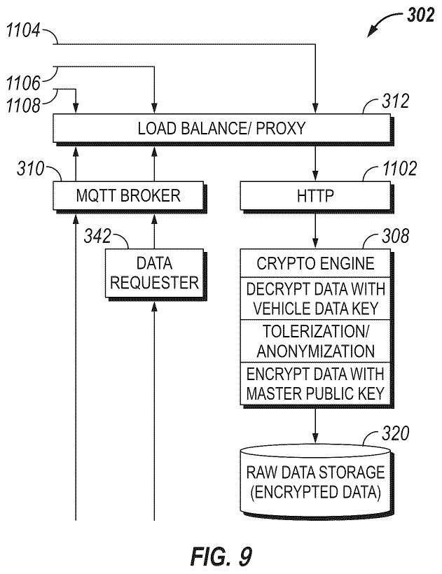

Referencing FIG. 8, an example data collector controller 202 having a number of components thereon, and configured to functionally execute operations of the data collector controller 202, is schematically depicted. The data collector controller 202 includes a vehicle OTA client (over the air) that receives policy updates, policies, and/or policy notifications from the off-vehicle device 104. The example vehicle OTA client communicates the policy, policy update, and/or policy notification to the policy manager. In certain embodiments, the policy may be provided from the off-vehicle device 104 through an MQTT broker (reference FIG. 9), allowing for the vehicle 102 to subscribe for policy updates, and to receive immediate notification that an updated policy is available, without requiring that the full policy be communicated to the vehicle 102 until the vehicle 102 is in a condition to receive and/or implement the policy. In certain embodiments, the policy manager may download a policy update and store it for later implementation. In certain embodiments, the policy manager may command a download of the policy only when the vehicle 102 is in a condition to implement the policy (e.g., during a shutdown operation, during steady state operation, or the like).

The example policy manager verifies the policy, for example performing checks based on vehicle specific information that may not be available to the policy manager 330 on the off-vehicle device 104, to ensure the policy can be implemented. For example, if the policy requires data collection from device that is not present, requires network traffic (on either network of the vehicle, through the ethernet switch, or at some other component of the vehicle network) that is not possible or otherwise not compliant with the requirements of the vehicle, and/or requires a type of information that the vehicle 102 cannot provide (e.g., a sampling rate and/or resolution that is not available), the policy manager may reject the policy and/or provide a notification to the off-vehicle device 104 that the policy was rejected. In certain embodiments, the policy manager may be configured to partially implement the policy, for example implementing higher priority data collection elements from one part of the policy and rejecting other lower priority data collection elements, and/or replacing part of a currently implemented policy having a lower priority than a high priority portion of the updated policy. However, in certain embodiments, the policy controller may be configured to either accept or reject a new or updated policy in the whole. In certain embodiments, for example where the policy manager is not able to fully comply with a new or updated policy, the policy manager may be configured to communicate information about the partial implementation of the policy to the off-vehicle device 104 (e.g., a flag indicating only partial compliance, and/or further information such as which parameters are not being serviced, and/or a level of service available or being provided instead).

In certain embodiments, the policy manager parses the policy elements and communicates relevant elements to policy managers throughout the system (e.g., to the Edge Gateway, ethernet switch, ethernet devices, and/or other components with the data collection controller 202 as described following). The example data collection controller 202 includes data receiver component(s) that receive data responsive to the policy (and/or planned for response if an event condition is detected) from the ethernet network (e.g., utilizing an Eth IP component) and/or other components on the vehicle 102 (e.g., from the user consent controller). The data receivers provide the data to a pre-processing component, which may determine virtual sensor or modeled values, adjust data sample rates (e.g., performing filtering operations), adjust resolution values, and the like. In certain embodiments, the pre-processing component may perform certain operations that support event detection, such as determining secondary state values that inform the event status determination, reject or tag data based on fault codes present, or the like.

The example data collection controller 202 includes a caching component that performs short-term data storage, for example to allow for parameter processing, and/or to support information capture such as rolling buffers where an event may trigger short-term past data recovery (e.g., a trigger indicating an accident, a component failure, or the like where past data is desirable when the event is detected). The example caching component may be responsive to commands from cache controller, which may receive parsed caching instructions to support the policy, and/or may adjust caching operations in response to the current operating conditions of the vehicle 102. In certain embodiments, the size of the cache and/or other available storage may affect the ability of the data collection controller 202 to meet the requirements of a policy. For example, where numerous events in the policy provide for significant consumption of cache memory, the policy manager may determine that the current configuration of the vehicle 102 cannot meet the policy. In certain embodiments, for example where multiple part numbers of the cache component having distinct cache sizes are present within a group of vehicles, and/or where a vehicle specific condition is present (e.g., a portion of the cache memory is failed or otherwise unavailable), the policy manager having superior information about the specific vehicle relative to the policy manager 330 on the off-vehicle device 104, may make a determination that the policy cannot be verified where the policy manager 330 approved the policy. In certain embodiments, the trigger condition evaluator receives parsed information from the policy manager indicating event detection criteria, and the trigger condition evaluator determines which event conditions are present in response to the event detection criteria and the cached and/or captured data. In certain embodiments, event detection may be performed in other components as described throughout the present disclosure, such as at the Edge Gateway policy manager and/or at the Ethernet device policy manager. In certain embodiments, the policy manager of the data collection controller 202 determines which device has sufficient information available to fulfill operations of the event detection and provides parsed elements of the policy to the appropriate component. Accordingly, in certain embodiments, the trigger condition evaluator may reference a state value indicating whether a given event condition has occurred, rather than perform a direct detection of the parameters utilized to determine whether an event has occurred. In certain embodiments, one device may perform primary event detection, and another component (e.g., the trigger condition evaluator) may perform a secondary detection of the same event, for example providing a system that is responsive to detect an event when a primary sensor indicating the event has failed, but a backup sensor to detect the occurrence of the event.

The example data collection controller 202 includes a capture component that provides the parameters for storage. In certain embodiments, the capture component is responsive to commands from a trigger condition evaluator, for example indicating that a trigger condition (event) is active, and may pull further information from the caching component (e.g., buffered values available in the cache) to support the implementation of the policy. The example data collection controller 202 includes a storage component that stores the captured data for transmission to the off-vehicle device 104. An example storage component utilizes non-volatile memory, such as FLASH memory, allowing for stored data that has not been transmitted to be saved in the event of power loss. The example data collection controller 202 includes a storage controller that provides storage commands for the storage component to support implementation of the policy, and/or to support specific operating conditions of the vehicle 102, such as intermittent loss of network communication to the off-vehicle device 104 and/or intermittent ability to communicate data to the off-vehicle device 104 (e.g., where higher priority resources are utilizing available bandwidth, and/or where data communication limits exist, such as a data plan limitation). In certain embodiments, storage of data collection parameters is performed until the store component is full, wherein some of the data is purged (e.g., oldest data, lowest priority data, and/or least utilized data). For example, if a first data element supports numerous policy requests, and another data element supports only a single policy request, the storage controller may be configured to keep the data that meets the higher percentage of the available policy requests. In certain embodiments, data element correspondence to various policy requests is not available at the storage controller, and other criteria are utilized to determine which data will be purged or expired. In certain embodiments, a portion of the data to be purged may additionally or alternatively be compressed and/or summarized to reduce utilization of the storage. In certain embodiments, a portion of the data to be purged may be down sampled to reduce utilization of the storage. In certain embodiments, the amenability of certain data elements to compression, summarization, and/or down sampling (amenability may include required consumption of processing power, descriptive value of the data in a compressed, summarized, or down sampled format for the underlying data, or similar considerations) may be considered in determining the commands from the storage controller in response to a full (or filling) storage component. In certain embodiments, commands to compress, summarize, and/or down sample data in response to a full or filling storage component may be provided as a part of the policy, and/or the policy may further include instructions for techniques to be utilized for the compression, summarization, and/or down sampling of data when indicated. In certain embodiments, the policy may further include thresholds (e.g., storage value thresholds, time remaining until storage is full, etc.) indicating when storage purging, compression, summarization, and/or down sampling operations are to be performed.

In certain embodiments, the storage controller is configured to support cache operations by utilizing a portion of the storage available on the storage component. In certain embodiments, the storage controller may be configured to determine an amount of storage than can be utilized based on historical information such as usage fractions of the storage component over time, and/or network availability to transfer collected data to the off-vehicle device 104. In certain embodiments, storage support for the caching component may be defined within the policy. In certain embodiments, storage support for the caching component may not be utilized. In certain embodiments, the availability of storage support for the caching component may be considered by the policy manager in operations to verify the policy.

In certain embodiments, the data collection controller 202 includes an encryption component configured to encrypt data to be transmitted to the off-vehicle device 104. In certain embodiments, the data collection controller 202 includes a compression component configured to compress data to be transmitted to the off-vehicle device 104. The compression may be lossy or lossless compression, and the compression type may be determined according to the type of data, the descriptive value of the data after compression, and/or may be determined by the policy. The data collection controller 202 further includes a transmit component configured to transmit collected data to the off-vehicle device 104, and a transmission controller component to configure the transmission, for example to support selected data protocols, to mediate between competing transmission resource of the vehicle 102 (e.g., comparing relative data priority to other transmission elements, scheduling transmission according to a data plan, vehicle operating condition, and/or to support a virtual channel utilized on a transceiver). In certain embodiments, the transmission controller is responsive to parsed elements of the policy indicating data plan values (which may differ between specific data elements—for example where a first data element is associated with a first requestor having a first data plan, and where a second data element is associated with a second requestor having a second data plan), transmission priorities, and/or vehicle operating conditions related to any of the foregoing.

In certain embodiments, one or more data stores described herein are utilized to store raw vehicle messages and data, and may further include metadata or other information to identify the data at a selected time-such as vehicle identifications, time stamps, identifiers for the data, and/or any other information allowing the system to access content of the raw data store at a selected time and utilize the content of the raw data store for one or more purposes described herein. Raw data may reference vehicle data communicated off-vehicle, stored locally on the vehicle (e.g., for a selected period of time), as the data is presented such as from a data collection controller 202 (reference FIG. 2). In certain embodiments, data may be processed at least partially, for example compressed data, down-sampled data, summary data, aggregated data, or the like, and may still constitute raw data as set forth herein. In certain embodiments, data may be significantly processed—for example data determined from a model, virtual sensor, or the like, and may still constitute raw data as set forth herein. For example, an output of a virtual sensor or model describing a basic vehicle parameter such as vehicle speed, ambient air temperature, or the like, may be stored as raw data for utilization by applications 402, 334 (e.g., reference FIG. 4). The description utilizing raw data may include data that is utilized in a manner as provided by the vehicle, and/or data utilized in a manner that is presented to applications 402, 334 as basic vehicle parameters that are available for utilization. A given data value (e.g., vehicle location) may be treated as raw data for a particular system and/or for a particular purpose, and not treated as raw data for another system and/or purpose.

Embodiments of the present disclosure provide for systems, apparatuses, and methods for management and/or operation of shared network storage for a mobile application having a number of data storage devices associated therewith, and/or may further include where the number of data storage devices are distributed across at least two networks and/or across networks of a mixed network for the mobile application. Embodiments include a unified storage shared by multiple applications, flows, processors, circuits, end points, devices, services, and the like. Embodiments herein provide for network file system access to end points, devices, applications, and/or flows on the networks of the mobile application. Embodiments herein provide for an overlaid database service for shared stored data, and/or portions thereof. Embodiments herein provide for selected encryption schemes for shared stored data, including at least encryption of data at rest. Embodiments herein provide for authentication, access control, and auditing of shared network storage operations, including at least scheduled operations according to a policy, permissions of participating devices, etc. Embodiments herein provide for data life cycle management of shared stored data, including at least: implementation of policies; data retention schemes; and/or prioritization between devices, end points, applications, flows, related services, data types, and/or determined operating conditions of the mobile application.

Example embodiments allow users to create custom trigger-action rules to automate the vehicle environment, and to allow in-vehicle capabilities that were not previously available. For example, embodiments herein include customer control of cabin temperature, lighting, infotainment, seats, windows, sunroof, cabriolet top, driving mode, and/or adjustment of any other actuator or vehicle interface in response to voice commands, smart phone inputs, buttons in the vehicle, and/or detected vehicle operating conditions or events.

An example system includes a centralized controller having an automation manager that determines a customized operation including a trigger-action (e.g., a voice command; an operator input value such as from an application, personal device, vehicle operator input, and/or vehicle display input; vehicle operating condition; detected event; and/or combinations of these). The example automation manager monitors vehicle conditions to determine if the trigger-action has occurred, and commands the customized operation in response to the trigger-action occurrence. In certain embodiments, the automation manager may limit implementation of the customized operation in response to vehicle conditions (e.g., an “open door” command that opens the driver door may include a condition such as zero vehicle speed, which may be implemented by the user providing the customized operation or otherwise enforced elsewhere in the system). In certain embodiments, interactions with certain actuators (e.g., a direct vehicle start command) may be disallowed and/or require additional authorization or permission. In certain embodiments, interactions with certain actuators (e.g., the vehicle start command) may embody a request to an application or flow of the vehicle, rather than a direct command of the implementing actuator (e.g., where the vehicle has an automated starting function available on the vehicle, whereby the customized operation requests implementation of the automated starting function, rather than providing a direct command to the starter of the vehicle), which may have permissions that are distinct from permissions associated with the direct command of the underlying actuators. In certain embodiments, customized operation data are stored in a memory storage on the system, such as with configuration information. In certain embodiments, the automation manager limits configuration of the customized operation based on permissions and/or authorizations of the configuring entity (e.g., owner, operator, manufacturer, 3^{rd} party application provider, etc.), and/or according to permissions associated with data elements accessed and/or actuators commanded as a part of the customized operation.

Example operations are described following to illustrate a few operations of a type supportable by embodiments of the present disclosure. The example operations are non-limiting, and an example automation manager is capable to respond to any input capable of being provided as a network communication and/or data parameter stored on a computer-readable medium, and to provide any response capable of being commanded to any actuator in the system, including actuators under the control of another controller in the system (e.g., a vehicle display, system speakers, vehicle powertrain, etc.).

An example automation manager (or vehicle automation manager) allows users to create arbitrary trigger-action rules which can be executed on the vehicle, such as by the centralized controller. For instance, the user could create a trigger-action rule that would automatically turn on the high-beam headlights when there is no oncoming traffic while driving at night. An example schematic flow description of the customized operation includes:

The user accesses an app on her phone or web browser and uses it to create custom trigger-action rules, or enable predefined ones created by the OEM; the trigger-action rules are sent to the cloud, and the enabled trigger-action rules are consolidated as a “recipe” on the cloud side; the cloud pushes the recipe to the vehicle through the vehicle update controller (VUC) (e.g., storing configuration information related to customized operations); and when the trigger evaluation engine receives the latest recipe, it analyzes each rule in the recipe and executes each rule in a controlled and isolated manner.

It can be seen that the vehicle automation manager allows users to enrich their vehicle experience without waiting for a feature request, approval, and update process. The example vehicle automation manager further allows the user to leverage their own creativity and/or the creativity of 3^{rd} party application providers to implement improved vehicle interactions. Additionally, the vehicle brand owner (e.g., manufacturer or OEM) or other supporting or responsible party can implement trigger-action rules to more rapidly and/or more frequently provide updates or features to many users, or even to specific users.

An example Vehicle Automation Manager (VAM) takes recipes from the cloud as inputs and executes the trigger-action rules in the recipes. Each trigger-action rule is composed of triggers, conditions, and actions. The triggers are the inputs to the rule that encompass signals from the CAN bus, time, location, diagnostic states, vehicle status, video/audio, driving log, etc. Conditions take trigger input values and decide if certain conditions are met.

The conditions are described using a custom syntax, in order to express complex logical conditions, such as multi-level AND/OR logic, comparators, and advanced utility functions to calculate sum/mean/stddev etc. If the conditions are met, then the corresponding actions will be executed, and/or requested (but may be blocked due to operating conditions, etc.). The actions could include calling services in the SOA or sending CAN signals to the CAN ECUS.

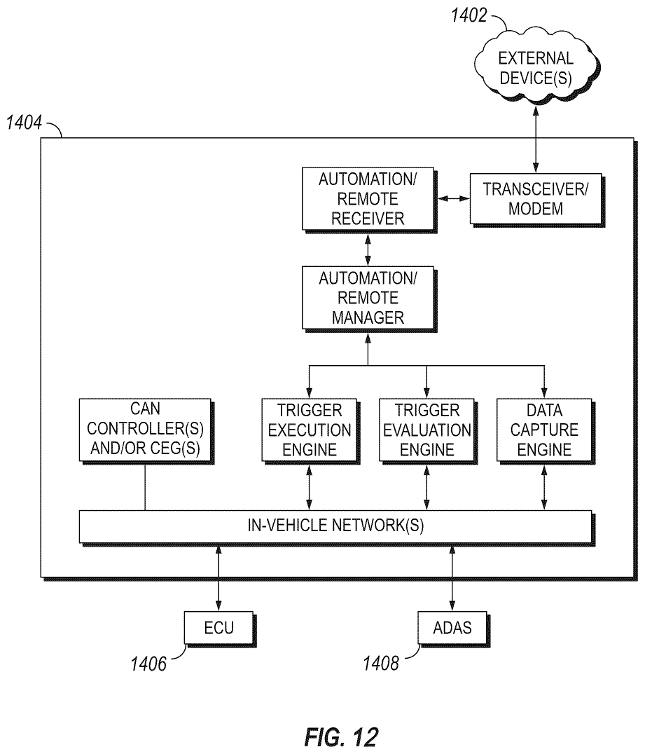

Referencing FIG. 12, an example automation manager is schematically depicted, and positioned on a centralized controller. In the example of FIG. 12, the VUC receives recipes (and/or configuration information describing a customized operation) from the cloud using MQTT/HTTP/WebSocket, etc. The VAM controls the vehicle automation based on the recipes, and includes a lexical engine to parse the recipes, and a rule engine to orchestrate the rule execution by leveraging a trigger evaluation engine and a task execution engine (and/or a trigger execution engine). Operations of the automation manager such as in FIG. 12 may include vehicle automation operations, event trigger operations, remote control operations, and/or any configurable operations performed in response to an application, feature, trigger, or other automated application created by a manufacturer, OEM, fleet owner, vehicle owner, vehicle operator, and/or a third party.

An example trigger evaluation engine takes triggers as inputs and evaluates the trigger conditions based on the trigger values. The trigger values can come from any network, such as a CAN bus, for example using a configurable edge gateway to adjust the routing table to retrieve the signal values dynamically. In addition, the values could also come from other Ethernet ECUs through a SOA, from other modules on the centralized controller (e.g., Diagnostic Server), or raw video/RADAR/LiDAR streams over Ethernet. The centralized controller may further share the data collection performed for customized operations with other aspects of the system, such as data collection operations for other purposes, and/or between multiple customized operations utilizing at least some of the same trigger data parameters, thereby reducing redundant requests for the same data parameters. In certain embodiments, data collection may be a separate operation that may additionally be based on a trigger condition, and/or data collection may be performed as a customized operation.

In the example of FIG. 12, the trigger manager (e.g., as the automation/remote manager in the example of FIG. 12) manages triggers from various trigger related clients, such as vehicle automation, remote control, and/or data collection triggered flows. The example in FIG. 12 further includes a data listener that receives data related to the triggers, which may be taken from any location in the vehicle, such as: a CAN bus; Ethernet packets (including EthCC packets having state information such as vehicle location); a diagnostic manager providing DET errors, RDBI data, fault codes, etc.; a system manager (e.g., providing vehicle power state information); a time manager (e.g., providing a current time value); and/or any other information such as from the SOA.

In the example of FIG. 12, the data cache stores the data for condition evaluation, for example including buffered data, intermediate parameters, etc.

In the example of FIG. 12, the condition evaluation runtime is an engine to evaluate the conditions based on the trigger values in the cache, and to determine whether the trigger condition is met in response to the evaluation. The condition evaluation supports any type of analysis or determination operations, including at least: basic logical operators (e.g., AND, OR, numerical comparisons, etc.); nested logical expressions with appropriate formatting (e.g., ((X>5 && Y<10)∥Z!=100) && P<0.05); math functions (e.g., arithmetic, exponential, trigonometric, modular, gamma, etc.); and/or complex data transformation functions over a range of data (e.g., median; mean; standard deviation; map; reduce; min/max; bucketing; filtering; integrating; derivating; and/or frequency analysis operations).

In the example of FIG. 12, the task execution engine performs actions defined in the action catalog (e.g., the actuators to be adjusted according to the customized operation). Example and non-limiting actions include turning on a light, turning on and/or adjusting the HVAC, turning on the ignition, etc. Embodiments of the present disclosure are capable to access any actuator that is reachable through any network, including actuators provided on more than one network (e.g., an Ethernet for one actuator, and a CAN for the other actuator). In certain embodiments, actions include a request for operation of an actuator (e.g., to another controller having direct control of the actuator), actions to request a published service be performed, and/or actions having complex interactions which may further be present on more than one other controller. For example, an action includes adjusting the ambient environment for the current user, which may include interacting with multiple controllers and/or flows, for example to determine a current user identity, her preferences, and adjusting the environment such as seat position, HVAC settings, radio channels, etc.

In certain embodiments, the automation manager advertises one or more customized operations as a service (e.g., which may be selectable by the requestor of the customized operation, defined in a policy, etc.). In certain embodiments, components, circuits, controllers, and/or engines of the automation manager are shared in whole or part with other managers such as a remote control manager, and/or may be responsive to other managers using an API, library calls, or other interaction interface, for example to determine whether a specified group of data and trigger logic (e.g., passed from the other manager to the automation manager) indicates that a trigger event has occurred (e.g., determined by the condition evaluation runtime), and/or to implement an operation provided by another manager (e.g., passed as an operation request from the other manager to the automation manager) to be implemented (e.g., operated by the task execution engine to move the actuator and/or provide appropriate commands to other controllers).

Implementations of the present disclosure provide for rapid development and deployment of customizable operations, automation implementation without coding and/or compilation requirements, access to customization for customers, 3^{rd} party applications, aftermarket suppliers, etc. Implementations of the present disclosure provide for ease of implementation of customizable operations even where data providers and/or actuators are distributed across more than one network type, and do not require that providers for customizable operations have knowledge of the present configuration of on vehicle networks. Implementations of the present disclosure provide for rapid development and deployment of test procedures, including active (e.g., “intrusive”) or passive tests, configuration and/or execution of tests to detect and/or confirm fault conditions of components, end points, flows, applications, or the like throughout the vehicle, configuration and/or execution of tests to perform fault analysis and/or root cause analysis in response to conditions on the vehicle, and/or diagnostic operations of any type. Implementations of the present disclosure allow for numerous improvements over previously known systems, including, without limitation: utilization of a greater range of testing operations than available in previously known systems due to capability constraints in reaching system components, sensors, actuators, or the like throughout the vehicle; utilization of a greater range of testing operations than available in previously known systems due to storage limitations (e.g., storage of instructions on a computer-readable medium to execute tests, store test results, and/or communicate test results and/or confirmation values); allowing vehicle experts (e.g., service experts, component experts, fault analysis experts, etc.) to be logically closer to test creation and implementation, for example by providing an interface to create and execute tests that does not require sophisticated coding skill sets, knowledge of end point positions and configurations, and knowledge of vehicle network topology, protocols, network limitations, and the like; improved response time for test implementation, execution, and updates, allowing for quicker implementation of service knowledge and customized response to the conditions for a particular vehicle; allowing for enhanced capability for test operations without changing fundamental code for the vehicle (e.g., firmware, base control operations, and/or full code updates), which would otherwise implicate enhanced requirements for certification, validation, or the like, and which would increase the risks to the vehicle mission (e.g., by potentially disabling or “bricking” one or more controllers on the vehicle) and costs for implementation (e.g., by requiring vehicle shutdown or downtime); and/or improving test operations by allowing test creation and implementation without requiring knowledge of the specific configuration of vehicles (e.g., the position, configuration, network location, etc. for end points of the vehicle, which can vary between vehicle models, with vehicle upgrades, due to manufacturing variability, and/or due to changes such as service events, recalls, after market changes, or the like). Example operations herein are capable to: gather data from any sensor or end point on the vehicle regardless of network position and configuration of the sensor or end point (e.g., units utilized, network address, physical network location, version of the sensor or end point, etc.); to control any actuator or end point on the vehicle regardless of the network position and configuration of the actuator or end point; to control any trigger conditions to implement a test or aspect of a test, including trigger conditions based on any parameters available on the vehicle, and/or logically combined triggers such as sequenced triggers, parallel triggers, conditional triggers, etc.; and/or utilize gathered data to implement trigger operations, to control test aspects, and/or for collection and analysis, for example to confirm proper operation of an end point, application, or flow, and/or to diagnose a tested aspect, component, or the like. In certain embodiments, circuits, controllers, procedures, and/or any other aspects of systems, apparatuses, or the like, may be utilized in embodiments to configure and/or implement a test operation herein, including without limitation embodiments to allow for policy based control and implementation of data collection, end point communications, data storage, stored data communication, stored data life cycle management, vehicle remote control operations, and/or automated vehicle response operations. Embodiments herein may be utilized at any point in the vehicle life cycle, including for example: during manufacture; confirmation after manufacture and/or at a stage within manufacture operations; after a service event; as a part of a service event; during a post-manufacture operation (e.g., an upgrade operation, installation of an after-market component or service, configuration by a body builder, and/or servicing and/or installation of components by a dealer); in-use operations (e.g., by a fleet owner or service provider, by the vehicle owner or operator, by the manufacturer, etc.); in response to a reported fault, customer request, and/or detected event; and/or in response to a general operation for a related group of vehicles, such as upgrading capability for the vehicles, performing recall operations, determining whether a recall operation is indicated, or the like.

Examples of the present disclosure provide for the ability to perform remote control operations for a mobile application. Remote control operations for certain features may be hard-coded in the ECU software—for example simple operations such as start/stop operations of the engine, lock/unlock operations of the doors, open/close operations of the windows and/or sunroof, etc. However, adding or changing functionality after production is complete for such features requires code changes and verification, which may include re-qualification of one or more ECUs, and/or software builds on those ECUs, that participate in remote functions. Embodiments of the present disclosure are capable to configure remote control operations of a mobile application at any point in the life cycle of the vehicle, and further allow for configuration, updating, and fixing of remote operations included at the time of manufacture. Additionally, or alternatively, where a more robust remote control implementation is present such as set forth in the present disclosure, features that would previously be hard-coded may be implemented as a dynamic feature as set forth herein.

An example system for performing remote control and configuration operations includes operating a control portion of the mobile application in a powered mode during a shutdown vehicle operating condition. In certain embodiments, a controller to perform remote control operations includes granular power control of the centralized controller and/or other ECUs on the vehicle, keeping only those controllers powered that are required to perform remote control operations, and providing for operation of those controllers and related hardware components (e.g., board, chip, core, voltage, clock, etc.) in a low power state that is capable to receive remote control commands and configuration requests. In certain embodiments, a remote control manager powers determines that a vehicle shutdown operation is active, and keeps aspects of the vehicle's hardware powered that are responsive to a remote control command and/or configuration request. In certain embodiments, the remote control manager powers down controllers and hardware that are not needed for remote control command and/or configuration requests in response to the vehicle shutdown operation. The example remote control manager receives a remote control operation and/or configuration request, and wakes up any controllers or hardware required to perform the requested functions, and then returns the vehicle controllers or hardware to a low power state.

Example operations of the remote control manager to perform a vehicle shutdown operation include:
Turn off all controllers, except an ECU configured to perform remote control functions, and a cellular modem;
Stop all applications and processes in the ECU, except those required to perform remote control functions;
Shut down all but one core of the ECU, and lower the ECU clock frequency, e.g., to a minimum allowed;
Determine if any of the following are running, otherwise initiate one of the following (the cloud support, combined with functional and performance tests will inform which one of these is best for a particular application):
a long polling request;
a server sent event request;
a WebSocket request; or
a HTTP/2 server push request; and
Place the cellular modem into a low-power mode, consistent with being capable to receive a message from the server.
Example operations of the remote control manager in response to a received remote control request include:
Process the message request, and based on the request, perform one or more of:
Place the cellular modem into a normal power mode;
Increase the clock frequency of the ECU to a normal level (and/or to a sufficient level to acceptably perform the remote control operations, which may be a lower clock frequency than required for normal vehicle operation);
Activate all cores (and/or a selected subset of cores) of the ECU;
Start applications (e.g., controllers, circuits, etc.) needed to execute the request (e.g., trigger evaluation engine, task execution engine);
Turn on controllers sufficient to provide control operations to service the remote control request (e.g., an Ethernet switch, configurable edge gateway, etc.), including actuator controllers, other ECUs, etc.; and
Execute the remote control request.

Upon completion of the remote control request, which may include feedback about the operation to service the remote control request (e.g., acknowledgement, success indicator, fault value, etc.), the example remote control manager returns the vehicle to the vehicle's state when the request was received, or to another vehicle state as specified in the request.

An example remote control manager monitors the battery level. In response to the battery charge condition falling below a threshold value, the remote control manager can perform actions according to a policy and/or configuration information. For example, the remote control manager may wake up the ECU and the cellular modem, and send a message to an external device (e.g., a cloud, web application, user device such as a smart phone, etc.) to alert the user to the condition. In certain embodiments, depending on the policy, the remote control manager may start a prime mover of the vehicle, and charge the battery to a second threshold value (e.g., higher than the first threshold value by a selected amount, and/or a fully charged condition). In certain embodiments, the remote control manager shuts down the vehicle and disables remote control support in response to the battery charge falling to the first threshold value or another charge value (e.g., lower than the first threshold value). In certain embodiments, the user is prompted and/or can request that the vehicle be started to recharge the battery, for example in response to the message sent when the battery charge condition falls below the first threshold value. In certain embodiments, depending upon a policy and/or a user input, the remote control manager keeps the remote feature active below the first threshold value.

An example system includes a centralized controller having a remote control manager that determines a remote control operation including a command value (e.g., activating a customized response, and/or from a user selecting a configured response from an application) that requests operation of the remote control function. The example remote control manager activates required controllers to execute the remote control function, and performs the function in response to the command. In certain embodiments, the remote control manager accesses a trigger evaluation engine and a task execution engine (e.g., as a part of a vehicle automation component of the vehicle, such as represented in FIG. 12) to determine that the vehicle condition is consistent with performing the operation (e.g., no obstructions in a window or door to be closed, no persons in close proximity to the vehicle before starting, etc.) and/or to perform the functions to be performed as the remote control operation. In certain embodiments, the remote control manager includes or accesses a trigger evaluation engine and/or task execution engine that is separate from other components of the system. The remote control manager thereby performs the remote control operation, and/or determines that all or a portion of the remote control operation cannot be performed, or is not going to be performed. Customized remote control operations may be prepared as a part of a policy and/or in configuration information, similar to customized operations described preceding. In certain embodiments, the remote control manager may limit implementation of the remote control operations in response to vehicle conditions. In certain embodiments, interactions with certain actuators may be disallowed and/or require additional authorization or permission. In certain embodiments, interactions with certain actuators (e.g., the vehicle start command) may embody a request to an application or flow of the vehicle, rather than a direct command of the implementing actuator (e.g., where the vehicle has an automated starting function available on the vehicle, whereby the customized operation requests implementation of the automated starting function, rather than providing a direct command to the starter of the vehicle), which may have permissions that are distinct from permissions associated with the direct command of the underlying actuators.

In certain embodiments, customized remote control operation data are stored in a memory storage on the system, such as with configuration information and/or as a part of a policy. In certain embodiments, the automation manager limits configuration of the customized operation based on permissions and/or authorizations of the configuring entity (e.g., owner, operator, manufacturer, 3^{rd} party application provider, etc.), and/or according to permissions associated with data elements accessed and/or actuators commanded as a part of the customized operation.

Example operations are described following to illustrate a few remote control operations of a type supportable by embodiments of the present disclosure. The example operations are non-limiting, and an example remote control manager is capable to respond to any input capable of being provided as a network communication and/or data parameter stored on a computer-readable medium, and to provide any response capable of being commanded to any actuator in the system, including actuators under the control of another controller in the system (e.g., a vehicle display, system speakers, vehicle powertrain, etc.).

An example operation includes receiving a customer configuration of a scheduled acclimatization, where remote control operations include activating the HVAC system at a scheduled time (e.g., 7 AM) on selected days (e.g., weekdays), to a selected condition (e.g., a selected temperature, and/or utilization of defrost to ensure the windows are clear). In certain embodiments, the customer may configure the operation using an application (e.g., a 3^{rd} party application), using a cloud or web-based interface, and/or using an application provided by a manufacturer, dealer, etc. In certain embodiments, an operator selects a recipe for a remote control operation (e.g., which may include prompts to set certain parameters, and/or may be only an instruction or approval to turn a feature on or off). In certain embodiments, an operator builds a customized remote control operation, which may, for example, be based upon customized operation features present on the vehicle, available in a recipe, and/or may be built entirely by the user interacting with an interface to allow the entry of operations to be performed, any conditions to be applied, and settings for any thresholds, etc.

An example operation includes an EV reactive grid compensation mode, whereby an electric vehicle is electrically coupled to a grid, and whereby an electric provider utilizes a bidirectional charger of the vehicle (e.g., to level out power demand spikes). In certain embodiments, the EV reactive grid compensation mode may include scheduling (e.g., time of day, charge target of the vehicle, days of the week, associated pairs of these, etc.) and/or may be toggled on or off (e.g., turning the feature on for an extended period when the operator goes on vacation).

An example operation includes the remote control manager responding to a progressive preconditioning command to heat the cabin of the vehicle in a selected order, such as using the HVAC to get cabin air to a desired temperature, then activating a heated steering wheel and/or heated seat function.

An example operation includes the remote control manager responding to a user setting request, and adjusting the vehicle configuration (e.g., steering column position, ambient light color, interior/dash light brightness, UI/UX style selection, etc.) in response to the user setting request.

An example operation includes a vehicle management setting (e.g., a valet mode, borrowed vehicle mode, configured mode for a child of the parent owner when driving the vehicle, etc.), for example to reduce a vehicle speed limit, a location limit (e.g., a geofence perimeter of 500 m from an activation location, limits with defined areas such as a city limit, and/or outside of defined areas such as a state line, another city limit, a total distance from an activation location, etc.). The applied limits for the vehicle management setting may be an actual applied limit (e.g., a maximum speed, performance value, etc.) or a notification limit (e.g., typically a geographic restriction may be implemented as a notification limit rather than a shutdown limit), where a notification is sent to the owner and/or to a selected device if a limit of the vehicle management setting is exceeded (and/or tested, such as with an actual applied limit).

An example operation includes a security mode, for example requesting data from a camera, microphone, vehicle display, dashboard, etc., in response to a request for the security mode. In certain embodiments, the user can select one or more devices (e.g., specific cameras and/or locations within or relative to the vehicle), and can receive streaming video and/or a snapshot from the selected device(s). In certain embodiments, the security mode allows for a data request from a device communicatively coupled to the vehicle, for example a security camera of a home security system in communication with the vehicle (e.g., see customized operations preceding).

An example operation includes a personalized operation, such as playing “Happy Birthday to You” and/or manipulating cabin lights upon the driver entering the vehicle on her birthday. Additionally or alternatively, a personalized operation can be any type of operation such as: playing a selected song or play list on a given calendar date, day of the week, etc.; reminding an operator of a calendar event (e.g., linking to a calendar function of a smart phone, etc.), an anniversary, etc. upon entry to the vehicle; and/or reminding an operator of a scheduled stop (e.g., picking up groceries upon entering the vehicle to return home from work).

Example and non-limiting remote control operations allow for determination of complex conditions (e.g., utilizing CAN data, location, time, date, etc.), either in determining conditions for executing a remote control operation, and/or in performing the remote control operation. Example and non-limiting remote control operations include a scheduled sequence of a number of operations, including determining conditions when a first scheduled operation is completed and a next operation should be performed.

Example and non-limiting remote control operations include performing one or more operations, such as: sending a note to the operator, showing the note on a vehicle display, and/or announcing the note on a speaker; taking a snapshot from one or more cameras and sending it to an operator and/or requestor; allowing a 3^{rd} party service (e.g., mobile re-fueling, vehicle service, and/or delivery company) to access vehicle location and door status, but only under specified conditions (e.g., selected times of the day, until the completion of an event, and/or in response to a proximity of the 3^{rd} party service to the vehicle); beginning start-up operations of the vehicle, a controller, the head unit, etc., as an operator approaches; reacting to environmental changes by defrosting the vehicle (e.g., in response to frost build-up, ambient temperature determination, etc.); and/or running a scheduled test for diagnostic purposes (e.g., running an active diagnostic test when the operator is away from the vehicle, reducing impact of the test on the vehicle mission).

Example remote control operations include a prerequisite condition, a task, and/or a status report. The prerequisite condition includes any combination of vehicle status, CAN signals, Ethernet packets, information stored on a computer-readable medium (e.g., log information, trip information, and/or other vehicle information stored in a memory location), time and/or date, location, etc. to be utilized as a prerequisite trigger condition for the remote operation, and can further be configured as a complex logical expression and may further be based on a number of conditions. The task includes an action that can be performed utilizing a CAN signal, Ethernet packet, or other network communication, including at least any action described under customized operation preceding. The status report includes acknowledgement information, confirmation that an operation was performed and/or notification that an operation was not performed, related data, confirming data, utilization data related to the remote control operation, etc. The content of the status report may vary with the recipient and/or requestor of the status report—for example the operator may receive a simple status report confirming the operation, a service personnel may receive a more detailed status report with associated parameters related to the operation, and a manufacturer may receive a detailed status report with personally identifiable information removed (e.g., to compile reliability data, while allowing for storage and aggregation of the data without having to manage personally identifiable information). The presence and/or content of the prerequisite condition, task, and/or status report may be provided and/or updated by user input, policy, and/or configuration information.

An example remote control solution supports combinations of different elements of a remote control request, for example as reflected in the example code snippet for a request:

```
If (preCondition1 is true) {
  do(Task1);
  report(Status1);
If (preCondition2 is true) {
  do(Task2);
  report(Status2);
do(Task3);
report(Status3);
......
```

An example remote control solution supports the specification of a final vehicle state (to which the vehicle should return) after all the remote control functions are completed (e.g., an operating condition, interior cabin settings, a battery state of charge, etc.). This vehicle state can be different than the vehicle state when the request was received. It is also configurable and programmable, similar to the task.

Again referencing FIG. 12, an example remote control manager is schematically depicted, being a part of a centralized controller in the example, although the remote control manager may be a distinct device, and/or positioned on another device. The interface to the CAN controller may be performed through a configurable edge gateway. In the example, the task execution engine and trigger evaluation engine is depicted as separate and dedicated to the remote control manager, solely for clarity of the present description. The task execution engine and/or trigger evaluation engine may be positioned, in whole or part, with another device or controller such as an automation manager, shared between the remote control manager and the automation manager, and/or each of the remote control manager and automation manager (where present) may have separate trigger evaluation engine(s) and/or task execution engine(s).

As OEMs enhance vehicles with advanced features and enriched content, the volume of data in the vehicle is increasing exponentially. This data needs to be stored in the vehicle—temporarily or longer—before it is consumed or transmitted elsewhere. Unfortunately, in traditional E/E architectures, memory is embedded in ECUs and is generally not accessible by other ECUs, which makes it difficult to share, secure, and preserve data. Centralized and/or distributed shared storage is an enabler of centralized vehicle functionality and hardware resources, which will reduce complexity and costs for storing a greater volume of data, reducing stored data redundancy, and the like.

Shared Network Storage enables more efficient data collection, storage and sharing by in-vehicle apps and services, more effective data security and backups, and new solutions like OTA (over the air). OEMs will benefit from lower overall memory costs, increased safety and performance, and increased revenues and profits from new, high-value applications and services. Customers will benefit from new data-rich features (e.g., Sentry Mode), flexible content downloads for entertainment, personal storage options (e.g., personal photos), and reduced input costs to the vehicle.

Example operations of a shared storage controller are provided for illustrative purposes.

An example shared storage controller includes storing vehicle condition information, such as camera footage for cameras related to the vehicle, which may be stored in a rolling data buffer. The contents of the buffer may be preserved upon a request (e.g., a customer receives a notification that her parked car has been hit, and requests preservation of the data which may include prompting the customer to preserve the data), and/or may be preserved according to event detection rules (e.g., a rule indicating to save the camera data buffer in response to an impact detection while parked, etc.). In the example, the customer can then retrieve (and/or provide to an insurance provider, police, etc.) the data including video recordings for a few minutes before the impact.

An example shared storage controller includes preserving configuration information for an ECU in the system, for example an image of a software installation update for the Head Unit. In the example, where the ECU fails an update, and the customer has indicated that operation of the vehicle is preferred over another attempt at the time, the ECU having the failed update can revert to the previous installation, and the image having the update is stored for installation at a later time. In certain embodiment, the shared storage controller may delete the image having the update after a later successful installation of the update for the ECU.

An example shared storage controller includes downloading media (e.g., a movie, game, music, audio book, etc.), for example when cellular data is readily available, where WiFi or another relatively unlimited external data connection is available, and/or upon request by a user. In the example, the request for the downloaded media may be made with a user device (e.g., a mobile device, web application, etc.) and/or a vehicle display such as the Head Unit. In the example, the passengers can then watch the movie, play the game, or otherwise access the media without interruption by slow or intermittent cellular connectivity, and/or without incurring cellular download costs. In the example, the shared storage controller may delete the downloaded media based on rules provided in configuration information and/or a policy, after a selected period of time, based on available space (e.g., rolling out older or least used media to make room for additional downloads, etc.).

An example shared storage controller caches data for external communication, for example collected data according to a policy, event detection, and/or a data collection request, and communicates the data at a later time. Accordingly, external data communications can be time shifted, for example to allow for more efficient use of cellular communications, to take advantage of an opportunistic high capability connection such as a WiFi, and/or to manage intermittent data interruptions (e.g., traveling through a tunnel). In certain embodiments, the cached data is deleted after later communication, and/or may be deleted according to data priority, policy, or other considerations, if the cache is filled before the data is communicated. In certain embodiments, configuration information, rules, and/or policy may indicate that certain data values should be compressed, summarized, and/or otherwise processed to reduce the storage space of the data, if the full data cannot be communicated before the cache is filled. In certain embodiments, other available data spaces that are unutilized, such as media storage space, preserved configuration information space, or any other available data space as disclosed herein, may be utilized in whole or part before deletion of collected data, for example allowing for a temporary increase of the data collection cache.

An example shared storage controller provides storage for a learning system, for example where large amounts of data are stored to collect and analyze driving behavior, vehicle performance, settings, environmental data, etc. to support learning operations to adjust to a customer driving style and/or to improve performance of an ADAS system. In the example, the data may be stored until a low cost transmission network, such as a WiFi, is available.

Using shared network storage, new ECU software can be further abstracted from the underlying hardware—enabling a consolidated architecture where vehicle applications run on a few high performance ECUs.

Embodiments of the present disclosure include an architecture that includes a secure centralized vehicle memory (optionally, through an expansion slot) and/or additional user-provided memory, such as a USB drive (which is both cost-effective and highly flexible). This allows users to store large amounts of data which is accessible from multiple sources which, in embodiments, may be through an in-vehicle network, external network, and/or other interfaces.

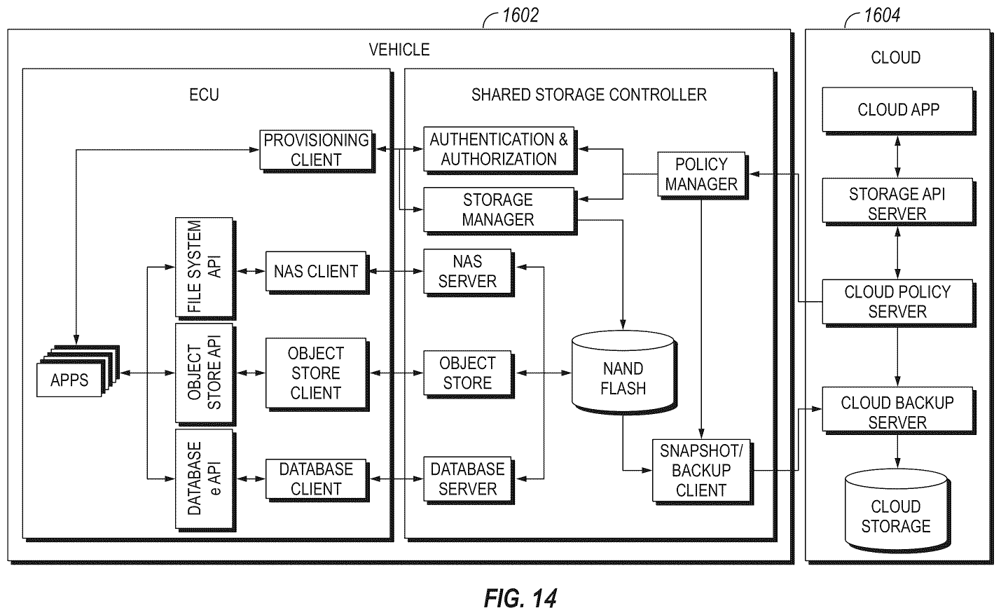

Referencing FIG. 14, an example shared storage controller is depicted, which is depicted as interfacing with an ECU in the example of FIG. 14 (although a given embodiment may include a number of ECUs and/or the shared storage controller may be positioned, in whole or part, on one or more ECUs). An example shared storage controller includes an in-vehicle storage server that enables multiple applications from different ECUs to store or retrieve data to/from the shared storage. An example shared storage includes a centralized storage, such as a centralized flash drive. In certain embodiments, the shared storage may be distributed among a number of devices, where the centralization of the storage is a logical organization rather than a physical organization. Nevertheless, in certain embodiments the shared storage is a physical organization, whether in a single device or a small number of centralized devices.

The storage server is communicatively coupled to the in-vehicle network (IVN), and is capable of storing data in selected formats, for distinct file systems, and/or configured data objects and structures. Example file systems (e.g., formatting and addressing, decisions regarding which data is stored in what locations, etc.) include vehicle data, user data, and/or video files (e.g., generated for during monitoring operations, data captures after events, etc.). Example data objects include data collection objects (e.g., data structures holding collected data in a selected format), machine learning data (e.g., training data, feature vectors, neural parameters, etc.), and shared resources (e.g., data caches, configuration information, policy data, and/or any other shared resource data from ECUs on the system). In certain embodiments, the storage server provides one or more dedicated partitions of the shared storage, which may be virtual partitions or physical partitions (or a combination, for example providing a physical partition for ECUs having a large stable demand for storage resources, and virtual partitions for transient demands, uncertain demands, and/or during transient operating conditions to allow easier movement of storage capacity between ECUs). In certain embodiments, the storage server adjusts a size of a partition, allowing for reduced waste of utilized shared storage. In certain embodiments, the storage server provides for shared partitions, which may be shared between all ECUs and/or a subset of ECUs (e.g., grouping ECUs by function, data formats, data storage duty cycle matching and/or de-synchronization, etc.).

An example shared storage controller includes an authentication and authorization manager, which grants or denies access to ECUs to any specific container, for example based on policies (e.g., interfacing with the Policy Manager), configuration information, priority associated with the ECU and/or a flow associated with the ECU, etc. In certain embodiments, the authentication and authorization manager provides access to data storage capacity based on permissions, policy, priority, and the like. For example, the authentication and authorization manager may provide access to write to: a partition, a folder and/or subfolders, a file, etc. In embodiments, the authentication and authorization manager may separate reading rights from writing rights. For example, where a high priority ECU requires an increase in utilization of the shared storage, the increased storage may be provided, if available, and/or taken from lower priority shared data storage utilizers. In certain embodiments, snapshots, backups (full or partial), and/or cached data targeted for external communication, may be stored in the shared storage.

The shared storage may be of any size, for example 16 GB, 32 GB, 64 GB, or any other value. One of skill in the art, having the benefit of the present disclosure and information ordinarily available when contemplating a particular system, can readily determine an appropriate size for the shared storage. Certain considerations for determining a shared storage size include, without limitation: the number of ECUs on the system and the net storage need for the ECUs beyond their internal storage capability; the amount of data collection to be performed on the vehicle, the types of data to be stored, and the profile of available data communication to external devices (e.g., bandwidth, costs, and/or the magnitude and extent of likely low bandwidth periods or high bandwidth periods); the distributions of ECUs across separate networks; the amount of data communication expected between ECUs on separate networks; the bandwidth available on in-vehicle networks to support network cross-communications between ECUs on the separate networks; and/or the likely number and data requirements for consumer or 3^{rd} party features that may require data storage (e.g., for media buffering, pre-downloads, data collection, etc.). Referencing Table 2, typical sizing for video files is depicted for reference.

TABLE 2
Typical video file size data

| | Size of Storage | | |
|---|---|---|---|
| Video Quality | 32GB | 64GB | 128GB |
| HD (1280 × 720)@1.5Mbps | 26.6 hrs | 53.2 hrs | 106.4 hrs |
| FHD | 12.8 hrs | 25.6 hrs | 51.2 hrs |
| (1920 × 1080)@3.0Mbps | | | |
| Driving Log | 6,400 hrs | 12,800 hrs | 25,600 hrs |

An example operating system for the shared storage controller includes a Linux operating system, although any operating system may be utilized. Without limitation, example data services include: NAS server operations including file system protocols such as NFS, SMB, and/or FTP; an object store for object-based storage; and/or a database server for storing custom database tables and indexes. Embodiments of the disclosure may use non-relational databases, e.g., a key/value pair database. In certain embodiments, the shared storage controller is configured to compress data as it is ingested, which may be configured according to the type of data (e.g., lossless compression for highly digitized data and/or data where compression loss is undesirable and/or will not meet requirements for the data; and/or lossy compression, for example where loss of information is acceptable, for highly continuous/varying data, etc.). In certain embodiments, the shared storage controller is configured to perform deep compression of cold data—for example data that is not likely to be utilized by an ECU on the system in the near term, which may also relieve vehicle control ECUs from deep compression tasks that may be highly intensive for processing and/or I/O resources. In certain embodiments, the shared storage controller is configured to encrypt data at rest. In certain embodiments, the shared storage controller is configured to age out data, to remove unneeded data, and/or to enforce a data retention policy. An example shared storage controller is configured to back up snapshot data in response to connectivity to an external backup device (e.g., a cloud server) and/or available bandwidth to communicate the snapshot data.

Example embodiments provide for expanded effective storage capacity of all ECUs on the vehicle, through both cost savings that allow for resources to dedicate to centralized storage, reduction of wasted storage space, and balancing of aggregate storage needs to provide greater certainty of the whole system storage needs versus highly variable individual ECU storage requirements that must be managed with individual storage capabilities associated with each device. Example embodiments provide for ease of scalability in storage capacity and performance, where relatively few resources can greatly expand available storage for the system. Example embodiments provide for data isolation, with app-specific and/or ECU-specific partitions, and secure access management between ECUs. Example embodiments provide for centralized secure storage of data, and simplification of data security management (e.g., reducing the requirement to configure and verify individual ECUs to ensure secure storage of related data).

An example system includes the provisioning client to be used as a proxy between apps running on individual ECUs and the authentication and authorization manager in the shared storage. An example system includes data clients (e.g., NFS, SMB, Object Store) for the apps to use as a proxy for sending and receiving data to and from the shared storage.

The growth of advanced vehicle functionality combined with pressures to reduce costs have combined to the point where typical vehicle configurations include a large number of ECUs, for example up to 150 ECUs. The current configuration of vehicles results in inefficient use of hardware, with redundant capability in processing power, memory, and other resources, while at the same time causing high network utilization, limited processing power and/or memory for individual applications, redundant software present throughout the system, and inconsistent quality and functionality of ECU implementations.

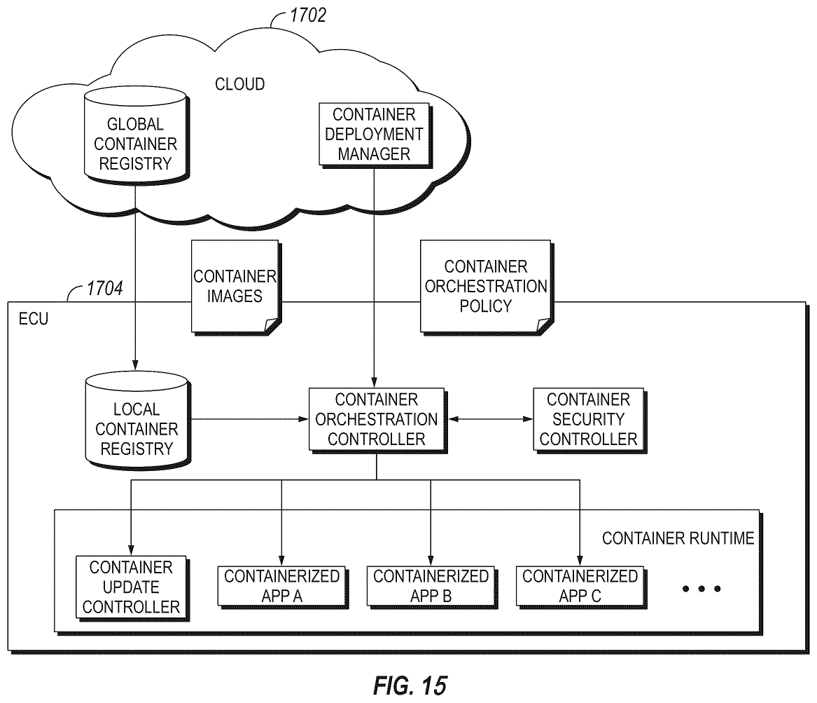

Referencing FIG. 15, an example system supports consolidation of vehicle features and control operations into a reduced number of more powerful ECUs. Additionally, the example system supports migration from legacy implementations with a multitude of ECMs 1704, to sequential progression toward consolidation of features over time, over the life cycle of a vehicle, over a number of model years of a vehicle, etc. The example system includes a cloud support component 1702, with a global registry of container based functions available for implementation on vehicle(s), and a container deployment manager that is capable to confirm container authorization, versions appropriate to particular vehicle(s), and to implement installation, verification, etc. of container based functionality to be added to vehicle(s).

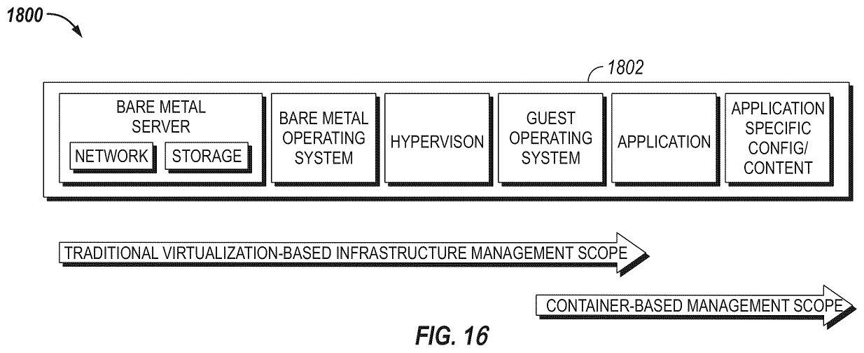

Referencing FIG. 16, an example system 1800 schematically illustrating migration of a relevant group of vehicles from a traditional control environment to a containerized control environment is schematically depicted. The example system 1800 includes a container manager 1802 having components for container based implementation on vehicles. Containerized applications can easily be added, combined, and moved to create feature sets for different models and trim levels, update vehicle features, and even relocate applications between servers for reliability and power management.

End-to-end control of the operating environment can be problematic—the rich ecosystem of infrastructure management tools developed over decades largely does not translate to the container-based world.

Key resources in a Data Center that normally require strict management, such as network and storage endpoints, are now abstracted out, with limited control functions.

HA/redundancy shifted from monolithic architectures to horizontally-scaled, software-driven platforms. This moved control away from the operations personnel and into the hands of developers.

Most hypervisors and virtualization platforms have strong, commercially-supported options. However, the container world (and its associated ecosystem) are primarily rooted in the “DIY”, open source world, which is continuously evolving.

Due to the container ecosystem's alignment with developers, its configuration constructs are aligned to their worldview, which includes concepts such as API calls, configuration files written in declarative YAML or JSON format templates, repositories, and integration with CI/CD workflows. These concepts are not common in the traditional operations world, and they require a completely different approach and skillset to manage. Even within the IT industry, this continues to be a considerable challenge.

Without limitation to any other aspect of the present disclosure, example embodiments of devices set forth throughout the present disclosure, including circuits, controllers, computing devices, modules, engines, configurable switches, configurable gateways, converged network devices, managers, evaluators, creators, applications, and other similar terminology, include any one or more of: any sensor present on the vehicle and/or communicative coupling to any such sensor (e.g., an electrical interface, LIN interface, A/D processing of a sensor signal, etc.); any actuator present on the vehicle and/or communicative coupling to any such actuator (e.g., electrical interface, LIN interface, command interface to the actuator, feedback interface from the actuator, etc.); any controller and/or computing device on the vehicle, cloud server, external device, etc., including processing resources, storage resources, I/O resources, and/or communication resources thereof; instructions stored on a computer-readable medium, where the instructions are configured such that a computing device executing the instructions thereby performs one or more operations of the device; and/or access to any one or more of these either directly (e.g., accessing a parameter from a memory value of a controller, inserting a command value into a memory value of a controller, etc.) or indirectly (e.g., accessing a parameter on a network zone of the vehicle, providing a command value to a controller on a network zone of the vehicle, sending requests or commands to a controller of the vehicle, exercising an interface to access parameters, send commands, configure features, sensors, actuators, and/or control operations, etc.).

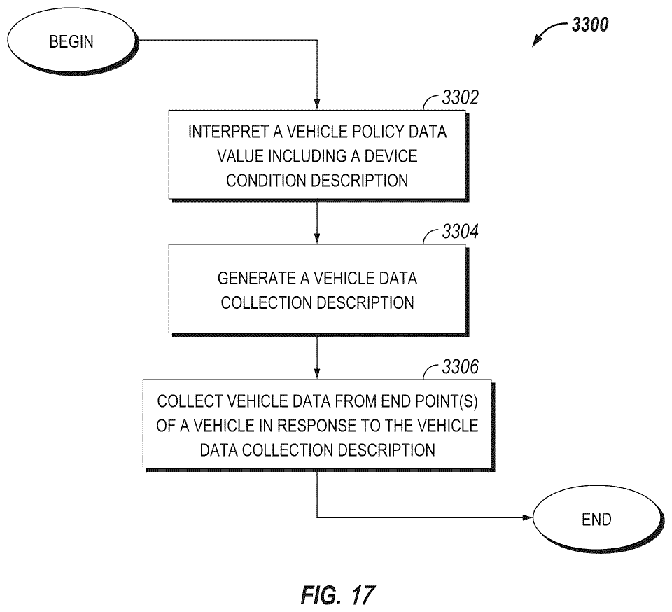

Referencing FIG. 17, an example procedure 3300 for implementing a policy responsive to fault and/or diagnostic values for device(s) in a vehicle system is schematically depicted. The example procedure 3300 includes an operation 3302 to interpret a vehicle policy data value including a device condition description, and an operation 3304 to generate a vehicle data collection description in response to the vehicle policy data value. The example procedure 3300 further includes an operation 3306 to collect vehicle data from end points of the vehicle in response to the vehicle data collection description.

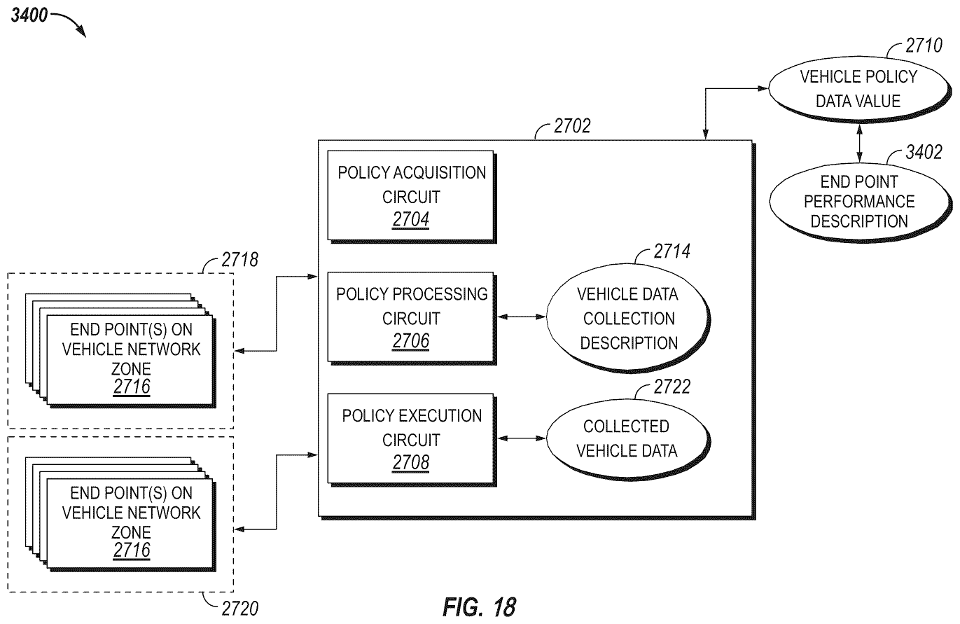

Referencing FIG. 18, an example apparatus 3400 is depicted to provide data collection operations in response to a vehicle policy data value, including commencing, changing, and/or stopping data collection operations based on end point performance description(s) for end points of the vehicle. For example, operations of the apparatus 3400 allow for selected data collection, and/or adjustments of collected data, based on indications of capability of the end point, changes to the end point, and/or a configuration of the vehicle that can be determined based on the end point performance (e.g., a sensor or actuator capability that provides an indication that the vehicle is provided in a certain configuration—for example the presence of a particular sensor, and/or an output value or resolution provided by the sensor, may indicate that a particular vehicle configuration, feature set, performance rating, etc. is present on the vehicle).

The example apparatus 3400 includes the policy acquisition circuit 2704 that interprets a vehicle policy data value 2710 including an end point performance description 3402, and a policy processing circuit 2706 that generates parsed policy data including a vehicle data collection description 2714, based at least in part on the vehicle policy data value 2710.

An example end point performance description 3402 includes a first data value to be collected in response to a target end point being in a first condition, and a second data value to be collected in response to the target end point being in a second condition. The utilization of the first condition and the second condition allows for changing the data to be collected based on any condition of the end point, including at least a type of the end point, a status of the end point (e.g., nominal, passed, failed, suspect, etc.), and/or another aspect of the vehicle that is indicated by the condition of the end point. An example apparatus 3400 includes the target end point in the first condition indicating a first vehicle configuration, and the target end point in the second condition indicating a second vehicle configuration. An example apparatus 3400 includes the target end point in the second condition indicating the target end point is determined to be in an off-nominal condition, such as: a failed condition, a faulted condition, a non-responsive condition, and/or a lost communication condition. An example apparatus 3400 includes the target end point in the first condition indicating a first target end point configuration (e.g., a sensor type, actuator type, version of a related application, flow, and/or control operation, etc.), and where the target end point in the second condition includes a second target end point configuration. The first data value includes data to be collected from a first end point group (e.g., the target end point in the first condition indicates that the vehicle data collection description 2714 is directed to a group of parameters from the first end point group, which may include the target end point or not), and the second data value includes data to be collected from a second end point group (e.g., the target end point in the second condition indicates that the vehicle data collection description 2714 is directed to a group of parameters from the second end point group, which may include the target end point or not). In certain embodiments, the first end point group and the second end point group may include one or more, or all, of the same end points, with the differences between the first end point group and the second end point group being limited to the overall parameter selection for collection from each end point group. In certain embodiments, and end point group (e.g., the first end point group and/or the second end point group) may include a single end point—for example and without limitation, a highly capable controller managing a large number of sensors, actuators, and/or control operations, may have a large number of parameters available, such that the parameters expressed by the first end point group and/or the second end point group may all be available from the single highly capable end point. In certain embodiments, the first end point group and the second end point group include at least one distinct data value (e.g., data values for collection from the first end point group have at least one different value from data values for collection from the second end point group) for collection. In certain embodiments, the first end point group and the second end point group include at least one distinct end point (e.g., end points making up the first end point group have at least one different end point from end points making up the second end point group). In certain embodiments, differences between the first end point group and the second end point group are present, additionally or alternatively, in other dimensions than the data values or the end points, for example priority values, formatting values, processing values, sampling rates, etc.

The embodiment of FIG. 18 is described, for purposes of illustration, with regard to data collection operations responsive to an end point performance description. Additionally, or alternatively, operations of an apparatus 3400 may adjust one or more of: feature parameters; enabling or disabling features; commencing and/or stopping data collection; and/or activating one or more actuators, in response to the end point performance description.

Without limitation to any other aspect of the present disclosure, on-vehicle storage resources may include: memory allocations and/or stored values utilizing memory; resources utilized to delete, move, compress, and/or summarize stored data; and/or resources to determine memory allocation, to update memory allocation (e.g., based on collected data amounts relative to estimated data amounts to be collected), and/or to track expiration times and/or aging of stored data. Without limitation to any other aspect of the present disclosure, off-vehicle transmission resources may include: bandwidth utilization of external data transfer components (e.g., cellular data routes, Ethernet data routes, WiFi data routes, and/or other network data routes such as CAN communications); data capacity limitations (e.g., capped data amounts; data amounts associated with an entity, application, flow, etc.; and/or data amounts associated with an access point name (APN)); and/or power utilization associated with external data transfer (e.g., at any time, and/or during certain operating conditions such as when a prime mover of the vehicle is not providing power and battery power may be utilized for external data transfer). Without limitation to any other aspect of the present disclosure, on-vehicle transmission resources may include: bandwidth utilization of one or more network zones; allowed utilization of a network zone for a given end point, flow, application, etc.; latency management of communications on a network zone, including competition for low latency communications; and/or resource utilization of an inter-network device (e.g., a CEG, CES, and/or CND).

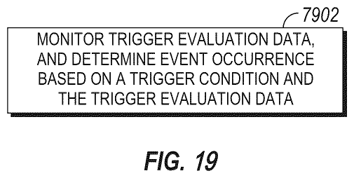

Referencing FIG. 19, an example operation 7902 includes an operation to monitor trigger evaluation data, and determine the event occurrence based on a trigger condition (e.g., provided in a policy) and the trigger evaluation data.

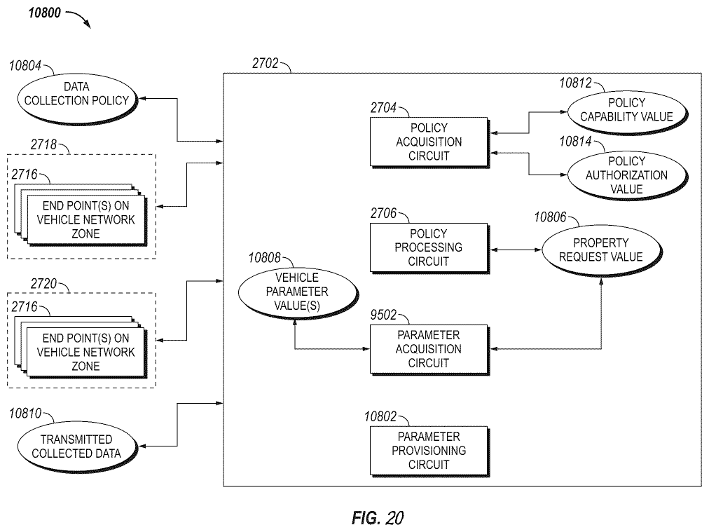

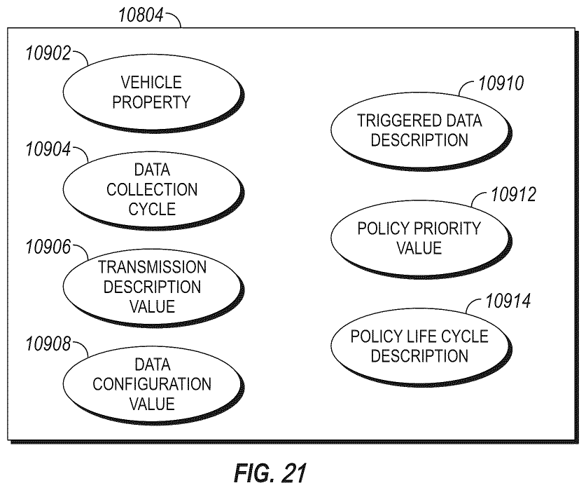

Referring to FIGS. 20 and 21, an example data collection policy 10804 includes a policy type, where the parameter acquisition circuit 9502 further interprets the vehicle parameter values 10808 in response to the policy type. The policy type may be any type of policy as set forth herein, for example a persistent policy, discrete and/or limited policy type, and/or a streaming policy type. In certain embodiment, the policy type additionally or alternatively is a policy type within a policy hierarchy, for example a built-in policy type, factory policy type, and/or downloaded policy type. In certain embodiments, the parameter acquisition circuit 9502 persistently evaluates the data collection policy 10804 in response to the policy type being a persistent policy type—for example persistently collecting data, and/or persistently evaluating data collection criteria to determine whether data should be collected. In certain embodiments, the parameter acquisition circuit 9502 discontinues evaluating the data collection cycle of the data collection in response to fulfilling a data collection cycle of the data collection policy—for example where the policy type is an on demand policy (e.g., discontinuing after the defined data collection is serviced), where the policy type is a streaming policy (e.g., discontinuing after the defined data collection is provided), and/or where the policy type is a discrete or limited policy (e.g., discontinuing after a determined number of data collection events, expiration of a time period, etc.). In certain embodiments, the policy acquisition circuit 2704 deletes the data collection policy 10804 in response to the parameter acquisition circuit 9502 discontinuing the evaluating the data collection policy 10804—for example deleting the associated policy once the evaluation operations are discontinued, and/or deleting the associated policy after the related collected data is transmitted.

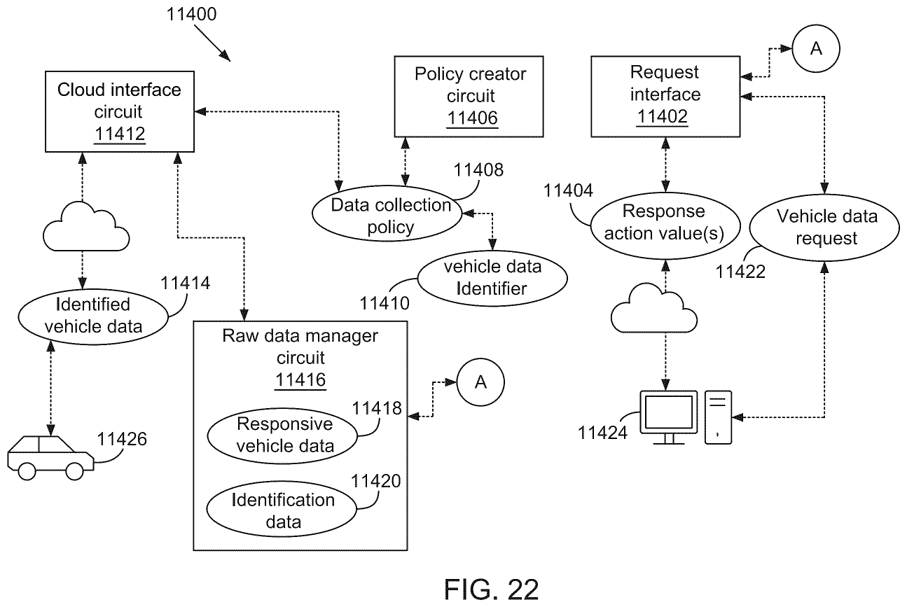

Referencing FIG. 22, an example cloud system 11400 for retrieving selected data from a vehicle, and/or dividing stored collected data and access to the data. The example of FIG. 22 is described as a cloud-based system 11400 for clarity of the description to illustrate aspects of the present disclosure. However, operations of the system 11400 may be performed, additionally or alternatively, on any system configuration external to the vehicle. For example, operations may be performed in whole or part by a service tool, a manufacturing tool, a computing device at least selectively communicatively coupled to the vehicle, or other configurations as set forth herein. An example system includes an external device, whether a cloud-based system or otherwise, coupled to the vehicle using a cellular data connection, a WiFi connection, a physical port connection to a network zone of the vehicle, a Bluetooth connection, and/or any other connection as understood in the art. Operations of intra-vehicle network zone connection devices, such as a CES, CEG, and/or CND, allow for a connection to any network zone of the vehicle to be utilized to receive, configure, and/or update policies to be implemented on the vehicle, and to transmit collected data. In certain embodiments, aspects of the system 11400 may be implemented in the cloud, with other aspects implemented on another external device.

The example system 11400 includes a request interface 11402 configured to interpret a plurality of response action values 11404 from an external device 11424. The response action values 11404 include, without limitation, one or more of: data values for collection (e.g., requested data to be collected from the vehicle); trigger conditions for conditional actions (e.g., data values to be observed for characteristics indicating the trigger event, for example determined by threshold values, processed responses such as a rate of change of a value, a trigger based on a number of values, state values such as “ON”, “OFF”, “ACTIVE”, and/or mode values such as indications of an operating mode, control operation state, etc.); time frames for data collection (e.g., calendar time; operating time relative to the vehicle; a time based amount of data to be collected—e.g., three minutes of data; a relative time to an event detection or trigger condition, such as beginning five minutes after the event, data from the three minutes preceding the event, etc.); priority information to be attributed to any of the foregoing; sampling rates for data values; formatting for data values (e.g., parameter units, bit depth, metadata descriptions, etc.); and/or a data type to be associated with the data values. In certain embodiments, the response action values 11404 may be provided by a user selection of preconfigured values—for example a user may select “vehicle speed” for inclusion as response action value 11404. In certain embodiments, aspects of the response action values 11404 that the user is not authorized to request may be hidden from the user—for example by not providing such values to the user interface operated on the external device 11424. In certain embodiments, aspects of the response action values 11404 that the user is not authorized to request may be annotated—for example with a greyed out text or the like—letting the user know that such values are generally available, but not with the present permissions of the user. In certain embodiments, aspects of the response action values 11404 are presented to the user, and enforcement of the authorization is performed by the policy creator circuit 11406, e.g., by excluding the values from a final data collection policy 11408, and/or by excluding the entire set of response action values 11404 from the final data collection policy 11408.

In the example of FIG. 22, response action values 11404 indicate defining operations for data collection, trigger evaluation, and/or automatic operations of the vehicle, while vehicle data requests 11422 indicate requests to access responsive vehicle data 11418 collected in response to the response action values 11404. The terminology utilized herein is illustrative and non-limiting.

Operations to generate the data collection policy 11408 with excluded values may include a notification to the user that the requested response action values 11404 were not authorized. In certain embodiments, a notification to the user that the requested response action values 11404 are not authorized in response to a submission attempt by the user—for example allowing the user to identify which aspects of the response action values 11404 are preventing submission, and allowing the user to adjust the response action values 11404. In certain embodiments, a combination of these operations are utilized on the interface—for example hiding some not authorized parameters completely from the user (e.g., highly sensitive parameters that are only available to certain users), and displaying some not authorized parameters to the user. Additionally or alternatively, some parameters may be available in response to a further approval—for example an administrative or supervising user of an entity may have authorization to approve certain parameters as response action values 11404, where another user from the entity requesting the certain parameters may receive a notification to request authorization, and/or the administrative or supervising user may receive a notification that one or more of the certain parameters have been requested. Additionally or alternatively, some parameters may be available based on a subscription, a particular version of the user interface (e.g., a standard versus premium version of a web portal, local application, mobile application, or the like), where the interface may prompt the user to obtain the authorizing features (e.g., subscription, or updated interface version), and/or a notification associated with the parameters may indicate the features needed to access the parameters. In certain embodiments, certain parameters may be available based on access characteristics—for example an unsecured access to the interface and/or a partial login operation to the interface (e.g., entering a password, but not a second step of a two-step authentication, etc.)—where the request interface 11402 may selectively hide parameters unavailable based on the access characteristics, and/or show the parameters as inactive on the interface.

In certain embodiments, the request interface 11402 is configured according to the external device, an associated entity, and/or a type of user and user goal associated with these. For example, the request interface 11402 for interaction with an owner of the vehicle and/or a third-party application developer may be simplified, allowing for selection of data collection parameters using selections from menus, utilizing templates, and/or with more limited capability. In another example, the request interface 11402 for interaction with a sophisticated developer, such as a manufacturing entity, fleet owner, or the like, may include convenient interfaces, allow for direct submission of completed policy data structures (e.g., an HTML file, XML file, delimited file, binary file, or the like), or a combination of these (e.g., building an initial data structure based on menu interactions and selections, and allowing access to the source file generated thereby for direct editing and submission).

In certain embodiments, a user device 11424 to provide the response action values 11404 and to provide vehicle data requests 11422 may be different devices, and/or may access separate interfaces 11402. In certain embodiments, a first user providing the response action values 11404 and a second user providing the vehicle data requests 11422 may be separate users, users associated with different entities, and/or may be entirely unrelated. For example, a third-party application developer may provide response action values 11404, where the vehicle data requests 11422 may be provided by a vehicle owner. In certain embodiments, a number of separate users may have access to the responsive vehicle data 11418.

In the example of FIG. 22, the system 11400 is depicted with a first cloud boundary to the external device 11424, and a second cloud boundary to the vehicle 11426, with the cloud system positioned therebetween, including the request interface 11402, the policy creator circuit 11406, the raw data manager circuit 11416, and the cloud interface circuit 11412. In certain embodiments, one or more aspects of the cloud system, or all aspects of the cloud system, may be positioned apart from a cloud system, for example with aspects positioned on the vehicle 11426, another external device, or combinations of these. Additionally, or alternatively, aspects of the cloud system 11400 may be provided as an internet-based aspect, a web portal, a mobile application, or the like. An example request interface 11402 includes more than one option to interface with the cloud system, for example with a first interface operated as a web portal, another interface operated as a mobile application, another interface operated on a tool, and/or another interface such as on an external device 11424 operating a local application on the device. Embodiments of the tool, as disclosed herein, may be a service tool, manufacturing tool, engineering tool, dealer tool, bodybuilder tool, OEM tool, and/or the like. Embodiments of a test rig, as disclosed herein, may be a tool related to manufacturing, engineering, 3rd part (OEM, bodybuilder), aftermarket development, etc., and/or may include a data-based test rig (e.g., collecting data, sending commands), or a partially electronic test rig (e.g., emulating parts of the environment, load, and/or vehicle, dynamometer, etc.).

In certain embodiments, capabilities available for interacting with the cloud system may be varied according to the interface utilized for the interaction (e.g., a service tool having distinct capabilities relative to a mobile application), an entity associated with a user exercising the interface (e.g., a third party application provider, manufacturer, dealer, vehicle owner, etc.), and/or a type of interaction with the cloud system (e.g., a web portal access having distinct capabilities to a manufacturing tool coupled directly to a network zone of the vehicle). Additionally, or alternatively, interactions with the cloud system may utilize verification and/or authorization, for example exercising a login interface, encrypted communications between the cloud system and external devices, between the cloud system and the vehicle, and between components of the cloud system. In certain embodiments, the cloud system components may be separate devices-including physically separate devices and/or logically separated devices. For example, the request interface 11402 may be embodied on a separate device (or group of devices) than the raw data manager circuit 11416. In another example, a portion of the request interface 11402 may be at least partially included on an external device and/or on the vehicle.

The example system 11400 includes a policy creator circuit 11406 that determines a data collection policy 11408 in response to the response action values 11404, the data collection policy 11408 including a vehicle data identifier 11410. In certain embodiments, the policy creator circuit 11406 compiles more than one response action values 11404 from more than one user into a data collection policy 11408, for example creating a single compiled data structure representing the policy, and/or providing multiple separate data structures representing the policy. In certain embodiments, the policy creator circuit 11406 checks authorization for portions of the policy according to the entity, user, application, flow, or the like providing the respective portion. In certain embodiments, the policy creator circuit 11406 checks for capability of the policy, for example determining whether data storage resources, processing resources, parameter availability, and/or transmission resources of the vehicle are capable to service data collection or other operations responsive to the policy. In certain embodiments, a policy manager on the vehicle further performs an authorization and/or capability check of the policy provided to the vehicle, for example providing a confirmation to the cloud interface circuit 11412 if the policy is accepted, and providing a notification to the cloud interface circuit 11412 if the policy is declined.

An example cloud interface circuit 11412—for example configured to access the vehicle—is configured to receive identified vehicle data 11414 collected in response to the data collection policy 11408. The vehicle data identifier 11410 may be specifically identifiable information about the vehicle—for example a vehicle identification number (VIN), serial number, media access control (MAC) address from a specified controller of the vehicle, or the like, and/or identifiable information ensuring that the identified vehicle data 11414 can be matched to the vehicle and/or a vehicle data request 11422. An example vehicle data identifier 11410 includes a session identifier (e.g., identifying a data collection “session”, and/or a data collection instance, tied to the block of collected data provided in response to the data collection policy 11408)—for example a unique identifier included with the data collection policy 11408, and attached to the identified vehicle data 11414, allowing identification of the responsive vehicle data 11418 separate from other information such as personal information about the vehicle owner, identification of the specific vehicle related to the data, etc. In certain embodiments, the vehicle data identifier 11410 utilized for a particular data collection policy 11408 may depend upon the type of policy (e.g., a persistent policy may utilize a first type of identifier, and a discrete and/or streaming policy may utilize a second type of identifier), and/or according to the importance for the particular system to keep identifying information separate from the responsive vehicle data 11418.

An example raw data manager circuit 11416 stores at least a portion of the received identified vehicle data 11414, the at least a portion of the identified vehicle data including responsive vehicle data 11418 and identification data 11420. The identification data 11420 may be the same as the vehicle data identifier 11410, or a different identifier. In certain embodiments, the responsive vehicle data 11418 may be encrypted separately from the identification data 11420, allowing for the raw data manager circuit 11416 to provide the correct responsive vehicle data 11418 by comparing the related identification data 11420, without the raw data manager circuit 11416 having access to the responsive vehicle data 11418. The separation of the responsive vehicle data 11418 promotes separation of risk of a data breach, where improper access to a single aspect of the cloud system does not allow matching of the responsive data 11418 with identifying information such as an owner name, specific vehicle, or the like. Example identification data 11420 includes metadata specific to a particular set of response action value(s) 11404.

An example request interface 11402 interprets a vehicle data request 11422, and retrieves at least a portion of the responsive vehicle data 11418 from the raw data manager circuit 11416 in response to the vehicle data request 11422. The example request interface 11402 provides the retrieved data to the external device 11424.

An example system 11400 includes the responsive vehicle data 11418 encrypted utilizing a first encryption key set, and the identification data 11420 encrypted utilizing a second encryption key set. Accordingly, the raw data manager circuit 11416 can be configured to identify responsive data to vehicle data requests 11422, without having access to the responsive vehicle data 11418. In certain embodiments, the raw data manager circuit 11416 may identify responsive data utilizing a hash check or other operation. In certain embodiments, an encryption key to decrypt the responsive vehicle data 11418 is not present on the cloud system 11400, and/or unavailable to selected portions of the cloud system 11400 (e.g., unavailable to the raw data manager circuit 11416).

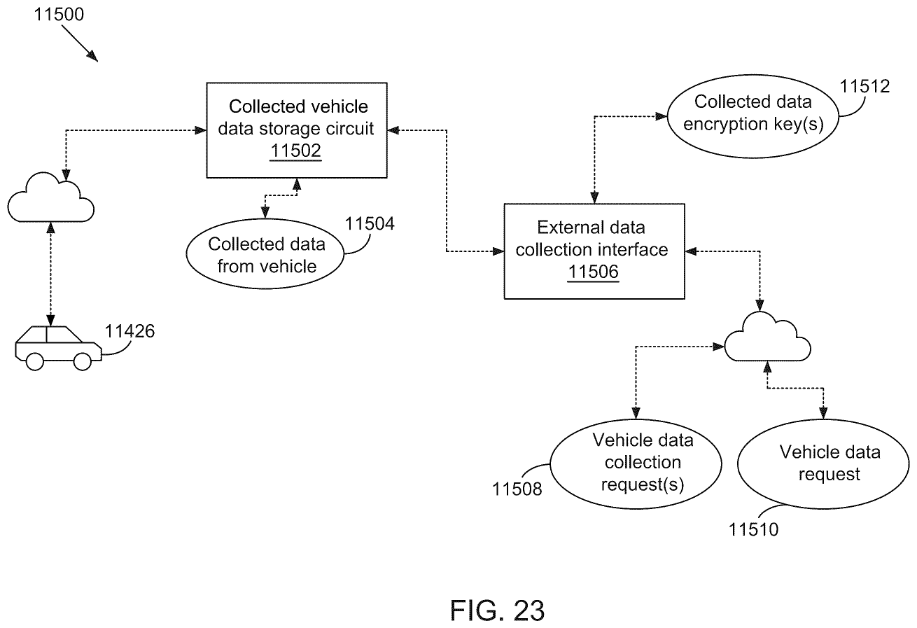

Referencing FIG. 23, an example cloud system 11500 for retrieving selected data from a vehicle, and/or dividing stored collected data and access to the data is schematically depicted. The example of FIG. 23 is described as a cloud-based system 11500 for clarity of the description to illustrate aspects of the present disclosure. However, operations of the system 11500 may be performed, additionally or alternatively, on any system configuration external to the vehicle.

The example system 11500 includes a collected vehicle data storage circuit 11502 that stores collected data 11504 from a vehicle, and an external data collection interface 11506 that selectively provides vehicle data collection request(s) 11508 from an external device to the vehicle, for example by processing the vehicle data collection request(s) 11508 into a policy data structure provided to the vehicle. The example external data collection interface 11506 further provides at least a portion of the stored collected data 11504 from the collected vehicle data storage circuit 11502 in response to a vehicle data request 11510 from an external device. The example system includes separation of at least a portion of the stored collected data 11504 from an encryption key for the at least a portion of the stored collected data 11504. Example arrangements to separate the encryption key from the at least a portion of the stored collected data 11504 include, without limitation to any other aspect of the present disclosure: separate encryption of an identifying portion of the data from a payload portion of the data; identification and/or verification of the payload portion of the data utilizing a hash check; and/or identification and/or verification of the payload portion with a separate identifier for the payload portion. An example external data collection interface 11506 selectively provides the vehicle data collection request(s) 11508 to the vehicle by providing the requests 11508 to the collected vehicle data storage circuit 11502, and/or to a policy creator circuit 11406 (e.g., reference FIG. 22 and the related description).

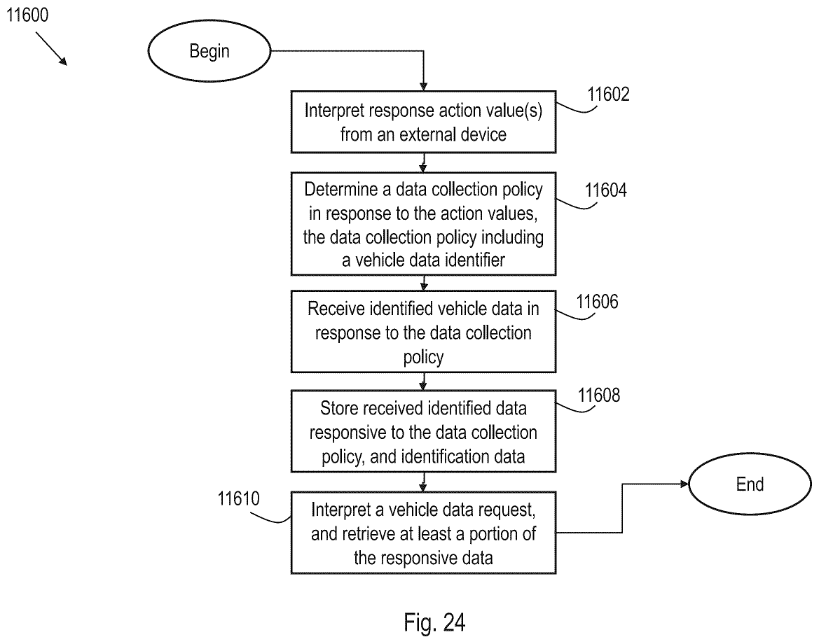

Referencing FIG. 24, an example procedure 11600 for data collection operations from a vehicle is schematically depicted. The example procedure 11600 includes an operation 11602 to interpret response action values from an external device, and an operation 11604 to determine a data collection policy in response to the action values, the data collection policy including a vehicle data identifier. The example procedure 11600 includes an operation 11606 to receive identified vehicle data in response to the data collection policy, an operation 11608 to store received identified data from the vehicle that is responsive to the data collection policy and related identifying data, and an operation 11610 to interpret a vehicle data request, and to retrieve at least a portion of the responsive data.

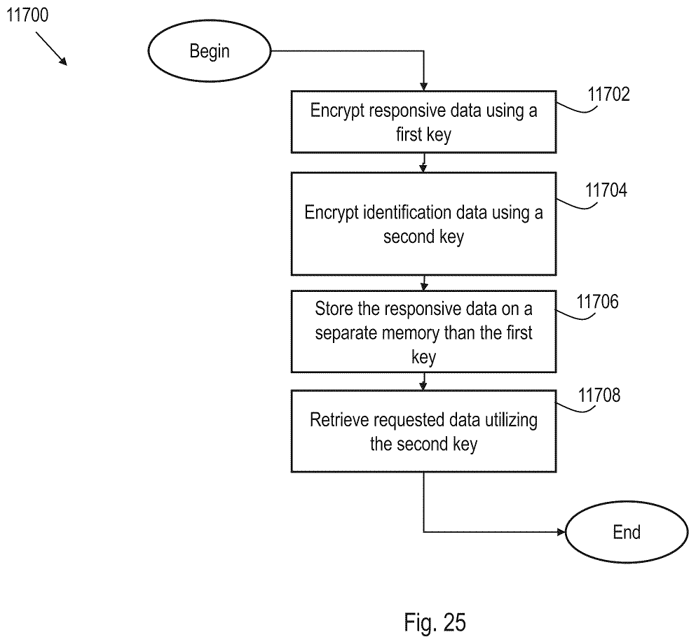

Referencing FIG. 25, an example procedure 11700 for separating responsive data to a vehicle data collection operation from access to the responsive data is schematically depicted. The example procedure 11700 includes an operation 11702 to encrypt responsive data using a first encryption key, and an operation 11704 to encrypt identification data using a second encryption key. In certain embodiments, identification data may be unencrypted. The example procedure 11700 further includes an operation 11706 to store the responsive data on a separate memory from the first encryption key, and an operation 11708 to retrieve requested data utilizing the second encryption key (and/or utilizing the identification data).

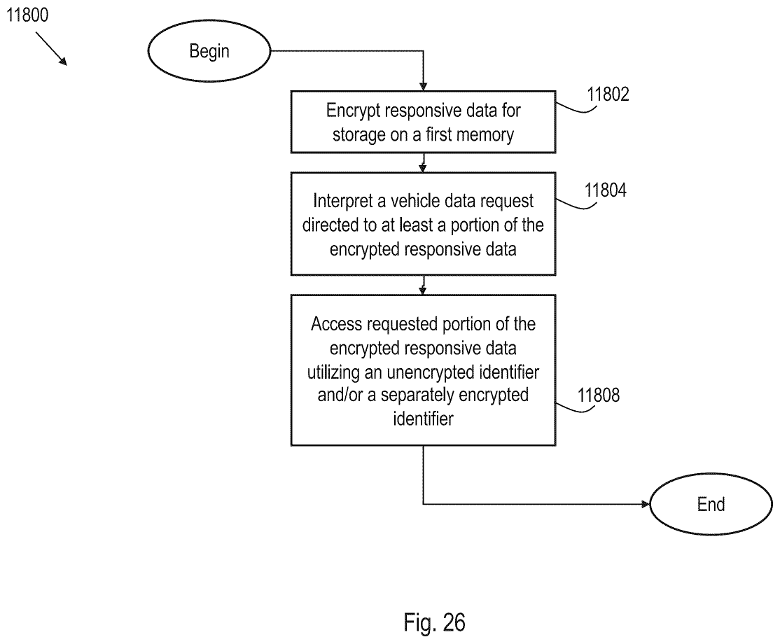

Referencing FIG. 26, an example procedure 11800 for separating responsive data to a vehicle data collection operation from access to the responsive data is schematically depicted. The example procedure 11800 includes an operation 11802 to encrypt responsive data for storage on a first memory, an operation 11804 to interpret a vehicle data request directed to at least a portion of the encrypted responsive data, and an operation 11808 to access requested portions of the encrypted responsive data utilizing an unencrypted identifier and/or a separately encrypted identifier.

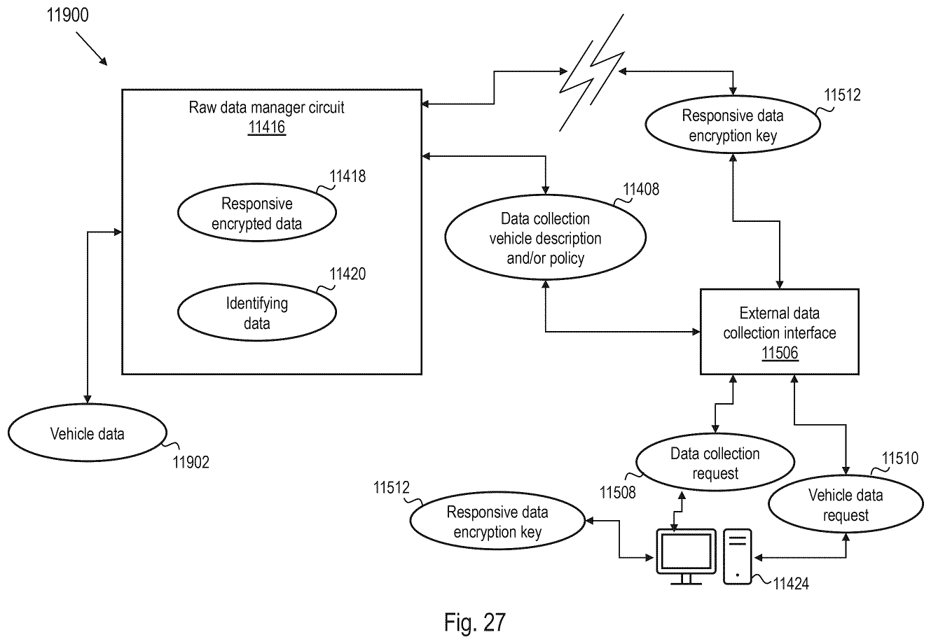

Referencing FIG. 27, an example system 11900 for retrieving selected data from a vehicle, and/or dividing stored collected data and access to the data is schematically depicted. The example system 11900 includes a raw data manager circuit 11416 that stores responsive encrypted data 11418, collected in response to a data collection vehicle description 11408 (and/or a policy), utilizing vehicle data 11902 provided by the vehicle operating a data collection policy on the vehicle. The example system 11900 includes an external data collection interface 11506 that provides at least a portion of the responsive encrypted data 11418 to an external device in response to a vehicle data request 11510. In the example of FIG. 27, an encryption key 11512 for the responsive encrypted data 11418 is kept separate from the raw data manager circuit 11416, for example utilizing separate identifying data 11420 to determine portions of the responsive encrypted data 11418 without decrypting the responsive encrypted data 11418. In certain embodiments, either or both of the external data collection interface 11506 or the external device 11424 have access to the responsive data encryption key 11512, thereby allowing the external device 11424 to access the received data. In the example of FIG. 27, the break between the responsive data encryption key 11512 and the raw data manager circuit 11416 is explicitly depicted for purposes of illustration, but the responsive data encryption key 11512 may be stored on a separate device from the raw data manager circuit 11416, whether a separate physical device or a separate logical device.

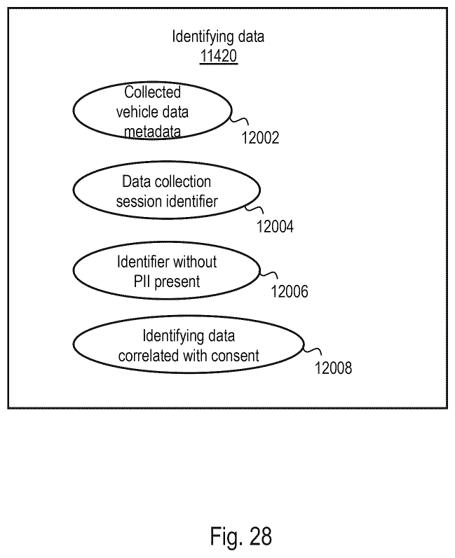

Referencing FIG. 28, example and non-limiting examples of identifying data 11420 are depicted. Example identifying data 11420 include one or more of the following: a collected vehicle data metadata 12002, a data collection session identifier 12004, an identifier configured without personally identifiable information (PII) present 12006, and/or identifying data correlated with a consent 12008 (e.g., where the request interface 11402, and/or a policy manager on the vehicle, provide a consent notification to an external device, where the consent notification includes consent for information presented in the identifying data 11420).

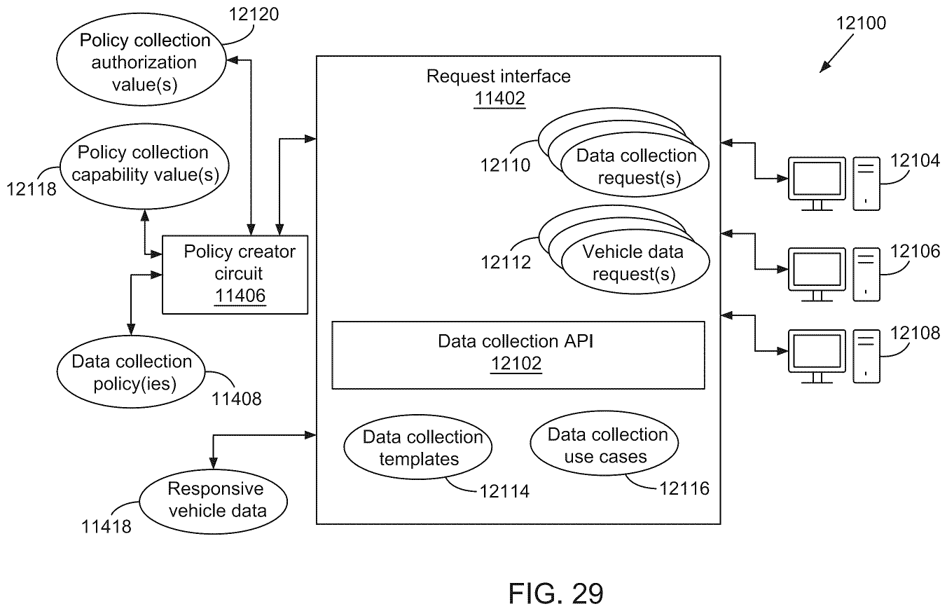

Referencing FIG. 29, an example cloud system for preparing data collection policies, and collecting responsive data from a vehicle, is schematically depicted. The example of FIG. 29 is described as a cloud-based system 12100 for clarity of the description to illustrate aspects of the present disclosure. However, operations of the system 12100 may be performed, additionally or alternatively, on any system configuration external to the vehicle.

The example system 12100 includes a request interface 11402 configured to interpret a vehicle data collection request 12110 for at least one identified vehicle, and a policy creator circuit 11406 that determines a data collection policy 11408 in response to the vehicle data collection request(s) 12110. An example cloud interface provides the data collection policy 11408 to a vehicle, and a raw data manager circuit that stores at least a portion of responsive vehicle data received from the vehicle (e.g., reference FIG. 22).

An example request interface 11402 is further configured to expose an application programming interface (API) (e.g., data collection API 12102) to an external device 12104, 12106, 12108. The API may include access to any selected operations, for example allowing a web portal, mobile application, tool, local application, or the like, to operate an interface to select available data values for collection, to configure a data structure including any aspects of a policy as set forth herein, and/or to request responsive data 11418 after collection operations. The example request interface 11402 further interprets a vehicle data request 12112, and provides retrieved data from the responsive vehicle data 11418 to an external device in response to a vehicle data request 12112. The data collection requests 12110 and/or the vehicle data requests 12112 may be received based on interactions with a user interface provided to the external device(s), and/or in response to an exercise of the API 12102 by the user, an application operated by the user, or the like. The example policy creator circuit 11406 determines the data collection policy 11408 in response to the data collection requests 12110, and/or further in response to policy collection authorization value(s) 12120 and/or policy collection capability value(s) 12118.

Example operations of the policy creator circuit 11406 to determine the policy capability value 12118 include determining the policy capability value 12118 in response to one or more of: a data storage size determined to support the vehicle data collection request; a transmission amount value determined to support the vehicle data collection request; a data availability value associated with the vehicle data collection request; or a data configuration value associated with the vehicle data collection request. Example operations of the policy creator circuit include determining a policy capability value 12118 in response to the vehicle data collection request 12110 and at least one additional vehicle data collection request 12110, and to selectively enable, in response to the policy capability value 12118, at least one of: determining the data collection policy 11408, or including at least one of the vehicle data collection request 12110 or the at least one additional vehicle data collection request 12110. The policy creator circuit 11406 further determines the policy capability value 12118 in response to at least one parameter such as: a data storage size determined to support each of the vehicle data collection request 12110 and the at least one additional vehicle data collection request 12110; a transmission amount value determined to support each of the vehicle data collection request 12110 and the at least one additional vehicle data collection request 12110; a data availability value associated with each of the vehicle data collection request 12110 and the at least one additional vehicle data collection request 12110; a data configuration value associated with each of the vehicle data collection request 12110 and the at least one additional vehicle data collection request 12110; or a priority determination between the vehicle data collection request 12110 and the at least one additional vehicle data collection request 12110 for any one or more of the foregoing.

An example policy creator circuit 11406 determines a policy authorization value 12120 in response to the vehicle data collection request 12110, and to perform at least one operation, in response to the policy authorization value, such as: selectively enabling the determining the data collection policy 11408; or determining the data collection policy 11408 to support at least a portion of the vehicle data collection request 12110. The request interface 11402 is configured to provide at least one use case value 12116 to a user interface, each use case value 12116 including a vehicle data collection template 12114, and determining the vehicle data collection request 12110 in response to responses from the user interface to the provided at least one use case value 12116. The request interface 11402 is further configured to determine the at least one use case value in response to at least one of: an entity type associated with the user interface; a permissions value associated with the user interface; and previous data collection policies determined for users having a shared characteristic determined for the user interface.

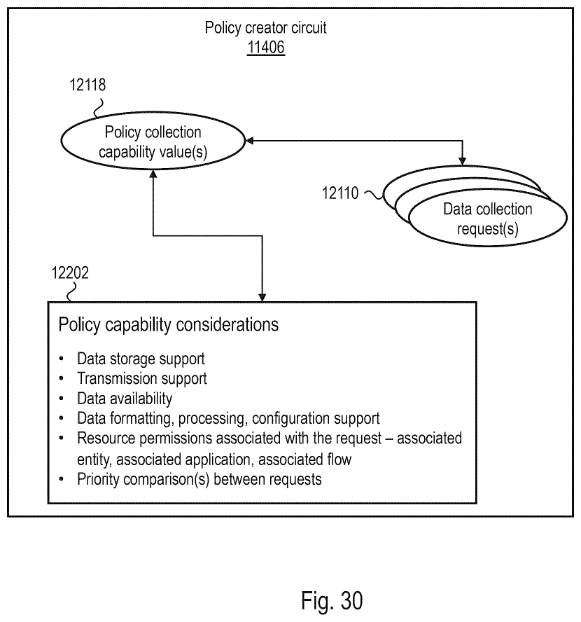

Referencing FIG. 30, an example policy creator circuit 11406 is schematically depicted. The example policy creator circuit 11406 may be utilized in any system herein, and/or may perform operations herein, related to determining, interpreting, and/or creating a policy and/or data collection operations. The example policy creator circuit 11406 determines a policy collection capability value 12118 in response to received data collection requests 12110. In certain embodiments, the policy creator circuit 11406 determines the policy collection capability values 12118 in response to capability considerations 12202 such as: data storage support to service the policy, data transmission support to service the policy, data availability to support the policy (e.g., are the requested data values available), data formatting, processing, and/or configuration support for the policy (e.g., can the parameters be provided in the requested units, bit depth, sampling rates, response time, etc., including whether processing support resources are available to perform formatting and/or configuration operations for collected data), resource permissions associated with the request (e.g., does an entity, flow, and/or application associated with the data collection request 12110 have sufficient permissions to utilize supporting resources, and/or sufficient permissions to consume supporting resources in a quantity needed to support the data collection request 12110), and/or priority comparisons between requests (e.g., lower priority data collection requests 12110 may be excluded if the overall policy including all requests exceeds a capability value).

Referencing FIG. 31, an example request interface 11402 providing use case and/or template selections to external device(s) is schematically depicted. The example request interface 11402 may be utilized in any system herein, and/or may perform operations herein, related to determining, interpreting, and/or creating a policy and/or data collection operations, and/or related to receiving and processing data collection requests. The example request interface 11402 determines a data collection template 12114 and/or a data collection use case 12116 for providing to an external device 12104, 12106, 12108 on an interface, where the use case 12116 and/or template 12114 is available for selection as a data collection request, and/or for modification to rapidly configure a data collection request. The example request interface 11402 determines the data collection templates 12114 and/or data collection use cases 12116 in response to selection considerations 12302 such as: an entity type associated with a request (e.g., providing useful use cases and/or templates according to the entity type-such as a manufacturer, service organization, application developer, dealer, vehicle operator, vehicle owner, etc.); a permissions value associated with an interfacing external device (e.g., where users having a similar permissions profile may be more likely to be seeking similar data, and/or users having a similar permissions profile can efficiently utilize the same templates and/or use cases due to overlap in available parameters); previous data collection policies and/or requests from the same user (and/or same entity, same external device, same access location, etc.); and/or previous data collection policies and/or requests from other users having a shared characteristic with the user (e.g., sharing an expressed goal, an entity type, a permissions value, and/or a categorical selection, such as by a user, where the categorical selection may relate to subject matter of the data collection-location data, powertrain data, feature utilization data, etc.—and/or may relate to an intended use of the data collected—service feature, efficiency feature, operator convenience feature, etc.).

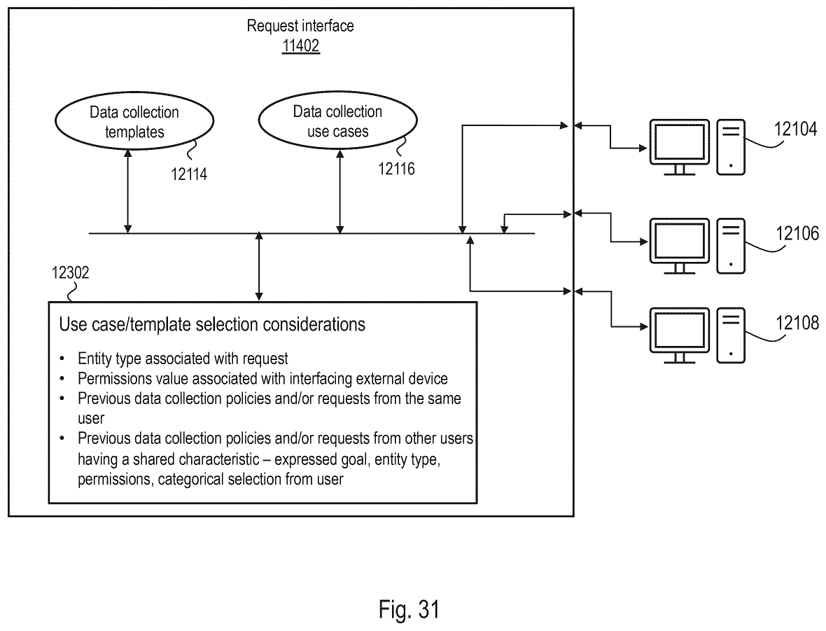

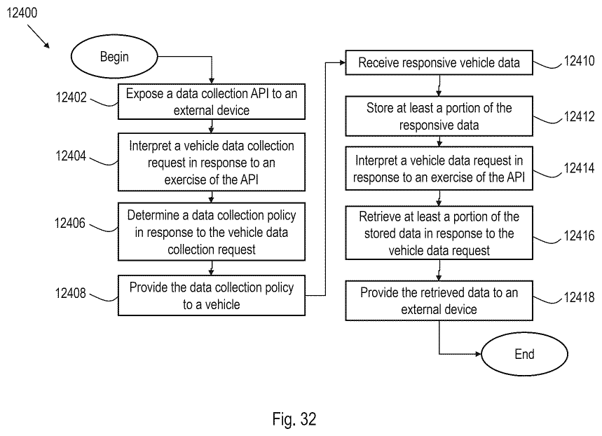

Referencing FIG. 32, an example procedure 12400 for operating a request interface to determine data collection requests and/or collected data access requests is schematically depicted. The example procedure 12400 includes an operation 12402 to expose a data collection API to an external device, an operation 12404 to interpret a vehicle data collection request in response to an exercise of the API, and an operation 12406 to determine a data collection policy in response to the vehicle data collection request. The example procedure 12400 includes an operation 12408 to provide the data collection policy to a vehicle, an operation 12410 to receive responsive vehicle data collected in response to the data collection policy, and an operation 12412 to store at least a portion of the responsive data 11418. The example procedure 12400 includes an operation 12414 to interpret a vehicle data request in response to an exercise of the API, an operation 12416 to retrieve at least a portion of the stored data in response to the vehicle data request, and an operation 12418 to provide the retrieved data to an external device.

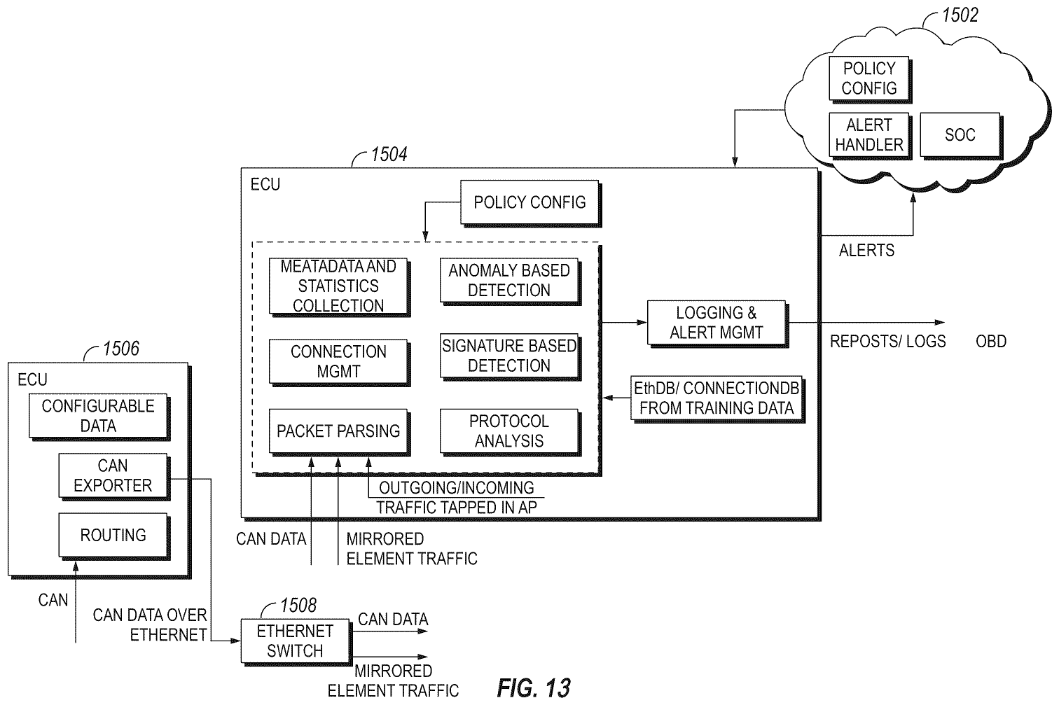

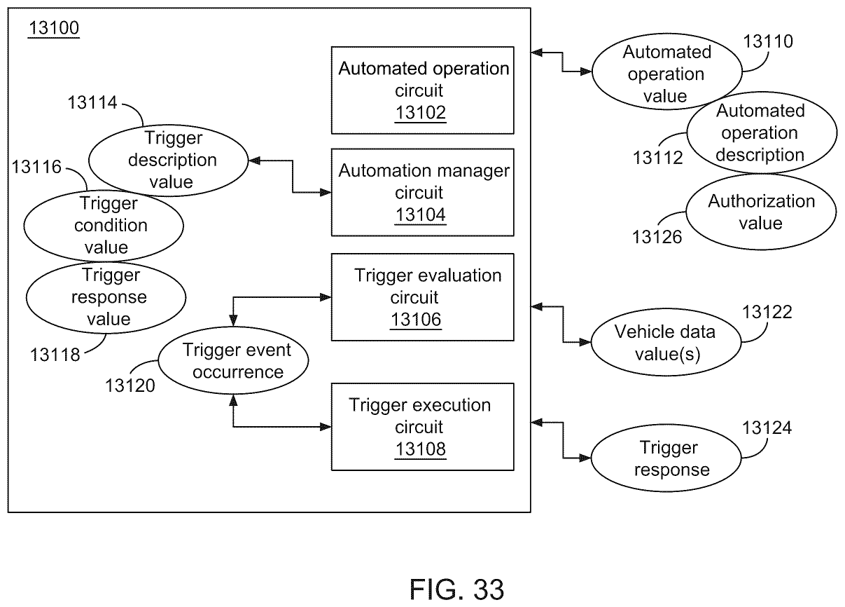

Referencing FIGS. 33-36, example embodiments of the present disclosure are schematically depicted to provide automated vehicle operations based on detected data values, response of data values, combined data values and/or responses, and/or trigger evaluations as set forth throughout the present disclosure. The apparatuses, systems, circuits, and/or operations set forth in relation to FIGS. 33-36 and the related descriptions may be utilized in any embodiments of the present disclosure, may be utilized in whole or part with embodiments of FIGS. 1-14, and/or aspects of embodiments depicted in FIGS. 1-14 may be utilized in whole or part with embodiments of FIGS. 33-36. The utilization of automated response operations of a vehicle leverage numerous aspects of embodiments of the present disclosure—for example, and without limitation: allowing for rapid implementation of features utilizing little or no application development resources for the features; allowing for installation and utilization of features having a light footprint in terms of verification, installation, and distribution of features to a number of vehicles; allowing for creative third parties and/or vehicle owner/operators to provide high value and/or convenience enhancements for interactions with the vehicle; and/or allowing for installation of feature (e.g. as a containerized application) at a first time, and enabling of the feature at a later time (e.g., to provide verification time, provide for distributed roll-out risk, etc.). In certain embodiments, aspects of the present disclosure enable high capability automated vehicle operations, including aspects such as: the ability of embodiments herein to retrieve and/or provide data values to any end point on any network zone of any type; to control access to features, end points, applications, flows, and/or actuators that are protective of vehicle security and mission integrity; allowing for access to any data on the vehicle and/or any actuator on the vehicle without requiring in-depth knowledge of the vehicle configuration; and/or utilization of an external device facing interface and API to provide a selected user experience and enable easy access to available capabilities of the vehicle.

Referencing FIG. 33, an example apparatus for performing automated operations on a vehicle is schematically depicted. The example apparatus 13100 includes an automated operation circuit 13102 structured to interpret an automated operation value 13110 including an automated operation description for a vehicle 13112. The example apparatus 13100 further includes an automation manager circuit 13104 structured to determine a trigger description value 13114 in response to the automated operation value 13110, the trigger description value 13114 including a trigger condition value 13116 (e.g., data values, operating conditions, state values, and/or mode values defining detected values utilized to determine whether the trigger event has occurred), and a trigger response value 13118 (e.g., operations to be performed in response to a trigger event occurrence 13120, including operation of an actuator, collection of data, providing notifications or alerts, etc.). The example apparatus 13100 further includes a trigger evaluation circuit 13106 structured to determine a trigger event occurrence 13120 in response to the trigger condition value 13116 and at least one vehicle data value 13122. The example apparatus 13100 includes a task and/or trigger execution circuit 13108 structured to execute a trigger response 13124 in response to the trigger event occurrence 13120. Embodiments of the disclosure may execute one or more tasks without a trigger.

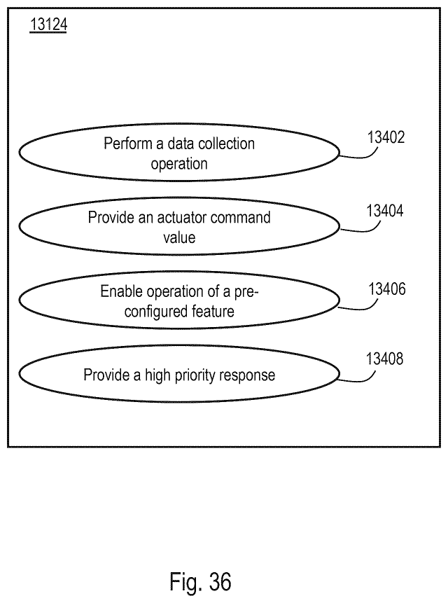

Example and non-limiting trigger responses 13124 include operations such as: performing a data collection operation 13402 (e.g., reference FIG. 36); providing an actuator command value 13404; and/or enabling operation of a pre-configured feature on a controller of the vehicle 13406. An example trigger response 13124 includes providing a high priority response 13408 for at least a portion of the trigger response 13124, for example to allow for a rapid user experience for at least a portion of the trigger response 13124, for example providing immediate feedback to the user that an operation has commenced, providing for a rapid notification or external communication, and/or providing a high priority actuator command (e.g., unlocking a door) as a part of the trigger response 13124. An example automated operation value 13110 includes a selection from a number of pre-configured automated operation values 13110, for example to provide pre-configured operations available on an interface to allow for rapid configuration of automated operations, and/or to ensure that certain operations are always performed together or in a determined arrangement (e.g., confirming aspects before allowing an engine start, such as enforcing a zero vehicle speed, closed doors, etc.). An example automation manager circuit 13104 is further structured to determine an authorization value 13126 associated with the automated operation value 13110, and to selectively determine the trigger description value 13114 in response to the authorization value 13126 (e.g., declining to implement the automated operation value 13110 if the authorization is insufficient, providing a notification that the automated operation value 13110 is not to be implemented, etc.). An example automation manager circuit 13104 is further structured to determine the trigger description value 13114 as a persistent value (e.g., similar to implementation of a persistent policy), and/or as a limited execution value (e.g., similar to implementation of a limited and/or discrete policy). An example automation manager circuit 13104 is further structured to maintain a receiver of the vehicle in a selected power mode during selected operating conditions of the vehicle—for example allowing for exchange of external data to support automated operations of the vehicle, and/or to enhance a response time of the vehicle, while managing power consumption. An example automation manager circuit 13104 is further structured to maintain at least one controller of the vehicle in a selected power mode during selected operating conditions of the vehicle, for example to monitor data values supporting an automated operation and/or to monitor a trigger condition value 13116, and/or to reduce a response time of the vehicle to an automated operation, for example keeping a selected controller in a power mode where a startup time is reduced and/or eliminated, while managing power consumption. An example automation manager circuit 13104 is further structured to maintain the at least one controller of the vehicle in the selected power mode in response to a content of the trigger description value 13114 (e.g., keeping controllers associated with a monitored value and/or actuator in a selected power mode).

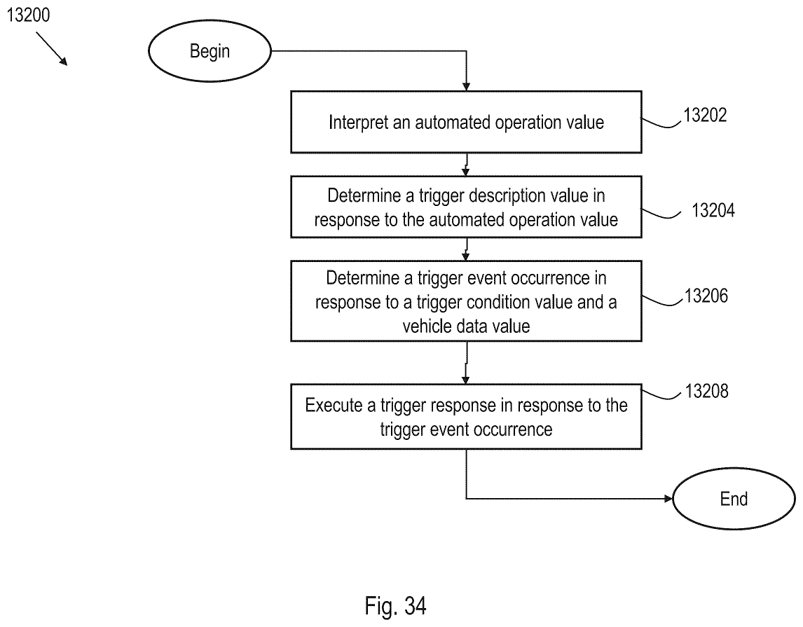

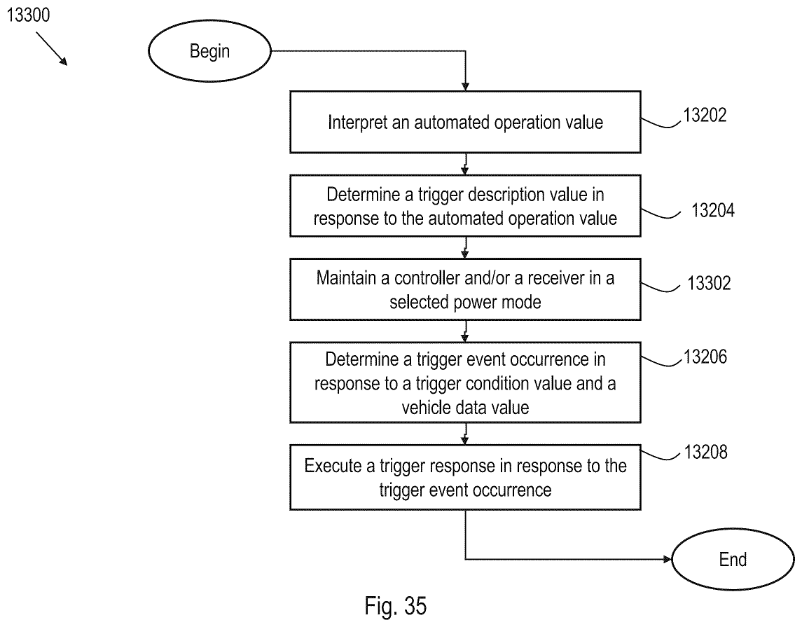

Referencing FIG. 34, an example procedure 13200 to implement an automated operation of a vehicle is schematically depicted. The example procedure 13200 includes an operation 13202 to interpret an automated operation value, an operation 13204 to determine a trigger description value in response to the automated operation value, an operation 13206 to determine a trigger event occurrence in response to a trigger condition value and a vehicle data value, and an operation 13208 to execute a trigger response in response to the trigger event occurrence. In embodiments, one or more trigger/event responses may be included in a recipe which may be created via an external tool, e.g., a cloud application, and deployed to one or more vehicles. Referencing FIG. 35, another example procedure 13300 to implement an automated operation of the vehicle is schematically depicted. The example procedure 13300, in addition to procedure 13200, further includes an operation 13302 to maintain a controller and/or a receiver (e.g., a WiFi and/or cellular data receiver) in a selected power mode.

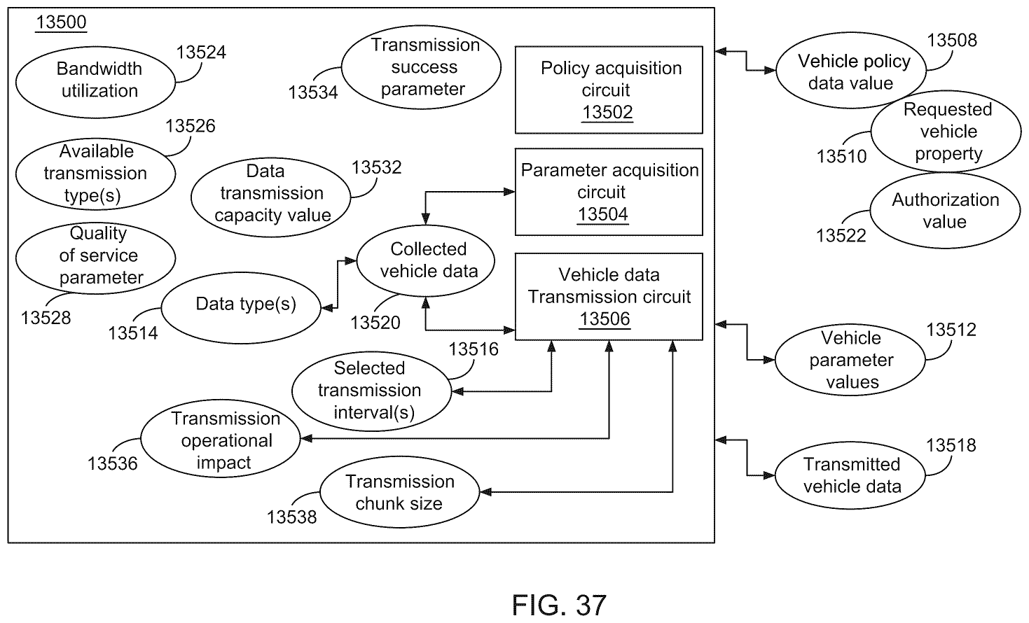

Referencing FIG. 37, an example apparatus 13500 for transmission operations of vehicle data with a cloud system and/or an external device is schematically depicted. The example apparatus 13500 includes a policy acquisition circuit 13502 that interprets a vehicle policy data value 13508 including at least one requested vehicle property 13510, a parameter acquisition circuit 13504 structured to interpret a plurality of vehicle parameter values 13512, responsive to the at least one requested vehicle property 13510, from a number of providing end points, each of the number of providing end points on at least one network zone of a vehicle. An example vehicle policy data value 13508 further includes an authorization value 13522, which may be utilized to determine whether transmission is authorized, and/or to determine if certain transmission resource utilizations are authorized. The example apparatus 13500 further includes a vehicle data transmission circuit 13506 that selectively transmits at least a portion of collected vehicle data 13520, for example provided by end points responsive to the vehicle parameter values 13512, and provided as transmitted vehicle data 13518. In certain embodiments, the vehicle parameter values 13512 are retrieved from a network zone of the vehicle, and/or requested from an end point where a given vehicle parameter value 13512 is not already available on a network zone.

An example vehicle data transmission circuit 13506 further selectively transmits the at least a portion of the collected vehicle data 13520 by selecting a transmission interval 13516 for the at least a portion of the collected vehicle data 13520. An example vehicle data transmission circuit 13506 is further structured to select the transmission interval 13516 in response to at least one of: an interval provided in the vehicle policy data value 13508; an interval responsive to a priority of the at least a portion of the collected vehicle data 13520; an interval responsive to an availability description for transmitting resources (e.g., based on current vehicle operating conditions, availability of external data communication, current bandwidth for a network zone supporting external communications, and/or a transceiver providing external communications, etc.) for the at least a portion of the collected vehicle data 13520; an interval responsive to a historical transmission availability for the vehicle; and/or an operating condition of the vehicle.

An example vehicle data transmission circuit 13506 is further structured to selectively transmit the at least a portion of the collected vehicle data 13520 by selecting a bandwidth utilization 13524 for the at least a portion of the collected vehicle data 13520 (e.g., a permitted bandwidth utilization for the element of the collected vehicle data 13520). An example vehicle data transmission circuit 13506 is further structured to select the bandwidth utilization 13524 in response to at least one of: a bandwidth utilization provided in the vehicle policy data value; a bandwidth utilization responsive to a priority of the at least a portion of the collected vehicle data 13520; a bandwidth utilization responsive to an availability description for transmitting resources for the at least a portion of the collected vehicle data 13520; an interval responsive to a historical transmission availability for the vehicle; or an operating condition of the vehicle.

An example vehicle data transmission circuit 13506 is further structured to selectively transmit the at least a portion of the collected vehicle data by selecting a transmission interval 13516 in response to a data type 13514 of the at least a portion of the collected vehicle data 13520. The vehicle data transmission circuit 13506 is further structured to selectively transmit the at least a portion of the collected vehicle data 13520 in response to a vehicle operational impact 13536 of transmission operations (e.g., based on utilization of network zones and/or external data transfer resources according to various operating conditions of the vehicle, such as an operating state, power throughput, engine speed, etc.). The vehicle data transmission circuit is further structured to selectively transmit the at least a portion of the collected vehicle data in response to a power utilization impact of transmission operations. The vehicle data transmission circuit 13506 is further structured to selectively transmit the at least a portion of the collected vehicle data 13520 in response to a data transmission capacity value 13532. The data transmission capacity value 13532 includes at least one data transmission capacity value such as: a data transmission capacity 13532 associated with a time interval (e.g., a transmission rate, and/or an amount of data over a predetermined time period); a data transmission capacity 13532 associated with an entity related to the at least a portion of the collected vehicle data; a data transmission capacity 13532 associated with an access point name; a data transmission capacity 13532 associated with a flow related to the at least a portion of the collected vehicle data; a data transmission capacity 13532 associated with an application of the vehicle related to the at least a portion of the collected vehicle data; or a data transmission capacity 13532 associated with a vehicle function related to the at least a portion of the collected vehicle data.

An example vehicle data transmission circuit 13506 is further structured to selectively transmit the at least a portion of the collected vehicle data 13520 in response to a currently available transmission type 13526, for example a cellular data transmission, WiFi transmission, physically connected device transmission, or the like. The vehicle data transmission circuit 13506 is further structured to selectively transmit the at least a portion of the collected vehicle data by selecting a data transmission chunk size 13538 for the at least a portion of the collected vehicle data. The data transmission chunk size 13538 includes at least one of an individual message size (e.g., a packet size value) or a single transmission flow size (e.g., a data amount to be transmitted over the course of a single transmission attempt period). An example vehicle data transmission circuit 13506 is further structured to select the transmission chunk size 13538 in response to at least one of: a transmission chunk size provided in the vehicle policy data value; a transmission chunk size to a priority of the at least a portion of the collected vehicle data (e.g., increasing a chunk size to pass high priority data faster, and/or reducing a chunk size to improve a success rate of transmitting high priority data); a transmission chunk size responsive to an availability description for transmitting resources for the at least a portion of the collected vehicle data (e.g., configuring chunk size based on a capability of available transmission resources); a transmission chunk size responsive to a historical transmission availability for the vehicle; or an operating condition of the vehicle. An example vehicle data transmission circuit 13506 is further structured to adjust the selectively transmitting the at least a portion of the collected vehicle data in response to a success parameter 13534 for transmitting operations (e.g., allowing for adjustment and/or variation in transmission parameters to continuously improve transmissions, and/or adapt transmission parameters to conditions). The vehicle transmission circuit is further structured to adjust the selectively transmitting the at least a portion of the collected vehicle data in response to a quality of service parameter 13528 for transmitting operations (e.g., adapting transmission selections to improve a quality of service, to enforce a quality of service requirement, etc.).

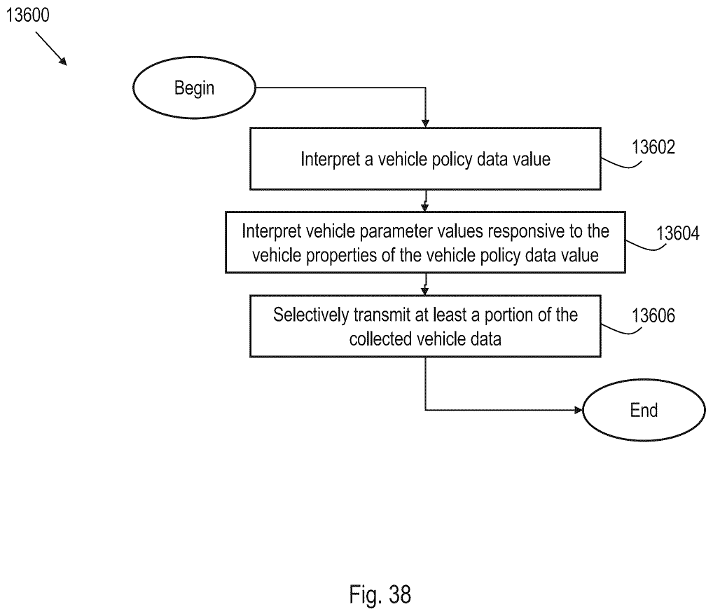

Referencing FIG. 38, an example procedure 13600 to manage transmission operations of a vehicle is schematically depicted. The example procedure 13600 includes an operation 13602 to interpret a vehicle policy data value, an operation 13604 to interpret vehicle parameter values responsive to the vehicle properties of the vehicle policy data value, and an operation 13606 to selectively transmit at least a portion of the collected vehicle data.

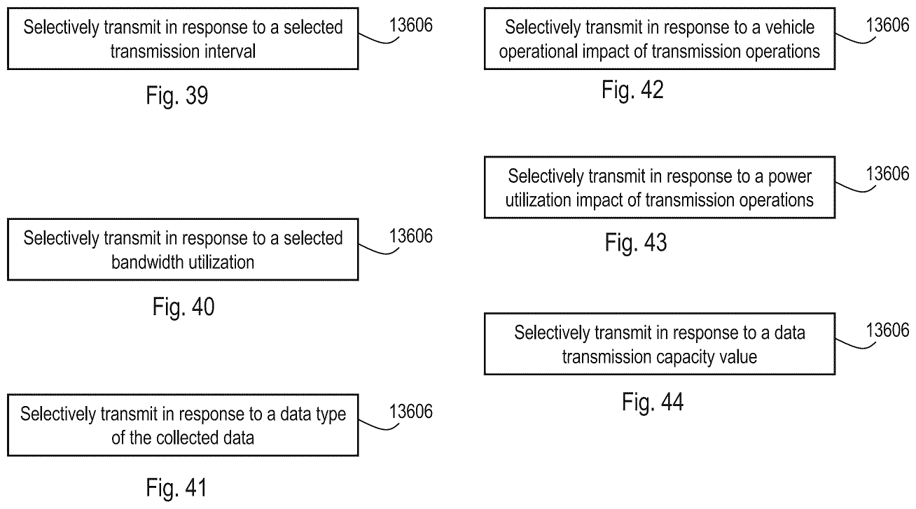

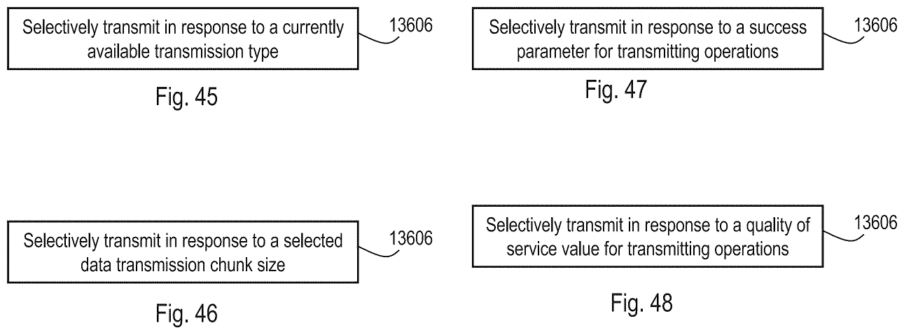

Referencing FIGS. 39-48, example operations 13606 to selectively transmit at least a portion of the collected vehicle data are schematically depicted. Referencing FIG. 39, an operation 13606 includes selectively transmitting collected data in response to a selected transmission interval. Referencing FIG. 40, an operation 13606 includes selectively transmitting collected data in response to a selected bandwidth utilization. Referencing FIG. 41, an operation 13606 includes selectively transmitting collected data in response to a data type of the collected data. Referencing FIG. 42, an operation 13606 includes selectively transmitting collected data in response to a vehicle operational impact of transmission operations. Referencing FIG. 43, an operation 13606 includes selectively transmitting collected data in response to a power utilization impact of transmission operations. Referencing FIG. 44, an operation 13606 includes selectively transmitting collected data in response to a data transmission capacity value. Referencing FIG. 45, an operation 13606 includes selectively transmitting collected data in response to a currently available transmission type. Referencing FIG. 46, an operation 13606 includes selectively transmitting collected data in response to a selected data transmission chunk size. Referencing FIG. 47, an example operation 13606 includes selectively transmitting collected data in response to a success parameter for transmitting operations. Referencing FIG. 48, an example operation 13606 includes selectively transmitting collected data in response to a quality of service value for transmitting operations.

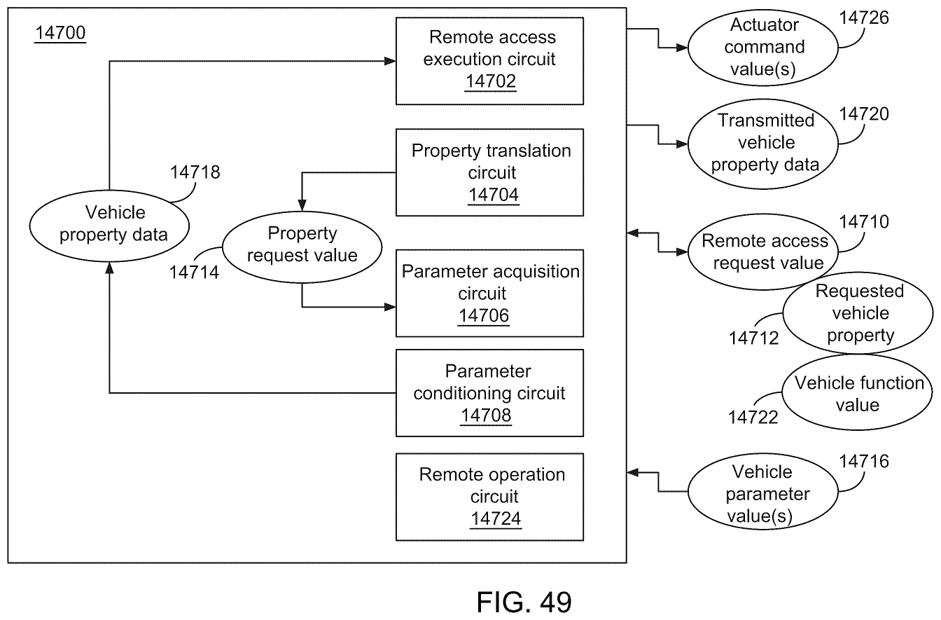

Referencing FIG. 49, an example apparatus 14700 for implementing remote assistance operations for a vehicle is schematically depicted. The example apparatus 14700 includes a remote access execution circuit 14702 structured to interpret a remote access request value 14710 from a requesting device (e.g., an external device coupled to a cloud system, and/or otherwise in communication with the vehicle), the remote access request value 14710 including at least one requested vehicle property 14712. The example apparatus 14700 includes a property translation circuit 14704 structured to determine a property request value 14714 in response to the at least one requested vehicle property 14712, and a parameter acquisition circuit 14706 structured to interpret a plurality of vehicle parameter values 14716 in response to the property request value 14714. The example apparatus 14700 includes a parameter conditioning circuit 14708 structured to generate, in response to the property request value 14714, vehicle property data 14718 from the plurality of vehicle parameter values 14716, the vehicle property data 14718 corresponding to at least one the requested vehicle property 14712, where the remote access execution circuit 14702 is further structured to transmit the vehicle property data 14718 to the requesting device—for example as transmitted vehicle property data 14720. For example, the requested vehicle property 14712 describes a parameter of interest to a user of the requesting device, which may be selected from an interface—for example a service interface (e.g., where technical assistance is provided by a remote service personnel), and/or an owner or operator of the vehicle (e.g., where the owner/operator remotely accesses the vehicle to determine data of interest and/or perform a remote operation). In the example, the property request value 14714 may be provided as a value to be requested, for example from an end point of a network zone of the vehicle, and the vehicle parameter value 14716 is the responsive value provided by the end point. In a further example, the vehicle property data 14718 includes the vehicle parameter value 14716, configured according to the external value as requested in the requested vehicle property 14712, for example a value determined from one or more vehicle parameter values 14716, and/or a vehicle parameter value 14716 which has formatting, selected units, sampling rates, bit depth, etc. configured to the requested vehicle property 14712. An example apparatus 14700 includes a converged network device (CND) structured to regulate communications between a first network zone having a first network endpoint and a second network zone having a second network endpoint, wherein at least a portion of the plurality of vehicle parameter values 14716 are generated by each of the first network endpoint and the second network endpoint.

The apparatus further includes wherein the remote access request value 14710 further includes a vehicle function value 14722—for example an actuator operation, a feature to be enabled, exercised, and/or configured, and/or a sequence of operations (e.g., starting an engine, operating the vehicle through a sequence of operations, testing a number of actuators, etc.). An example property translation circuit 14704 determines an actuator command value 14726 in response to the vehicle function value 14722; and a remote operation circuit 14724 provides the actuator command value 14726 to an endpoint of a network zone of a vehicle. An example apparatus 14700 further includes a converged network device (CND) structured to regulate communications between a first network zone having a first network endpoint and a second network zone having a second network endpoint and including the network zone of the vehicle; wherein the first network endpoint provides at least a portion of the plurality of vehicle parameter values; and wherein the second network endpoint includes an actuator responsive to the actuator command value 14726. An example property translation circuit 14704 is further structured to determine the actuator command value 14726 by performing at least one operation such as: determining the actuator command value 14726 as a sequence of actuator commands corresponding to a diagnostic test operation; determining the actuator command value 14726 as a sequence of actuator commands corresponding to a remote control operation; and/or determining the actuator command value 14726 as at least one actuator command responsive to the vehicle function value 14722.

An example apparatus 14700 includes an additional number of endpoints distributed across at least the first network zone and the second network zone, wherein the additional plurality of endpoints each provide at least a portion of the plurality of vehicle parameter values 14716. An example apparatus 14700 further includes an additional number of endpoints distributed across at least the first network zone and the second network zone, wherein the additional plurality of endpoints each include a corresponding actuator, each responsive to at least a portion of the actuator command value 14726. An example remote access request value 14710 includes a policy. The policy includes at least one value such as: an authorization value of the requesting device; a data collection description including the at least one requested vehicle property; a trigger description value including a trigger condition and a trigger response value, and where the parameter acquisition circuit 14706 is further structured to generate at least a portion of the vehicle property data 14718 from the plurality of vehicle parameter values 14716 further in response to the trigger description value and/or a policy priority value.

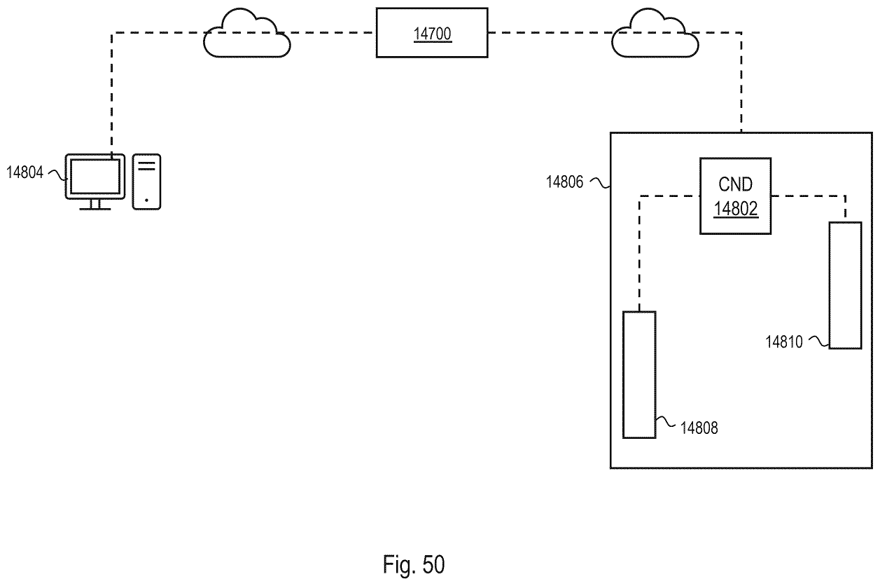

Referencing FIG. 50, an example system including an apparatus 14700 is schematically depicted. The example system may include any apparatus, as set forth herein, and is not limited to inclusion of the apparatus 14700. Additionally, or alternatively, the apparatus 14700 and/or portions thereof may be provided on the vehicle 14806, and/or on the external device 14804. The example of FIG. 50 illustrates the apparatus 14700 provided as a cloud system, but a connection between the external device 14804 and the vehicle 14806 may be provided in any manner, including connection through a WiFi, LAN, and/or any other connection configuration described throughout the present disclosure. In certain embodiments, the external device 14804 may couple directly to the vehicle 14806, with operations of the apparatus 14700 performed in a cloud system, and/or on the vehicle 14806 and/or the external device 14804. The example of FIG. 50 includes a CND 14802 configured to allow data value and/or actuator access between network zones 14808, 14810 of the vehicle 14806. The system of FIG. 50 allows for remote assistance and/or remote control operations of the vehicle 14806, including access to data values, operation of actuators, and/or operation of more complex operational features, regardless of the configuration of end points on the vehicle 14806, and without requiring knowledge of the vehicle configuration by the user of the external device 14804, and/or a user configuring operations of the apparatus 14700.

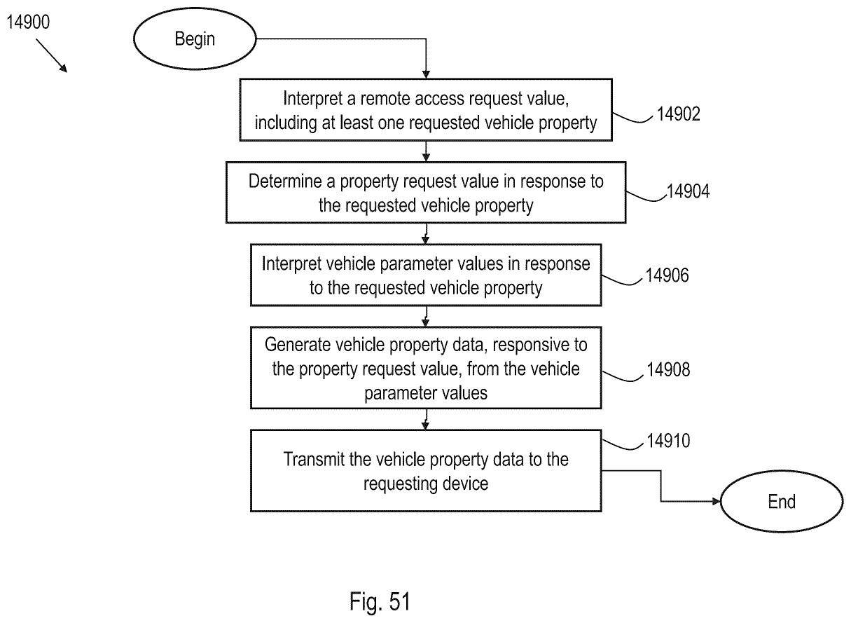

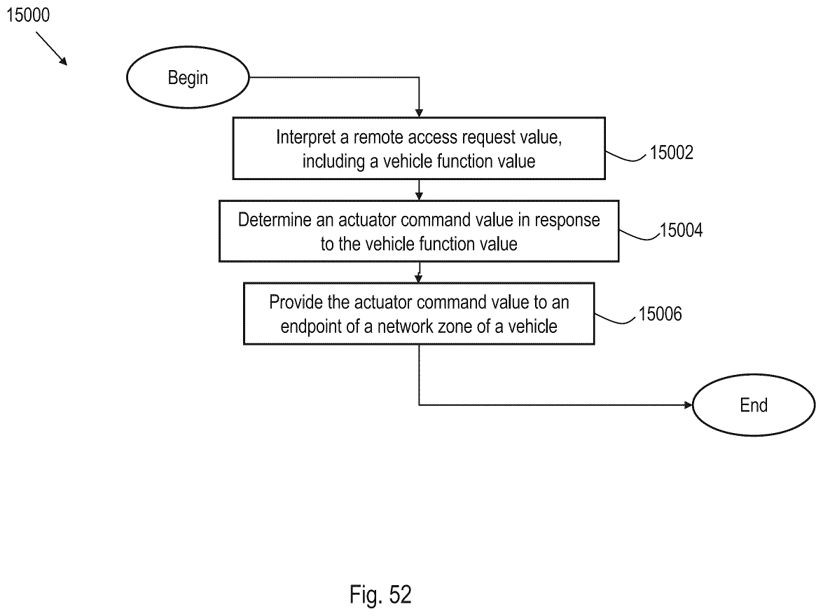

Referencing FIG. 51, an example procedure 14900 for performing remote operations for a vehicle, including remote assistance operations, is schematically depicted. The example procedure 14900 includes an operation 14902 to interpret a remote access request value, including at least one requested vehicle property, an operation 14904 to determine a property request value in response to the requested vehicle property, an operation 14906 to interpret vehicle parameter value(s) in response to the requested vehicle property, an operation 14908 to generate vehicle property data, responsive to the property request value, from the vehicle parameter values, and an operation 14910 to transmit the vehicle property data to the requesting device. Referencing FIG. 52, an example procedure 15000 for performing operations for a vehicle, including remote assistance operations, is schematically depicted. The example procedure 15000 includes an operation 15002 to interpret a remote access request value, including a vehicle function value, an operation 15004 to determine an actuator command value in response to the vehicle function value, and an operation 15006 to provide an actuator command value to an end point of a network zone of the vehicle.

As will be appreciated, embodiments of the disclosure may provide for a requesting entity to be agnostic with respect to the manner in which different vehicles acquire/collect data, and/or the configuration (e.g., network zones, end points, control operation locations, etc.) of the vehicle. In other words, embodiments of the disclosure may provide for a requesting entity to use the same type of property request value to request the same vehicle property from different vehicles, and/or from the same vehicle having different configurations, regardless of any underlying distinctions between how the vehicles collect and configure their own vehicle parameters. For example, a first vehicle of a first make, model and year may have an oil temperature sensor disposed on a CAN. A requesting entity may be able to retrieve the oil temperature from the first vehicle via a first property request value that requests “oil temperature”. The first property request value may then be interpreted by an apparatus, which then generates first vehicle property data providing the oil temperature of the first vehicle to the requesting entity. A newer version of the model of the first vehicle, e.g., a second vehicle of the same make and model but of a newer year, may have an oil temperature sensor disposed on an Ethernet, and/or the oil temperature sensor may be of a completely different type and/or have a differently formatted output, as compared to the oil temperature of the first vehicle. Embodiments of the disclosure provide for the requesting entity to send a second property request, that is substantially the same as the first property request, requesting “oil temperature” to the second vehicle. The second property request may then be interpreted by an apparatus, which then generates second vehicle property data, that may be substantially the same as the first vehicle property data, which provides the oil temperature of the second vehicle to the requesting entity.

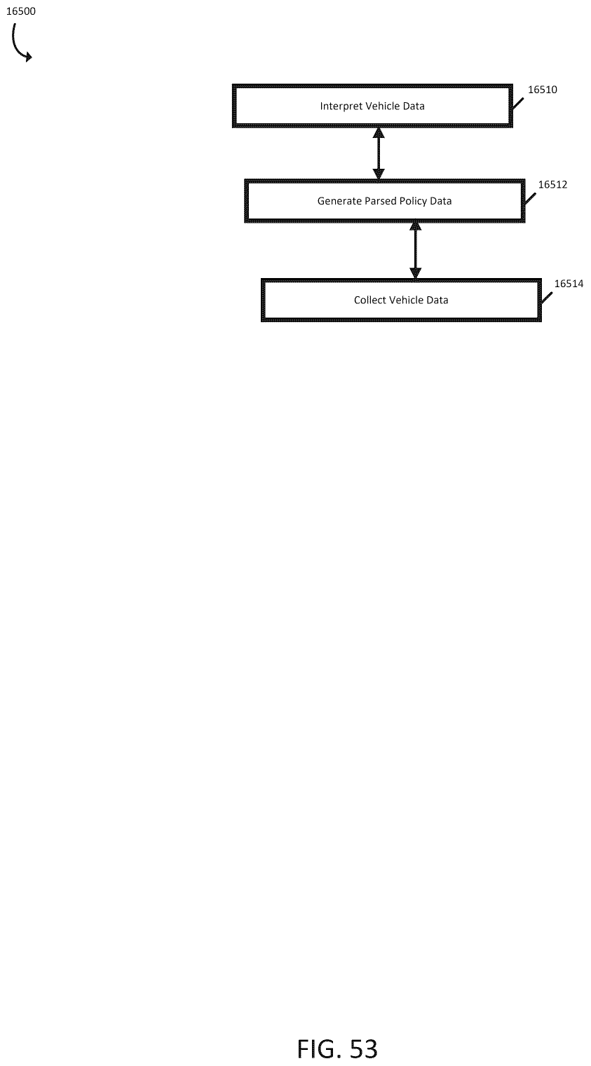

Illustrated in FIG. 53 is a method 16500 for data collection policy intake and execution, in accordance with an embodiment of the disclosure. The method 16500 may be performed by any controller and/or apparatus described herein. Accordingly, referring to FIG. 53, in embodiments, the method 16500 includes interpreting 16510 a vehicle policy data value having at least a portion of a vehicle policy. The method 16500 further includes generating 16512, in response to and based at least in part onboard the vehicle policy data value, parsed policy data that includes of one or more vehicle sub-policies of the vehicle policy. The method 16500 further includes collecting 16514 vehicle data from one or more vehicle sensors in response to the parsed policy data.

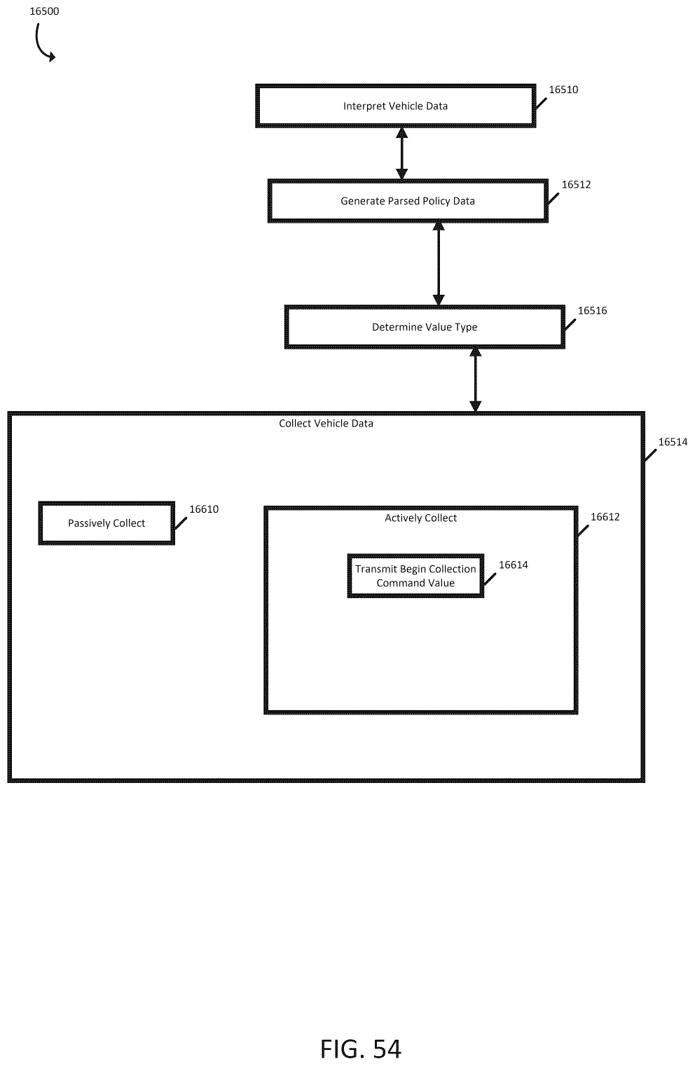

Referring now to FIG. 54, in embodiments, the method 16500 may include determining 16516, from the vehicle policy data value, a type value of the vehicle policy. As such, collecting 16514 the vehicle data may include passively collecting 16610 the vehicle data in response to the type value. In embodiments, collecting 16514 the vehicle data may include actively collecting 16612 the vehicle data in response to the type value. Actively collecting 16612 the vehicle data may include transmitting 16614 a begin collection command value.

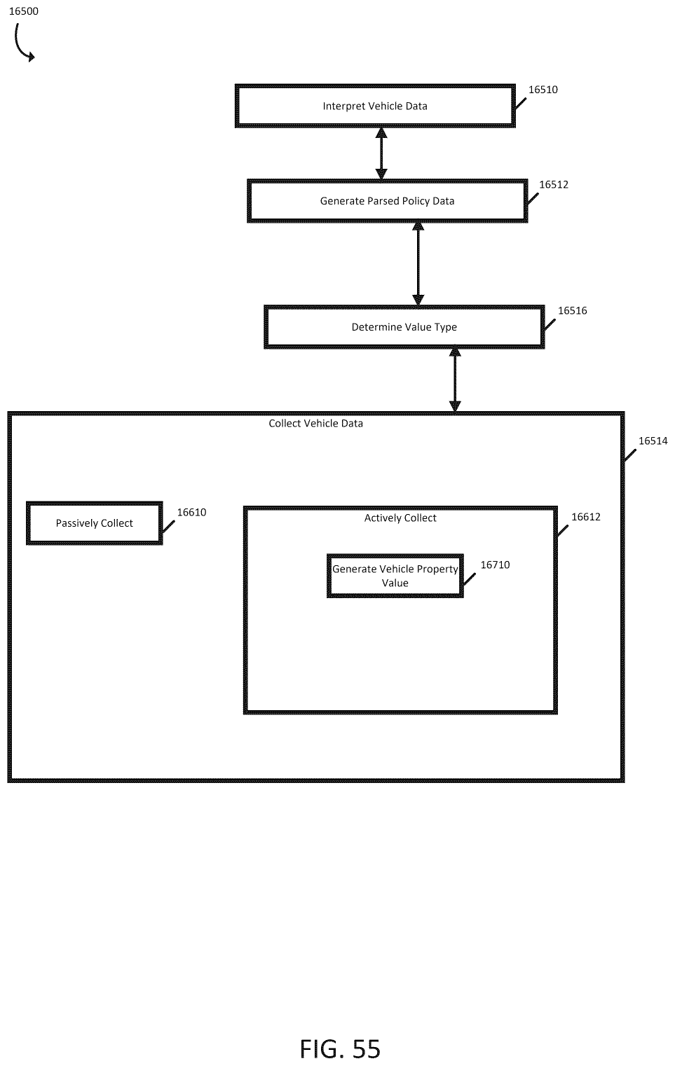

As shown in FIG. 55, actively collecting 16612 the vehicle data may include generating 16710 a vehicle property value based at least in part on the collected vehicle data.

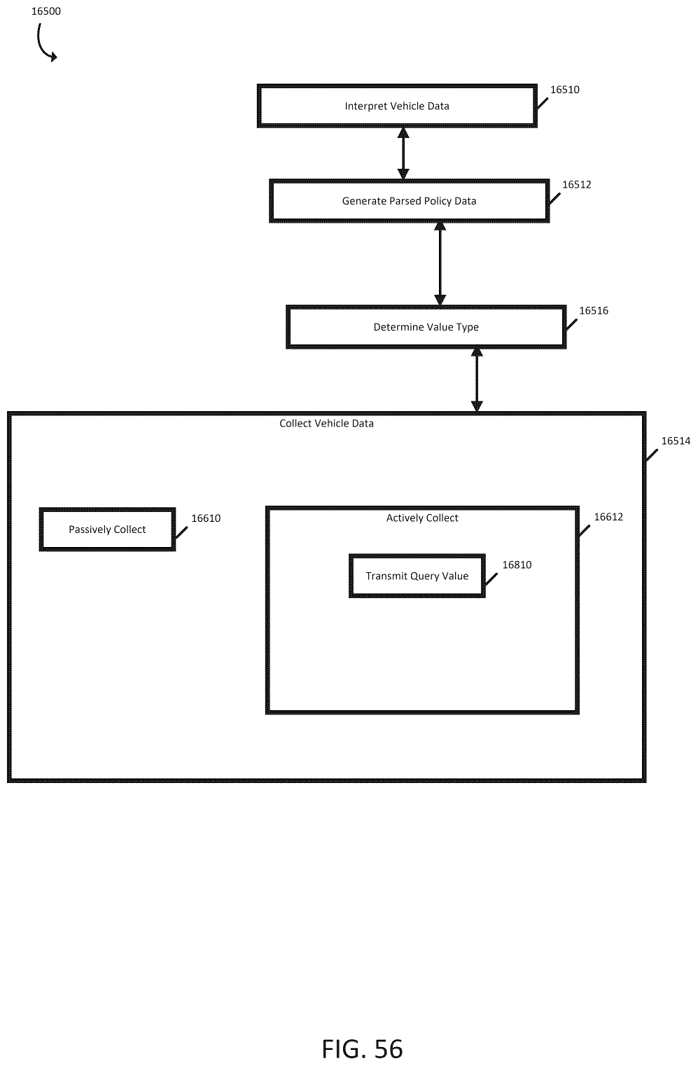

As shown in FIG. 56, actively collecting 16612 the vehicle data may include transmitting 16810 a query value.

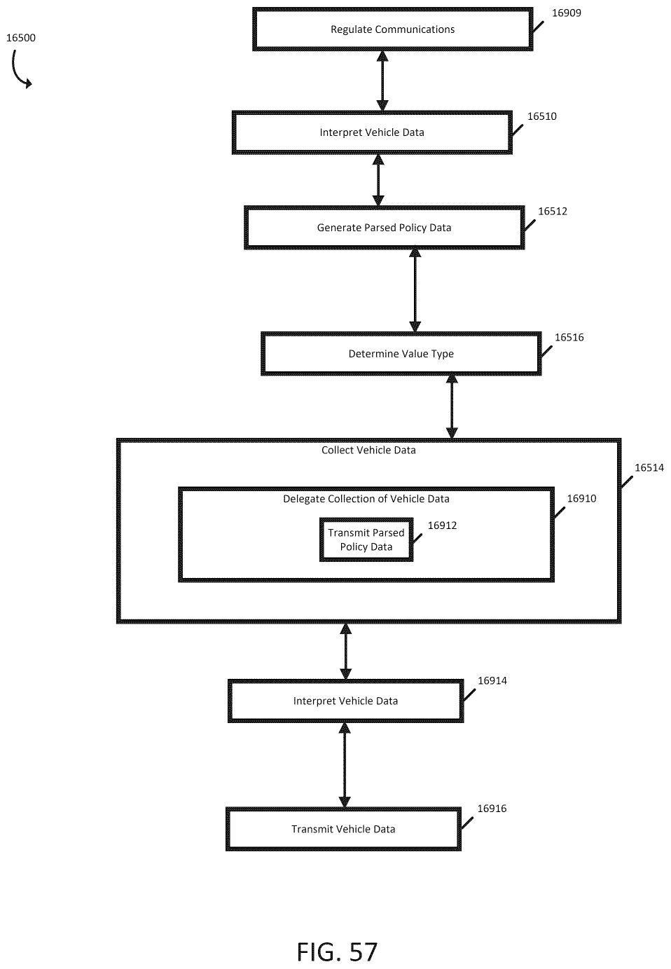

Referring now to FIG. 57, in embodiments, the method 16500 may include regulating communications 16909 between a first network zone and a second network zone. In embodiments, the first network zone may have a first vehicle sensor of the one or more vehicle sensors, from which the vehicle data is collected, and the second network zone may have a second vehicle sensor of the one or more vehicle sensors, from which the vehicle data is collected. In embodiments, the first network zone and the second network zone may be of distinct types. In embodiments, collecting 16514 the vehicle data may include delegating collection 16910 of the vehicle data to one or more vehicle controllers. Delegating collection 16910 of the vehicle data to one or more vehicle controllers may include transmitting 16912 at least some of the parsed policy data to the one or more vehicle controllers.

In embodiments, the method 16500 may further include interpreting 16914 the vehicle data collected by the one or more vehicle controllers.

In embodiments, the method 16500 may include transmitting 16916 the collected vehicle data.

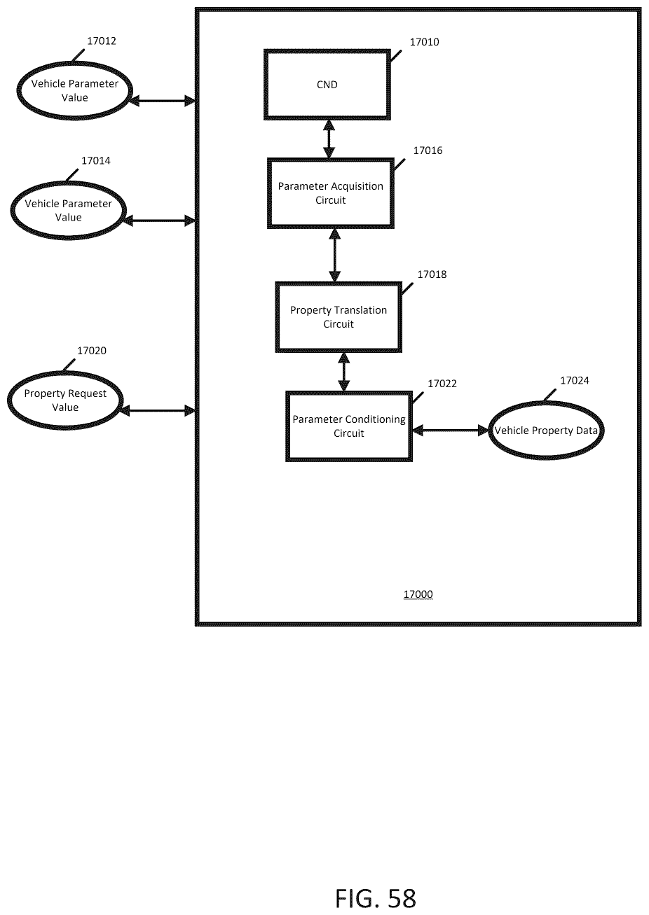

Referring now to FIG. 58, an embodiment of an apparatus 17000 for data collection in a mixed network environment, e.g., a car and/or other vehicle described herein, is provided. As shown in FIG. 58, the apparatus 17000 includes a converged network device (CND) 17010 which, as described herein and in other portions of this disclosure, may be structured to regulate communications between a first network zone having a first network endpoint and a second network zone having a second network endpoint. The endpoints may include vehicle sensors and/or other devices as described herein. A plurality of vehicle parameter values 17012 and 17014 is generated by the first and the second network endpoints. The apparatus 17000 further includes a parameter acquisition circuit 17016 structured to interpret the plurality of vehicle parameter values 17012 and 17014. The apparatus 17000 further includes a property translation circuit 17018 structured to interpret a property request value 17020 that includes at least a portion of a requested vehicle property. The apparatus 17000 further includes a parameter conditioning circuit 17022 structured to generate, in response to the property request value 17020, vehicle property data 17024 from the plurality of vehicle parameter values 17012 and 17014. As will be appreciated, the vehicle property data 17024 corresponds to the requested vehicle property.

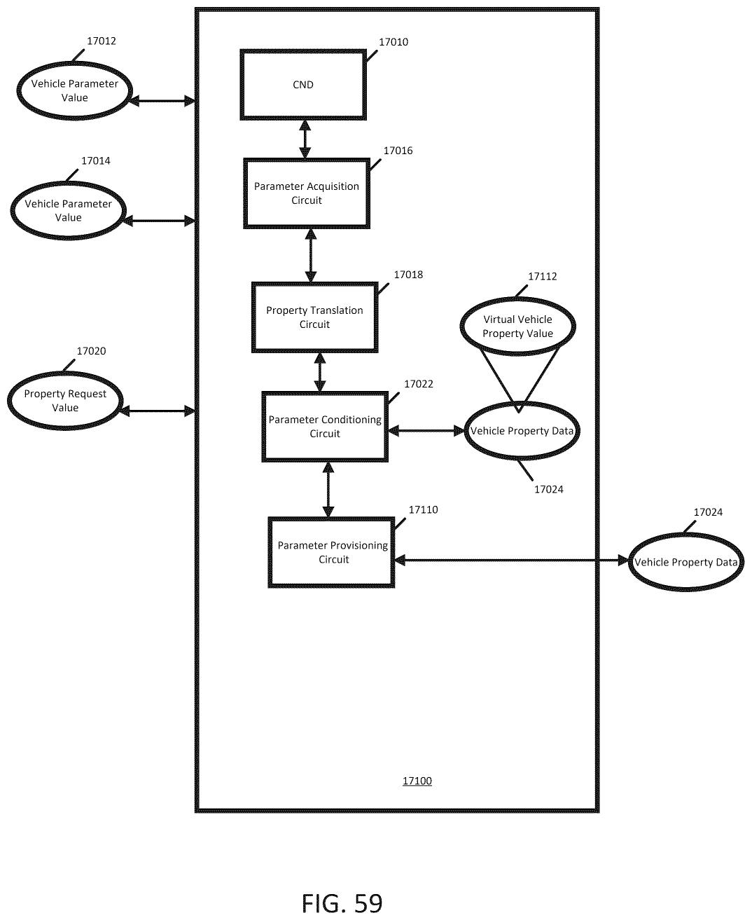

Turning to FIG. 59, another embodiment of an apparatus 17100 for data collection in a mixed network environment, e.g., a car and/or other vehicle as described herein, is provided. Similar to the apparatus 17000 of FIG. 58, the apparatus 17100 includes a CND 17010 which, as described herein and in other portions of this disclosure, may be structured to regulate communications between a first network zone having a first network endpoint and a second network zone having a second network endpoint. The endpoints may include vehicle sensors and/or other devices as described herein that generate the plurality of vehicle parameter values 17012 and 17014. The apparatus 17100 further includes a parameter acquisition circuit 17016 structured to interpret the plurality of vehicle parameter values 17012 and 17014. The apparatus 17100 further includes a property translation circuit 17018 structured to interpret a property request value 17020 that includes at least a portion of a requested vehicle property. The apparatus 17100 further includes a parameter conditioning circuit 17022 structured to generate, in response to the property request value 17020, vehicle property data 17024 from the plurality of vehicle parameter values 17012 and 17014. As will be appreciated, the vehicle property data 17024 corresponds to the requested vehicle property.

As further shown in FIG. 59, the apparatus 17100 may include a parameter provisioning circuit 17110 structured to transmit the vehicle property data 17024. In embodiments, the first network zone and the second network zone are of distinct types, as described herein. In embodiments, the first network zone may include a controller area network (CAN), an Ethernet based network, and/or any other type of network described herein. In embodiments, the first and the second network endpoints may be vehicle sensors. In embodiments, the plurality of vehicle parameter values 17012 and 17014 directly corresponds to the requested vehicle property.

In embodiments, one or more of vehicle the parameter values 17012 and 17014 includes at least one of: a vehicle speed value; a prime mover speed value; a prime mover torque value; a user actuated vehicle feature value; or a vehicle location value. In embodiments, one or more of the plurality of vehicle parameter values 17012 and 17014 may include at least one of: a network utilization value for a network zone of the vehicle; a raw network message from a network zone of the vehicle; a network address for an endpoint on a network zone of the vehicle; a memory storage description of a controller of the vehicle; a value from an end point on a controller area network (CAN); a value from an end point on a local interconnect network (LIN); or an intermediate control value. In embodiments, the requested vehicle property may include at least one of: a component temperature value; a sensor raw value; a component speed value; or an actuator feedback value. In embodiments, the requested vehicle property may include at least one of: a drivetrain component speed value; a drive shaft speed value; a drive shaft torque value; a selected gear value; a battery state of health value; a battery state of charge value; or a battery power throughput value.

As further shown in FIG. 59, the parameter conditioning circuit 17022 may be structured to generate, in response to the property request value 17020, a virtual vehicle property value 17112 from two or more vehicle parameter values 17012 and/or 17014. In embodiments, the vehicle property data 17024 includes the virtual vehicle property value 17112.

In embodiments, the virtual vehicle property value 17112 includes at least one of: a vehicle speed value; a motive power efficiency value; an event occurrence value; or a listing of previous vehicle locations. In embodiments, the virtual vehicle property value 17112 includes at least one of: a listing of one or more user activated features; an average vehicle runtime value; or an estimated vehicle operating cost value.

In embodiments, the vehicle property data 17024 is of a different format than the plurality of vehicle parameter values 17012 and 17014.

Additionally, while embodiments of the CND 17010 facilitate communications between the apparatuses 17000 and 17100 and two onboard networks from which the vehicle parameter values 17012 and 17014 are transmitted over, it should be understood that, in embodiments, the CND 17010 may facilitate communication with one or more offboard networks, as described in other portions of this disclosure.

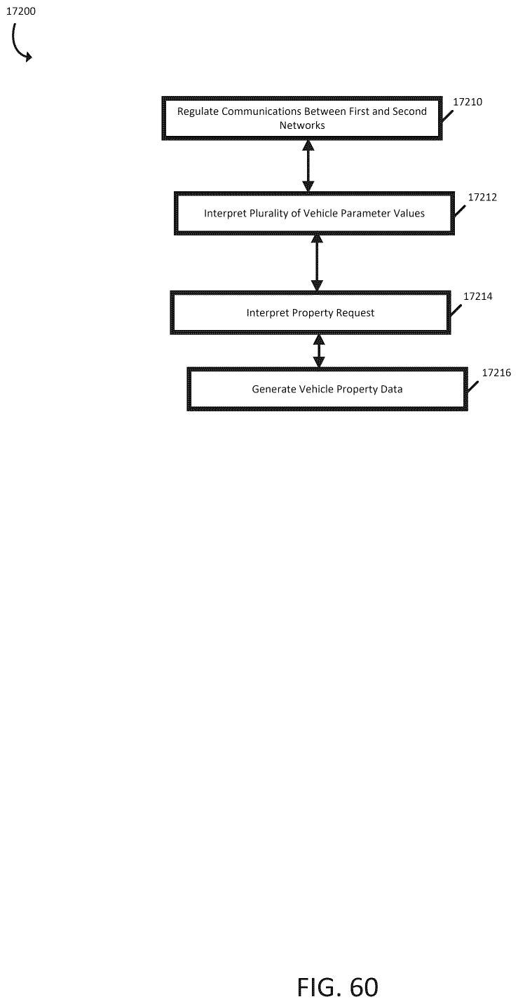

Illustrated in FIG. 60 is a method 17200 for data collection in a mixed network environment, e.g., a car and/or other vehicle described herein, in accordance with an embodiment of the disclosure. The method 17200 may be performed by the either embodiments of the apparatus 17000, 17100, and/or by any other apparatus and/or controller described herein. Accordingly, referring now to FIGS. 58 and 60, the method 17200 includes regulating 17210 communications between a first network zone having a first network endpoint and a second network zone having a second network endpoint, wherein a plurality of vehicle parameter values 17012 and 17014 is generated by the first and the second network endpoints. The method 17200 further includes interpreting 17212 the plurality of vehicle parameter values 17012 and 17014. The method 17200 further includes interpreting 17214 a property request value 17020 that defines, at least in part, a requested vehicle property. The method 17200 further includes generating 17216, in response to the property request value 17020, vehicle property data 17024 from the plurality of vehicle parameter values 17012 and 17014 such that the vehicle property data 17024 corresponds to the requested vehicle property.

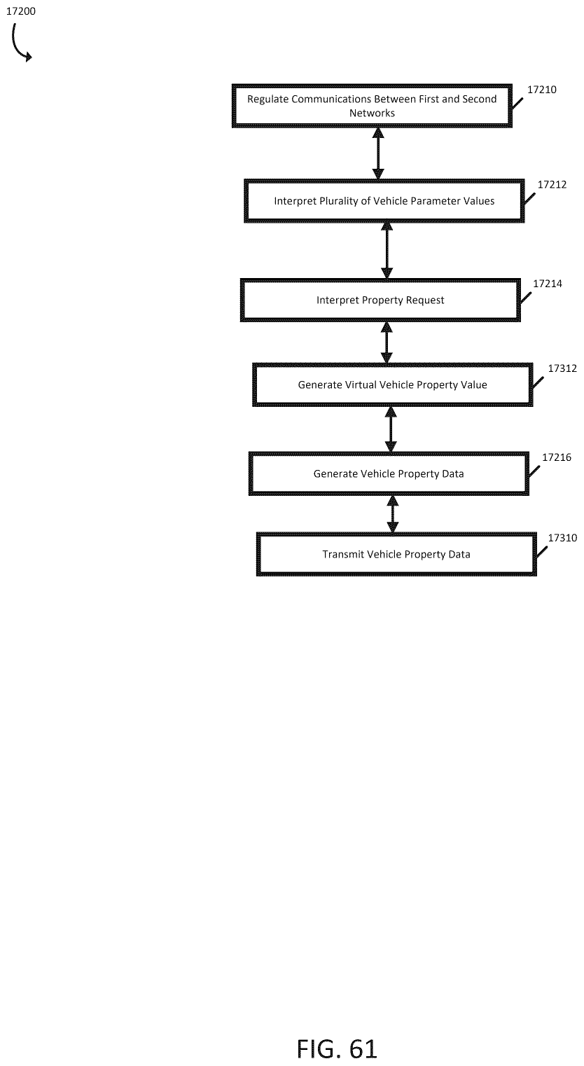

Referring now to FIGS. 59 and 61, in embodiments, the method 17200 may include transmitting 17310 the vehicle property data 17024.

In embodiments, the first network zone and the second network zone may be of distinct types, as described herein. In embodiments, the first network zone may include a controller area network (CAN). In embodiments, the first and the second network endpoints may be vehicle sensors. In embodiments, the plurality of vehicle parameter values 17012 and 17014 may directly correspond to the requested vehicle property.

In embodiments, the method 17200 may include generating 17312, in response to the property request value 17020, a virtual vehicle property value 17112 from two or more vehicle parameter values 17012 and 17014. In embodiments, the vehicle property data 17024 includes the virtual vehicle property value 17112.

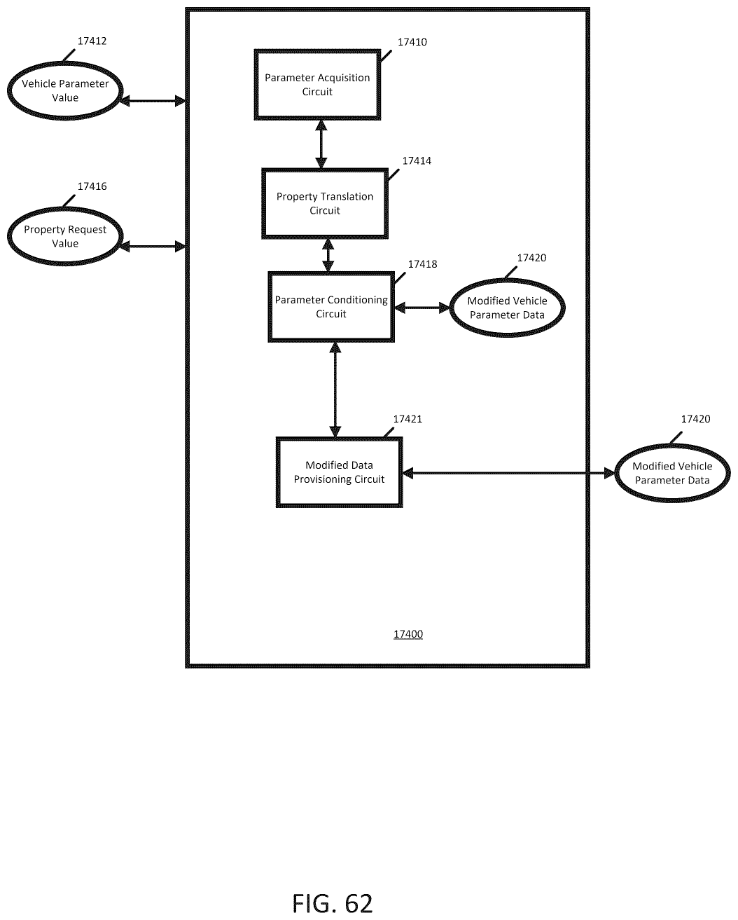

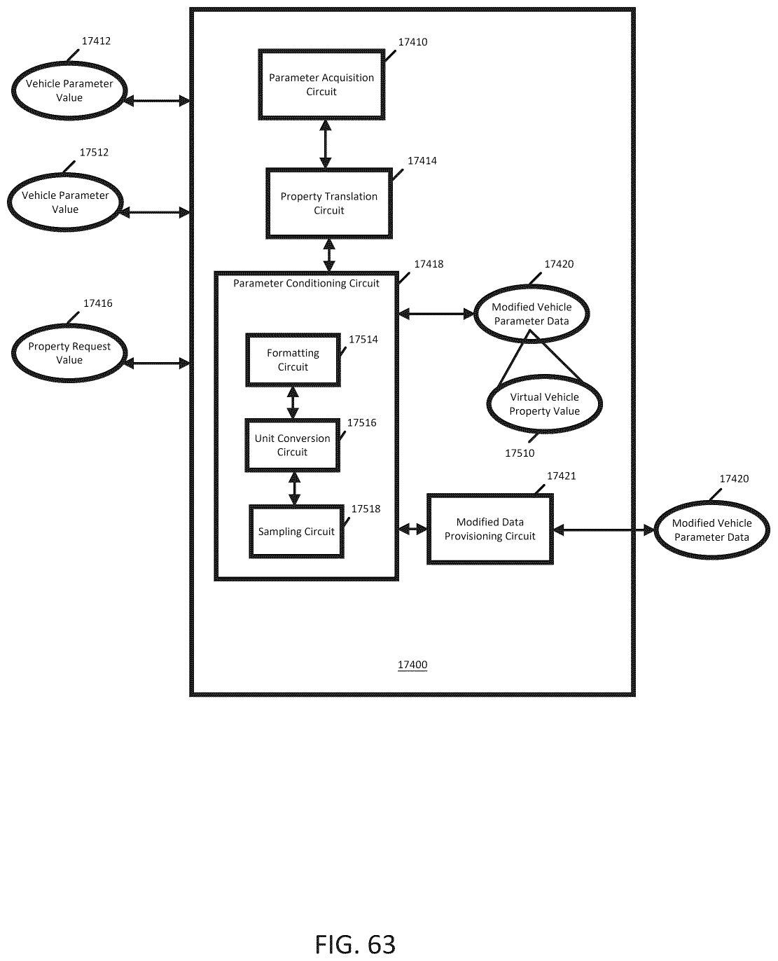

Referring now to FIG. 62, an apparatus 17400 for data collection process management, in accordance with an embodiment of the current disclosure, is shown. The apparatus 17400 includes a parameter acquisition circuit 17410 structured to interpret a vehicle parameter value 17412, and a property translation circuit 17414 structured to interpret a property request value 17416 that defines, at least in part, a requested vehicle property. While FIG. 62 depicts the parameter acquisition circuit 17410 interpreting a single vehicle parameter value 17412, it is to be understood that, in embodiments, the parameter acquisition circuit 17410 may interpret two or more vehicle parameter values 17412 (as shown in FIG. 63). The apparatus 17400 further includes a parameter conditioning circuit 17418 structured to generate, in response to the property request value 17416, modified vehicle parameter data 17420 from the vehicle parameter value 17412. As will be appreciated, the modified vehicle parameter data 17420 corresponds to the requested vehicle property. The modified vehicle parameter data 17420 may then be transmitted via a modified data provisioning circuit 17421. Transmission of the modified vehicle parameter data 17420 may be to a requesting entity, i.e., the entity that generated the property request value 17416, and/or to another entity and/or location specified by the requesting entity and/or as specified by a vehicle policy, as described herein.

As will be explained in greater detail below, embodiments of the parameter conditioning circuit 17418 generate the modified vehicle parameter data 17420 by formatting the vehicle parameter value 17412, deriving data and/or values from the vehicle parameter value 17412 (for inclusion in the modified vehicle parameter data 17420), and/or otherwise conditioning the data of the vehicle parameter value 17412 such that the modified vehicle parameter data 17420 contains data regarding the requested vehicle property that is in a desired format, e.g., a format usable and/or expected by an intended receiving device, e.g., another controller and/or storage device. In embodiments, the desired format may be based at least in part on units, network protocols, expected sampling and/or streaming rates, storage of the vehicle parameter value in a non-transitory computer-readable medium, compression standards, and/or other types of formatting. Thus, embodiments of the apparatus 17400 provide for a requesting entity, i.e., the entity that generates the property request value 17416, to be agnostic with respect to the native/raw format(s) of the vehicle parameter values 17412 that are used to generate data corresponding to the requested property. Embodiments of the apparatus 17400 also provide for manufacturers of vehicles to be agnostic, when selecting onboard sensors and/or onboard communication infrastructures, to the formatting requirements of a requesting entity.

For example, the property request value 17416 may correspond to a request for an oil temperature in degrees Fahrenheit and the vehicle parameter value 17412 may be oil temperature in degrees Celsius. The parameter conditioning circuit 17418 may generate the modified vehicle parameter data 17420 by converting the parameter value 17412 to degrees Fahrenheit. In another non-limiting example, the property request value 17416 may correspond to a request for total milage of the vehicle and the vehicle parameter value 17412 may be total kilometers of the vehicle. The parameter conditioning circuit 17418 may generate the modified vehicle parameter data 17420 by converting the parameter value 17412 to milage. In yet another example, a requesting entity, or other entity or device intended to receive the modified vehicle parameter data 17420 may have a capacity to receive the modified vehicle parameter data 17420 that does match and/or otherwise align with a rate at which the vehicle parameters are generated onboard a vehicle. In such scenarios, embodiments of the apparatus 17400 may adjust the rate at which the modified vehicle parameter data 17420 is transmitted to meet the needs of the receiving entity and/or device. In yet another example, the modified vehicle parameter data 17420 may be destined for storage in a non-transitory computer-readable medium, e.g., a memory device, that has a limited storage capacity. In such a scenario, embodiments of the apparatus 17400 may generate the modified vehicle parameter data 17420 such that the information, corresponding to the requested property, is in a compressed form. As will be appreciated, such compression may increase the amount of data regarding the requested vehicle property that can be stored and/or transmitted. In yet another non-limiting example, embodiments of the apparatus 17400 may adjust the transmission rate of the modified vehicle parameter data 17420 based on network transportation costs, e.g., cellular network bandwidth and/or data rates. In such embodiments, the apparatus 17400 may reduce the transmission rate of the modified vehicle parameter data 17420 when network transportation costs are expensive and increase the transmission rate of modified vehicle parameter data 17420 when network transportation costs are inexpensive. In yet another non-limiting example, embodiments of the apparatus 17400 may adjust the transmission rate of the modified vehicle parameter data 17420 based on available off-vehicle network bandwidth. In such embodiments, the apparatus 17400 may reduce the transmission rate of the modified vehicle parameter data 17420 when off-vehicle network bandwidth is limited, and/or otherwise “slow”, and increase the transmission rate of modified vehicle parameter data 17420 when off-vehicle network bandwidth is not limited, and/or otherwise “fast”.

Turning to FIG. 63, in embodiments, the parameter conditioning circuit 17418 may generate a virtual property value 17510. The virtual vehicle property value 17510 may be derived from and/or otherwise based at least in part on two or more vehicle parameter values 17412 and 17512. As shown in FIG. 63, the modified vehicle parameter data 17420 may include the virtual vehicle property value 17510.

In embodiments, the parameter conditioning circuit 17418 may include a formatting circuit 17514 structured to format the vehicle parameter value(s) 17412 and/or 17512 to a desired format of the requested vehicle property 17416 such that the modified vehicle parameter data 17420 has the desired format. Such formatting of the vehicle parameter value(s) 17412 and/or 17512 may include: packaging the vehicle parameter value(s) 17412 and/or 17512 in a network protocol, e.g., TCP/IP; transforming the vehicle parameter value(s) 17412 and/or 17512 into a desired data acquisition protocol (which may be subsequently packaged in a network protocol); compression of data; and/or other types of formatting.

In embodiments, the parameter conditioning circuit 17418 may include a unit conversion circuit 17516 structured to convert one or more units of the vehicle parameter value(s) 17412 and/or 17512 to one or more desired units of the requested vehicle property such that the modified vehicle parameter data 17420 has the desired one or more units. Non-limiting examples of unit types that may be converted include distances, time periods, temperatures, pressures, strains, rotation speeds, rotation counts, fuel efficiency, battery charge, etc.

In embodiments, the parameter conditioning circuit 17418 may include a sampling circuit 17518 structured to adjust a sampling rate of the vehicle parameter value(s) 17412 and/or 17512 to a desired sampling rate of the requested vehicle property such that the modified vehicle parameter data 17420 has the desired sampling rate. In embodiments, the sampling rate of the vehicle parameter value(s) 17412 and/or 17512 may be the rate at which the vehicle parameter value(s) 17412 and/or 17512 are generated, and the desired sampling rate of the requested vehicle property may be a rate at which the modified vehicle parameter data 17420 is transmitted. Accordingly, the sampling circuit 17518 may be structured to up-sample and/or down-sample the vehicle parameter value(s) 17412 and/or 17512.

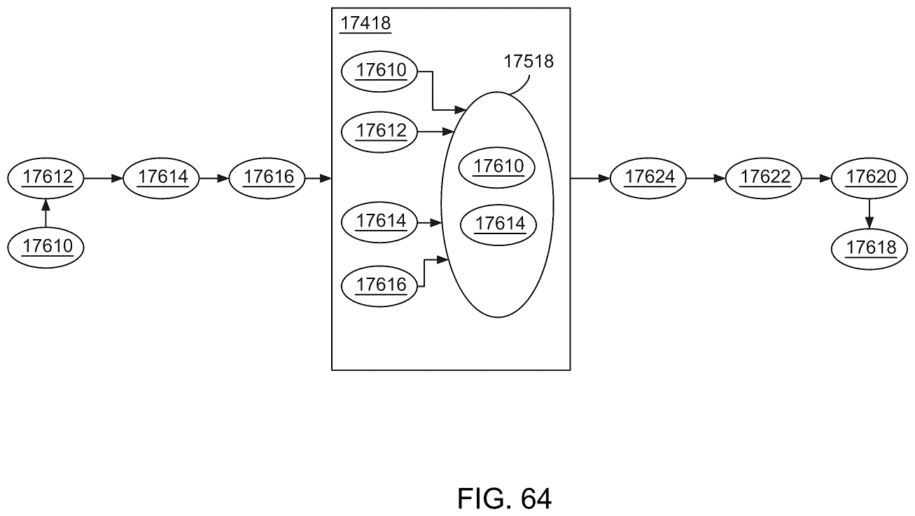

For example, turning to FIG. 64, a non-limiting example of down-sampling the vehicle parameter value(s) is shown. In such embodiments, the sampling circuit 17518 may receive a plurality of vehicle parameter values 17610, 17612, 17614, and 17616 at a first rate ∇₁, e.g., the sampling circuit 17518 may receive each of the vehicle parameter values 17610, 17612, 17614, and 17616 at subsequent time periods t₀, t₁, t₂, t₃, where t₁≈t₀+t_{∇1}, t₂≈t₁₊t_{∇1}, and t₃≈t₂₊t_{∇1}. The vehicle parameter values 17610, 17612, 17614, and 17616 may be from the same sensor or from different sensors. The sampling circuit 17518 may then cause the vehicle parameter values 17610, 17612, 17614, and 17616 to be transmitted out of the apparatus 17400 as modified vehicle parameter data 17618, 17620, 17622, and 17624 at a second rate ∇₂. e.g., modified vehicle parameter data 17618, 17620, 17622, and 17624, respectively corresponding to the vehicle parameter values 17610, 17612, 17614, and 17616, may be respectively transmitted out of the apparatus 17400 at subsequent time periods of time t₄, t₅, t₆, t₇, where t₅≈t₄+t_{∇2}, t₆≈t₅₊t_{∇2}, and t₇≈t₆₊t_{∇2}. As will be appreciated, ∇₂ may be larger than ∇₁, e.g., where the modified vehicle parameter data is transmitted at a slower rate than the vehicle parameter values are received. In embodiments, the sampling circuit 17518 may adjust ∇₂ based on information contained within the property request value 17416 and/or a vehicle policy, as described herein. In embodiments, the sampling circuit 17518 may adjust ∇₂ based on off-vehicle network connection available bandwidth and/or transmission costs. For example, ∇₂ may be decreased when off-vehicle network connection available bandwidth is high and/or when transmission costs are low. Conversely, ∇₂ may be increased when off-vehicle network connection available bandwidth is low and/or when transmission costs are high.

In embodiments, the sampling circuit 17518 may reduce the number of modified vehicle parameter data, respectively corresponding to the vehicle parameter values, that are transmitted out of the apparatus 17400, e.g., the sampling circuit 17518 may respectively receive and/or interpret vehicle parameter values 17610, 17612, 17614, and 17616 at times t₀, t₁, t₂, t₃ and transmit modified vehicle parameter data 17618, and 17622 respectively at times t₄ and t₆. In such embodiments, the modified vehicle parameter data 17618 and 17622 may respectively correspond to the vehicle parameter values 17610 and 17614. In embodiments, the modified vehicle parameter data 17618 and 17622 may each correspond to two or more of the vehicle parameter values 17610, 17612, 17614, and 17616. For example, modified vehicle parameter data 17618 may be derived from, and/or otherwise be a combination of, vehicle parameter values 17610 and 17612, and modified vehicle parameter data 17622 may be derived from, and/or otherwise be a combination of, vehicle parameter values 17614 and 17616. In such embodiments, each of the modified vehicle parameter data 17618 and 17622 may be an average of the corresponding vehicle parameter values.

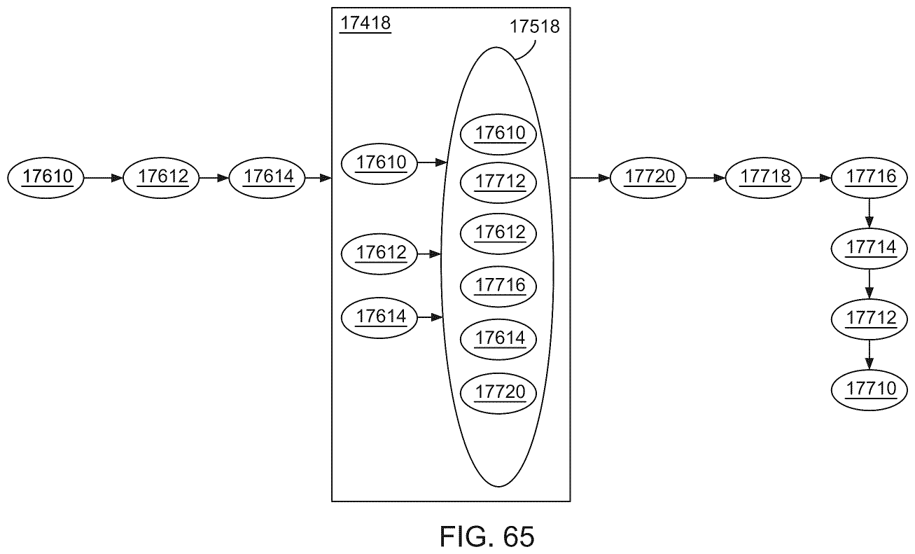

Turning to FIG. 65, a non-limiting example of up-sampling the vehicle parameter value(s) is shown. In such embodiments, the sampling circuit 17518 may receive a plurality of vehicle parameter values 17610, 17612, and 17614 at a first rate ∇₁, e.g., the sampling circuit 17518 may receive each of the vehicle parameter values 17610, 17612, and 17614, at subsequent time periods t₀, t₁, and t₂, where t₁≈t₀+t_{∇1}, and t₂≈t₁₊t_{∇1}. The parameter values 17610, 17612, and 17614 may be from the same sensor or from different sensors. The sampling circuit 17518 may then cause more modified vehicle parameter data 17710, 17712, 17714, 17716, 17718, and 17720, as compared to the vehicle parameter values received by the sampling circuit 17518, to be transmitted from the apparatus 17400 at subsequent time periods t₃, t₄, t₅, t₆, t₇, t₈, where t₄≈t₃+t_{∇2}, t₅≈t₄₊t_{∇2}, and t₆≈t₅₊t_{∇2}, etc. As will be appreciated, ∇₂ may be smaller than ∇₁, i.e., the modified vehicle parameter data is transmitted at a faster rate than the vehicle parameter values are received. In embodiments, the sampling circuit 17518 may adjust ∇₂ based on information contained within the property request value 17416 and/or a vehicle policy, as described herein. In embodiments, the sampling circuit 17518 may adjust ∇₂ based on off-vehicle network connection available bandwidth and/or transmission costs. For example, ∇₂ may be decreased when off-vehicle network connection available bandwidth is high and/or when transmission costs are low. Conversely, ∇₂ may be increased when off-vehicle network connection available bandwidth is low and/or when transmission costs are high.

As show in the non-limiting example of FIG. 65, modified vehicle parameter data 17710, 17714, and 17718 may respectively correspond to vehicle parameter values 17610, 17612, and 17614, wherein modified vehicle parameter data 17712, 17716, and 17720 are additional modified vehicle parameter data inserted into the transmission sequence. In embodiments, the additional modified vehicle parameter data 17712, 17716, and 17720 may be interpolated, and/or otherwise derived, from the parameter values 17610, 17612, and/or 17614.

As will be appreciated, the insertion of the additional modified parameter data into the transmission sequence may provide for the modified vehicle parameter data to be transmitted to a receiving entity and/or device at an expected rate. Further, embodiments, wherein the additional modified parameter data is interpolated from the vehicle parameter values 17610, 17612, and/or 17614 may approximate higher resolution monitoring of the requested vehicle property.

Non-limiting examples of type values include a vehicle state value (e.g., an operating state such as “RUNNING”, “SHUTDOWN”, “IDLE”, etc.; an environment parameter such as location, altitude, ambient temperature, etc.; and/or a state of a control operation such as nominal performance, derated performance, utilization of a substitute data value and/or control operation, etc.); a vehicle mode value (e.g., a control mode such as a control operation having authority for a function of the vehicle; an operation type such as motive power, power takeoff operation, idle operation, hoteling operation; and/or a special mode operation of any type such as high altitude operation, limp home operation, performance operation, economy operation, etc.); a diagnostic value (e.g., a diagnostic code, counter, status, and/or intermediate parameter, which may be related to any sensor, actuator, flow, application, end point, control operation, or the like); and/or a fault value (e.g., a fault status, counter, code, intermediate value, etc., which may be related to any sensor, actuator, flow, application, end point, control operation, or the like).

A mission, vehicle mission, or other similar terminology as used herein should be understood broadly. A mission, as utilized herein, references any one of: a primary function; an intended function; a critical function; and/or a minimum enabling function (e.g., a function required for operations to be considered normal, and/or acceptable to allow continued operation). A mission, for example of the vehicle, may depend upon the current operating condition of the vehicle and/or an intended use of the vehicle. For example, a vehicle mission may include an ability to provide motive power and/or motive operation, and may further include a performance description such as a minimum available power, torque, and/or vehicle speed (e.g., which may be the same as, or lower than, rated values for these). In another example, a mission may be an ability to provide power and/or functionality of a system of the vehicle—such as a light, communication operations, holding operations, cabin environment operations, or the like. In certain embodiments, some level of operation of the vehicle or component may be available, where the vehicle or component is not mission capable—for example where motive operation is available, but below acceptable performance characteristics for the vehicle. In certain embodiments, a mission related aspect may not affect the performance of the vehicle but nevertheless be mission critical—for example a loss of air bag function, ABS function, or the like may not prevent operation of the mission (e.g., motive operation), but nevertheless be considered mission critical for the vehicle to continue operation in an acceptable manner. It can be seen that the mission of a vehicle, component, control operation, or the like may depend on the context of the vehicle, including design considerations, purpose of the vehicle, policies and/or preferences of an entity related to the vehicle (e.g., a fleet owner, vehicle owner, regulatory authority, etc.), geographic location of the vehicle, and/or terrain position of the vehicle (e.g., current altitude, grade, road type, etc.). A data value or other feature may be a mission critical and/or mission related data value or feature on a first vehicle but not on a second vehicle, and/or at a first time for a given vehicle but not at a second time for the given vehicle. One of skill in the art, having the benefit of the present disclosure and information ordinarily available for a vehicle and components thereof, can readily determine whether a data value, control operation, component, or other element of the system is mission critical and/or mission related. Certain considerations to determine whether a data value, control operation, component, or other element of the system is mission critical and/or mission related include, without limitation: a rating of the vehicle, an intended use of the vehicle, a quality of service requirement associated with the vehicle, a warranty description of the vehicle or a component thereof, a duty cycle expected for the vehicle, a geographical operating region of the vehicle, a terrain operating region of the vehicle, regulatory requirements associated with the vehicle, and/or policy considerations associated with the vehicle.

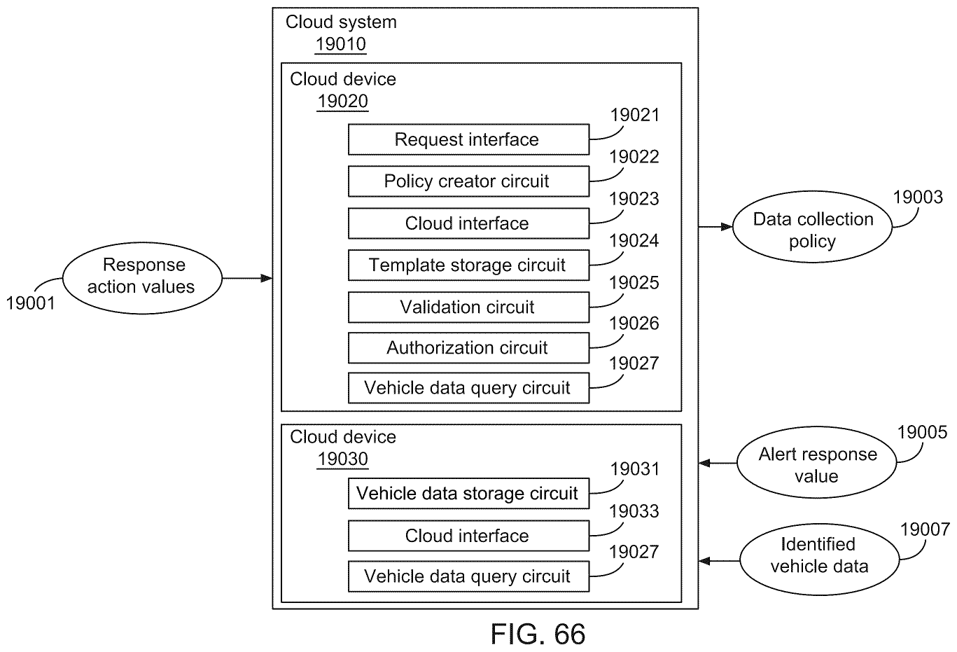

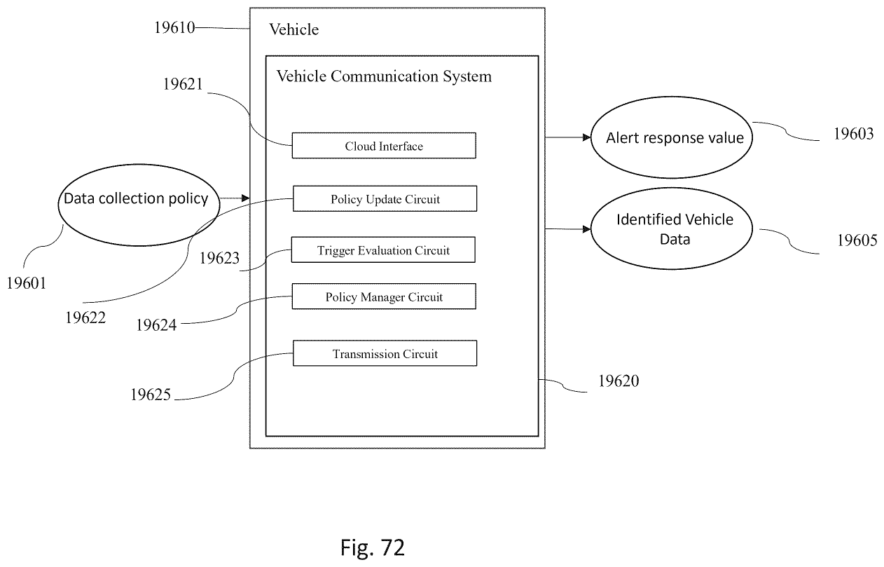

With reference to FIG. 66, there is illustrated a cloud system 19010 including cloud devices 19020 and 19030. Cloud system 19010 is structured to receive response action values 19001 from one or more user devices such as such as user device, output a data collection policy 19003 to a vehicle, such as vehicle 19610 of FIG. 72, and receive at least one of an alert response value 19005 or identified vehicle data 19007 in response to data collection policy 19003.

Cloud device 19020 includes a request interface 19021, a policy creator circuit 19022, a cloud interface 19023, a template storage circuit 19024, a validation circuit 19025, and an authorization circuit 19026.

Request interface 19021 is configured to interpret a plurality of response action values. Request interface 19021 may be structured to communicate with a plurality of user devices.

Policy creator circuit 19022 is configured to determine data collection policy 19003 in response to one or more response action values. Data collection policy 19003 may include a vehicle data identifier configured to identify vehicle data to be captured, a trigger evaluation data identifier configured to identify trigger evaluation data, and a trigger condition to be evaluated in response to the identified trigger evaluation data. In certain embodiments, determining data collection policy 19003 includes mapping the vehicle data identifier to a data source of the vehicle. For example, when one of the response action values 19001 requests vehicle speed, policy creator circuit 19022 determines a source of vehicle data that observes vehicle speed and includes the identifier corresponding to the vehicle data in data collection policy 19003. In another example, data collection policy 19003 may combine vehicle data from multiple sources to form a virtual data source, and map the vehicle data identifier to the virtual data source.

In certain embodiments, the plurality of response action values 19001 includes a plurality of evaluation collection parameter values each corresponding to trigger evaluation data from a common vehicle data source. Policy creator circuit 19022 is configured to determine an evaluation collection parameter value for the data collection policy in response to the response to the plurality of evaluation collection parameter values. For example, the plurality of evaluation collection parameter values may be plurality of different frequencies and the evaluation collection parameter value of data collection policy 19003 specifies a single frequency to collect vehicle data which will satisfy the frequencies required by the response action values.

Data collection policy 19003 is configured to define a data collection procedure implemented by the vehicle. Data collection policy 19003 includes one or more trigger policies, each trigger policy including one or more triggers, each trigger including a trigger condition. According to data collection policy 19003, the vehicle collects trigger evaluation data to evaluate the trigger conditions of data collection policy 19003. The vehicle may also collect identified vehicle data from sources subject to data collection parameters, such as frequency, defined by data collection policy 19003. The data capture time window of the identified vehicle data to be collected is determined by evaluating triggers of data collection policy 19003. For example, data collection policy 19003 may cause the vehicle to start transmitting a location of the vehicle once the ignition of the vehicle is turned on and the vehicle enters a geofence, and stop transmitting the location once the ignition is turned off.

Data collection policy 19003 may include a plurality of trigger types. A trigger may include a trigger identifier, a trigger type identifier, and a trigger condition. A trigger may also include additional fields. The trigger identifier is a globally unique identifier configured to identify the corresponding trigger in order to distinguish the corresponding trigger from other triggers. The trigger type identifier is configured to identify the type of the trigger. For example, the trigger type identifier may be a value which identifies the trigger as a signal trigger, a vehicle status trigger, a timing trigger, a schedule trigger, or a geofence trigger, an environment trigger, a user input trigger, or an error trigger, to name but a few examples.

The trigger condition is either satisfied or unsatisfied, also known as true or false, and the evaluation of the trigger produces a Boolean result indicating whether the trigger condition is satisfied. The trigger condition may include one or more fields of the trigger.

In certain embodiments, a trigger condition is configured as a comparison expression, where a key and a value are compared. The key and value may be compared using one of a plurality of comparators, such as greater than, less than, equal to, greater than or equal to, less then or equal to, or not equal to, to name but a few examples. The key is based on trigger evaluation data interpreted by a data collection controller of the vehicle. For example, a trigger condition may be used to determine whether a vehicle speed is greater than 5 mph, where the vehicle speed collected from the vehicle is the key and five is the value. In certain embodiments, the key is a derivative or antiderivative of the trigger evaluation data. In certain embodiments, the key is a sum of the trigger evaluation data.

In certain embodiments, the trigger condition is configured as a change-to expression, where a previous value of a key, a current value of a key, and a preset value are compared. The trigger condition is satisfied if the current value of the key is equal to the preset value and if the previous value of the key was not equal to the preset value. For example, a trigger condition change-to expression may be satisfied upon determining the vehicle has started, but then is unsatisfied at a future trigger condition evaluation, even though the vehicle is still in operation.

The plurality of triggers may include a signal trigger. The data collection controller uses a signal trigger to collect data based on a value of a signal generated by the vehicle. The signal trigger includes a signal identifier configured to identify a single signal including a value, the signal being transmitted on one of the communication channels of the vehicle. The signal identifier includes a name of the signal unique across all communication channels of the vehicle. In certain embodiments, the name of the signal is based on a CAN database and an Ethernet database. The signal trigger includes a condition of the trigger which is determined to be satisfied based on evaluating an expression using the identified signal. In certain embodiments, a signal trigger condition may be evaluated to determine if the value of the identified signal satisfies a comparison expression or a change-to expression. For example, a signal trigger condition may be satisfied if the value of the identified signal changes from a previous value to a preset value indicating an ABS warning light has been turned on. In another example, a signal trigger condition may be satisfied when the value of the identified signal makes a comparison expression true, such as where a signal value is five and the expression is the signal value being greater than three.

The plurality of triggers may include a vehicle status trigger. The data collection controller uses a vehicle status trigger to collect data based on a vehicle status of the vehicle. The vehicle status trigger includes a vehicle status identifier configured to identify a vehicle status of the vehicle. For example, a vehicle status identifier may identify an accessory mode status, or one of a plurality of ignition position statuses. The vehicle status trigger includes a condition that is satisfied based on the vehicle status corresponding to the vehicle status identifier. For example, the condition may be satisfied where the vehicle status identifier corresponds to an accessory mode, the condition is that the accessory mode is on, and data collection controller determines that the accessory mode of the vehicle is indeed turned on.

The plurality of triggers may include a timing trigger. The data collection controller uses a timing trigger to collect data based on a time occurring after a discrete event. The timing trigger includes a discrete event identifier and a condition including a delay value. The discrete event identifier is configured to identify a discrete event of the vehicle, such as an engine start, to name but one example. The delay value includes a time duration, such as a number of milliseconds, to name but one example. The condition is satisfied after the time duration is completed following the discrete event, the timing trigger outputs a value indicating the timing trigger has been satisfied. For example, if the timing trigger includes a discrete event identifier for vehicle startup and a delay value of 5000 milliseconds, the condition of the timing trigger will be satisfied 5000 milliseconds after the data collector controller determines the vehicle startup has occurred.

The plurality of triggers may include a schedule trigger. The data collection controller uses a schedule trigger to collect data based on a schedule. The schedule trigger includes a condition satisfied at one or more times. The condition may include a plurality of fields, such as minutes, hours, days of the week, days of the month, months, and years, to name but a few examples. In certain embodiments, each unpopulated field of the plurality of fields corresponds to a repeated time that will satisfy the trigger. For example, with a condition including an hours field populated by 12, a minutes field populated by 0, and a days of the week field populated with Sunday, the trigger would be satisfied at 12:00 pm on Sunday for every Sunday of every month of every year. In certain embodiments, the schedule trigger includes a missed schedule field configured to indicate if the last schedule data collection was missed. If missed, the condition of the schedule trigger is satisfied, causing data collection to occur immediately rather than at the next scheduled time.

The plurality of triggers may include a geofence trigger. The data collection controller uses a geofence trigger to collect data based on a geofence. The geofence trigger includes a trigger identifier, an event field, and an area field. The event field includes a value corresponding to entering the area, being inside the area, being outside the area, or leaving the area. This area field may include coordinates defining boundaries of a geographical area. In certain embodiments, the area field includes longitude and latitude coordinates of a first position and launch two and latitude coordinates of a second position, the first and second location corresponding to opposite corners of a rectangular geographical area. The condition of the geofence trigger is satisfied when the vehicle completes the event relative to the area. For example, a geofence trigger may include an event field value corresponding to all being inside a rectangular geographic area. The condition is satisfied by determining the longitude of the vehicle is between the longitudes of the first and second positions of the area and between the latitudes of the first and second position of the area.

The plurality of triggers may include an error trigger. The data collection controller uses an error trigger to collect data based on error messages generated by the vehicle. For example, the trigger condition may specify a low oil pressure warning such that the trigger condition is satisfied when the low oil pressure warning is activated.

The plurality of triggers may include an environment trigger. The data collection controller uses an environment trigger to collect data based on an environmental parameter. For example, the trigger condition may specify an ambient temperature such that the trigger condition is satisfied when an ambient temperature exceeds a preset value.

The plurality of triggers may include a user input trigger. The data collection controller uses a user input trigger to collect data based on input received from a user. For example, the trigger condition may specific a signal from a button within the vehicle such that the trigger condition is satisfied when the button is pushed.

The trigger policies of data collection policy 19003 define which triggers are evaluated to determine a trigger event occurrence and which triggers are evaluated to determine a trigger event termination. A trigger policy may include a trigger identifier, a trigger type identifier, and a condition. A trigger policy may also include additional fields. The trigger identifier is a globally unique identifier configured to identify the corresponding trigger in order to distinguish the corresponding trigger from other triggers. The trigger type identifier is configured to identify the type of the trigger. For example, the trigger type identifier may be a value which identifies the trigger as a signal trigger, a vehicle status trigger, a timing trigger, a schedule trigger, a geofence trigger, an error trigger, an environment trigger, or a user input trigger, to name but a few examples. In certain embodiment, the trigger event termination is not determined by a trigger, but instead by a max start value, indicating a number of times the start trigger conditions can be true before the trigger should be disabled.

Data collection policy 19003 identifies vehicle data to be captured in response to each trigger policy of data collection policy 19003. Alternatively, data collection policy 19003 specifies an alert response value to be sent in response to one or more trigger policies of data collection policy 19003. Data collection policy 19003 also identifies the trigger evaluation data, which is the data required to be collected into order to evaluate the trigger conditions of data collection policy 19003. Data collection policy 19003 may cause multiple types of data to be captured and transmitted from the vehicle, and may require multiple types of data to be collected for trigger evaluation data.

Cloud interface 19023 is configured to communicate with cloud interface 19033 of cloud device 19030 and may be configured to receive identified vehicle data 19007 in response to data collection policy 19003, or an alert response value 19005 in response to data collection policy 19003.

Template storage circuit 19024 is configured to store a plurality of vehicle use case templates. In response to a request from a user device, template storage circuit 19024 may provide a requested template. In certain embodiments, template storage circuit 19024 only provides a requested template after determining the user is authorized to view the template based on an authorization value or based on a location of the vehicle or the user device.

Validation circuit 19025 is configured to determine a vehicle is capable of capturing data requested by the user and is configured to reject one of the response action values 19001. In certain embodiments, validation circuit 19025 is configured to reject one of the plurality of response action values 19001 in response to determining an execution parameter value. Validation circuit 19025 determines the execution parameter value by determining the vehicle data identified by the rejected response action value cannot be captured by a vehicle.

Authorization circuit 19026 is configured to tag a data collection policy in response to an authorization value. The authorization value indicates a user requesting one of the plurality of response action values 19001 is not authorized to receive the identified vehicle data 19007. For example, a manufacturer may request camera data from a vehicle, but the request will be tagged if the vehicle owner has not yet given authorization to the manufacturer. In this way, the camera data may still be captured and returned to cloud, but the manufacturer will not have access to the camera data until the vehicle owner grants authorization.

Cloud device 19030 includes a vehicle data storage circuit 19031, a cloud interface 19033, and a vehicle data query circuit 19027. Vehicle data storage circuit 19031 is configured to store the identified vehicle data received from a vehicle, in response to data collection policy 19003. In certain embodiments, identified vehicle data 19007 is encrypted while stored with vehicle storage circuit 19031 such that cloud device 19030 is not configured to decrypt the identified vehicle data 19007 stored with the vehicle data storage circuit 19031. In this way, a cyber attacker who achieves access to the stored identified vehicle data 19007 will not have the means to decrypt the data, while a cyber attacker who achieves access to cloud device 19020 will also not gain access to the identified vehicle data 19007.

Cloud interface 19033 is configured to provide the identified vehicle data to cloud interface 19023 in response to a vehicle data request from a vehicle data query circuit 19027 of cloud device 19020. In response to a vehicle data request, cloud device 19030 may search metadata corresponding to the identified vehicle data stored in vehicle data storage circuit 19031. It shall be appreciated that any or all of the foregoing features of cloud system 19010 may also be present in the other cloud systems disclosed herein. It shall be appreciated that any or all of the foregoing features of cloud system 19010 may also be present in the other embodiments disclosed herein. It shall be appreciated that any or all of the foregoing features of data collection policy 19003 may be present in any other embodiment disclosed herein.

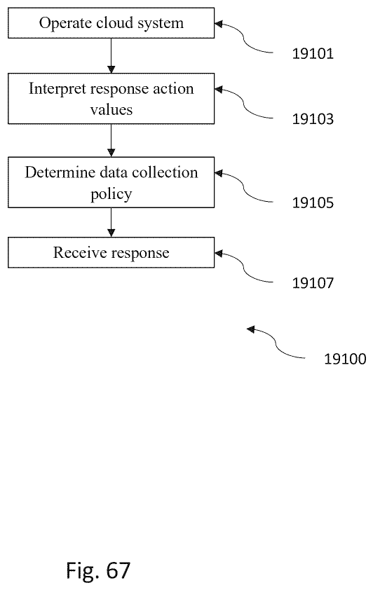

With reference to FIG. 67, there is illustrated an example cloud system-based vehicle data collection process 19100. Process 19100 may be implemented in whole or in part in one or more of the cloud systems disclosed herein. It shall be further appreciated that variations of and modifications to process 19100 are contemplated including, for example, the omission of one or more aspects of process 19100, the addition of further conditionals and operations, or the reorganization or separation of operations and conditionals into separate processes.

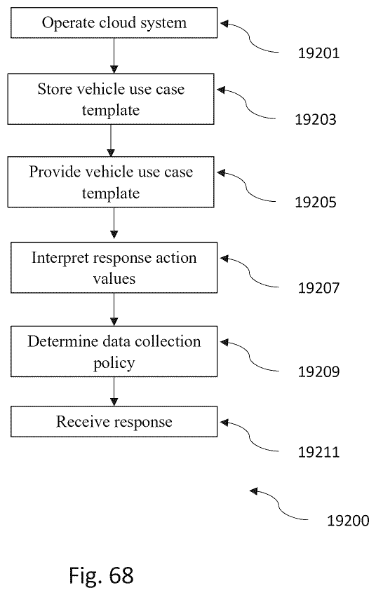

Process 19100 begins at operation 19101 including operating a cloud system including a request interface, a policy creator circuit, and a cloud interface. Process 19100 proceeds to operation 19103 where the cloud system interprets a plurality of response action values. Process 19100 proceeds to operation 19105 where the cloud system determines a data collection policy in response to the plurality of response action values, the data collection policy including a vehicle data identifier, a trigger evaluation data identifier configured to identify trigger evaluation data, and a trigger condition to be evaluated in response to the identified trigger evaluation data. Process 19100 proceeds to operation 19107 where the cloud system receives at least one of at least a portion of identified vehicle data in response to the data collection policy, or an alert response value in response to the data collection policy. It shall be appreciated that any or all of the foregoing features of example process 19100 may also be present in the other processes disclosed herein, such as processes illustrated in FIGS. 68-71, to name but a few examples.

With reference to FIG. 68, there is illustrated an example cloud system-based vehicle data collection process 19200. Process 19200 may be implemented in whole or in part in one or more of the cloud systems disclosed herein. It shall be further appreciated that variations of and modifications to process 19200 are contemplated including, for example, the omission of one or more aspects of process 19200, the addition of further conditionals and operations, or the reorganization or separation of operations and conditionals into separate processes.

Process 19200 begins at operation 19201 including operating a cloud system including first cloud device including a request interface, a policy creator circuit, and a cloud interface, and a second cloud device. Process 19200 proceeds to operation 19203 where the first cloud device stores a plurality of vehicle use case templates. Process 19200 proceeds to operation 19205 where the first cloud device is configured to provide one of the plurality of vehicle use case templates in response to a user device request and at least one of an authorization value or a location value. Process 19200 proceeds to operation 19207 where the first cloud device interprets a plurality of response action values. Process 19200 proceeds to operation 19209 where the first cloud device determines a data collection policy in response to the plurality of response action values, the data collection policy including a vehicle data identifier, a trigger evaluation data identifier configured to identify trigger evaluation data, and a trigger condition to be evaluated in response to the identified trigger evaluation data. Process 19200 proceeds to operation 19211 where the second cloud device receives at least one of at least a portion of identified vehicle data in response to the data collection policy, or an alert response value in response to the data collection policy. It shall be appreciated that any or all of the foregoing features of example process 19200 may also be present in the other processes disclosed herein.

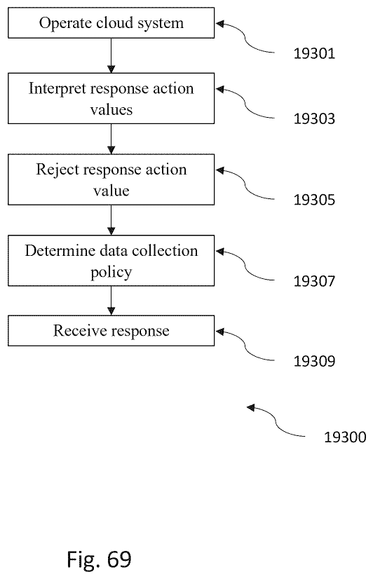

With reference to FIG. 69, there is illustrated an example cloud system-based vehicle data collection process 19300. Process 19300 may be implemented in whole or in part in one or more of the cloud systems disclosed herein. It shall be further appreciated that variations of and modifications to process 19300 are contemplated including, for example, the omission of one or more aspects of process 19300, the addition of further conditionals and operations, or the reorganization or separation of operations and conditionals into separate processes.

Process 19300 begins at operation 19301 including operating a cloud system including a request interface, a policy creator circuit, a validation circuit, and a cloud interface. Process 19300 proceeds to operation 19303 where the cloud system interprets a plurality of response action values. Process 19300 proceeds to operation 19305 where the cloud system rejects one of the plurality of response action values in response to determining an execution parameter value. Process 19300 proceeds to operation 19307 where the cloud system determines a data collection policy in response to the plurality of response action values, the data collection policy including a vehicle data identifier, a trigger evaluation data identifier configured to identify trigger evaluation data, and a trigger condition to be evaluated in response to the identified trigger evaluation data. Process 19300 proceeds to operation 19309 where the cloud system receives at least one of at least a portion of identified vehicle data in response to the data collection policy, or an alert response value in response to the data collection policy. It shall be appreciated that any or all of the foregoing features of example process 19200 may also be present in the other processes disclosed herein, such as processes illustrated in FIGS. 67-68 and 70-71, to name but a few examples.

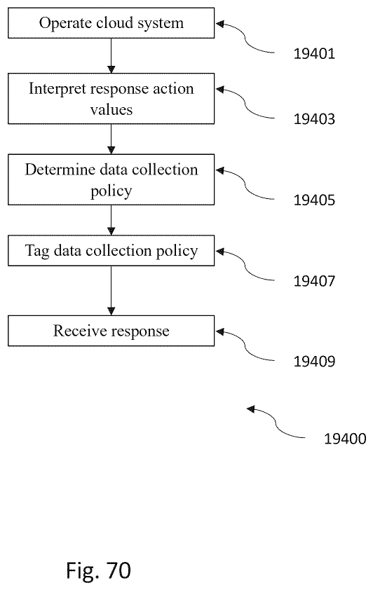

With reference to FIG. 70, there is illustrated an example cloud system-based vehicle data collection process 19400. Process 19400 may be implemented in whole or in part in one or more of the cloud systems disclosed herein. It shall be further appreciated that variations of and modifications to process 19400 are contemplated including, for example, the omission of one or more aspects of process 19400, the addition of further conditionals and operations, or the reorganization or separation of operations and conditionals into separate processes.

Process 19400 begins at operation 19401 including operating a cloud system including a request interface, a policy creator circuit, an authorization circuit, and a cloud interface. Process 19400 proceeds to operation 19403 where the cloud system interprets a plurality of response action values. Process 19400 proceeds to operation 19405 where the cloud system determines a data collection policy in response to the plurality of response action values, the data collection policy including a vehicle data identifier, a trigger evaluation data identifier configured to identify trigger evaluation data, and a trigger condition to be evaluated in response to the identified trigger evaluation data. Process 19400 proceeds to operation 19407 where the cloud system tags a data collection policy in response to an authorization value, wherein the authorization value indicates a source of one of the plurality of response action values is not authorized to receive the identified vehicle data. Process 19400 proceeds to operation 19409 where the cloud system receives at least one of at least a portion of identified vehicle data in response to the data collection policy, or an alert response value in response to the data collection policy. It shall be appreciated that any or all of the foregoing features of example process 19400 may also be present in the other processes disclosed herein, such as processes illustrated in FIGS. 66-69 and 71, to name but a few examples.

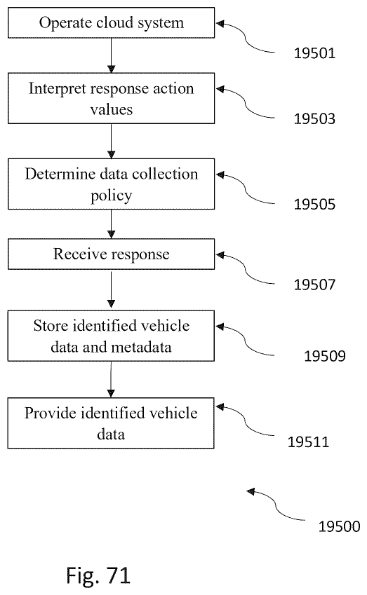

With reference to FIG. 71, there is illustrated an example cloud system-based vehicle data collection process 19500. Process 19500 may be implemented in whole or in part in one or more of the cloud systems disclosed herein. It shall be further appreciated that variations of and modifications to process 19500 are contemplated including, for example, the omission of one or more aspects of process 19500, the addition of further conditionals and operations, or the reorganization or separation of operations and conditionals into separate processes.

Process 19500 begins at operation 19501 including operating a cloud system including a first cloud device and a second cloud device. Process 19500 proceeds to operation 19503 where the first cloud device interprets a plurality of response action values. Process 19500 proceeds to operation 19505 where the first cloud device determines a data collection policy in response to the plurality of response action values, the data collection policy including a vehicle data identifier, a trigger evaluation data identifier configured to identify trigger evaluation data, and a trigger condition to be evaluated in response to the identified trigger evaluation data. Process 19500 proceeds to operation 19511 where the second cloud device receives identified vehicle data in response to the data collection policy. Process 19500 proceeds to operation 19505 where the second cloud device stores identified vehicle data and metadata corresponding to the identified vehicle data. Process 19500 proceeds to operation 19505 where the second cloud device provides identified vehicle data to the first cloud device in response to a request from the first cloud device. Process 19500 proceeds to operation 19507 where the cloud system interprets a plurality of response action values.

With reference to FIG. 72, there is illustrated an example vehicle 19610 including an example vehicle communication system 19620 structured to receive a data collection policy 19601, determine data collection policy 19601 is valid and authorized, reconfigure the vehicle communication system 19620 to collect trigger evaluation data and potentially identified vehicle data 19605 defined by data collection policy 19601, and output at least one of an alert response value 19603 or identified vehicle data 19605 in response to data collection policy 19601.

Vehicle communication system 19620 includes a cloud interface 19621, a policy update circuit 19622, a trigger evaluation circuit 19623, a policy manager circuit 19624, and a transmission circuit 19625.

Cloud interface 19621 is configured to interpret data collection policy 19601 from a remote device, such as a cloud device. Data collection policy 19601 may include a trigger evaluation data identifier configured to identify trigger evaluation data to be collected according to a vehicle data collection parameter, the trigger evaluation data being the data required to evaluate the trigger condition(s) of data collection policy 19601. For example, data collection policy 19601 may identify vehicle speed as the trigger evaluation data, a sampling frequency as the data collection parameter, and the vehicle speed exceeding 80 mph as the trigger condition.

Policy update circuit 19622 is configured to determine whether the vehicle can perform the operations required by the data collection policy 19601. Policy update circuit 19622 may determine a collection validation value in response to the identified trigger evaluation data and a vehicle data collection parameter. The collection validation value may indicate whether the vehicle is structured to provide the trigger evaluation data or identified vehicle data. For example, if the vehicle data collection parameter includes a sampling frequency that is too high to be performed by the vehicle, the collection validation value will indicate the vehicle cannot perform data collection policy 19601.

In certain embodiments, policy update circuit 19622 is configured to determine an authorization status of data collection policy 19601. The authorization status may be determined based on an authorization value of a user requesting information from the vehicle. For example, policy update circuit 19622 may determine a manufacturer, having an authorization value, requesting vehicle data is authorized to receive the vehicle data captured in response to data collection policy 19601. In another example, policy update circuit 19622 may determine an authorization status indicating certain vehicle data may be collected based on the location of the vehicle, the location of the user requesting the data, or the location of the intermediary devices transmitting vehicle data from the vehicle to the user. In certain embodiments, the authorization value may be used to determine authorization to collect a certain vehicle data according to a corresponding data parameter. For example, a vehicle owner's authorization value may indicate authorization to collect vehicle speed, but not at a sampling rate greater than 1 Hz. In certain embodiments, policy update circuit 19622 determines a change in the authorization status of data collection policy 19601 and causes the vehicle to stop executing data collection policy 19601. For example, the execution may be stopped in response to at least one of an updated authorization value or an updated location value.

Trigger evaluation circuit 19623 is configured to evaluate the trigger conditions of data collection policy 19601 in response to the collection validation value and/or the authorization status. For example, trigger evaluation circuit 19623 may only receive the trigger conditions if the policy update circuit 19622 determines data collection policy 19601 is authorized and/or valid.

Policy manager circuit 19624 is configured to parse data collection policy 19601 in response to the collection validation value and/or the authorization status. Policy manager circuit 19624 distributes the parsed data collection policy effective to reconfigure the vehicle for collecting data according to data collection policy 19601. In certain embodiments, policy manager circuit 19624 is configured to encrypt data collection policy 19601 and replace a previous data collection policy with data collection policy 19601 in response to the collection validation value indicating data collection policy 19601 is valid and/or the authorization status indicating data collection policy 19601 is authorized.

Transmission circuit 19625 is configured to provide identified vehicle data 19605 or an alert response value in response to a trigger event occurrence determined by trigger evaluation circuit 19623. Transmission circuit 19625 may communicate with the remote device which transmitted data collection policy 19601 or another device, such as a user device. The alert response value may include at least one of: an alert criterion, an alert type, an alert content, and an alert location. It shall be appreciated that any or all of the foregoing features of vehicle 19610 may also be present in the other vehicles disclosed herein.

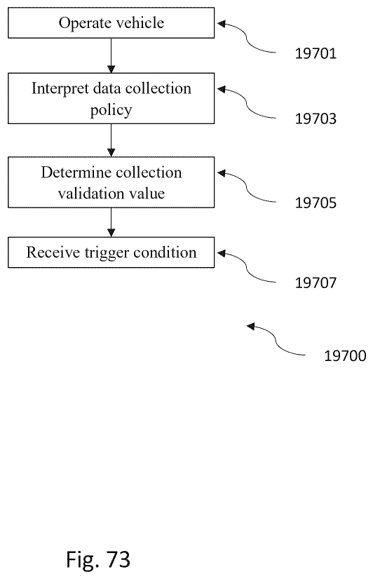

With reference to FIG. 73, there is illustrated an example vehicle-based vehicle data collection process 19700. Process 19700 may be implemented in whole or in part in one or more of the vehicles disclosed herein. It shall be further appreciated that variations of and modifications to process 19700 are contemplated including, for example, the omission of one or more aspects of process 19700, the addition of further conditionals and operations, or the reorganization or separation of operations and conditionals into separate processes.

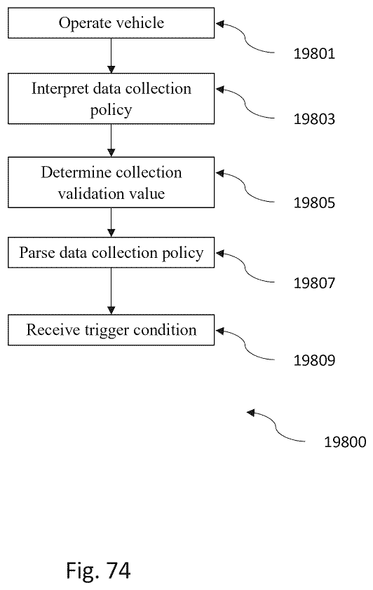

Process 19700 begins at operation 19701 including operating a vehicle including a cloud interface, a policy update circuit, and a trigger evaluation circuit. Process 19700 proceeds to operation 19703 where the vehicle interprets a data collection policy from a remote device, the data collection policy including a trigger evaluation data identifier configured to identify trigger evaluation data to be evaluated in response to a trigger condition. Process 19700 proceeds to operation 19705 where the vehicle determines a collection validation value in response to the identified trigger evaluation data and a vehicle data collection parameter. Process 19700 proceeds to operation 19707 where the trigger evaluation circuit receives the trigger condition in response to the collection validation value. It shall be appreciated that any or all of the foregoing features of example process 19700 may also be present in the other processes disclosed herein, such as processes illustrated in FIGS. 74-76, to name but a few examples.

With reference to FIG. 74, there is illustrated an example vehicle-based vehicle data collection process 19800. Process 19800 may be implemented in whole or in part in one or more of the vehicles disclosed herein. It shall be further appreciated that variations of and modifications to process 19800 are contemplated including, for example, the omission of one or more aspects of process 19800, the addition of further conditionals and operations, or the reorganization or separation of operations and conditionals into separate processes.

Process 19800 begins at operation 19801 including operating a vehicle including a cloud interface, a policy update circuit, and a trigger evaluation circuit. Process 19800 proceeds to operation 19803 where the vehicle interprets a data collection policy from a remote device, the data collection policy including a trigger evaluation data identifier configured to identify trigger evaluation data to be evaluated in response to a trigger condition. Process 19800 proceeds to operation 19805 where the vehicle determines a collection validation value in response to the identified trigger evaluation data and a vehicle data collection parameter. Process 19800 proceeds to operation 19807 where the vehicle parses the data collection policy in response to the collection validation value. Process 19800 proceeds to operation 19809 where the trigger evaluation receives the trigger condition in response to the collection validation value. It shall be appreciated that any or all of the foregoing features of example process 19800 may also be present in the other processes disclosed herein, such as the processes illustrated in FIGS. 73 and 75-76, to name but a few examples.

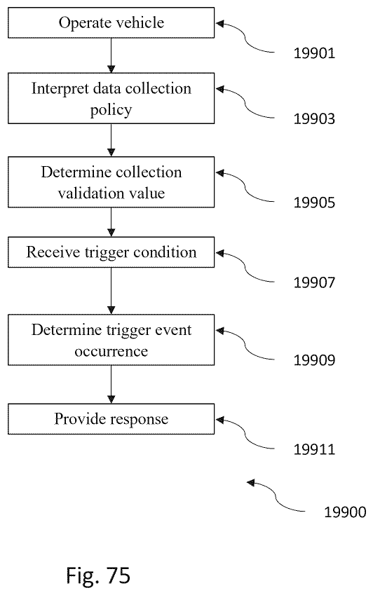

With reference to FIG. 75, there is illustrated an example vehicle-based vehicle data collection process 19900. Process 19900 may be implemented in whole or in part in one or more of the vehicles disclosed herein. It shall be further appreciated that variations of and modifications to process 19900 are contemplated including, for example, the omission of one or more aspects of process 19900, the addition of further conditionals and operations, or the reorganization or separation of operations and conditionals into separate processes.

Process 19900 begins at operation 19901 including operating a vehicle including a cloud interface, a policy update circuit, and a trigger evaluation circuit. Process 19900 proceeds to operation 19903 where the vehicle interprets a data collection policy from a remote device, the data collection policy including a trigger evaluation data identifier configured to identify trigger evaluation data to be evaluated in response to a trigger condition. Process 19900 proceeds to operation 19905 where the vehicle determines a collection validation value in response to the identified trigger evaluation data and a vehicle data collection parameter. Process 19900 proceeds to operation 19907 where the trigger evaluation circuit receives the trigger condition in response to the collection validation value. Process 19900 proceeds to operation 19909 where the vehicle determines a trigger event occurrence in response to the trigger condition. Process 19900 proceeds to operation 19911 where the vehicle provides identified vehicle data in response to the trigger event occurrence, or an alert response value in response to the trigger event occurrence.

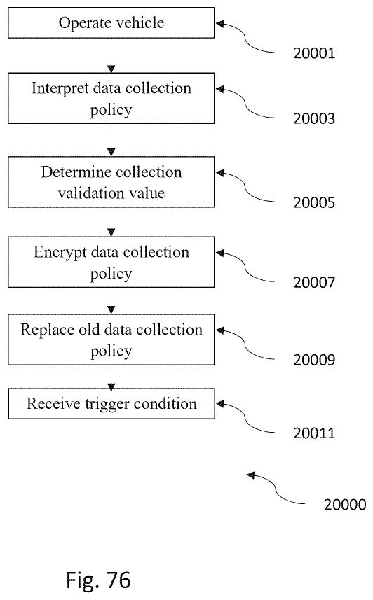

With reference to FIG. 76, there is illustrated an example vehicle-based vehicle data collection process 20000. Process 20000 may be implemented in whole or in part in one or more of the vehicles disclosed herein. It shall be further appreciated that variations of and modifications to process 20000 are contemplated including, for example, the omission of one or more aspects of process 20000, the addition of further conditionals and operations, or the reorganization or separation of operations and conditionals into separate processes.

Process 20000 begins at operation 20001 including operating a vehicle including a cloud interface, a policy update circuit, a policy manager circuit, and a trigger evaluation circuit. Process 20000 proceeds to operation 20003 where the vehicle interprets a data collection policy from a remote device, the data collection policy including a trigger evaluation data identifier configured to identify trigger evaluation data to be evaluated in response to a trigger condition. Process 20000 proceeds to operation 20005 where the vehicle determines a collection validation value in response to the identified trigger evaluation data and a vehicle data collection parameter. Process 20000 proceeds to operation 20007 where a policy manager circuit encrypts the data collection policy. Process 20000 proceeds to operation 20009 where the policy manager circuit replaces a previous data collection policy with the data collection policy in response to collection validation value. Process 20000 proceeds to operation 20011 where the vehicle receives the trigger condition in response to the collection validation value.

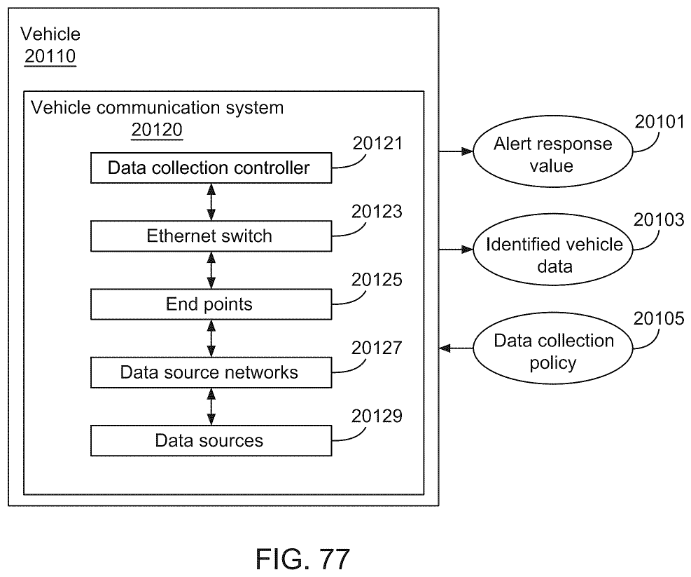

With reference to FIG. 77, there is a block diagram illustrating an example vehicle 20110 including a vehicle communication system 20120. The vehicle communication system is structured to receive a data collection policy 20105 from a remote device, such as a cloud device, and output at least one of an alert response value 20101 or identified vehicle data 20103 in response to data collection policy 20105. In certain embodiments, vehicle communication system 20120 is configured to simultaneously implement at least two of an on-demand data collection policy, a persistent data collection policy, and a streaming data collection policy. It shall be appreciated that the topology of vehicle communication system 20120 is illustrated for the purpose of explanation and is not intended as a limitation of the present disclosure. For example, vehicle communication system 20120 may include a plurality of data sources coupled to one of a plurality of end points by way of one of the plurality of data source networks. In another example, vehicle communication system 20120 may include a single end point or a single data source network, to name but a few examples.

Vehicle communication system 20120 includes a data collection controller 20121, an ethernet switch 20123, a plurality of end points 20125, a plurality of data source networks 20127, and a plurality of data sources 20129. Ethernet switch 20123 is communicatively coupled between data collection controller 20121 and the plurality of end points 20125. Each end point of the plurality of end points 20125 is communicatively coupled between ethernet switch 20123 and at least one of the plurality of data source networks 20127. Each data source of the plurality of data sources is communicatively coupled to an end point of the plurality of end points 20125 by way of a data source network of the plurality of data source networks 20127.

Data collection controller 20121 is configured to receive data collection policy 20105 and determine a set of data that must be collected from one or more data sources according to data collection parameters in order to evaluate trigger conditions of data collection policy 20105, referred to herein as trigger evaluation data. Data collection controller 20121 may also be configured to determine data to be collected from one or more data sources of the vehicle according to data collection parameters, at least a portion of which will be transmitted from the vehicle once at least one trigger condition of data collection policy 20105 is satisfied, referred to herein as identified vehicle data. Data collection controller 20121 is configured to output instructions or a portion of data collection policy 20105 effective to reconfigure ethernet switch 20123 and the plurality of end points 20125 to collect a raw vehicle data stream including a trigger evaluation data stream and an identified vehicle data stream. In certain embodiments, ethernet switch 20123 and the plurality of end points 20125 are reconfigured to collect the identified vehicle data stream after a trigger condition has been satisfied.

Ethernet switch 20123 is configured to receive data from the plurality of end points 20125 and output the data to data collection controller 20121. In certain embodiments, ethernet switch 20123 includes a data source from which to collect a value of the trigger evaluation data or the identified vehicle data. For example, trigger evaluation data may include network traffic data for ethernet switch 20123. In certain embodiments, data collection controller 20121 is incorporated into an electronic control unit of ethernet switch 20123.

The plurality of end points 20125 are configured to receive data from the plurality of data sources 20129. In certain embodiments, data collection controller 20121 reconfigures one or more of the plurality of end points to collect a portion of the trigger evaluation data stream or identified vehicle data stream. For example, data collection controller 20121 may provide an end point with a list of CAN signals required by the data collection controller 20121 for trigger evaluation data. The trigger evaluation data may need to include data from a data source that does not already output the required data, in which case the endpoint is reconfigured to request the data from the data source. The new data may include new CAN messages or CAN signals, to name but a few examples.

In another example, an end point may be reconfigured to request a data source output data according to a different data collection parameter, such as an increased frequency. Each end point may be configured to provide a raw vehicle data stream including the trigger evaluation data stream and the identified vehicle data stream in response to data collection policy 20201. In certain embodiments, the raw data stream transmitted from the end point includes only a portion of the data received by the end point. For example, an end point may be reconfigured to receive data from a data source having a high sampling frequency, filter the data, and output the raw vehicle data stream including the data having a reduced sampling frequency.

In certain embodiments, data collection policy 20105 includes trigger conditions requiring the same trigger evaluation data value collected from the same source at different frequencies. In response, an end point is configured to collect the trigger evaluation data value at the highest required frequency or at a frequency which is a multiple of one or more of the different frequencies. For example, one trigger condition may require vehicle speed at a frequency of two samples per second and a second trigger condition may require vehicle speed at a frequency of three samples per second. The end point may be configured to collect vehicle speed at 3 samples per second or six samples per second. It shall be appreciated that any or all of the foregoing features of vehicle 20110 may also be present in the other vehicles disclosed herein.

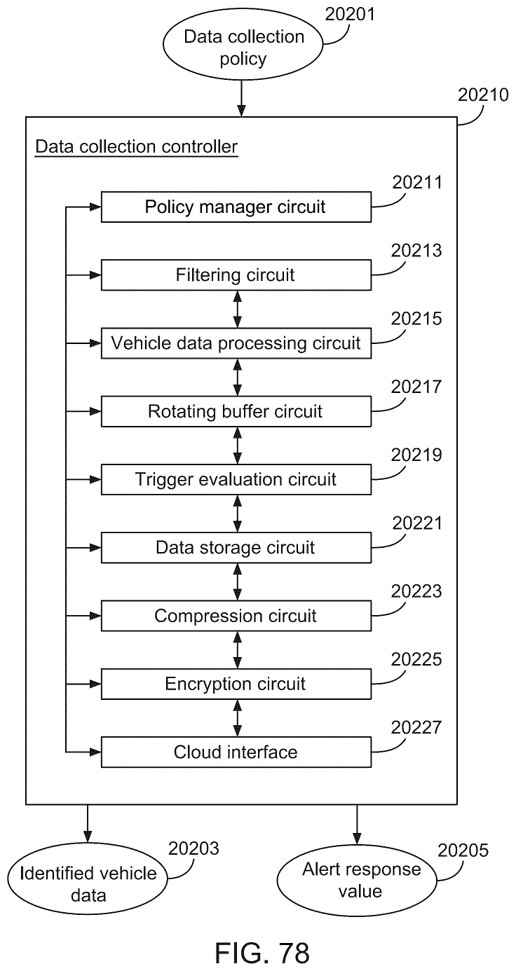

With reference to FIG. 78, there is illustrated an example data collection controller 20210 of an example vehicle communication system configured to receive a data collection policy 20201 and reconfigure the vehicle communication system, including the components of data collection controller 20210, to collect trigger evaluation data identified by data collection policy 20201. Data collection controller 20210 may also reconfigure the vehicle communication system, including the components of data collection controller 20210, to collect identified vehicle data identified by data collection policy 20201.

Controller 20210 includes a policy manager circuit 20211, a filtering circuit 20213, a vehicle data processing circuit 20215, a rotating buffer circuit 20217, a trigger evaluation circuit 20219, a data storage circuit 20221, a compression circuit 20223, an encryption circuit 20225, and a cloud interface 20227. In other embodiments, controller 20210 may include fewer components or more components.

Policy manager circuit 20211 is communicatively coupled to filtering circuit 20213, vehicle data processing circuit 20215, rotating buffer circuit 20217, trigger evaluation circuit 20219, data storage circuit 20221, compression circuit 20223, encryption circuit 20225, and cloud interface 20227. Policy manager circuit 20211 is configured to interpret data collection policy 20201, configured to identify trigger evaluation data, and may be configured to identify vehicle data. Policy manager circuit 20211 is further configured to parse data collection policy 20201 in order to reconfigure the components of data collection controller 20210 and the other components of the vehicle communication system to evaluate the trigger conditions of data collection policy 20201 and transmit at least one of identified vehicle data 20203 or alert response value 20205.

Filtering circuit 20213 interprets the raw vehicle data stream and is configured to determine the trigger evaluation data stream of the raw vehicle data stream in response to trigger evaluation data identifiers provided by policy manager circuit 20211. Filtering circuit 20213 may then provide the trigger evaluation data stream to vehicle data processing circuit 20215 or, in embodiments where data collection controller 20210 does not includes circuit 20215, to rotating buffer circuit 20217. Filtering circuit 20213 may also be configured to determine the identified vehicle data stream of the raw vehicle data stream in response to the vehicle data identifiers provided by policy manager circuit 20211. In certain embodiments, filtering circuit 20213 is configured to discard any remaining portion of the raw vehicle data stream that is not the trigger evaluation data or the identified vehicle data stream.

Vehicle data processing circuit 20215 is configured to preprocess the data filtered by filtering circuit 20213. In certain embodiments, vehicle data processing circuit 20215 is configured by policy manager circuit 20211 to sample the trigger evaluation data stream or identified vehicle data stream in response to a sampling parameter of data collection policy 20201. For example, vehicle data processing circuit 20215 may reduce a sampling frequency of a value of the trigger evaluation data stream where the sampling parameter of the data collection policy 20201 specifies a sampling frequency required for trigger condition evaluation that is less the sampling frequency received by vehicle data processing circuit 20215. In certain embodiments, vehicle data processing circuit 20215 is configured by policy manager circuit 20211 to normalize a trigger evaluation data value format or an identified vehicle data value format. For example, a value of the trigger evaluation data may be converted from miles per hour to meters per second, where the trigger evaluation data value format required by a trigger condition is meters per second. In certain embodiments, vehicle data processing circuit 20215 is configured to determine a trigger evaluation data aggregation parameter required to evaluate a trigger condition of data collection policy 20201. A data aggregation parameter may include an average, a sum, a minimum, a maximum, a mean, or a count of a value stream of the trigger evaluation data stream, to name but a few examples. In certain embodiments, vehicle data processing circuit 20215 is configured to determine an identified vehicle data aggregation parameter of identified vehicle data in response to collection policy 20201.

Rotating buffer circuit 20217 may be configured to store a rotating time window of the trigger evaluation data stream or identified vehicle data stream. Different values of the trigger evaluation data stream may be stored according to time windows of different sizes. The size of the time window for the trigger evaluation data stream is determined in response to a trigger condition. For example, if a trigger condition is satisfied when a peak vehicle speed during the previous two minutes exceeds a preset value, rotating buffer circuit 20217 will be configured by policy manager circuit 20211 to store a two minute time window of the vehicle speed value of the trigger evaluation data. The size of the time window for the identified vehicle data stream is determined in response to data collection policy 20201. For example, if data collection policy 20201 specifies image data is to be captured beginning thirty seconds before a trigger occurrence indicating a vehicle crash, rotating buffer circuit 20217 stores a thirty second time window of image data of the identified vehicle data stream.

Policy manager circuit 20211 is configured to provide the trigger evaluation circuit 20219 with trigger policies including one or more trigger conditions. Trigger evaluation circuit 20219 may be configured to determine a trigger event occurrence in response to evaluating the trigger condition using the first rotating time window. Trigger evaluation circuit 20219 is configured to evaluate a plurality of trigger conditions of the data collection policy simultaneously, and wherein trigger evaluation circuit 20219 is configured to determine the trigger event occurrence in response to a plurality of trigger conditions.

Vehicle data storage circuit 20221 may be configured to store identified vehicle data 20203 of the identified vehicle data stream in response to the trigger event occurrence and the data collection policy. Policy manager circuit 20211 may configure vehicle data storage circuit 20221 to store data based on a transmission parameter of the data collection policy 20201. For example, vehicle data storage circuit 20221 may store identified vehicle data if the transmission parameter indicates identified vehicle data should be transmitted from the vehicle periodically rather than streamed in real time.

In certain embodiments, vehicle data storage circuit 20221 discards stored data according to a priority defined by data collection policy 20105. For example, data may be discarded based on the age of the data, whether a receipt confirmation for the data has been received from the cloud device, or a change in memory space of data storage circuit 20221, to name but a few examples.

Compression circuit 20223 may be configured to compress the identified vehicle data to increase bandwidth efficiency. Encryption circuit 20225 may be configured to encrypt the identified vehicle data. Cloud interface 20227 may be configured to provide identified vehicle data 20203 of the identified vehicle data stream in response to a trigger event occurrence and transmission parameter value of the data collection policy 20201. Cloud interface 20227 may be configured to provide an alert response value 20205 in response to the trigger event occurrence. In certain embodiments, data will be uploaded to the cloud using HTTPS with applicable ciphers, e.g., according to industry standards, defined by a vehicle OEM, and/or any other standard applicable to the vehicle and/or system. Transmission may occur at a fixed interval or as soon as a trigger condition termination occurs, to name but a few examples. It shall be appreciated that any or all of the foregoing features of data collection controller 20210 may also be present in the other vehicles disclosed herein.

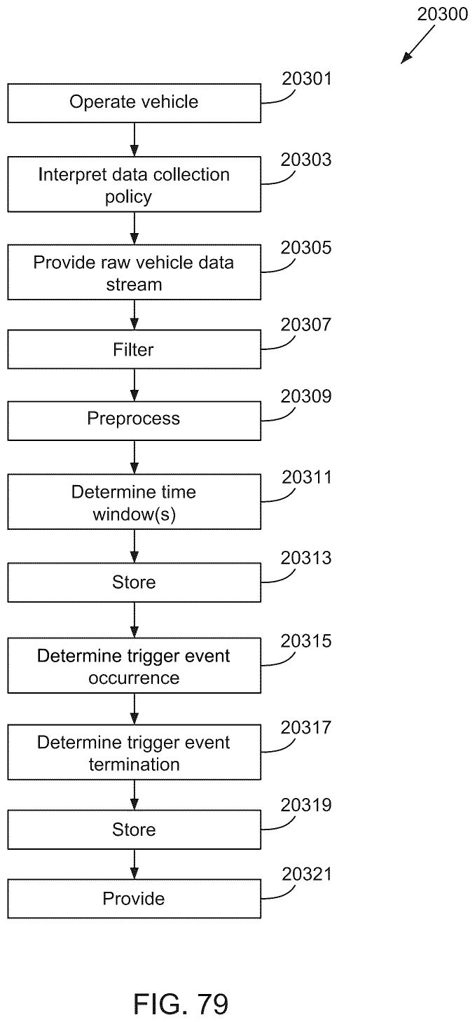

With reference to FIG. 79, there is illustrated an example vehicle data collection process 20300. Process 20300 may be implemented in whole or in part in one or more of the vehicle communication systems disclosed herein. It shall be further appreciated that variations of and modifications to process 20300 are contemplated including, for example, the omission of one or more aspects of process 20300, the addition of further conditionals and operations, or the reorganization or separation of operations and conditionals into separate processes.

Process 20300 begins at operation 20301 where a vehicle is operated, the vehicle including a vehicle communication system including a policy manager circuit and an endpoint. In certain embodiments, the vehicle communication system includes a data collection controller including at least one of the policy manager circuit, a filtering circuit, a vehicle data processing circuit, a rotating buffer circuit, a trigger evaluation circuit, a vehicle data storage circuit, a vehicle data compression circuit, a vehicle data encryption circuit, or a cloud interface.

Process 20300 proceeds to operation 20303 where the vehicle communication system interprets a data collection policy. In certain embodiments, operation 20303 includes interpreting, with the policy manager circuit, a data collection policy including a trigger condition, a vehicle data identifier configured to identify vehicle data to be captured in response to a trigger event occurrence, and a trigger evaluation data identifier configured to identify trigger evaluation data to be captured in response to the trigger condition.

Process 20300 proceeds to operation 20305 where the vehicle communication system provides a raw vehicle data stream, which includes a trigger evaluation data stream and may include an identified vehicle data stream, in response to the data collection policy.

Process 20300 proceeds to operation 20307 where the vehicle communication system filters the raw vehicle data stream. Operation 20307 may include determining, with the filtering circuit, the trigger evaluation data stream of the raw vehicle data stream in response to trigger evaluation data identifier. Operation 20307 may include determining, with the filtering circuit, the identified vehicle data stream in response to the vehicle data identifier.

Process 20300 proceeds to operation 20309 where the vehicle communication system preprocesses the trigger evaluation data stream. Operation 20309 may include at least one of: sampling the trigger evaluation data stream in response to a sampling parameter of the data collection policy, normalizing a trigger evaluation data value format, or determining a trigger evaluation data aggregation parameter in response to a plurality of trigger conditions of the data collection policy.

Process 20300 proceeds to operation 20311 where the vehicle communication system determines a time window of the trigger evaluation data stream. Operation 20311 may include determining, with the rotating buffer circuit, a rotating time window in response to the trigger condition. Operation 20311 may also include determining, with the rotating buffer circuit, a second rotating time window in response to the data collection policy.

Process 20300 proceeds to operation 20313 where the vehicle communication system stores the time window of the trigger evaluation data stream determined in operation 20311. Operation 20313 may include storing, with the rotating buffer circuit, the rotating time window of trigger evaluation data. Operation 20313 may also include storing a second rotating time window of the identified vehicle data stream in response to the data collection policy.

Process 20300 proceeds to operation 20315 where the vehicle communication system determines a trigger event occurrence. Operation 20315 may include determining, with the trigger evaluation circuit, a trigger event occurrence in response to evaluating the trigger condition using the rotating time window of trigger evaluation data stored with the rotating buffer circuit. In certain embodiments, the trigger evaluation circuit evaluates a plurality of trigger conditions of the data collection policy simultaneously determines the trigger event occurrence in response to evaluating a plurality of trigger conditions using the rotating time window.

Process 20300 proceeds to operation 20317 where the vehicle communication system determines a trigger event termination. Operation 20317 may include determining a trigger event termination in response to a trigger condition of the data collection policy.

Process 20300 proceeds to operation 20319 where the vehicle communication system stores identified vehicle data captured in response to at least one of the trigger event occurrence or the trigger event termination. Operation 20319 may include storing, with the vehicle data storage circuit, identified vehicle data of the identified vehicle data stream in response to the trigger event occurrence and the data collection policy. In certain embodiments, at least a portion of the identified vehicle data has occurred before the trigger event occurrence.

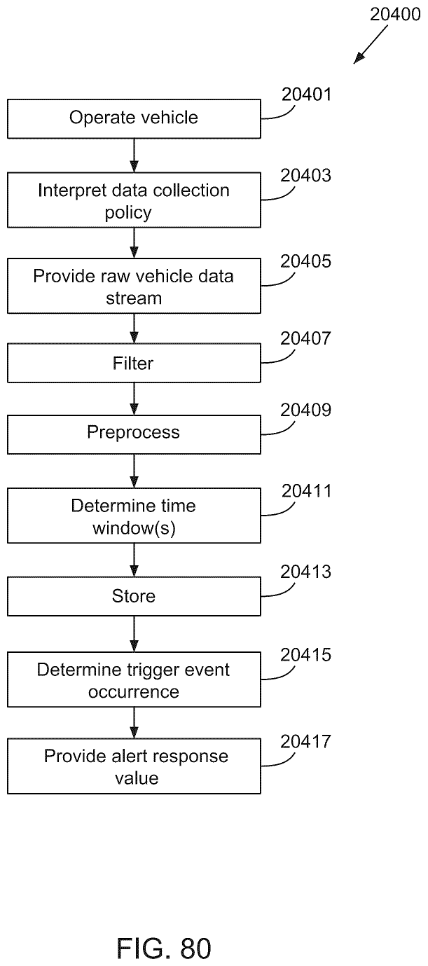

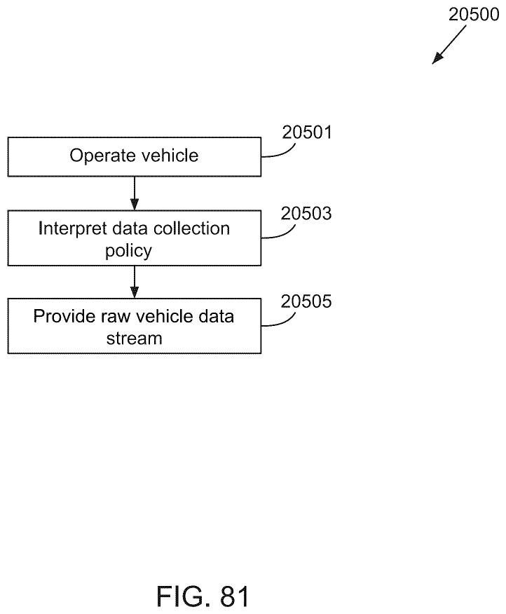

Process 20300 proceeds to operation 20321 where the vehicle communication system provides the identified vehicle data. Operation 20321 may include providing, with the cloud interface, identified vehicle data of the identified vehicle data stream in response to the trigger event occurrence and a transmission parameter value of the data collection policy. Operation 20321 may also include providing, with a cloud interface, an alert response value in response to the trigger event occurrence, wherein the alert response value includes at least one of an alert criterion, an alert type, an alert content, and an alert location. It shall be appreciated that any or all of the foregoing features of example process 20300 may also be present in the other processes disclosed herein, such as the processes illustrated in FIGS. 80-81, to name but a few examples.

With reference to FIG. 80, there is illustrated an example vehicle data collection process 20400. Process 20400 may be implemented in whole or in part in one or more of the vehicle communication systems disclosed herein. It shall be further appreciated that variations of and modifications to process 20400 are contemplated including, for example, the omission of one or more aspects of process 20400, the addition of further conditionals and operations, or the reorganization or separation of operations and conditionals into separate processes.

Process 20400 begins at operation 20401 where a vehicle is operated, the vehicle including a vehicle communication system including a policy manager circuit and an endpoint. In certain embodiments, the vehicle communication system includes a data collection controller including at least one of the policy manager circuit, a filtering circuit, a vehicle data processing circuit, a rotating buffer circuit, a trigger evaluation circuit, a vehicle data storage circuit, a vehicle data compression circuit, a vehicle data encryption circuit, or a cloud interface.

Process 20400 proceeds to operation 20403 where the vehicle communication system interprets a data collection policy. In certain embodiments, operation 20403 includes interpreting, with the policy manager circuit, a data collection policy including a trigger condition and a trigger evaluation data identifier configured to identify trigger evaluation data to be captured in response to the trigger condition.

Process 20400 proceeds to operation 20405 where the vehicle communication system provides a raw vehicle data stream, which includes a trigger evaluation data stream in response to the data collection policy.

Process 20400 proceeds to operation 20407 where the vehicle communication system filters the raw vehicle data stream. Operation 20407 may include determining, with the filtering circuit, the trigger evaluation data stream of the raw vehicle data stream in response to trigger evaluation data identifier.

Process 20400 proceeds to operation 20409 where the vehicle communication system preprocesses the raw vehicle data stream. Operation 20409 may include at least one of: sampling the trigger evaluation data stream in response to a sampling parameter of the data collection policy, normalizing a trigger evaluation data value format, or determining a trigger evaluation data aggregation parameter in response to a plurality of trigger conditions of the data collection policy.

Process 20400 proceeds to operation 20411 where the vehicle communication system determines a time window of the trigger evaluation data stream. Operation 20411 may include determining, with the rotating buffer circuit, one or more rotating time windows of the trigger evaluation data in response to the trigger condition.

Process 20400 proceeds to operation 20413 where the vehicle communication system stores the time window of the trigger evaluation data stream determined in operation 20411. Operation 20413 may include storing, with the rotating buffer circuit, the multiple time windows for multiple values of the trigger evaluation data stream.

Process 20400 proceeds to operation 20415 where the vehicle communication system determines a trigger event occurrence. Operation 20415 may include determining, with the trigger evaluation circuit, a trigger event occurrence in response to evaluating the trigger condition using the rotating time window of trigger evaluation data stored with the rotating buffer circuit. In certain embodiments, the trigger evaluation circuit evaluates a plurality of trigger conditions of the data collection policy simultaneously determines the trigger event occurrence in response to evaluating a plurality of trigger conditions using the rotating time window.

Process 20400 proceeds to operation 20417 where the vehicle communication system provides an alert response value in response to the trigger event occurrence, wherein the alert response value includes at least one of an alert criterion, an alert type, an alert content, and an alert location. It shall be appreciated that any or all of the foregoing features of example process 20400 may also be present in the other processes disclosed herein, such as the processes illustrated in FIG. 79 or 81, to name but a few examples.

With reference to FIG. 81, there is illustrated an example vehicle data collection process 20500. Process 20500 may be implemented in whole or in part in one or more of the vehicle communication systems disclosed herein. It shall be further appreciated that variations of and modifications to process 20500 are contemplated including, for example, the omission of one or more aspects of process 20500, the addition of further conditionals and operations, or the reorganization or separation of operations and conditionals into separate processes.

Process 20500 begins at operation 20501 where a vehicle is operated, the vehicle including a vehicle communication system including a policy manager circuit and an endpoint. In certain embodiments, the vehicle communication system includes a data collection controller including at least one of the policy manager circuit, a filtering circuit, a vehicle data processing circuit, a rotating buffer circuit, a trigger evaluation circuit, a vehicle data storage circuit, a vehicle data compression circuit, a vehicle data encryption circuit, or a cloud interface.

Process 20500 proceeds to operation 20503 where the vehicle communication system interprets a data collection policy. In certain embodiments, operation 20503 includes interpreting, with the policy manager circuit, a data collection policy including a trigger condition, a vehicle data identifier configured to identify vehicle data to be captured in response to a trigger event occurrence, and a trigger evaluation data identifier configured to identify trigger evaluation data to be captured in response to the trigger condition.

Process 20500 proceeds to operation 20505 where the vehicle communication system provides a raw vehicle data stream, which includes a trigger evaluation data stream and may include an identified vehicle data stream, in response to the data collection policy. It shall be appreciated that any or all of the foregoing features of example process 20500 may also be present in the other processes disclosed herein, such as the processes illustrated in FIGS. 79-80, to name but a few examples.

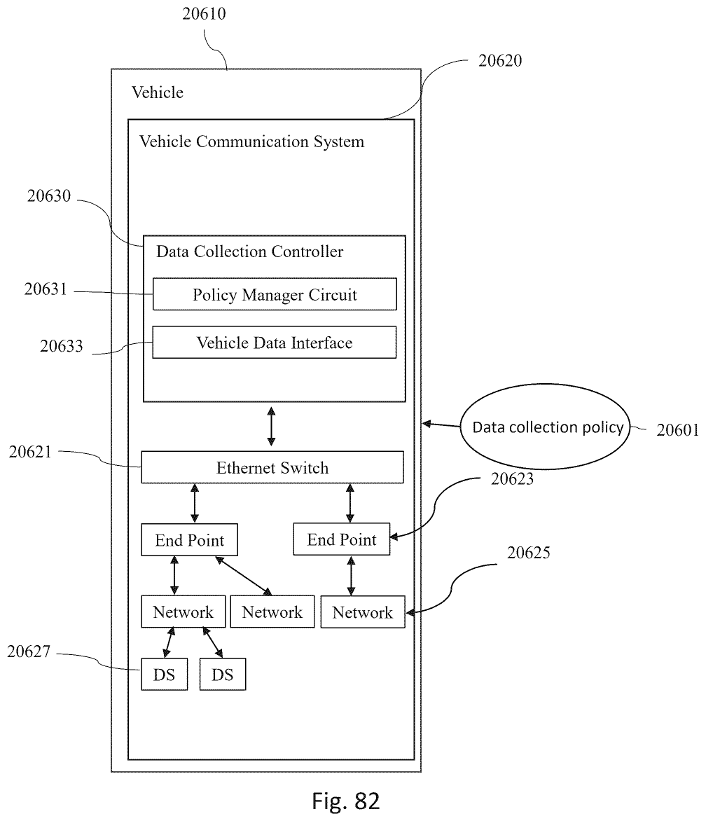

With reference to FIG. 82, there is a block diagram illustrating an example vehicle 20610 including a vehicle communication system 20620. The vehicle communication system is structured to receive a data collection policy 20601 from a remote device, such as a cloud device, and update the operation of vehicle communication system 20620 in response to data collection policy 20601. It shall be appreciated that the topology of vehicle communication system 20620 is illustrated for the purpose of explanation and is not intended as a limitation of the present disclosure. For example, vehicle communication system 20620 may include more or fewer end points, more or fewer data source networks, or more or fewer data sources, to name but a few examples.

Vehicle communication system 20620 includes data collection controller 20630, ethernet switch 20621, a plurality of end points 20623, a plurality of data source networks 20625, and a plurality of data sources 20627. Data collection controller 20630 may be configured to receive a data collection policy 20601 from a remote device, such as a cloud system, and capture vehicle data from data sources of the vehicle including the plurality of data sources 20627 in response to data collection policy 20601.

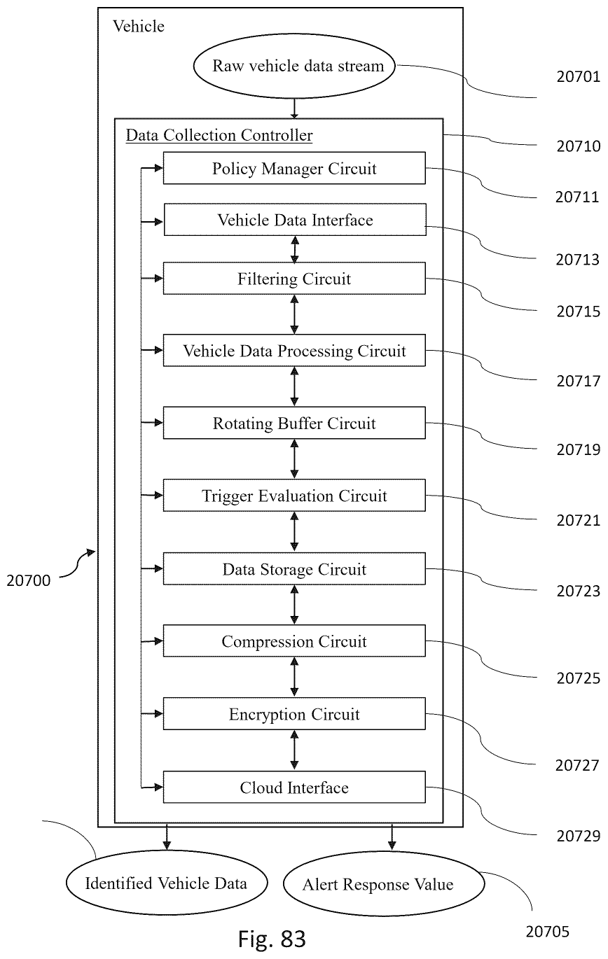

In the illustrated embodiment, data collection controller 20630 includes a policy manager circuit 20631 and a vehicle data interface 20633. In certain embodiments, data collection controller 20630 includes additional components, such as the components of the data collection controllers illustrated in FIGS. 78 and 83. It shall be appreciated that the components of data collection controller 20630 may include instructions, a memory device configured to store the instructions, and a processing device configured to execute the stored instructions effective to perform the operations attributed to the components of data collection controller 20630 described herein. In certain embodiments, one or more of the components of data collection controller 20630 may share a memory device or a processing device.

A processing device of data collection controller 20630 in different embodiments may be a programmable type, a dedicated, hardwired state machine, or a combination thereof. The processing device may further include multiple processors, Arithmetic-Logic Units (ALUs), Central Processing Units (CPUs), Digital Signal Processors (DSPs), Field-programmable Gate Array (FPGA), to name but a few examples. For forms of a processing device with multiple processing units, distributed, pipelined, or parallel processing may be used as appropriate. The processing device may be dedicated to performance of just the operations described herein or may be utilized in one or more additional applications. The processing device may be a programmable variety that executes processes and processes data in accordance with programming instructions (such as software or firmware) stored in a memory device of data collection controller 20630. Alternatively, or additionally, programming instructions may be defined by hardwired logic or other hardware. The processing device may be comprised of one or more components of any type suitable to process the signals received from an input/output device, and provide desired output signals. Such processing device components may include digital circuitry, analog circuitry, or a combination of both.

A memory device of data collection controller 20630 in different embodiments is of one or more types, such as a solid-state variety, electromagnetic variety, optical variety, or a combination of these forms, to name but a few examples. Furthermore, the memory device may be volatile, nonvolatile, transitory, non-transitory or a combination of these types, and some or all of the memory device may be of a portable variety, such as a disk, tape, memory stick, cartridge, to name but a few examples. In addition, the memory device may store data that is manipulated by the processing device of data collection controller 20630, such as data representative of signals received from or sent to an input/output device in addition to or in lieu of storing programming instructions, just to name one example.

Policy manager circuit 20631 is configured to interpret data collection policy 20601. As described in detail above, data collection policy 20601 is configured to identify data required to be evaluated by trigger conditions and may be configured to identify vehicle data to be captured when the trigger conditions are satisfied. In certain embodiments, data collection policy 20601 includes a plurality of trigger evaluation data identifiers configured to identify trigger evaluation data to be evaluated by a plurality of trigger conditions of the data collection policy. In certain embodiments, data collection policy 20601 includes a plurality of vehicle data identifiers configured to identify vehicle data to be captured in response to trigger conditions specified by a trigger policy. The trigger evaluation data identifiers and vehicle data identifiers may correspond to a plurality of data types including at least two of a controller area network (CAN) message, a CAN signal, an ethernet packet, a vehicle location, a vehicle status, diagnostic trouble codes, an ethernet status, a file stored within the vehicle, or vehicle communication controller statistics, to name but a few examples.

In response to data collection policy 20601, policy manager circuit 20631 is configured to cause vehicle communication system 20620 to collect the data identified by data collection policy 20601 and transmit a raw vehicle data stream to data collection controller 20630. The raw vehicle data stream may include a trigger evaluation data stream and an identified vehicle data stream. In certain embodiments, the trigger evaluation data stream and identified vehicle data stream may include a common value of the raw vehicle data stream. In certain embodiments, the trigger evaluation data stream and identified vehicle data stream may include no common value of the raw vehicle data stream. Each value of the trigger evaluation data stream or identified vehicle data stream corresponds to data received from a data source of the vehicle according to data collection parameters specified by data collection policy 20601. The trigger evaluation data stream or the identified vehicle data stream may include a plurality of value streams from a plurality of data sources of vehicle 20610.

Vehicle data interface 20633 is configured to receive the raw vehicle data stream which includes the trigger evaluation data stream and may include the identified vehicle data stream.

Each end point of the plurality of end points 20623 may be configured to capture at least a portion of a trigger evaluation data stream in response to data collection policy 20601. In certain embodiments, more than one end point of the plurality of end points 20623 are configured to capture and output portions of the trigger evaluation data stream or the identified vehicle data stream. Each end point of the plurality of end points 20623 may be communicatively coupled to an ethernet switch 20621. In certain embodiments, one end point is communicatively coupled to more than one of the plurality of networks 20625 configured to communicate data sources using a plurality of communication protocols.

In certain embodiments, the trigger evaluation data stream or the identified vehicle data stream includes data from data sources configured to communicate with one end point using different communication protocols. For example, the trigger evaluation data stream received by an end point may include a CAN message from a CAN bus network and an ethernet packet received from another network communicatively coupled between the data source and the end point. In certain embodiments, the end point does not need to request a value of the trigger evaluation data stream or identified vehicle data stream because the data source is already providing the data. In certain embodiments, the end point, in response to data collection policy 20601, requests the trigger evaluation data stream value or the identified vehicle data stream value from a data source communicatively coupled to the end point. It shall be appreciated that any or all of the foregoing features of vehicle 20610 may also be present in the other vehicles disclosed herein.

With reference to FIG. 83, there is illustrated an example vehicle 20700 including a data collection controller 20710. Data collection controller 20710 is configured to receive a raw vehicle data stream 20701 and output at least one of identified vehicle data 20703 or an alert response value 20705. It shall be appreciated that data collection controller 20710 may include components and features described herein with respect to other illustrated data collection controllers, such as data collection controller 20210 of FIG. 78.

The illustrated data collection controller 20710 includes a policy manager circuit 20711, a vehicle data interface 20713, a filtering circuit 20715, a vehicle data processing circuit 20717, a rotating buffer circuit 20719, a trigger evaluation circuit 20721, a data storage circuit 20723, a compression circuit 20725, an encryption circuit 20727, and a cloud interface 20729. In other embodiments, data collection controller 20710 may include more or fewer components.

Policy manager circuit 20711 may be configured to interpret a data collection policy including a vehicle data identifier and a trigger configured to define a trigger condition. The data collection policy may include a plurality of trigger types, the plurality of trigger types including a signal trigger, a vehicle status trigger, a timing trigger, a schedule trigger, a geofence trigger, an error trigger, an environment trigger, or a user input trigger. In certain embodiments, the plurality of trigger conditions of the plurality of triggers correspond to the same value of the trigger evaluation data.

In certain embodiments, the trigger evaluation data or identified vehicle data includes at least one of a vehicle state, a vehicle status, a vehicle operating mode, or a vehicle discrete event. In certain embodiments, the plurality of trigger evaluation data or the identified vehicle data corresponds to a plurality of data types, including at least two of a controller area network (CAN) message, a CAN signal, an ethernet packet, a vehicle location, a vehicle status, and a diagnostic trouble code. In certain embodiments, the trigger evaluation data or the identified vehicle data includes a virtual sensor value derived from a plurality of vehicle data values.

Filtering circuit 20715 may be configured to receive raw vehicle data stream 20701 from vehicle data interface 20713, determine a trigger evaluation data stream or identified vehicle data stream from raw vehicle data stream 20701, and output only the trigger evaluation data stream or identified vehicle data stream. In certain embodiments, filtering circuit 20715 discards the remaining portion of raw vehicle data stream 20701.

Vehicle data processing circuit 20717 may be configured to receive the trigger evaluation data stream or identified vehicle data stream, preprocess the received stream for either trigger evaluation circuit 20721 or cloud interface 20729, and output the received stream to rotating buffer circuit 20719.

Rotating buffer circuit 20719 is configured to store the time window of a value stream of the trigger evaluation data stream or identified vehicle data stream in response to the data collection policy. The size of the time window is based on the historical values of the value stream required by the data collection policy. For example, the time window of an engine temperature value stream may be five minutes if trigger condition corresponding to the value stream is satisfied when a threshold temperature is exceeded within the past five minutes. In another example, the time window of a vehicle speed value stream may be two minutes if the data collection policy specifies that two minutes of historical vehicle speed will be collected in response to a vehicle crash. Rotating buffer circuit 20719 may be configured to provide a time window of trigger evaluation data to trigger evaluation circuit 20721 while storing identified vehicle data until the trigger condition corresponding to the trigger evaluation data is satisfied. In certain embodiments, at least a portion of the trigger evaluation data is not stored by rotating buffer circuit 20719.

Trigger evaluation circuit 20721 is configured to determine a trigger event occurrence in response to a trigger condition and trigger evaluation data. In certain embodiments, trigger evaluation circuit 20721 determines the trigger event occurrence by evaluating the trigger evaluation data using the trigger condition, wherein the trigger condition defines a relationship with a preset value that may be satisfied or unsatisfied by the trigger evaluation data. For example, trigger evaluation circuit may determine a trigger occurrence if a trigger condition evaluating whether vehicle speed exceeds a threshold value is satisfied. In certain embodiments, trigger evaluation circuit 20721 determines a trigger event occurrence in response to a plurality of trigger conditions. For example, trigger evaluation circuit 20721 may determine a trigger event occurrence if a vehicle ignition is on and a warning CAN signal is being transmitted. In certain embodiments, trigger evaluation circuit 20721 determines the trigger event occurrence in response to at least two trigger conditions. In certain embodiments, determining the trigger event occurrence is based on a plurality of trigger conditions of different trigger types.

Trigger evaluation circuit 20721 is configured to determine a trigger event termination. Trigger evaluation circuit 20721 may determine the trigger event termination in response to a trigger condition or after a period of time following the trigger event occurrence. In certain embodiments, determining the trigger event termination includes determining a plurality of trigger conditions of different trigger types are satisfied.

Trigger evaluation circuit 20721 is configured to determine a data capture window in response to the trigger event occurrence, trigger event termination, and the data collection policy. The portion of the identified vehicle data stream generated during the data capture window is the identified vehicle data that will be transmitted from vehicle 20700. In certain embodiments, the data capture window may begin at the trigger event occurrence or end at the trigger event termination. In certain embodiments, the data capture window may begin before the trigger event occurrence or end after the trigger event termination. In certain embodiments, the data collection policy may specify identified vehicle data should be captured that occurred before the trigger event occurrence or after the trigger event termination. For example, the data collection policy may specify collecting thirty minutes of engine temperature values that were collected before an engine failure. In another example, the data collection policy may specify collecting data two seconds after trigger event termination to allow a measured value to stabilize before measurement following the trigger event termination.

Data storage circuit 20723 is configured to store identified vehicle data captured within the data capture window if the data collection policy specifies the identified vehicle data is to be stored before being transmitted. For example, the data collection policy may specify a transmission interval during which captured identified vehicle data is to be aggregated before transmitting. In another example, data storage circuit 20723 may not store identified vehicle data value within the data capture window where the data collection policy indicates the value is to be streamed from the vehicle in real time.

Compression circuit 20725 is configured to compress aggregated identified vehicle data before transmission to increase bandwidth efficiency. Encryption circuit 20727 is configured to encrypt the identified vehicle data to be transmitted from the vehicle. In certain embodiments, the identified vehicle data is encrypted using a key that is unavailable to the remote device that will receive and store the identified vehicle data.

Cloud interface 20729 is configured to provide at least one of identified vehicle data 20703 or an alert response value 20705 to a remote device, such as a cloud device. In certain embodiments, cloud interface 20729 may be configured to provide an alert response value 20705 directly to a user device.

Alert response value 20705 may include at least one of an alert criterion, an alert type, an alert content, and an alert location. The alert criterion may be configured to notify a user that a trigger condition has been satisfied or that a trigger event occurrence. An alert type may be configured to identify a notification medium, such as a text message or haptic feedback, to name but a few examples. An alert content may be configured to convey a notification to the user and may include a prompt for user response. An alert location may be configured to identify a location of the vehicle. It shall be appreciated that any or all of the foregoing features of vehicle 20700 may also be present in the other vehicles disclosed herein.

In one example, data collection controller 20710 may transmit an alert response value 20705 to notify a user a trigger event occurrence has occurred. In another example, data collection controller 20710 may send an alert response value 20705 to a specified device once a trigger event occurrence has occurred. In another example, data collection controller 20710 may send an alert response value 20705 to notify a user identified vehicle data 20703 has been captured and transmitted from the vehicle. In another example, data collection controller 20710 may send an alert response value 20705 in response to policy manager circuit 20711 determining a data collection policy or trigger policy is invalid. In another example, data collection controller 20710 may send an alert response value 20705 in response to policy manager circuit 20711 determining a data collection policy is valid, but the user is not yet authorized to receive the captured identified vehicle data. In another example, data collection controller 20710 may send an alert response value 20705 configured to provide a periodic summary of the data collection policy execution on the vehicle. In certain embodiments, data collection controller 20710 transmits identified vehicle data 20703 and/or alert response values 20705 to multiple external devices.

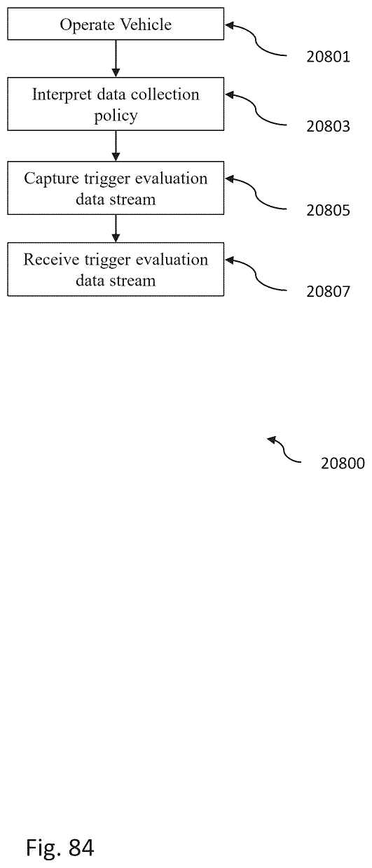

With reference to FIG. 84, there is illustrated an example vehicle data collection process 20800. Process 20800 may be implemented in whole or in part in one or more of the vehicle communication systems disclosed herein. It shall be further appreciated that variations of and modifications to process 20800 are contemplated including, for example, the omission of one or more aspects of process 20800, the addition of further conditionals and operations, or the reorganization or separation of operations and conditionals into separate processes.

Process 20800 begins at operation 20801 including operating a vehicle including a policy manager circuit, an end point, and a vehicle data interface. Process 20800 proceeds to operation 20803 where the vehicle interprets a data collection policy including a trigger condition and a trigger evaluation data identifier. In certain embodiments, the data collection policy includes a plurality of trigger evaluation data identifiers configured to identify trigger evaluation to be evaluated by a plurality of trigger conditions of the data collection policy, wherein the trigger evaluation data identifiers correspond to a plurality of data types including at least two of a controller area network (CAN) message, a CAN signal, an ethernet packet, a vehicle location, a vehicle status, and a diagnostic trouble code.

Process 20800 proceeds to operation 20805 where the vehicle captures a trigger evaluation data stream in response to the trigger evaluation data identifier and the trigger condition. In certain embodiments, the vehicle includes a plurality of end points communicatively coupled to an ethernet switch and at least a portion of the plurality of end points capture a portion of the plurality of trigger evaluation data stream in response to the data collection policy. In certain embodiments, the end point is communicatively coupled to a plurality of networks configured to communicate using a plurality of communication protocols and the end point captures a plurality of trigger evaluation data streams from the plurality of networks in response to the data collection policy. In certain embodiments, capturing the trigger evaluation data stream includes receiving the trigger evaluation data stream from a data source communicatively coupled to the end point without requesting the trigger evaluation data, or requesting the trigger evaluation data stream from a data source communicatively coupled to the end point.

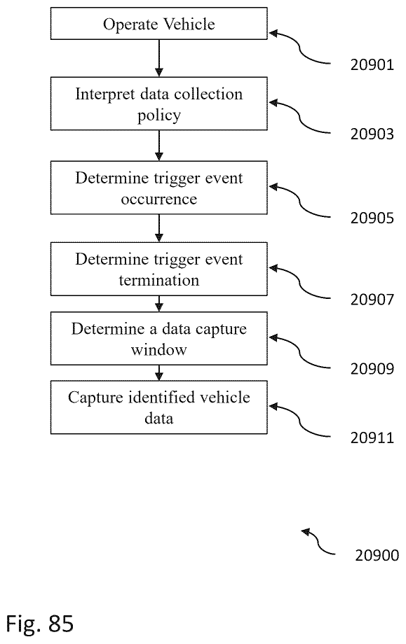

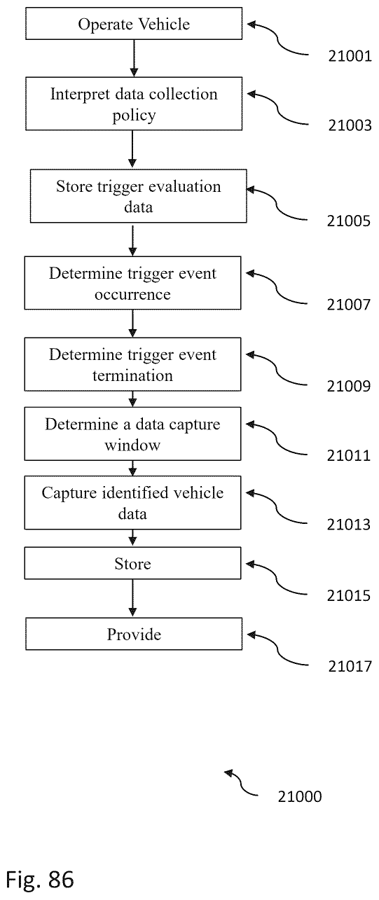

Process 20800 proceeds to operation 20807 where the vehicle data interface receives the trigger evaluation data stream. It shall be appreciated that any or all of the foregoing features of example process 20800 may also be present in the other processes disclosed herein, such as the processes illustrated in FIG. 85 or 86, to name but a few examples.

With reference to FIG. 85, there is illustrated an example vehicle data collection process 20900. Process 20900 may be implemented in whole or in part in one or more of the vehicle communication systems disclosed herein. It shall be further appreciated that variations of and modifications to process 20900 are contemplated including, for example, the omission of one or more aspects of process 20900, the addition of further conditionals and operations, or the reorganization or separation of operations and conditionals into separate processes.

Process 20900 begins at operation 20901 including operating a vehicle including a policy manager circuit and a trigger evaluation circuit. Process 20900 proceeds to operation 20903 where the vehicle interprets a data collection policy including a vehicle data identifier and a trigger configured to define a trigger condition. Process 20900 proceeds to operation 20905 where the vehicle determines a trigger event occurrence in response to a trigger condition and trigger evaluation data. Determining the trigger event occurrence may include evaluating the trigger evaluation data using the trigger condition, wherein the trigger condition defines a relationship with a present value that may be satisfied or unsatisfied by the trigger evaluation data. In certain embodiments, the vehicle determines the trigger event occurrence in response to at least two trigger conditions. In certain embodiments, determining the trigger event occurrence is based on evaluating multiple trigger conditions of different trigger types.

Process 20900 proceeds to operation 20907 where the vehicle determines a trigger event termination. Process 20900 proceeds to operation 20909 where the vehicle determines a data capture window in response to the trigger event occurrence, trigger event termination, and the data collection policy. Process 20900 proceeds to operation 20911 where the vehicle captures identified vehicle data in response to the data capture window and the vehicle data identifier. It shall be appreciated that any or all of the foregoing features of example process 20900 may also be present in the other processes disclosed herein, such as the processes illustrated in FIG. 84 or 86, to name but a few examples.

With reference to FIG. 86, there is illustrated an example vehicle data collection process 21000. Process 21000 may be implemented in whole or in part in one or more of the vehicle communication systems disclosed herein. It shall be further appreciated that variations of and modifications to process 21000 are contemplated including, for example, the omission of one or more aspects of process 21000, the addition of further conditionals and operations, or the reorganization or separation of operations and conditionals into separate processes.

Process 21000 begins at operation 21001 including operating a vehicle including a policy manager circuit, a rotating buffer circuit, a trigger evaluation circuit, a vehicle data storage circuit, and a cloud interface. Process 21000 proceeds to operation 21003 where the vehicle interprets a data collection policy including a vehicle data identifier and a trigger configured to define a trigger condition. Process 21000 proceeds to operation 21005 where the vehicle stores a time window of the identified vehicle data and a time window of the trigger evaluation data.

Process 21000 proceeds to operation 21007 where the vehicle determines a trigger event occurrence in response to a trigger condition and trigger evaluation data. Process 21000 proceeds to operation 21009 where the vehicle determines a trigger event termination. Process 21000 proceeds to operation 21011 where the vehicle determines a data capture window in response to the trigger event occurrence, trigger event termination, and the data collection policy. Process 21000 proceeds to operation 21013 where the vehicle captures identified vehicle data in response to the data capture window and the data collection policy. Process 21000 proceeds to operation 21015 where the vehicle stores identified vehicle data in response to the data capture window. In certain embodiments, at least a portion of the identified vehicle data occurs before the trigger event occurrence. Process 21000 proceeds to operation 21017 where the vehicle provides at least a portion of the identified vehicle data to a cloud system in response to the data collection policy. It shall be appreciated that any or all of the foregoing features of example process 21000 may also be present in the other processes disclosed herein, such as the processes illustrated in FIG. 84 or 86, to name but a few examples.

As explained in greater detail herein, certain embodiments of the current disclosure provide for system/architecture independent communications with a variety of mobile systems, e.g., the use of high-level commands and/or data types by a technician, which may be a human and/or a machine artificial intelligence, to interact with the data collection and/or control elements of a mobile system without using commands and/or data formats specific to the mobile system. In other words, certain embodiments of the current disclosure provide for the ability to interact with data collection and/or control elements across a variety of mobile systems without the need to use data formats and/or commands specific to any one mobile system. Embodiments of the current disclosure may provide for diagnostic analysis and/or testing of a mobile system, and/or its components, during manufacturing and/or after the mobile system has left the manufacturing stage, i.e., the mobile system is in the “field”. For example, a non-limiting use case example may be the implantation of a policy, as described herein, into the mobile system, where the policy preemptively monitors one or more components of the mobile system for early warning signs of potential problems, e.g., minor discrepancies in an engine's firing sequence which could eventually lead to engine failure. Upon detection of such early warning signs, embodiments of the current disclosure may generate and/or transmit a message alerting one or more of an owner of the mobile system, a user of the mobile system, a technician for the mobile system, and/or other party of interest.

Embodiments of the current disclosure may also leverage system independent communications to provide for system independent diagnostics and/or testing of a mobile system. Such embodiments may use the CND, one or more edge gateways, network switches, network management controllers (e.g., data collection controller, transmission controller, storage controller, cache controller, policy controller, and/or container controller(s)), one or more engines (e.g., an API engine, data processing engine, trigger evaluation engine, trigger execution engine, and/or data capture engine), one or more circuits as set forth herein, and/or one or more managers (e.g., network manager, e.g., 324 (FIG. 3), vehicle policy communications manager, vehicle data request manager, consent manager, policy manager, storage manager, automation manager, etc.), to ensure that the correct data is collected and/or utilized, and that the correct actuators or other available levers are addressed and/or commanded, without requiring system specific knowledge for the requesting user, and to provide for greater control in structuring and/or controlling diagnostic and/or testing processes. For example, the CND and/or other aspects of the present disclosure may provide access to data within a mobile system that is not readily accessible by traditional diagnostic and/or testing systems—for example allowing the user to access any data, end points, sensors, actuators, etc., that are available on the vehicle, regardless of where these aspects are located on the vehicle network system, the addressing or terminology utilized for access, whether the aspect is published or publicly accessible, or the like. The CND and other aspects of the present disclosure may also provide for the generation of new diagnostic data requests and/or testing commands without requiring re-certification of embedded software components, for example by limiting changes to implement the diagnostics and/or tests to data file updates (e.g., a policy file), which allows (utilizing aspects of the present disclosure) full implementation of a test, including trigger evaluation, data collection, actuator adjustment, etc., without requiring a change in firmware, control instructions, or other code based changes that might implicate deeper certification or validation requirements for the vehicle.

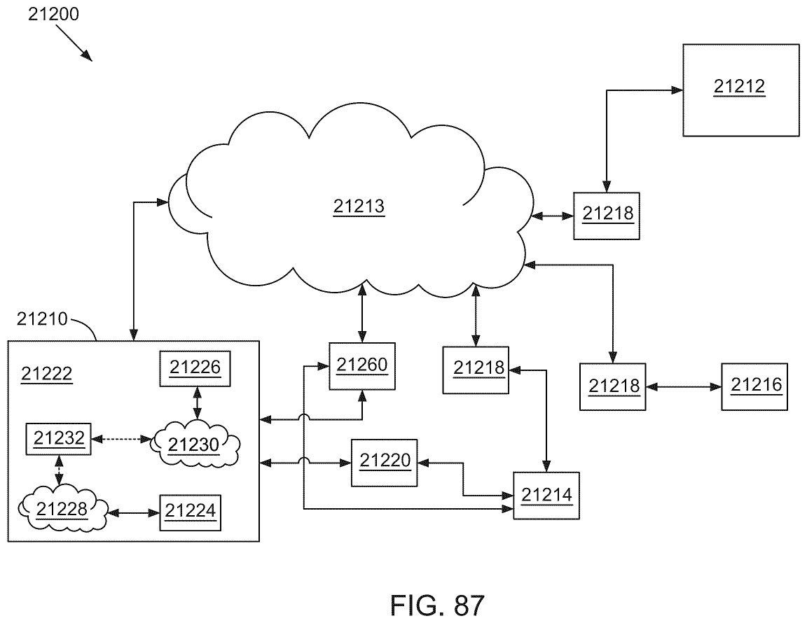

Accordingly, and referring to FIG. 87, an embodiment of a system 21200 for diagnosing and/or testing a mobile system 21210, in accordance with embodiments of the current disclosure, may include a server 21212, a mobile system interface device 21214, and/or a remote computing device 21216. In embodiments, the server 21212 may be a located in a computing facility and/or may be tool/device locally connected to the mobile system interface device 21214 and/or the mobile system 21210 via a hard connection, e.g., ethernet, CAN, and/or other physical link communication protocols, and/or a wireless connection, e.g., WiFi, Bluetooth, and/or other wireless communication protocols. Embodiments of the system 21200 may also include the mobile system 21210. As described in greater detail herein, embodiments of the mobile system interface device 21214 provide for agnostic data 21218 to be sent via a network 21213, e.g., the Internet, from the server 21212, and/or the remote computing device 21216, and interpreted/received by the mobile system 21210 as adapted data 21220; and/or for adapted data 21220 to be sent from the mobile system 21210 and interpreted/received by the server 21212, and/or the remote computing device 21216, as agnostic data 21218.

Agnostic data 21218, as disclosed herein, includes data in a format that may not be readily processed, understood, and/or effectively used by the mobile system 21210 and/or components 21222 thereof, e.g., one or more endpoints 21224, 21226 connected via distinct onboard network zones 21228, 21230 and/or a CND 21232. Nonlimiting examples of Agnostic data 21218 include: high level abstractions of data relating to one or more properties and/or functions/processes of the mobile system 21210 and/or components 21222 thereof; nicknames or common names for data elements that may be specific to an entity (e.g., a company) and/or to a particular group (e.g., a sales or marketing group); an industry-standard term for the data element (e.g., “vehicle speed”); and/or a previous version of adapted data 21220, for example for the data element as utilized by a previous model year of a vehicle. The utilization of agnostic data allows for the user to interact with data elements in a convenient manner specific to the user, without the user having to determine the specific naming conventions, formatting, units to be utilized, network addresses, etc., that are specific to the target vehicle or vehicles. In embodiments, agnostic data 21218 may include portions of adapted data, as disclosed herein, e.g., one or more vehicle specific commands that may be included with and/or encompassed by data that may not be readily processed, understood, and/or effectively used by the mobile system 21210 and/or components 21222 thereof. It can be seen that whether a data element is agnostic data 21218 or adapted data 21220 depends upon the source of the data element, and the purpose for utilizing the data element. For example, a data element may be agnostic data 21218 as used by the user (e.g., a user requesting an automated test to be implemented, and selecting the data element by name from a list of available data elements), and adapted data 21220 as used by the vehicle or mobile system 21210—for example where no change has occurred to the mobile system 21210 since the data element was populated onto the user interface for access by the user, and accordingly the translation of the data element from the agnostic data 21218 to adapted data 21220 in the particular instance does not change the data element. In another example, a data element may be agnostic data 21218 as used by the user (e.g., a user requesting an automated test to be implemented, and selecting the data element by name from a list of available data elements), with corresponding adapted data 21220 that is changed in some manner from the agnostic data 21218, for example utilizing a different parameter name, network address, units of the parameter, etc. In certain embodiments, agnostic data 21218 may be in some sense incomplete, for example where the user references only a parameter name to access and/or request the agnostic data 21218, with many aspects of the data element (e.g., sampling rate, bit depth, storage priority, etc.) that may not be of interest to the user and accordingly that are omitted from the agnostic data 21218 (or at least from a description of the agnostic data 21218 that is available to the user), but that may be present in the adapted data 21220, and/or that may be implemented as default behaviors for the adapted data 21220 (e.g., data storage priority may be an explicit or available aspect of a data element, but the storage controller or other implementing component for data storage may accept data elements that do not have an associated data storage priority, for example implementing default behavior, determining an implied storage priority based upon the type of data, flows or applications that utilize the stored data, etc.). Accordingly, the utilization of agnostic data 21218 and adapted data 21220 herein emphasizes the separation of vehicle or application-specific knowledge of data elements away from the user that creates, implements, and/or utilizes tests and/or diagnostics herein, without the user needing any specific information about the mobile system 21210, including for example the parameter naming, network position or addressing, end point sources for data elements, or the like.

Adapted data 21220, as disclosed herein, includes data in a format readily processed, understood, and/or effectively used by the mobile system 21210, and/or the components 21222 thereof. Nonlimiting examples of adapted data 21220 include component specific data values and/or commands/processes corresponding to properties of the mobile system 21210, and/or components thereof 21222. Adapted data 21220 may also include data that is in a format that is more readily processable, understood, and/or effectively used by the mobile system 21210, and/or the components 21222 thereof, as compared to corresponding agnostic data 21218.

Nonlimiting examples of mobile systems 21210 include: vehicles, e.g., cars, trucks, trains, ships, planes, spacecraft, underwater crafts, and/or any other type of transportation system for transporting humans and/or livestock: drones, e.g., aerial drones, underwater drones, spacefaring drones, and/or other types of autonomous mobile systems; and/or mobile computing systems, e.g., cellphones, laptops, tablets, mobile manufacturing systems, consumer appliances, etc.

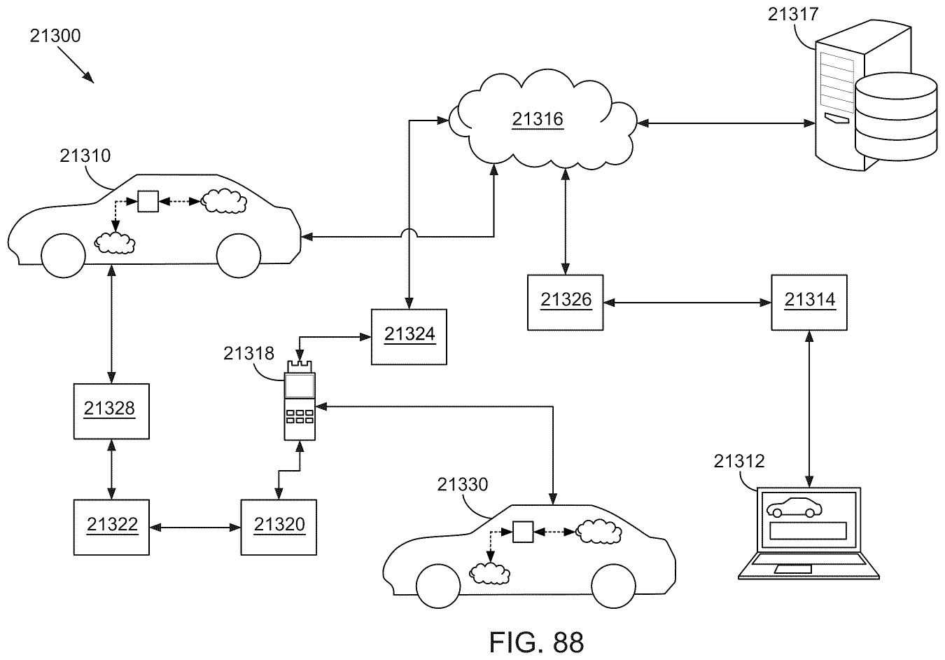

Referring to FIG. 88, as a non-limiting example, a system 21300 for diagnosing and/or testing a mobile system 21310, e.g., a car, may provide for a remote technician using a laptop/workstation 21312 to execute tests on the car 21310 and/or analyze diagnostic data from the car 21310 without having specialized knowledge of data formats, sensor arrangements, and/or communication protocols used by the onboard data acquisition and/or control systems of the car 21310. For example, a driver of the car 21310 experiencing engine sputtering may initiate a communication with the remote technician, and the remote technician may subsequently be interested in the car's “engine temperature”. The remote technician, however, may not be knowledgeable with respect to the particulars of the car's engine temperature sensor(s) and/or have software that can send data request commands to the car 21310 in a format understood by the car's onboard data acquisition and/or control systems. Nevertheless, an application executing on the laptop 21312 provides the remote technician with the ability to send an agnostic command 21314 over a network 21316 and/or in conjunction with server 21317, where the agnostic command 21314 may correspond to, “report back your engine temperature”. The agnostic command 21314 is then interpreted by an embodiment of the mobile interface device 21318 which translates the agnostic command 21314 into an adapted command 21320 and then transmits the adapted command to the appropriate component(s) onboard the car 21310. Responsive to receiving the adapted command 21320, the appropriate component(s) onboard the vehicle interpret the adapted command, generate the requested data, and transmit it as adapted data 21322 back to the mobile interface device 21318. The adapted data 21322 may include a confirmation/authorization by the drive/user/owner of the vehicle for the technician to request and/or receive data from the vehicle. Such authorization may be record in a blockchain, which may also record a log of the data exchanged between the technician and the vehicle. The adapted data 21322 may be in a format specific to the car 21310 and include temperature data from six different engine sensors, e.g., one for each cylinder, in degrees kelvin. The mobile interface device 21318 may then translate and/or condition the temperature data provided by the adapted data 21322 into agnostic data 21324 that it transmits back to the laptop 21312 for display by the application to the remote technician. For example, the mobile interface device 21318 may average the six temperatures provided in the adapted data 21322 to a single value and convert that value to degrees Celsius in a data format readily understood and/or used by the laptop 21312 and/or application executing thereon. Determining that the engine temperature is out of a safe operating range, the remote technician may then send another agnostic command 21326 over the network 21316, where the agnostic command 21326 corresponds to “shut the engine down”. The mobile interface device 21318 may then interpret the agnostic command 21326, translate it to an adapted command 21328 that it transmits to the appropriate component(s) onboard the car 21310 which, in turn, shut the engine down. As is to be appreciated, the remote technician can use the same laptop 21312, and application executing thereon, to get the engine temperature of and/or shutdown another vehicle 21330 that may be of a different model, make, and/or year from that of the car 21310 while also lacking knowledge as to the particulars of the vehicle's engine temperature sensor(s) and/or software that can send data request commands to the vehicle 21330 in a format understood by the vehicle's onboard data acquisition and/or control systems.

Various examples herein describe a test or diagnostic as a discrete event, for example where the test is executed based on a command or trigger condition, test/diagnostic activities are performed, and the test/diagnostic data is communicated to a target location. It will be understood that a given test or diagnostic may be a “long running” test or diagnostic—for example a test that continues for a long period of time, including potentially over several days, weeks, a number of trips, and/or a test/diagnostic that is commenced before a keyoff cycle, and continued after the keyoff cycle. In certain embodiments, a long running test or diagnostic is supported by embodiments herein, for example by capturing data related to the test/diagnostic on an ongoing basis, tracking state information, tracking triggering information, etc., where the captured data and tracking to support the long running test may be stored on the vehicle (e.g., a memory location accessible to the circuits and/or controllers performing the test) and/or off the vehicle, and may include any implementation aspects such as a streaming data support tool such as Kafka, and/or using a data subscription and/or publication facility available on the vehicle and/or accessible to the vehicle.

As will be appreciated, by translating between agnostic mobile system data and adapted mobile system data, embodiments of the system 21300 may provide for the ability to develop testing and/or diagnostic tools that can each be used across a wide variety of mobile systems, e.g., different vehicle makes, models, years. Such testing and/or diagnostic tools may also have extended life spans, e.g., the length of time a tool is practically useful and/or commercially viable, as translation between agnostic mobile system data and adapted mobile system data provides for the adapted mobile system data format to change while the agnostic mobile system data remains constant. Similarly, the underlying architecture of a mobile system may change, e.g., engine sensors may be combined and/or split out, without affecting the functionality of tools designed to use agnostic mobile system data. For example, a first version of a car of a particular make, model, and year may store its current road speed in a first memory location that is accessible by a testing and/or diagnostic tool, in accordance with embodiments of the current disclosure. A newer version of the car may then store the current road speed in a second memory location that is different from the first memory location, but which is still assessable via the same testing and/or diagnostic tool, either via an update to the interface device 21318, which may be integrated with the software and/or diagnostic tool or into the car itself. As will be appreciated, however, the software/computer instructions that define the test and/or diagnostic process, however, need not be updated. Put another way, in embodiments, the software/computer instructions that define a test and/or diagnostic process can simply ask for “vehicle current road speed” without regard to the particular memory location and/or format of the vehicle current road speed generated and/or stored by the interrogated vehicle. Similarly, a software engineer can write a test and/or a diagnostic process without having to know the specifics of how a mobile system stores and/or formats a particular property of the mobile system, as the details of translation are handled by embodiments of the mobile interface device, as disclosed herein.

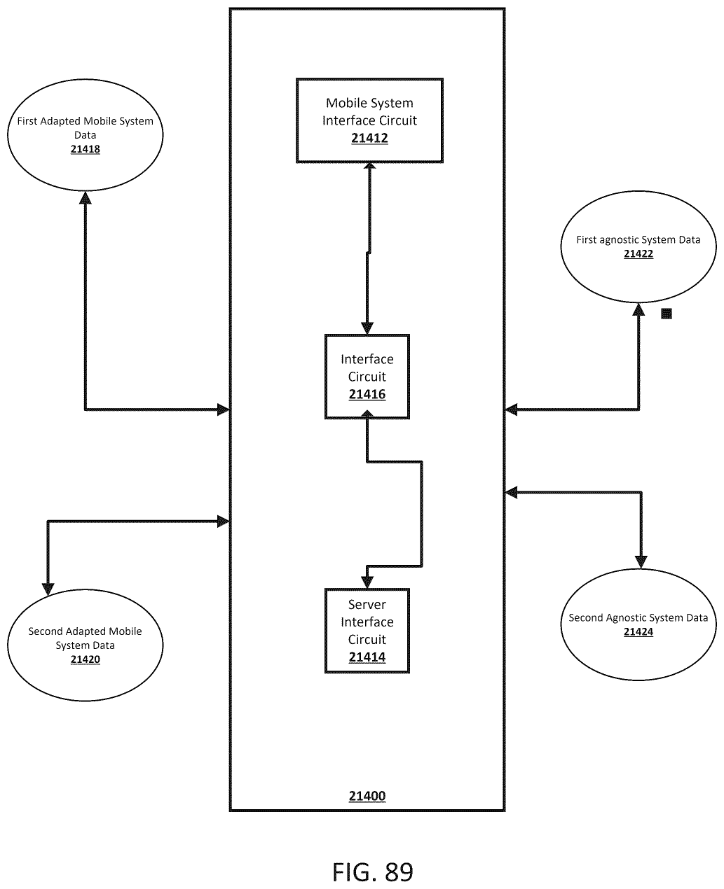

Referring now to FIG. 89, an embodiment of the mobile system interface device 21400, in accordance with the current disclosure, may include a mobile system interface circuit 21412, a server interface circuit 21414, and an interface/translation/converter circuit 21416. The mobile system interface circuit 21412 is structured to interpret first adapted mobile system data 21418 generated by a mobile system 21210 (FIG. 87), and to transmit second adapted mobile system data 21420, e.g., to the mobile system 21210. The first adapted mobile system data 21418 may be data generated by the mobile system 21210 that is intended for use by the server 21212 and/or remote computing device 21216 but which needs to be converted/translated into a format usable by the same, and the second adapted mobile system data 21420 may be a conversion/translation of data generated by the server 21212 and/or remote computing device 21216 and intended for use by the mobile system 21210 and/or a component thereof. For example, the first adapted mobile system data 21418 may be data generated and/or transmitted by the mobile system 21210, and/or one of its components, that includes one or more state values, as that term is disclosed herein, of the mobile system 21210 and/or one or more of its components. As another example, the first adapted mobile system data 21418 may indicate a fuel level of the mobile system 21210 as measured by a sensor of the mobile system 21210, wherein the fuel level is encoded in a format, e.g., liters conveyed by a floating-point value, used by the mobile system 21210 but not necessarily used by other mobile systems, e.g., a system where fuel level is in gallons stored as an integer value. The second adapted mobile system data 21420 may include data, in a format understood by the mobile system 21210 and/or its components, that is structured to configure the mobile system 21210 and/or one or more of its components. For example, the second adapted mobile system data 21420 may include a policy, and/or an updated version thereof, as described herein. The policy may be a data collection policy resulting from a known problem with the mobile system, where the data collection policy is structured to collect data related to one or more components of the mobile system to detect the occurrence of the known problem and/or to detect indications that the known problem may occur. In a non-limiting use case, a particular type of engine may be used in multiple vehicle types having different data collection and/or control systems. It may be discovered that the particular engine is prone to failure after a given number of miles. Embodiments of the current disclosure may provide for a technician working on behalf of the vehicle manufacturer to generate and push a single policy, structured to monitor the engine after a certain milage has been exceeded, to all vehicles having the particular type of engine without regard to the specifics of the various data collection and/or control systems of all of the affected vehicles.

The server interface circuit 21414 is structured to transmit first agnostic mobile system data 21422, e.g., to a server 21212 (FIG. 87), and to interpret second agnostic mobile system data 21424 generated by the server 21212 (FIG. 87). Embodiments of the server interface circuit 21414 may be structured to transmit the first agnostic mobile system data 21422 to a remote computing device, e.g., 21216 (FIG. 87).

The interface circuit 21416 is structured to generate the first agnostic mobile system data 21422 based at least in part on the first adapted mobile system data 21418, and to generate the second adapted mobile system data 21420 based at least in part on the second agnostic mobile system data 21424. In other words, embodiments of the interface circuit 21416 translate/concert agnostic data to adaptive data and vice-versa.

As will be appreciated, embodiments of the interface circuit 21416, as disclosed herein, may provide for a single testing and/or diagnostic tool to interface/work with a wide variety of mobile systems that may each have different underlying architectures and/or data formats. For example, a testing tool may have a test that is coded using agnostic commands, as disclosed herein, e.g., commands that are not specific to the architecture and/or formats used by any particular mobile system, with embodiments of the interface circuit 21416 handling the translation of the agnostic commands to adapted commands, as described herein, e.g., commands that are specific to a particular mobile system architecture and/or data formats, and vice versa. As such, embodiments of the interface circuit 21416 may reduce the cost of developing testing and diagnostic tools for mobile systems. Embodiments of the interface circuit 21416, as described herein, may also reduce the cost of mobile system maintenance and/or mobile system production as repair shops and/or manufacturers need not purchase and/or build individual/specialized testing and/or diagnostic tools for each type of mobile system architecture and/or data formats.

As will be understood, embodiments of the mobile system interface device 21400, as described herein, may be a device apart from the mobile system 21210, server 21212, and/or remote computing device 21216. In such embodiments, the mobile system interface device 21400 may include one or more user interface devices, e.g., electronic displays, keyboard, speakers, etc. for conveying information to and/or receiving input from a user. In embodiments, the mobile system interface device 21400 may be incorporated (fully or partially) into an external device, as described herein, e.g., external device 11424 in FIG. 22. In embodiments, the mobile system interface device 21400 may be incorporated into the mobile system 21210. In embodiments, one or more functions of the mobile system interface device 21400 and the corresponding circuits, e.g., 21412, 21414, 21416, may be incorporated into different devices, e.g., the mobile system 21210, the server 21212, the remote computing device 21216, and/or an external device, as described herein. One non-limiting benefit of incorporating the mobile system interface device 21400 into a mobile system, as described herein, is that the mobile system interface device 21400 may receive any software configurations for translating between agnostic and adapted mobile system data at the time of installation into the mobile system. Another non-limiting benefit of incorporating the mobile system interface device 21400 into a mobile system, as described herein, is that updates to the mobile system interface device 21400, as described herein, may be managed by the vehicle manufacturer who may have better knowledge of the specifics regarding any modification to the architecture and/or used data formats of the mobile system.

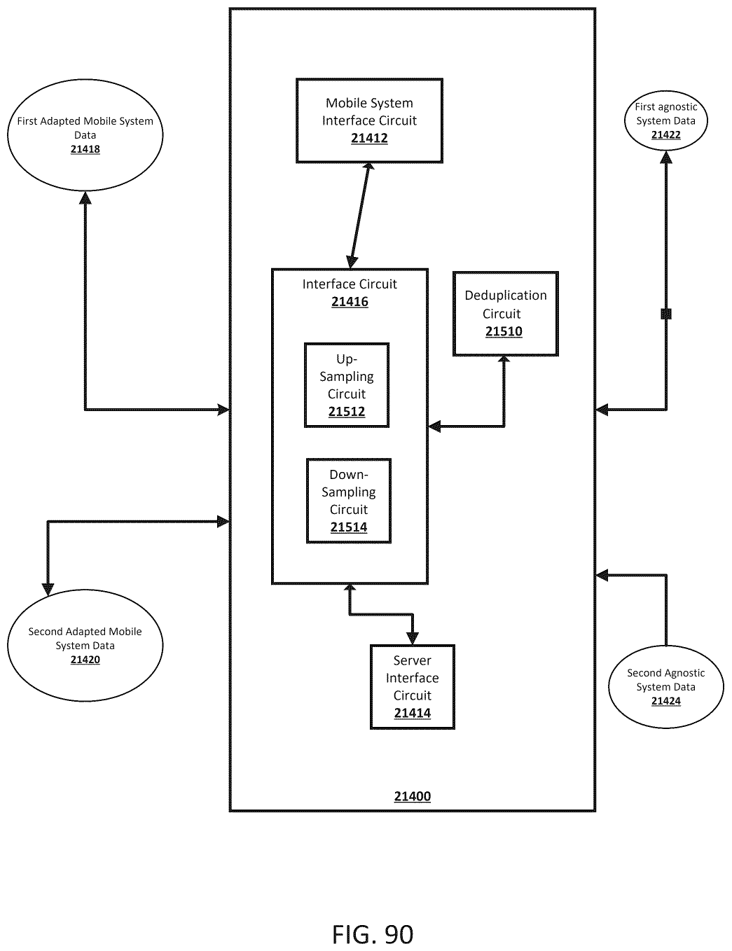

Turning to FIG. 90, in embodiments, the mobile system interface device 21400 may further include a deduplication circuit 21510 that provides for deduplication of commands and/or data requests in the agnostic system data 21422. For example, two distinct remote computing devices may both generate agnostic system data 21422 requesting a same property of the mobile system. The deduplication circuit 21510 may be structured to detect that both remote computing devices are requesting the same property and thus configure the interface circuit to 21416 to generate a single set of adapted mobile system data 21420 that corresponds to the agnostic mobile system data 21422 generated by both remote computing systems. The deduplication circuit 21510 may be further structured to detect when adaptive mobile system data 21418, responsive to the single set of adapted mobile system data 21420, is translated/converted into agnostic mobile system data by the interface circuit 21416 and then configure the server interface circuit 21414 to transmit the agnostic mobile system data to both remote computing devices. As will be understood, deduplication, as described herein, may be between two remote computing devices, two servers, and/or any combination thereof. As will be appreciated, duplication of commands and/or data requests via a deduplication circuit 21510, as disclosed herein, may improve the flow of communication traffic between a mobile system, mobile interface device, backend server, and/or laptop, e.g., a remote computing device, as disclosed herein.

In embodiments, the interface circuit 21416 may include an up-sampling circuit 21512 and/or a down-sampling circuit 21514. The up-sampling circuit may be structured to up-sample mobile system property data within the interpreted adapted mobile system data so that the translated agnostic mobile system data has corresponding mobile system property data at a higher sampling rate than the interpreted adapted mobile system data. Similarly, the down-sampling circuit may be structured to down-sample mobile system property data within the interpreted adapted mobile system data so that the translated agnostic mobile system data has corresponding mobile system property data at a lower sampling rate than the interpreted adapted mobile system data.

In embodiments, the interface circuit 21416 may drop/remove data present in agnostic mobile system data when generating corresponding adaptive mobile system data. For example, agnostic mobile system data may include a high-level request such as “report back vehicle speed”, wherein the corresponding adaptive mobile system data does not include the high-level request “report back vehicle speed” but may include mobile system specific commands to trigger reporting of speed by a mobile system, e.g., “read register 20 of controller ID 245”. Non-limiting examples of data that may be dropped/removed from agnostic mobile system data during the conversion/translation to adapted mobile system data include header fields, representations of commands and/or data fields common across distinct types of mobile systems, network related fields, etc.

In embodiments, the interface circuit 21416 may drop/remove data present in adaptive mobile system data when generating corresponding agnostic mobile system data. For example, a server, e.g., 21212, and/or remote computing device, e.g., 21216, may be structured to receive data for a certain state value from the mobile system at a particular resolution, e.g., one (1) reading a minute, and/or at a particular number of significant figures, e.g., two (2), whereas the mobile system may generate adaptive data corresponding to the state value at a rate of one-hundred (100) readings a minute with each reading having four (4) significant figures. In such a scenario, the interface circuit 21416 may be structured to average one or more of the state values in the adaptive data such that one agnostic data instance of the state value is generated every minute and represents the average of four (4) corresponding adaptive instances of the state value rounded to two (2) significant figures. Embodiments of the interface circuit 21416 may perform other types of data conditioning when converting/translating between adaptive data and agnostic data and/or vice-versa.

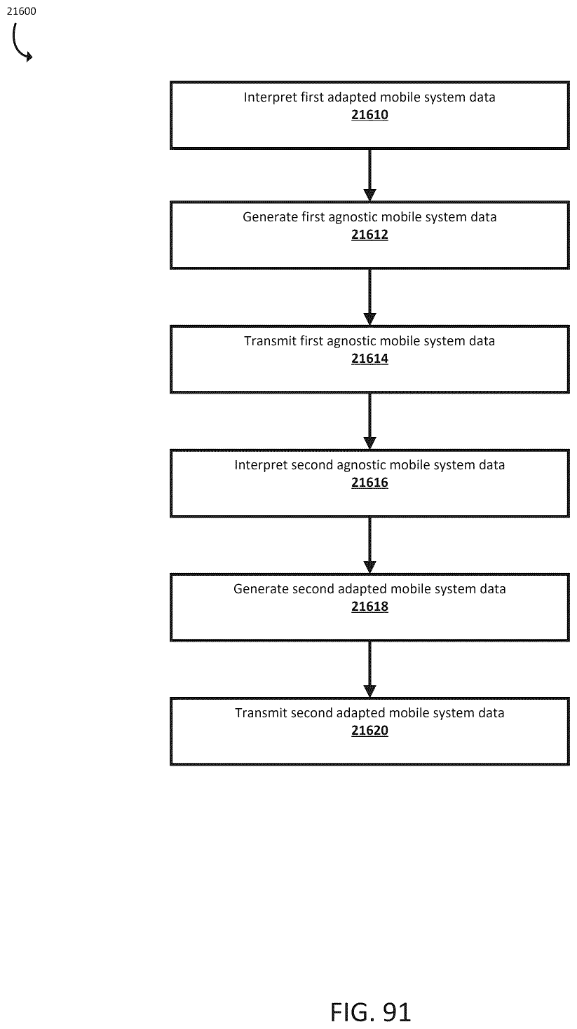

Referring now to FIGS. 89 and 91, a method 21600 for diagnosing and/or testing a mobile system is shown, in accordance with an embodiment of the current disclosure. The method 21600 may be performed, in whole or in part, using the apparatus 21400 of FIG. 89 and/or any other computing device described herein. The method 21600 includes interpreting 21610, via a mobile system interface circuit 21412, first adapted mobile system data 21418. The first adapted mobile system data 21418 may be from and/or generated by a mobile system, in accordance with the current disclosure, e.g., 21210 in FIG. 87. The method 21600 further includes generating 21612, via an interface circuit 21416 and based at least in part on the first adapted mobile system data 21418, first agnostic mobile system data 21422. The method 21600 may further include transmitting 21614, via a server interface circuit 21414, the first agnostic mobile system data 21422. The method 21600 may further include interpreting 21616, via the server interface circuit 21414, second agnostic mobile system data 21424. The method 21600 may further include generating 21618, via the interface circuit 21416 and based at least in part on the second agnostic mobile system data 21424, second adapted mobile system data mobile system data 21420. The method 21600 may further include transmitting 21620, via the mobile system interface circuit 21412, the second adapted mobile system data 21420. As will be appreciated, benefits of the method 21600 include the ability to pass data to and from a mobile system while limiting the number of parties who must know and/or understand the specifics of the mobile system architecture and/or used data formats. For example, in embodiments, only the party charged with updating the mobile system interface device need know the specifics of the mobile system's architecture and/or used data formats. Another benefit of the method 21600 is that embodiments of the mobile system interface device, as disclosed herein, provide for a single testing and/or diagnostic device to interface with, e.g., work with, a wide variety of mobile systems, which in turn may reduce the number of testing and/or diagnostic devices that an entity need to maintain in order to test and/or service a wide variety of mobile systems.

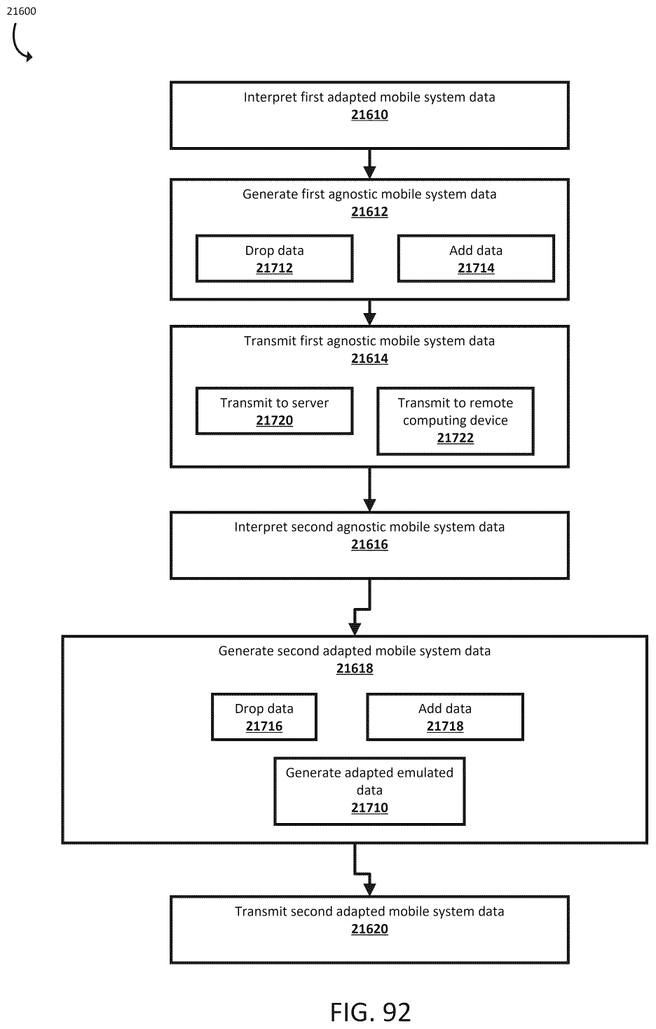

Referring now to FIGS. 90 and 92, generating 21618 the second adapted mobile system data may include generating 21710 adapted emulated data via a mobile system emulation circuit (MSE), as described herein, wherein the second adapted mobile system data 21420 includes the adapted emulated data. In embodiments, generating 21612 the first agnostic mobile system data may include dropping 21712 data from the interpreted first adapted mobile system data. In embodiments, generating 21612 the first agnostic mobile system data may include adding data 21714 to the agnostic mobile system data not present in the interpreted first adapted mobile system data. In embodiments, generating 21618 the second adapted mobile system data may include dropping data 21716, or elements thereof, present in the interpreted second agnostic mobile system data. In embodiments, generating 21618 the second adapted mobile system data may include adding 21718 data not present in the interpreted second agnostic mobile system data. One non-limiting benefit of generating adapted emulated data includes the ability to pool data from multiple sources into a single property, e.g., a mobile system may have a plurality of sensors that measure the speed of various engine components each having a different radius and/or rotation per minute (RPM), where embodiments of the mobile system interface device, as disclosed herein, may combine the plurality of readings into a single engine parameter property. A non-limiting benefit of generating adapted emulated data and/or dropping data includes the ability of some embodiments of the mobile system interface device, as disclosed herein, to match a data rate and/or resolution expected by either the mobile system and/or another device communicating with the mobile system via the mobile system interface device. Embodiments of the current disclosure may provide for a resolution reduction (e.g., 2-bit data instead of 4-bit data), and/or an obfuscating resolution reduction (e.g., rounded data, filtered data, etc.—for example to hide dynamics in the data that may reveal proprietary information, and/or are not needed, and/or are not available, to the requesting source). For example, engine speed may be: reduced resolution (e.g., to save network bandwidth, storage, and/or to provide responsive data for an older system that does not have the same parameter resolution as the requesting entity); rounded (e.g., nearest 10 RPM rather than the actual value); filtered (e.g., passed through a low-pass filter to hide dynamics and/or to reduce dynamics available such as providing with a 100-ms time constant, where the underlying data may have a 10-ms base sampling rate).

In embodiments, transmitting 21614 the first agnostic mobile system data may include transmitting 21720 the first agnostic mobile system data to a server, e.g., 21212 (FIG. 87) and/or transmitting 21722 the first agnostic mobile system data to a remote computing device, e.g., 21216 (FIG. 87).

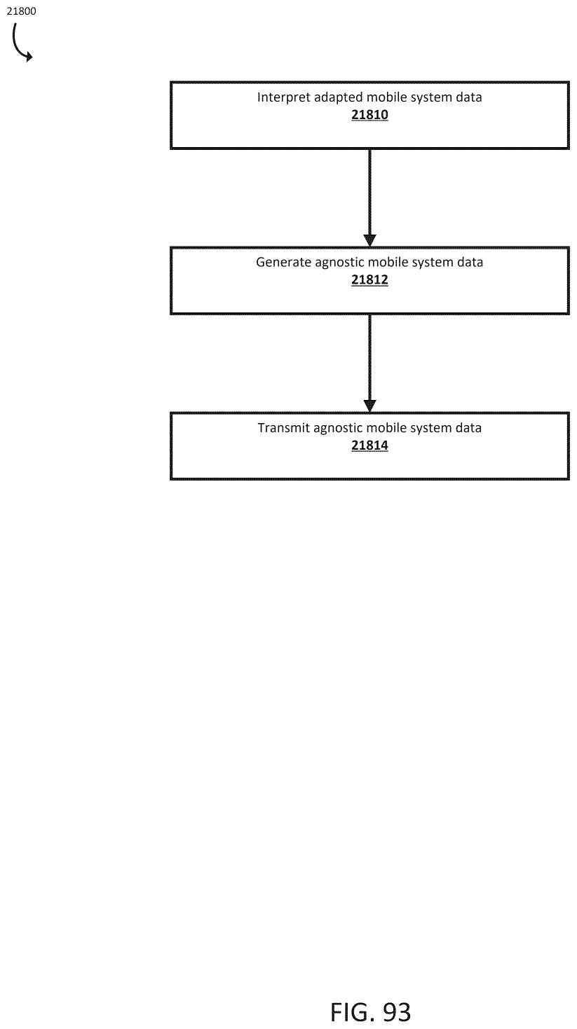

Referring now to FIGS. 89 and 93, another method 21800 for diagnosing and/or testing a mobile system is shown, in accordance with an embodiment of the current disclosure. The method 21800 includes interpreting 21810, via a mobile system interface circuit 21412, adapted mobile system data 21418. The method 21800 further includes generating 21812, via an interface circuit 21416 and based at least in part on the adapted mobile system data 21418, agnostic mobile system data 21424. The method 21800 further includes transmitting 21814, via a server interface circuit 21414, the agnostic mobile system data 21424. As will be appreciated, one non-limiting benefit of embodiments of the mobile system interface circuit 21412 is the ability to translate adapted mobile system data and transmit it to one or more recipients as agnostic mobile system data so that the one or more recipients do not need to know the specific data formats and/or protocols used by the mobile system. For example, a remote vehicle technician may be interested in whether an electric vehicle has enough power to move itself thirty miles. The vehicle may only have sensors that report total voltage of its primary battery and the system interface circuit 21412 may translate the voltage into a distance which it then transmits to the remote technician.

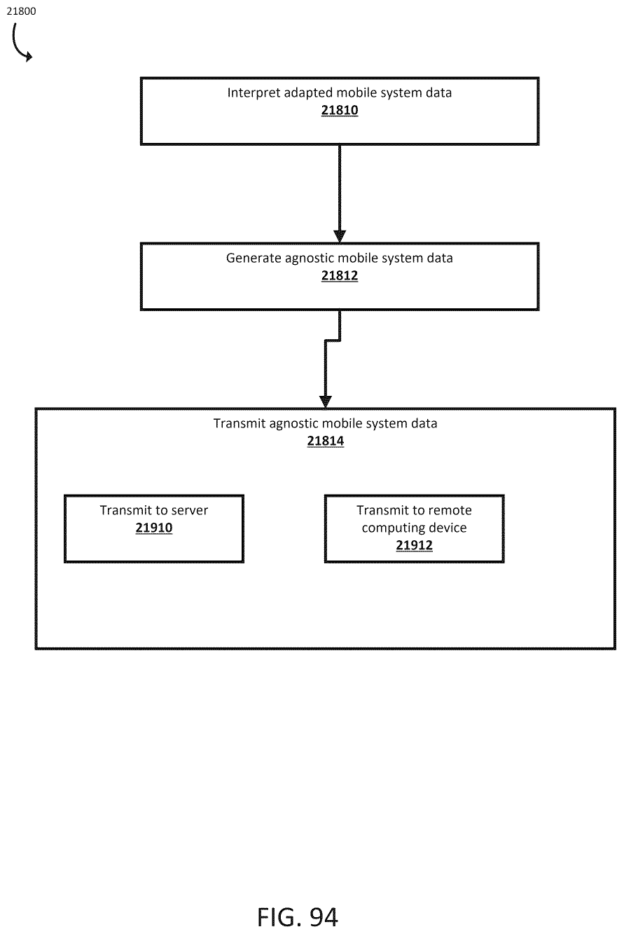

Referring now to FIGS. 89 and 94, transmitting 21814 the agnostic mobile system data 21424 may include transmitting 21910 the agnostic mobile system data 21424 to a server, e.g., 21212 (FIG. 87) and/or transmitting 21912 the agnostic mobile system data 21422 to a remote computing device, e.g., 21216.

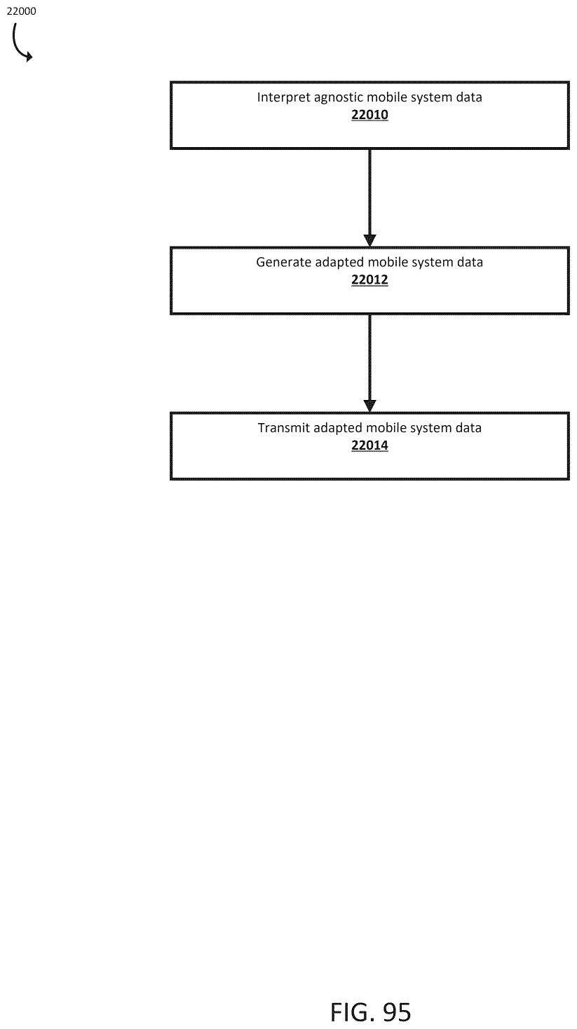

Referring to FIGS. 89 and 95, another method 22000 for diagnosing and/or testing a mobile system is shown, in accordance with an embodiment of the current disclosure. The method 22000 includes interpreting 22010, via a server interface circuit 21414, agnostic mobile system data 21422. The method 22000 further includes generating 22012, via an interface circuit 21416 and based at least in part on the agnostic mobile system data 21422, adapted mobile system data 21420. The method 22000 further includes transmitting 22014, via a mobile system interface circuit 21412, the adapted mobile system data 21420.

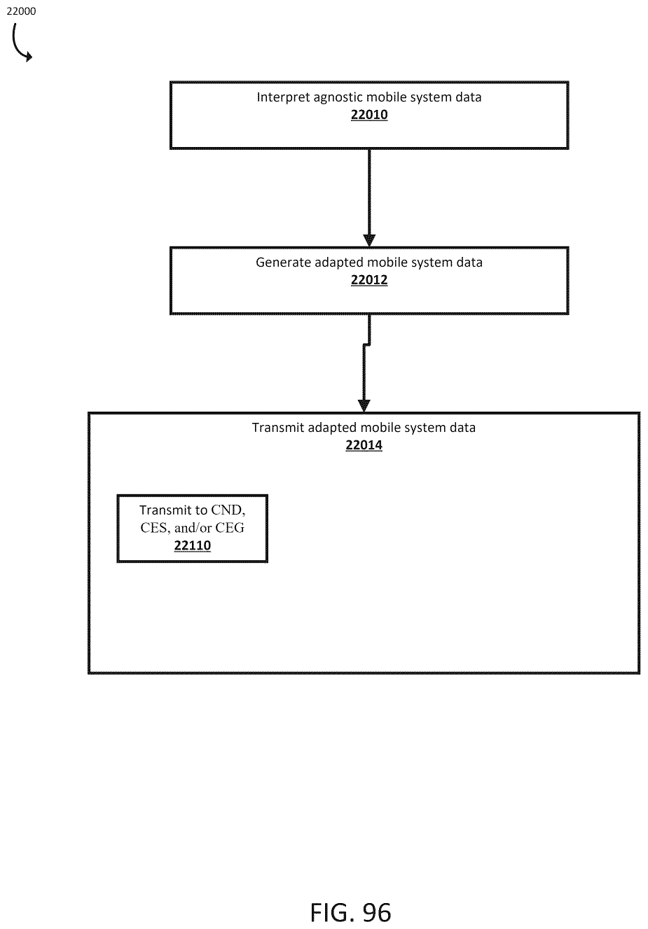

Referring to FIGS. 89 and 96, transmitting 22014 the adapted mobile system data 21420 may include transmitting 22110 the adapted mobile system data 21420 to a CND, CES, and/or CEG.

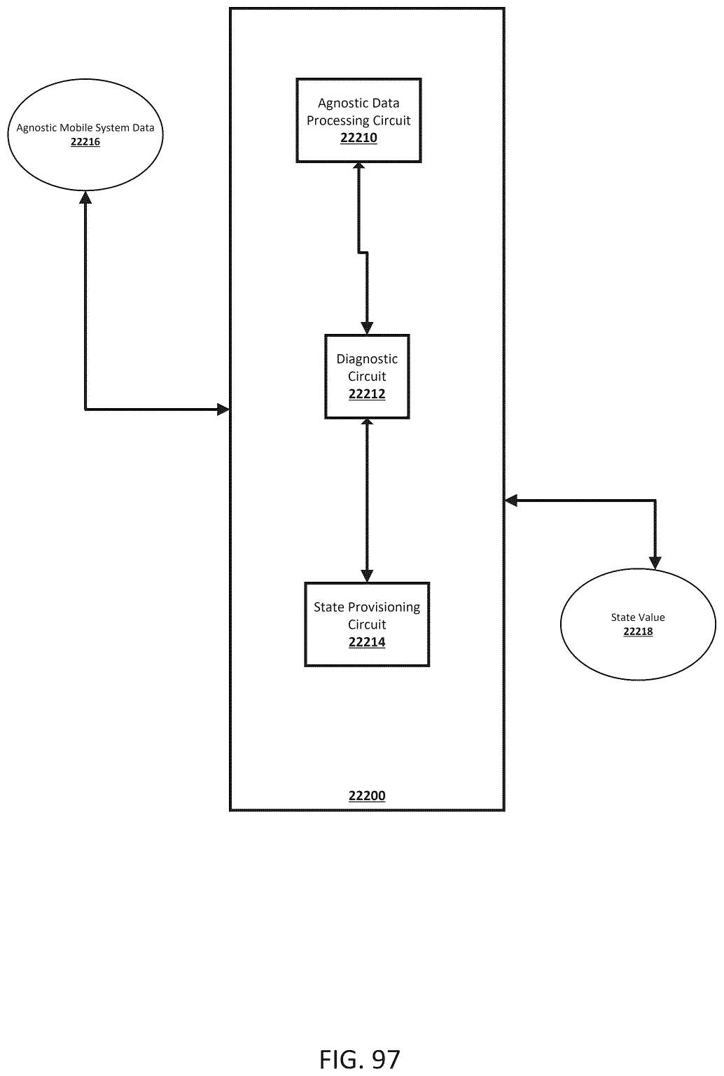

Illustrated in FIG. 97 is an apparatus 22200 for diagnosing a mobile system 21210 (FIG. 87), in accordance with an embodiment of the current disclosure. Embodiments of the apparatus 22200 may be incorporated, in whole or in part, into the server 21212, mobile system interface device 21214, remote computing device, 21216, the mobile system 21210, and/or any other computing device described herein. Accordingly, the apparatus 22200 may include an agnostic data processing circuit 22210, a diagnostic circuit 22212, and/or a state provisioning circuit 22214. The agnostic data processing circuit 22210 is structured to interpret agnostic mobile system data 22216 corresponding to diagnostic data from the mobile system 21210 (FIG. 87). The diagnostic circuit 22212 is structured to determine, based at least in part on the agnostic mobile system data 22216, a state value 22218 of the mobile system 21210 and/or components thereof. The state provisioning circuit 22214 is structured to transmit the state value 22218. In embodiments, the state provisioning circuit 22214 may be structured to transmit the state value 22218 to a mobile system interface device, e.g., 21214 (FIG. 87), a remote computing device, e.g., 21216 (FIG. 87), and/or to the mobile system, e.g., 21210 (FIG. 87). One non-limiting benefit of the apparatus 22200 is the ability of its circuits to determine a status, e.g., the state value 22218, of a mobile system without the need/use of knowledge of the specific architecture and/or data formats used by the mobile system 21210. For example, the apparatus 22200 may be able to determine that the mobile system's engine is disabled because the agnostic mobile system data 22216 is showing that the engine is not generating any RPMs, where the sensors on the mobile system may output combustion cycles per second, e.g., a mobile interface device, as described herein, may have translated the combustion cycles per second to RPMs. By analyzing agnostic mobile system data, however, embodiments of the apparatus 22200 can be used to diagnose a wide variety of vehicles as long as they generate adapted mobile system data that can be translated by a mobile system interface circuit, as described herein, to RPMS. While the foregoing example uses combustion cycles per second and RPMs, it is to be understood that other types of mobile system parameters and/or diagnostic data, as disclosed herein, are contemplated.

Nonlimiting examples of such diagnostic data may include: physical properties, e.g., a temperature, a pressure, a voltage, an amperage, etc., of a component of the mobile system; a status and/or state, e.g., open, closed, expected remaining life expectancy, etc. In embodiments, the diagnostic data may include state values, as described herein, for one or more other components and/or subcomponents, which the diagnostic processing circuit may uses to determine the state value 22218, wherein the state value 22218 corresponds to the mobile system 21210, as a whole, and/or another component of the mobile system 21210 distinct from those corresponding to the one or more state values in the diagnostic data. In embodiments, the apparatus 22200, in whole or in part, may be integrated into the server 21212 (FIG. 87), remote computing device 21216 (FIG. 87), mobile system interface device 21214 (FIG. 87), and/or any other computing device described herein. As will be understood, the state value 22218 may be for an engine system, a driving system, a fuel system, an infotainment system, and/or any other type of state value described herein. In embodiments, the state provisioning circuit 22214 may be further structured to transmit the state value to the server 21212 (FIG. 87), the remote computing device 21216, and/or any other computing device described herein.

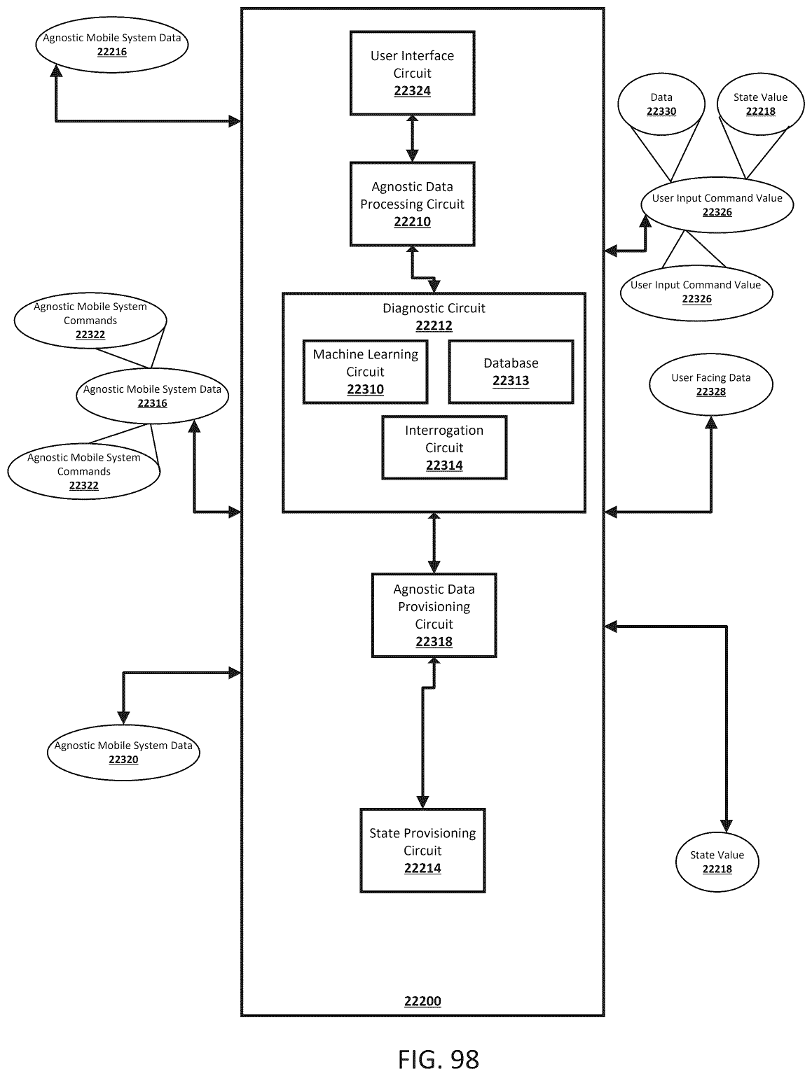

Turning to FIG. 98, in embodiments, the diagnostic circuit 22212 may include a machine learning circuit 22310 structured to determine the state value 22218. In embodiments, the machine learning circuit 22310 may provide for one or more neural networks and/or other weight training-based learning system. The apparatus 22200 may include a database 22313 that stores relationships of state values to known conditions of one or more mobile systems corresponding to the interpreted agnostic mobile system data 22216. In embodiments, the machine learning circuit 22310 may train and/or retrain on the data stored in the database 22313. In embodiments, training the machine learning circuit 22310 may include adjusting one or more weighted values and/or connections between neurons and/or layers of neurons. In embodiments, the objective of such training may be to adjust the weights of the neurons and/or connections between layers of neurons so that the neural network can accurately predict and/or determine the state value 22218 based on the interpreted agnostic mobile system data 22216. On non-limiting benefit of the machine learning circuit 22310 is that it may be able to detect patterns in agnostic mobile system data not practically achievable by a human mind. For example, the machine learning circuit 22310 may need to make and/or assist in making a diagnosis of the state of a mobile system within a few minutes, hours, and/or days, whereas a human mind, to the extent it could make such a diagnosis, would take weeks, months, and/or years to do the same. In other words, a user of a mobile system experiencing a problem cannot wait weeks or years for a human mind to determine a state value of the mobile system, if it is even able to do so at all. Further embodiments of the diagnostic circuit 22212 may be able to determine state values for multiple mobile systems at the same time.

Embodiments of the apparatus 22200 may provide for active diagnostics of a mobile system, e.g., 21210 in FIG. 87. Non-limiting examples of active diagnostics of a mobile system include analysis of diagnostic data corresponding to the mobile system and determining, in real time or near-real time, if additional diagnostic data corresponding to the mobile system would be beneficial and/or advantageous to determining the state value 22218, and obtaining such additional diagnostic data. For example, interpreted agnostic mobile system data 22216 corresponding to an exhaust system may have a higher-than-expected pollutant content which, in turn, may warrant inspection of data corresponding to an engine fuel controller which could reveal that the fuel controller is malfunctioning and/or requires maintenance, e.g., a software update. Accordingly, the diagnostic circuit 22212 may include an interrogation circuit 22314 structured to determine, in response to interpretation of the agnostic mobile system data 22216, additional data to be collected from the mobile system 21210 and, in turn, generate additional agnostic mobile system data 22316 structured to procure the additional data from the mobile system. One non-limiting benefit of providing active diagnostics is the ability to assist a user of a mobile system in real-time, or near real-time, so that the mobile system does not need to be transported to a service center before diagnostics can begin. In some instances, active diagnostics, as disclosed herein, provided by embodiments of the apparatus 22200 may completely alleviate the need to bring the mobile system to a service center for a particular problem. As will be understood, alleviated the need to go to a service center may reduce the amount of time the mobile system is out of commission and/or otherwise not operating in an optimal manner. In other words, a car owner may not need to wait weeks for an overloaded mechanic shop to determine why the car's brake light keeps coming on.

The apparatus 22200 may further include an agnostic data provisioning circuit 22318 structured to transmit the additional agnostic mobile system data 22316. In embodiments, the agnostic data provisioning circuit 22318 may be structured to transmit the additional agnostic mobile system data 22316 to a mobile interface device, e.g., 21214 (FIG. 87) for conversion to adapted mobile system data. The additional agnostic mobile system data 22316 may include one or more agnostic commands 22322 structured to trigger the generation of yet further additional agnostic mobile system data 22320 from the mobile system, e.g., 21210 (FIG. 87) which may be interpreted by the agnostic data processing circuit 22210. In embodiments, the interrogation circuit 22314 my use machine learning and/or lookup tables to determine what additional data should be collected from the mobile system. A non-limiting lookup table may map known values (and/or ranges) of properties of the mobile system (and/or components thereof) to types of additional data to be requested from the mobile system.

In embodiments, the apparatus 22200 provide for a user/technician to request data from the mobile system, e.g., via the remote computing device 21216 (FIG. 87). For example, the apparatus 22200 may further include a user interface circuit 22324 structured to interpret one or more user input command values 22326, and the diagnostic circuit 22212 may be further structured to generate the additional agnostic mobile system data 22316 based at least in part on the one or more user input command values 22326. In embodiments, the user interface circuit 22324 may be further structured to generate and transmit user facing data 22328 structured to display the agnostic mobile system data 22216, state value 22218, and/or data 22330 based at least in part on the agnostic mobile system data 22216 and/or the state value 22218, on a graphical user interface, e.g., an application executing on a remote computing device 21216 (FIG. 87).

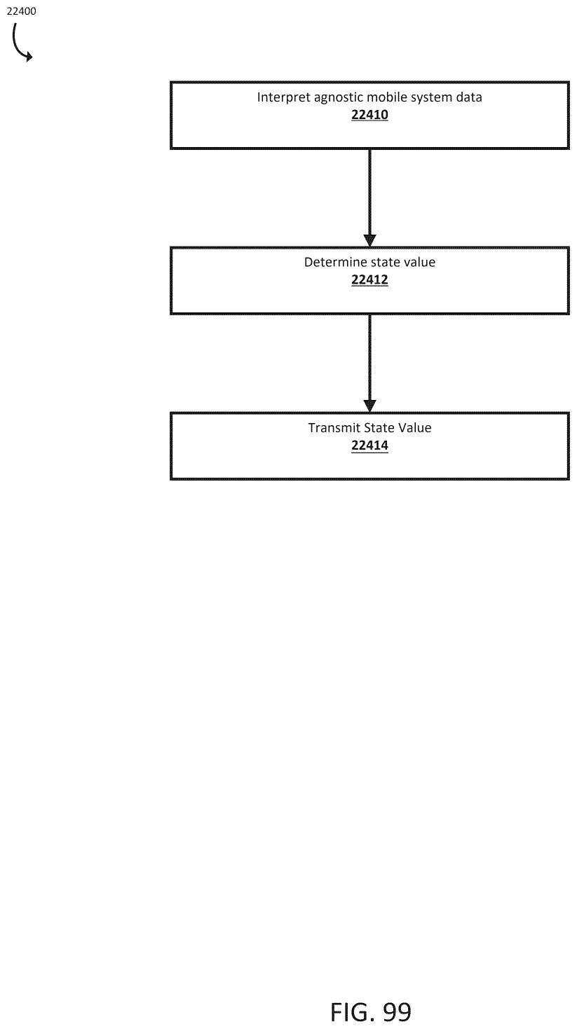

Referring now to FIGS. 97 and 99 a method 22400 for diagnosing a mobile system 21210 (FIG. 87), in accordance with an embodiment of the current disclosure, is shown. The method 22400 may be performed by the apparatus 22200 and/or any other computing device described herein. The method 22400 includes interpreting 22410, via an agnostic data processing circuit 22210, agnostic mobile system data 22216 corresponding to diagnostic data from a mobile system 21210 (FIG. 87). The method 22400 further includes determining 22412, via a diagnostic circuit and based at least in part on the agnostic mobile system data 22216, a state value 22218 of the mobile system 21210. The method 22400 further includes transmitting 222414, via a state provisioning circuit 22214, the state value 22218. One non-limiting benefit of diagnosing the mobile system via agnostic mobile system data is that the processes used to determine the state value of the mobile system may be used across a wide variety of mobile systems without the need for knowledge of the specific architecture and/or data formats used by various mobile systems.

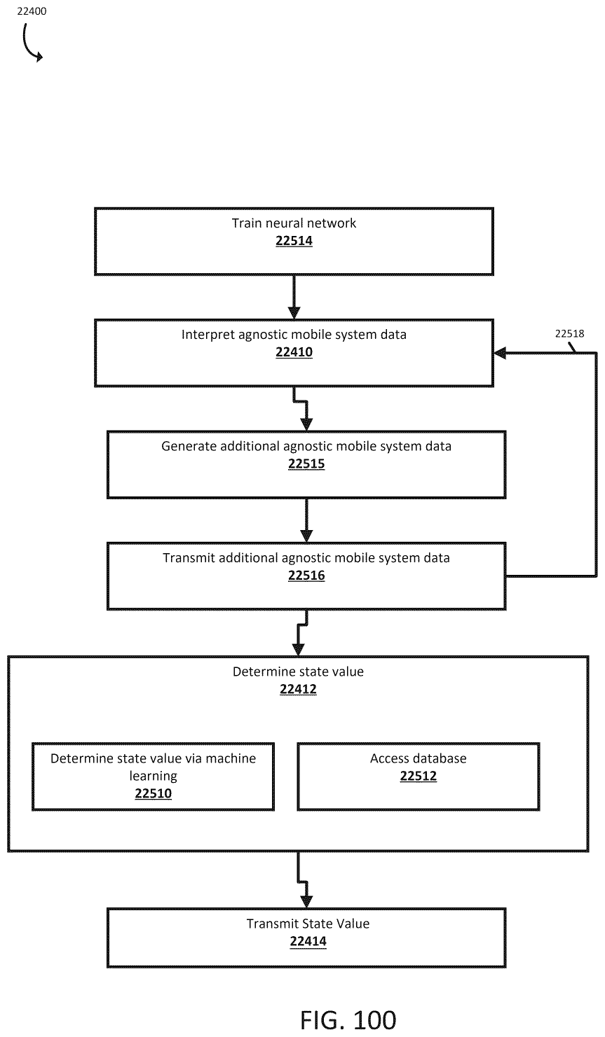

Referring now to FIGS. 98 and 100, in embodiments, determining 22412 the state value may include determining 22510 the sate value via machine learning. In embodiments, determining 22412 the state value may include accessing 22512 a database that stores relationships between state values and known conditions of one or more mobile systems. In embodiments, the method 22400 may further include training 22514 a neural network to determine a state value based at least in part on interpreted agnostic mobile system data. In embodiments, the method 22400 may include generating 22515, via an interrogation circuit 22314, additional agnostic mobile system data 22316, and transmitting 22516, via an agnostic data provisioning circuit 22318, the additional agnostic mobile system data 22316. In embodiments, the method 22400 may further interpreting yet further additional agnostic mobile system data, as represented by path 22518. Determining 22412 the state value may, in turn, be based on the totality of the agnostic mobile system data interpreted. As will be appreciated, some non-limiting benefits of using machine learning to determine a state value for a mobile system include doing so in a manner faster than is practically achievable via a human mind (to the extent a human mind is even capable of the same), as disclosed herein, and/or being able to detect patterns in the agnostic mobile system data not practically detected by a human mind (to the extent a human mind is even capable of the same). In other words, to the extent a human mind is capable of diagnosing a mobile system using agnostic mobile system data, such a diagnosis would take far longer than a user of the mobile system can afford to wait. Embodiments of the machine learning, as disclosed herein, are capable of detecting patterns in the agnostic mobile system data that are undetectable by a human mind.

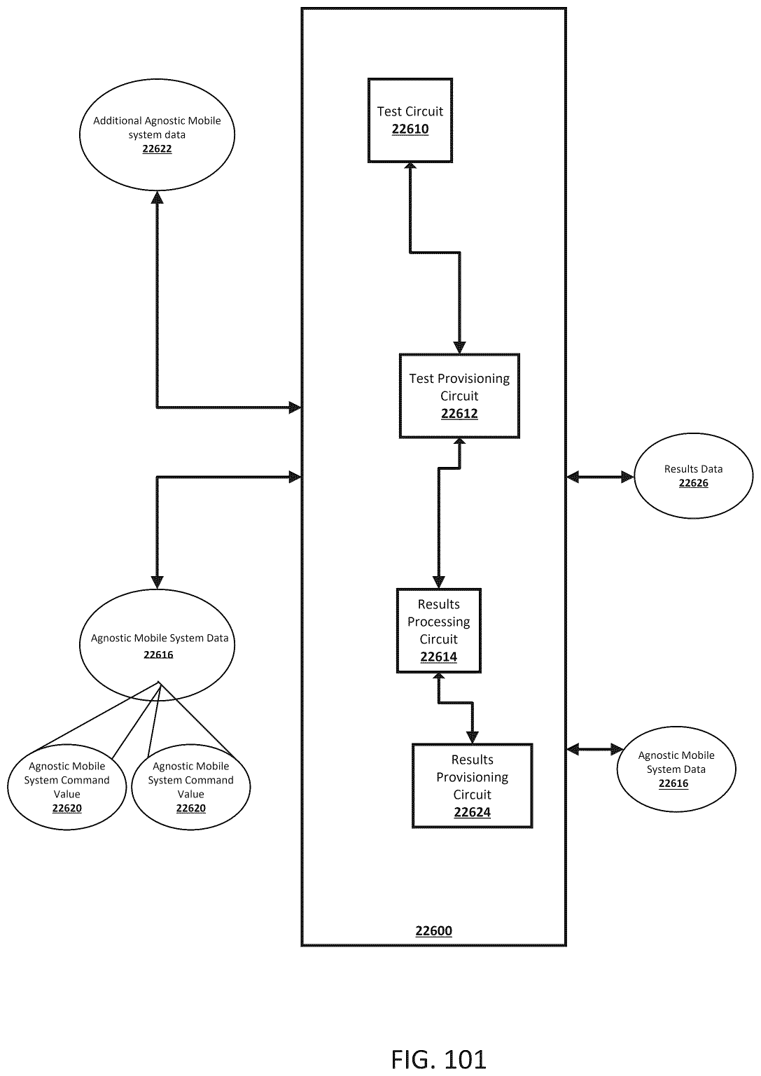

Illustrated in FIG. 101 is an apparatus 22600 for testing a mobile system 21210 (FIG. 87), in accordance with an embodiment of the current disclosure, that includes a test circuit 22610, a test provisioning circuit 22612, and a result processing circuit 22614. The test circuit 22610 is structured to generate agnostic mobile system data 22616 structured to execute a test of the mobile system 21210. The agnostic mobile system data 22616 may include one or more agnostic mobile system command values 22620 structured to execute a test of one or more components of the mobile system 21210. The test provisioning circuit 22612 is structured to transmit the agnostic mobile system data 22616. The results processing circuit 22614 is structured to interpret additional agnostic mobile system data 22622 which may have been generated in response to execution of the test of the one or more components of the mobile system. Non-limiting examples of agnostic mobile system command values 22620 may be for an engine system, a driving system, an electrical system, an infotainment system, and/or other types of systems forming part of a mobile system. Non-limiting examples of agnostic mobile system command values 22620 may include, without limitation: providing a sequence of actuator commands to be performed (e.g., lighting sequence, window position sequence, seat position sequence, etc.); providing a sequence of powertrain commands to be performed (e.g., fueling values, gear shift values, torque target values, etc.); providing a sequence of environmental commands to be performed (e.g., an HVAC system command, an infotainment system command, etc.); providing a sequence of set points and/or set point adjustments to be performed (e.g., cruise speed set point, cabin temperature set point, following distance set point, etc., where the set points can relate to any control algorithm, and which may include set points that are accessible to the operator, or set points that are not accessible to the operator); and/or a trajectory of any of these. In certain embodiments, commands may be performed for a specified period, for a specified number of times, during a specified number of trips, etc. In certain embodiments, one or more aspects of a command sequence may be passive commands—for example a command to shift from 2^{nd} gear to 3^{rd} gear at a vehicle speed exceeding 25 mph may be implemented as an active command (e.g., commands to the powertrain to execute that shift at that speed), as a passive command (e.g., observing vehicle operations, and when that shift occurs at that speed, consider those operations to be an execution of the test and take subsequent action, such as capturing selected data, potentially including data from before the execution of the test, such as capturing data from a rolling buffer), and/or as a mixed command (e.g., commanding the shift from 2^{nd} to 3^{rd} gear at a different time than in base shifting controls, for example when other elements of the test are already present—for example when the vehicle speed exceeds 25 mph and the vehicle is accelerating). It will be understood that a diagnostic or test may be implemented in any manner, and the description of test aspects as an active command, a passive command, or a mixed command, are for clarity of the present description to implement certain capabilities of embodiments herein. In embodiments, the apparatus 22600 may further include a results provisioning circuit 22624 structured to transmit the interpreted agnostic mobile system data 22622. In embodiments, the test results processing circuit 22614 may be further structured to analyze the interpreted agnostic mobile system data 22622 and generate results data 22626 which may be transmitted by the results provisioning circuit 22624. In embodiments, the results provisioning circuit 22624 may be structured to transmit interpreted agnostic mobile system data 22622 and/or results data 22626 to a remote computing device 21216 (FIG. 87), a mobile interface device 21214 (FIG. 87), the mobile system 21210 (FIG. 87), and/or a server 21212 (FIG. 87). Referring to FIGS. 89 and 101, a non-limiting use case involving apparatus 22600 may include a scenario where a technician on a vehicle assembly line uses a mobile system interface device, e.g., apparatus 21400 to test vehicle components during assembly of the vehicle. For example, responsive to establishing a connection between a vehicle component and the mobile system interface device via the mobile system interface circuit 21412, the mobile system interface device may establish a communication link with a server, e.g., apparatus 22600, via the server interface circuit 21414. Agnostic data defining a test may then be generated by the apparatus 22600 and transmitted to the mobile system interface device, as described herein. The mobile system interface device may then translate/convert the agnostic data to adapted data that is transmitted to the vehicle component via the mobile system interface circuit 21412. The adapted mobile system interface data may then cause a test of the vehicle component to be performed with adapted mobile system data generated in accordance with the test being sent back to the mobile system interface device, where it may be interpreted by the mobile system interface circuit, converted to agnostic data, and transmitted to the server, e.g., apparatus 22600, via the server interface circuit 21414. The server, e.g., apparatus 22600, may then process the received agnostic data, corresponding to the results of the test, and send results data back to the mobile system interface device for viewing by the technician. In embodiments, the apparatus 22600 may be used to generate a test of a data collection policy, as disclosed herein, wherein the policy is generated as agnostic data, and converted/translated to adapted data, which is loaded into a mobile system and/or one or more of its components. The mobile system may then be evaluated to see if it generates adapted data in accordance with what is expected with the test.

One non-limiting benefit of using apparatus 22600 to generate tests includes doing so in agnostic mobile system data so that the same test can be executed against various mobile systems having different architectures and/or different data formats. As will be appreciated, such reusability of a single test may provide for efficiencies in testing and/or reduction in costs as fewer tests need to be designed and can be executed by a fewer number of devices than is traditionally possible.

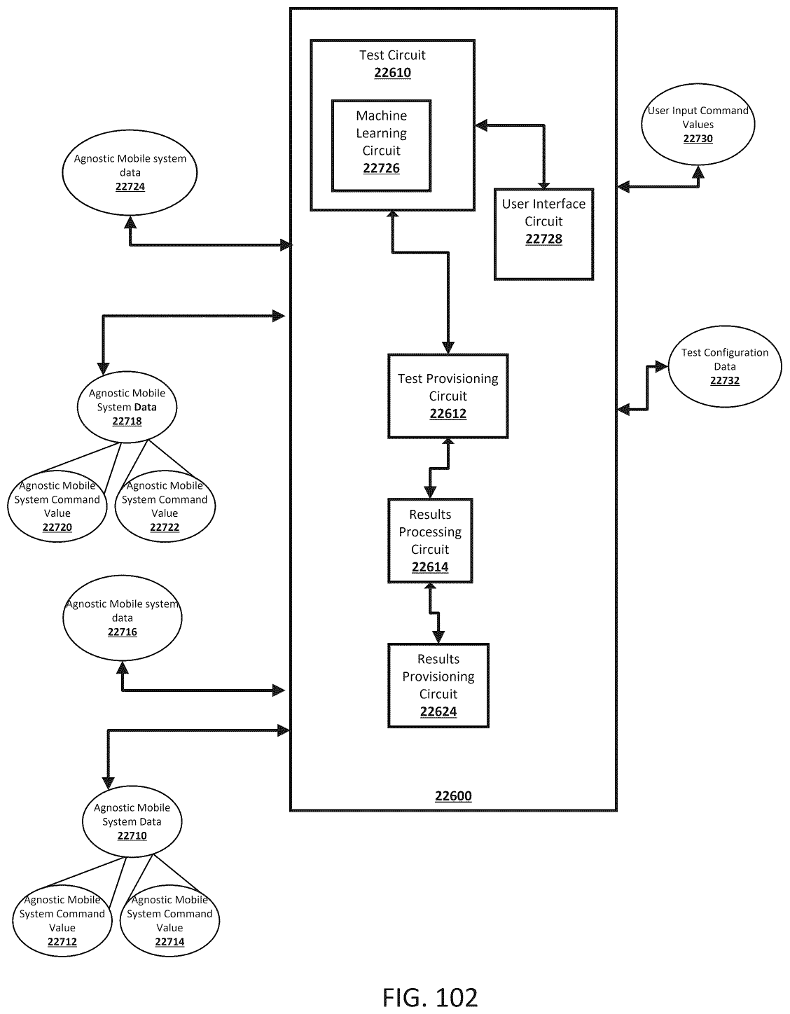

Turning to FIG. 102, embodiments of the apparatus 22600 may provide for active testing of a mobile system e.g., 21210 (FIG. 87) and/or components thereof. For example, the test circuit 22610 may be structured to generate first agnostic mobile system data 22710 corresponding to a first set of one or more agnostic commands 22712, 22714, wherein the test provisioning circuit 22612 transmits the first agnostic mobile system data 22710, e.g., to a mobile system interface device 21214 (FIG. 87), for conversion to adapted mobile system data having one or more adapted commands corresponding to the one or more agnostic commands 22712, 22714 so as to trigger the generation and/or transmission of second agnostic mobile system data 22716, e.g., the one or more agnostic commands 22712, 22714 of the first agnostic mobile system data 22710 may correspond to one or more requests for property value(s) for the mobile system, and/or components thereof. The one or more agnostic commands 22712, 22714 of the first agnostic mobile system data 22710 may correspond to tests of the mobile system and/or components thereof.

In embodiments, the results processing circuit 22614 may be further structured to interpret the second agnostic mobile system data 22716, and the test circuit 22610 may be further structured to generate, based at least in part on the interpreted second agnostic mobile system data 22716, third agnostic mobile system data 22718 that may include one or more additional agnostic commands 22720, 22722. The test provisioning circuit 22612 may then transmit the third agnostic mobile system data 22718, e.g., to a mobile system interface device 21214 (FIG. 87), for conversion to adapted mobile system data having one or more adapted commands corresponding to the one or more agnostic commands 22720, 22722 so as to trigger the generation and/or transmission of fourth agnostic mobile system data 22724, e.g., the one or more agnostic commands 22720, 22722 of the third agnostic mobile system data 22718 may correspond to one or more requests for property value(s) for the mobile system, and/or components thereof. The results processing circuit 22614 may interpret the fourth agnostic mobile system data 22724 and the test circuit 22610 may determine if further agnostic data should be transmitted, e.g., to the mobile system.

In embodiments, the test circuit 22610 may include a machine learning circuit 22726 structured to analyze the interpreted agnostic mobile system data and to determine whether additional agnostic data should be generated and transmitted.

In embodiments, the apparatus 22600 may include a user interface circuit 22728 structured to interpret user input command values 22730 and/or transmit test configuration data 22732. User input command values 22730 may include data defining one or more test parameters for a test corresponding to the one or more agnostic mobile system command values 22712, 22714, 22720, 22722. Such test parameters may include any parameter available on the vehicle, including at least: vehicle performance parameters (e.g., vehicle speed, power, fuel, charge level, etc.); set points for flows on the vehicle (e.g., cruise control speed, vehicle cabin temperature target, etc.); any actuator position and/or feedback value; any sensor value (e.g., the sensor data) and/or feedback value (e.g., any sensor status data); any parameter provided on the network by an end point, and/or available to be provided on the network, including service oriented architecture parameters that are published, and/or parameters on an end point that are not published; meta parameters such as network performance parameters, data storage parameters, end point status parameters, etc.; intermediate parameters such as parameters used in a flow (e.g., error values for a controller, state values for a control flow, and/or any parameter determined by an end point that is not normally published to a network); and/or any parameter that can be calculated by one of these and/or a combination of these. In certain embodiments, available test parameters may be provided to a user interface, including limiting the available test parameters according to user permissions (e.g., according to the user role, information associated with the user login or account, and/or according to an entity associated with the user), limiting parameters according to user selections (e.g., the user requests powertrain related parameters), and/or limiting parameters according to user preferences (e.g., the user requests hardware parameters, such as raw sensor values, and/or processed parameters such as a calculated temperature that may be based on sensed parameters, operations of a virtual sensor, or the like). Test configuration data 22732 may include data reflecting one or more test parameters for a test corresponding to the one or more agnostic mobile system command values 22712, 22714, 22720, 22722, and/or data indicating options for configuring the test. Non-limiting examples of test configuration data 22732 include parameters associated with test initiation, test continuity (e.g., where the test may be paused, terminated, continued, etc., based on the test configuration data 22732 or aspects thereof), test stage transitions, or the like. In certain embodiments, test parameters and/or test configuration data may be translated for the user into a terminology that allows for configuration of the test without requiring knowledge of the user for the specific configuration of the vehicle, including for example, one or more of: components installed and/or versions thereof (e.g., which part number for an ambient temperature sensor); connectivity of end points to a network (e.g., network address, which network zone the end point is coupled to, distribution of parameters across end points, etc.); which type of network an end point is coupled to and/or the parameter is available on; and/or a configuration of the parameter (e.g., parameter name, units, sampling rate, network message packaging, etc.).

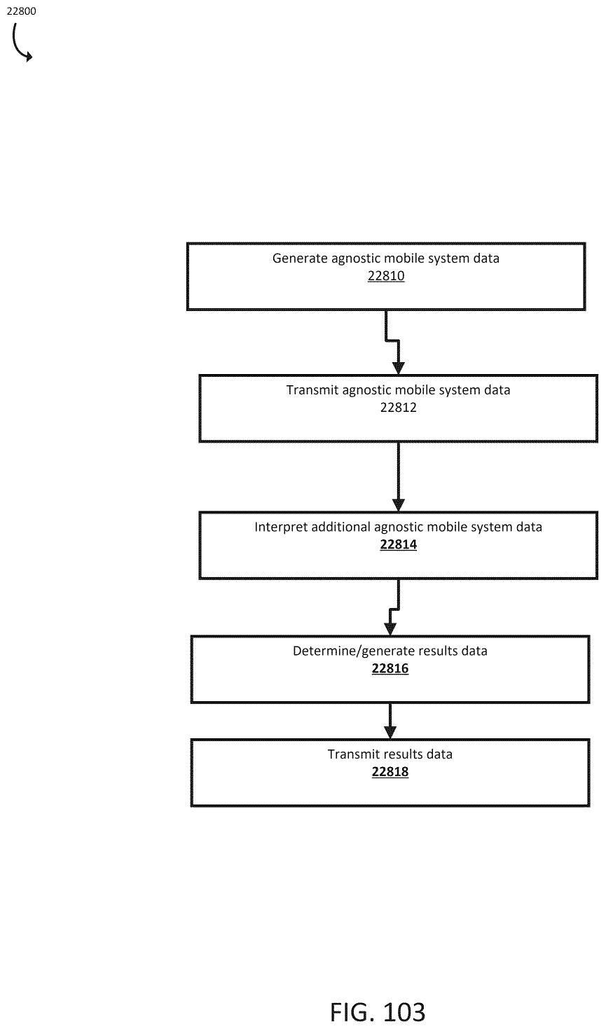

Referring now to FIGS. 101 and 103, a method 22800 for testing a mobile system, e.g., vehicle 102 (FIG. 1), in accordance with an embodiment of the current disclosure, is shown. The method 22800 may be performed via the apparatus 22600 and/or by any other computing device disclosed herein. The method 22800 includes generating 22810, via a test circuit 22610, agnostic mobile system data 22616. The agnostic mobile system data 22616 may include one or more agnostic mobile system command values 22620 structured to execute a test of one or more components of the mobile system 21210. The method 22800 further includes transmitting 22812, via a test provisioning circuit 22612, the agnostic mobile system data 22616. The method 22800 further includes interpreting 22814, via a result processing circuit 22614, additional agnostic mobile system data 22622 that may have been generated in response to executing the test of the one or more components of the mobile system 21210. In embodiments, the method may include determining/generating 22816 results data from the interpreted additional agnostic mobile system data and transmitting 22818 the results data. As will be understood, embodiments of the current disclosure may provide for a safety check of the mobile system prior to sending command values to the mobile system that may be structured to actuate one or more components thereof. In other words, embodiments of the current disclosure may verify that the mobile system is in a condition acceptable to safely conduct active testing of the mobile system and/or components thereof. The safety check may include verification that the mobile system, and/or its components, has a temperature in a safe operating range, that the mobile system is in a safe location, e.g., in a garage, that the mobile system, and/or components thereof, is in a safe operating state/mode, e.g., “parked”, and/or any other type of check of a state value of the mobile system, and/or components thereof.

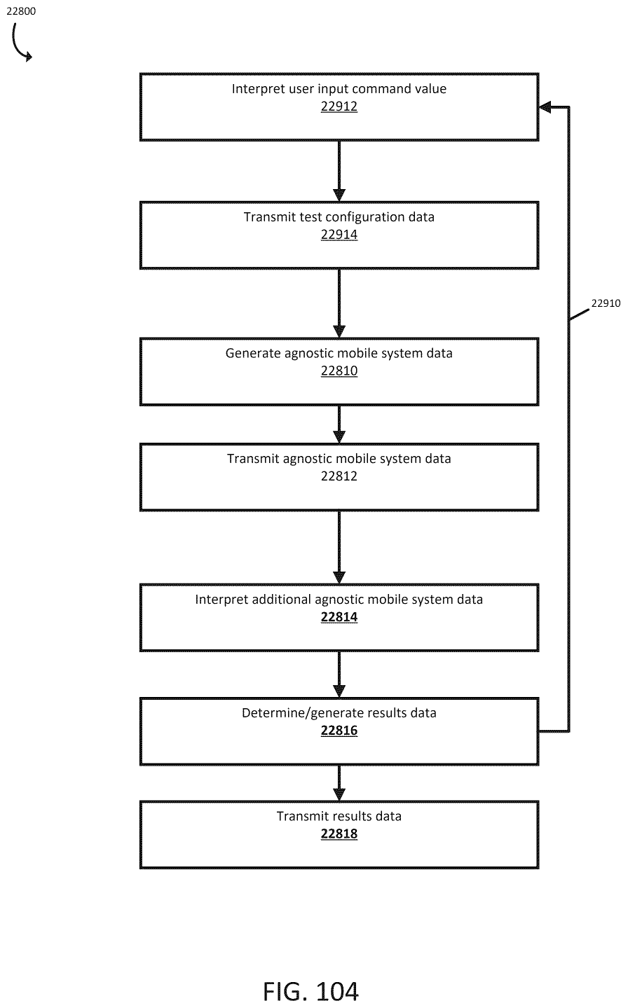

Referring to FIGS. 102 and 104, in embodiments, the method 22800 may further include generating (represented by path 22910) additional agnostic mobile system command data based at least in part on the interpreted agnostic mobile system data. The method 22800 may further include transmitting 22812 the additional agnostic mobile system data and interpreting 22814 additional agnostic mobile system data received in response to the transmission. In embodiments, the method 22800 may further include interpreting 22912 a user input command value and/or transmitting 22914 test configuration data.

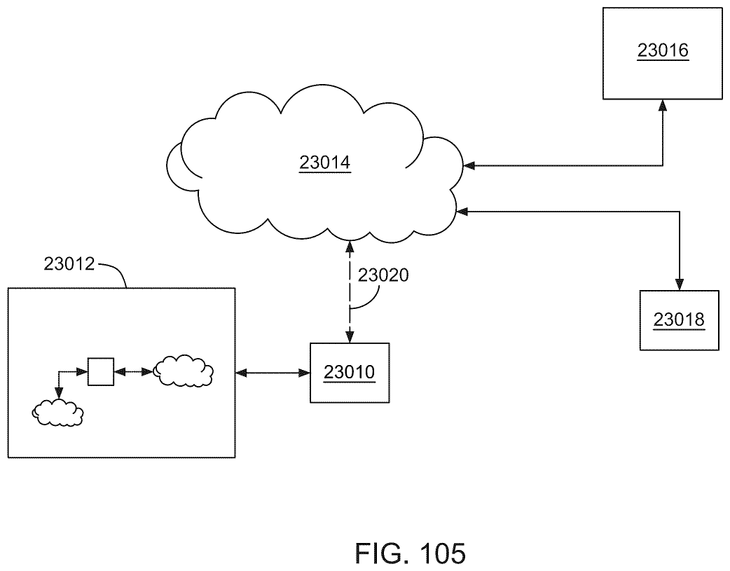

Turning to FIG. 105, embodiments of the mobile system interface device 23010 may provide testing and/or diagnostic analysis of a mobile system 23012 in situations where connectivity via a network 23014 to a server 23016 and/or remote computing device 23018 is impaired, as represented by the dashed arrow 23020. For example, the mobile system 23012 may be a vehicle located in a network dead zone, e.g., a location not having access to wireless and/or physical connection points to the network 23014. The mobile system interface device 23010 may have one or more circuits of apparatus 21400 (FIGS. 89 and 90, e.g., a mobile system interface device), apparatus 22200 (FIGS. 97 and 98, e.g., a diagnostic device), and/or apparatus 22600 (FIGS. 101 and 102, e.g., a testing device), and/or associated data sources, e.g., databases, as described herein. In embodiments, the apparatus 23010 may further include an external device interface circuit 23126 structured to communicate with a server, e.g., 23016, and/or a remote computing device, e.g., 23018, in circumstances when there is connectivity via network 23014. For example, in embodiments, the apparatus 23010 may log all data exchanged with the mobile system 23012 and/or processed by the apparatus 23010 when the network 23014 is unreachable by the apparatus 23010, and then transmit copies of such data to the server 23016 and/or remote computing device 23018 when a network connection, e.g., 23014, is established.

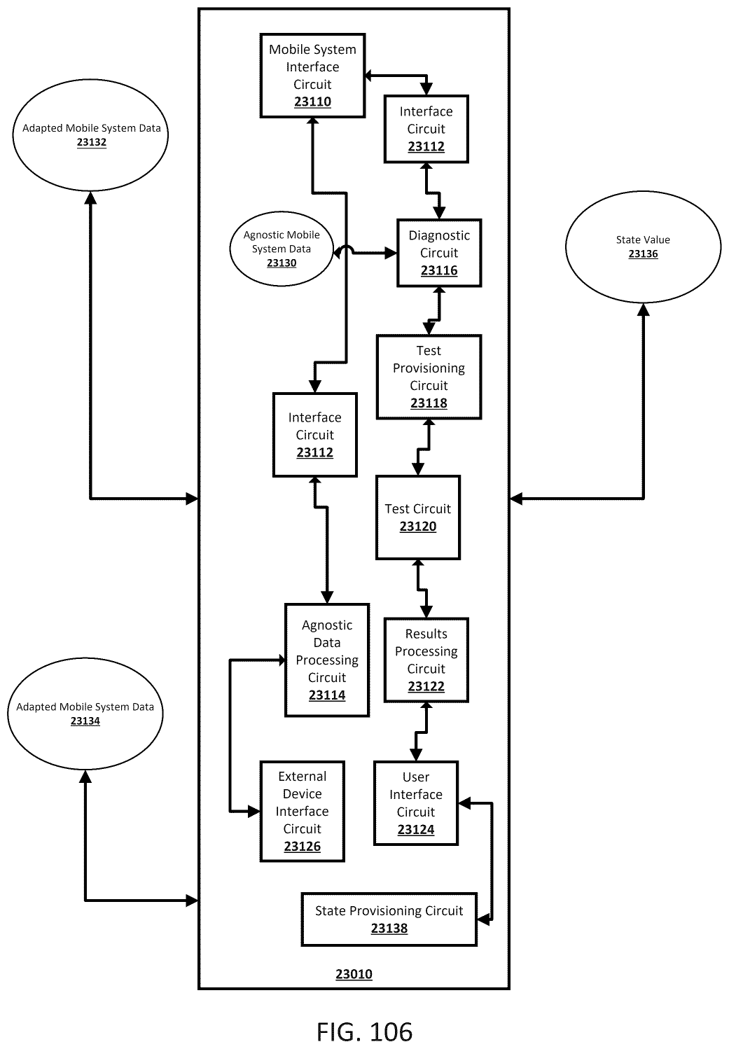

With reference to FIG. 106, an embodiment of the mobile system interface device 23010, in accordance with the disclosure herein, may include a mobile system interface circuit 23110, an interface circuit 23112, an agnostic data processing circuit 23114, a diagnostic circuit 23116, a test provisioning circuit 23118, a test circuit 23120, and/or a results processing circuit 23122. The mobile system interface device 23010 may further include a user interface circuit 23124, which may include an electronic display and/or one or more input devices, e.g., touch screen hardware, mouse, keyboard, buttons, etc.

The diagnostic circuit 23116 may generate agnostic mobile system data 23130 that the interface circuit 23112 translates/converts to adapted mobile system data 23132, which is then transmitted by the mobile system interface circuit 23110, e.g., to the mobile system 23012 (FIG. 105). The adapted mobile system data 23132 may be structured to elicit a response from the mobile system 23012 and/or one or more components thereof, i.e., the adapted mobile system data 23132 may be structured to trigger generation of additional adapted mobile system data 23134 by the mobile system, and/or components thereof. The adapted mobile system data 23134 from the mobile system 23012 may be interpreted by the mobile system interface circuit 23110 and analyzed by the diagnostic circuit 23116. The diagnostic circuit 23116 may then determine a state value 23136 based at least in part on the interpreted and/or analyzed adapted mobile system data 23134. The apparatus 23010 may further include a state provisioning circuit 23138 structured to transmit the state value 23136. In embodiments, transmission of the state value 23136 may be to a user interface device, e.g., an electronic display, of the apparatus 23010.

In embodiments, the test circuit 23120 may generate agnostic mobile system data 23130, corresponding to a test of a mobile system 23012 (FIG. 105) and/or one of its components, that is translated/converted by the interface circuit 23112 into adapted mobile system data 23132 that is transmitted by the mobile system interface circuit 23110, e.g., to the mobile system 23012. As described herein, the agnostic mobile system data may include one or more agnostic mobile system command values structured to perform the test, and the adapted mobile system data may include one or more adapted mobile system command values corresponding to the one or more agnostic mobile system command values. Transmission of the adapted mobile data, corresponding to the test, results in the test being performed on the mobile system, and/or its components, such that additional adapted data is generated by the mobile system, and/or its components, and transmitted to the apparatus 23010 where it may be interpreted by the mobile system interface circuit 23110. The interpreted adapted mobile system data analyzed by the results processing circuit 23122 which may initiate the generation of yet further agnostic mobile system data that corresponds to more agnostic mobile system command values to be sent and/or execute by the mobile system as converted/translated adapted mobile system data having adapted mobile system command values. The result processing circuit 23122 may generate, based at least in part on the interpreted adapted mobile system data, agnostic mobile system data corresponding to one or more results of the test of the mobile system and/or its one or more components, wherein the agnostic mobile system data may be transmitted, e.g., sent to the user interface circuit 23124 for display to a user. The apparatus 23010 may further include an external device interface circuit 23126 structured to transmit data generated and/or received by the apparatus 23010 to an external device, e.g., a server 23016 and/or remote computing device 23018, via a network connection, e.g., 23014, when available.

In embodiments, the user interface circuit 23124 may be structured to provide for active diagnostic and/or active testing of the mobile system, and/or one or more of its components, as described herein.

As will be appreciated, embodiments of the apparatus 23010 may allow users to create, update and deploy on-demand, persistent, and streaming policies to connected mobile systems in order to collect data from the mobile system for diagnostics. Embodiments of the apparatus 23010 may further provide access to: selected or all CAN messages and signals from a mobile system; any EthCC messages; any UDS information, including DTC and related data; mobile system status, e.g., state value; mobile system location information; onboard Ethernet network statistics; Vehicle Cloud Controller statistics; and/or any files (including DLT log files, Kernel log files, network traffic captures (pcap), and any other files) on CCU. Embodiments of the apparatus 23010 may also provide for the enabling, disabling, and/or configuring the mirroring of any Ethernet traffic to EMT port. Embodiments of the apparatus 23010 may also provide for interaction with a mobile system either via direct physical connection using EMT port, or a remote internet connection. Embodiments of the apparatus 23010 may further provide for CLI and/or Web based GUI user interface.

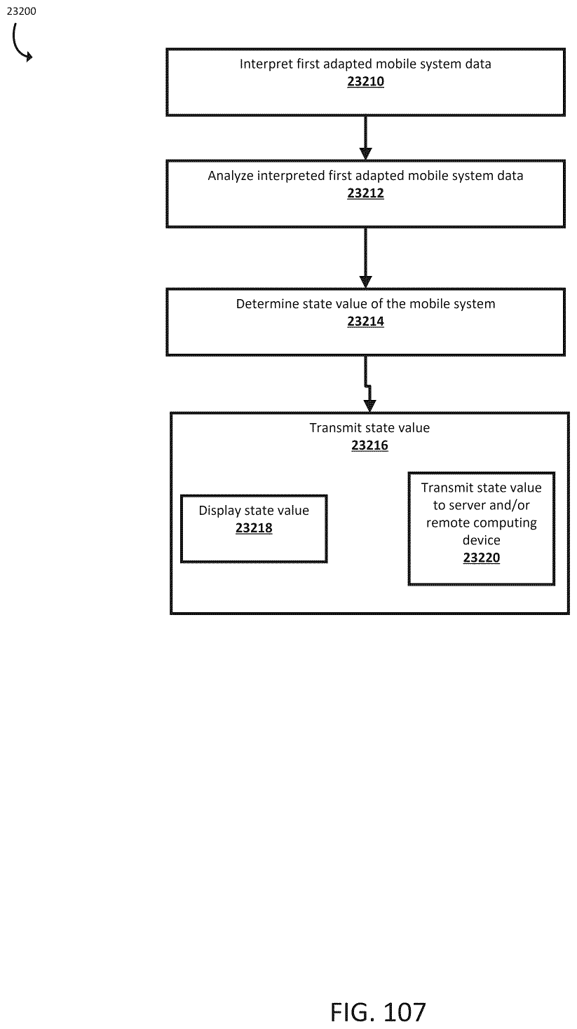

Referring now to FIGS. 106 and 107, a method 23200 for diagnosing a mobile system, e.g., 23012 (FIG. 105) is shown. The method 23200 may be performed, in whole or in part, by embodiments of the apparatus 23010 and/or any other computing device herein. The method 23200 may include interpreting 23210 first adapted mobile system data generated by a mobile system 23012 and analyzing 23212 the interpreted first adapted mobile system data via a diagnostic circuit 23116. The method 23200 may further include determining 23214, via the diagnostic circuit 23116, a state value of the mobile system 23012 based at least in part on the interpreted first adapted mobile system data. The method 23200 may further include transmitting 23216 the state value. In embodiments, transmission 23216 of the state value may be from the diagnostic circuit 23116 to the user interface circuit 23124 and the method 23200 may further include displaying 23218 the state value, e.g., on an electronic display of the apparatus 23010. In embodiments, transmitting 23216 the state value may be from the diagnostic circuit 23116 to the external device interface circuit 23126 and the method 23200 may further include transmitting 23220 the state value to a server 23016 and/or a remote computing device 23018.

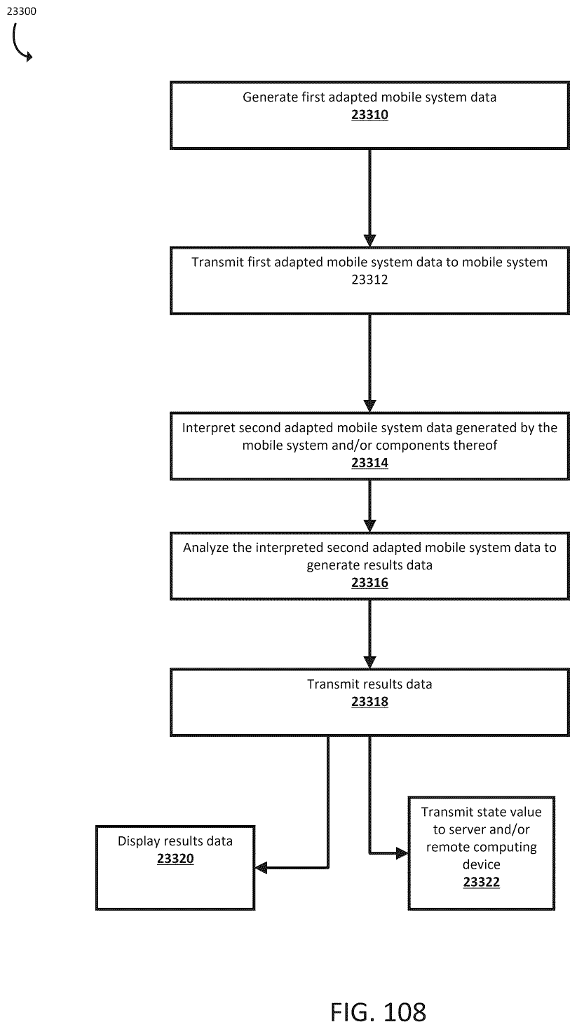

Referring now to FIGS. 106 and 108, a method 23300 for testing a mobile system, e.g., 23012 (FIG. 105) is shown. The method 23300 may be performed, in whole or in part, by embodiments of the apparatus 23010 and/or any other computing device herein. The method 23300 may include generating 23310, via the test circuit 23120, first adapted mobile system data corresponding to one or more adapted mobile system commands for performing a test of a mobile system, e.g., 23012, and/or one or more components thereof. The method may further include transmitting 23312 the first adapted mobile system data to the mobile system 23012 via the mobile system interface circuit 23110. The method 23300 may include interpreting 23314 second adapted mobile system data generated by the mobile system 23012, and/or components thereof, responsive to performing the test. The method 23300 may further include analyzing 23316 the interpreted second adapted mobile system data via the results processing circuit 23122 to generate results data. The method 23300 may further include transmitting 23318 the results data. In embodiments, transmission of the results data may be from the results processing circuit 23122 to the user interface circuit 23124 and the method 23300 may further include displaying 23320 the results data, e.g., on an electronic display of the apparatus 23010. In embodiments, transmitting 23318 the results data may be from results processing circuit 23122 to the external device interface circuit 23126 and the method 23300 may further include transmitting 23322 the results data to a server 23016 and/or a remote computing device 23018.

Turning again to FIG. 87, embodiments of the current disclosure provide for a mobile system emulation (MSE) circuit 21260 structured to generate emulated data that emulates data generated by one or more components 21222 of the mobile system 21210. In embodiments, the MSE circuit 21260 may be a separate device apart from the mobile system interface device 21214, the mobile system 21210, the server 21212, and/or the remote computing device 21216, as shown in FIG. 87. In other embodiments, the MSE circuit 21260 may be incorporated, in whole or in part, into one or more of the apparatus described herein, e.g., apparatus 21400 (FIGS. 89 and 90), apparatus 22600 (FIGS. 101 and 102), apparatus 23010 (FIG. 106), and/or any other computing device described herein. In embodiments, the MSE circuit 21260 may be incorporated into the mobile system 21210, and/or one or more of its components 21222. In embodiments, the MSE circuit 21260 may generate the emulated data as adapted mobile system data, e.g., adapted emulated data, and/or as agnostic mobile system data, e.g., agnostic emulated data. As will be understood, adapted emulated data may be in a form substantially similar to data generated by the mobile system 21210, and/or its components 21222, e.g., a specific signaling voltage value corresponding to a 15° angular position of a steering column and/or steering wheel, where agnostic emulated data is to be converted/translated to adapted emulated data via a mobile system interface device, e.g., 21214, as described herein. For example, agnostic emulated data may include data, other than a specific signaling voltage value, corresponding to a 15° angular position of a steering column that is translated/converted, via a mobile system interface device, e.g., 21214, into adapted emulated data having the corresponding specific signaling voltage value. As will be appreciated, emulation of a mobile system and/or its components by the MSE circuit 21260 may provide for improved diagnostic and/or testing over traditional approaches. Such improvements include the ability to test a mobile system and/or one or more of its components under simulated real-world operating conditions.

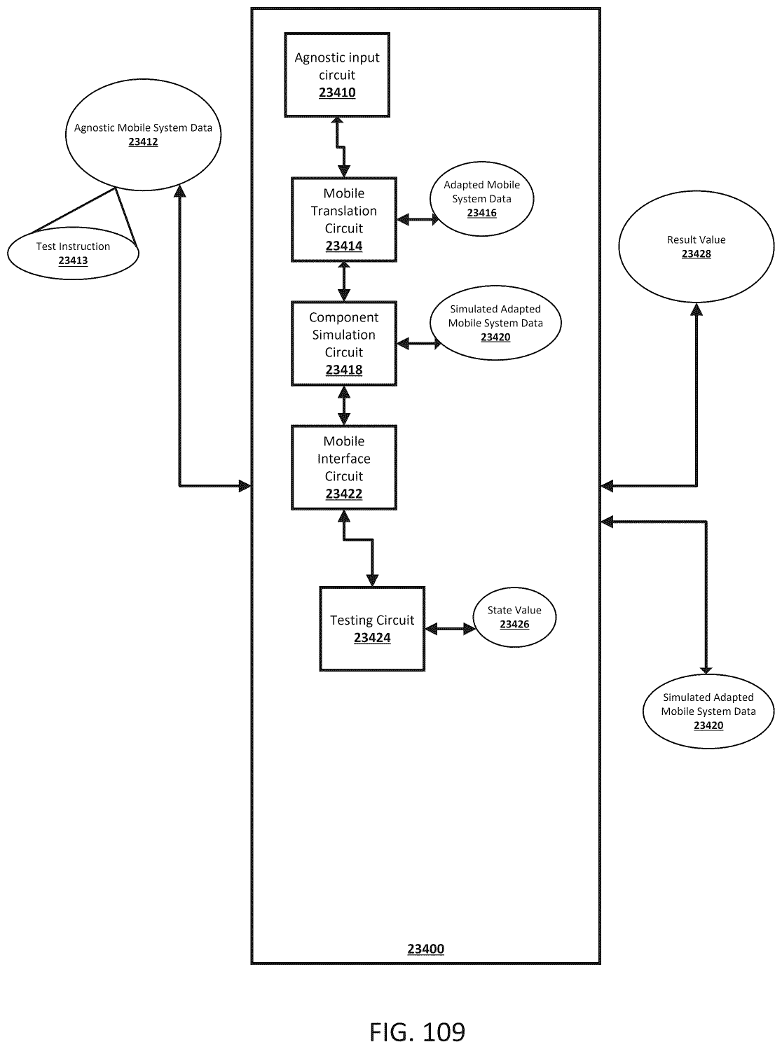

FIG. 109 depicts an embodiment of an apparatus 23400, in accordance with the disclosure herein, for testing a target mobile system 21210 (FIG. 87) and/or components 21222 (FIG. 87) thereof. As will be understood, one or more of the elements and/or functions of the apparatus 23400 may form part of and/or be performed by the mobile system interface device 21214 (FIG. 87), server 21212 (FIG. 87), the remote computing device 21216, the CND 21232 (FIG. 87), and/or any other computing device described herein. The apparatus 23400 may include an agnostic input circuit 23410 structured to interpret agnostic mobile system data 23412. The agnostic mobile system data 23412 may include a test instruction 23413 forming part of a test of the mobile system 21210 and/or its components 21222. The apparatus 23400 may further include a mobile translation circuit 23414 structured to generate adapted mobile system data 23416. The adapted mobile system data 23416 may include at least a portion of the agnostic mobile system data 23412 configured for the target mobile system 21210. The apparatus 23400 may further include a component simulation circuit 23418 structured to generate, in response to the adapted mobile system data 23416, simulated adapted mobile system data 23420 that includes data simulating a mobile system component 21222 in response to the adapted mobile system data 23416. The apparatus 23400 may further include a mobile interface circuit 23422 structured to transmit the simulated adapted mobile system data 23420 to the target mobile system 21210. The apparatus 23400 may further include a testing circuit 23424 structured to determine a state value 23426 of the target mobile system 21210 based at least in part on a result value 23428 generated by the target mobile system 21210 in response to the simulated adapted mobile system data 23420.

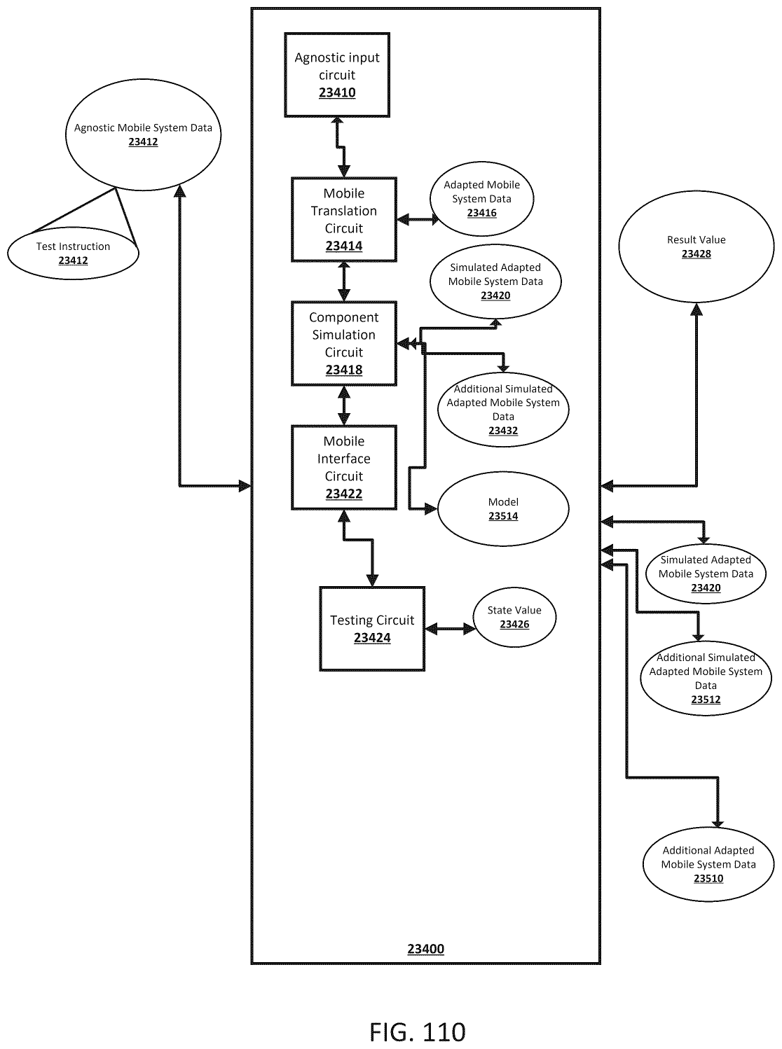

As shown in FIG. 110, the mobile system interface circuit 23422 may be further structured to interpret additional adapted mobile system data 23510 generated by the target mobile system 21210 in response to the simulated adapted mobile system data 23420. The component simulation circuit 23418 may be structured to generate additional simulated adapted mobile system data 23512 in response to the additional adapted mobile system data 23510. The additional simulated mobile system data 23512 may include data simulating a response of the mobile system component 21222 to the additional adapted mobile system data 23510. The mobile interface circuit 23422 may be further structured to transmit the additional simulated adapted mobile system data 23512 to the target mobile system 21210.

In embodiment, the simulated adapted mobile system data 23512 may correspond to a simulated state of the mobile system component 21222. Non-limiting examples mobile system component states include experienced environmental conditions, e.g., rain, snow, sleet, water exposure, temperature, altitude, air density, road conditions, etc.; experienced loads, e.g., electrical loads, power loads, weight loads, rotations per minute, etc.; and/or operating parameters.

A non-limiting use case of the apparatus 23400 include testing a component 21222 that is incorporated into the target mobile system 21210, e.g., testing a software update to an engine controller installed in a vehicle where the apparatus 23400 simulates components that would normally interact with the engine controller during actual operation of the mobile system 21210.

Another non-limiting use case of the apparatus 23400 includes testing a prospective component of the target mobile system 21210, e.g., testing a new engine controller that is planned to be installed into a vehicle at a future date where the apparatus 23400 simulates components that will interact with the new engine controller during actual operation of the mobile system 21210.

In embodiments, the component simulation circuit 23418 is further structured to generate the simulated adapted mobile system data 23420 and/or the additional simulated adapted mobile system data 23432 based at least in part on a model 23514 of the mobile system component 21222. The model 23514 may be structured to receive adapted mobile system data, e.g., 23416 and/or 23512, and generate and/or output the simulated adapted mobile system data 23420 and/or the additional simulated adapted mobile system data 23432 in response. As a non-limiting example, the apparatus 23400 may be configured to perform a test of a cruise control controller of a car under various environmental conditions where the model simulates an engine controller under the various environmental conditions such that the cruise controller, which may be installed in the car, “sees” the simulated data generated by the model and reacts accordingly.

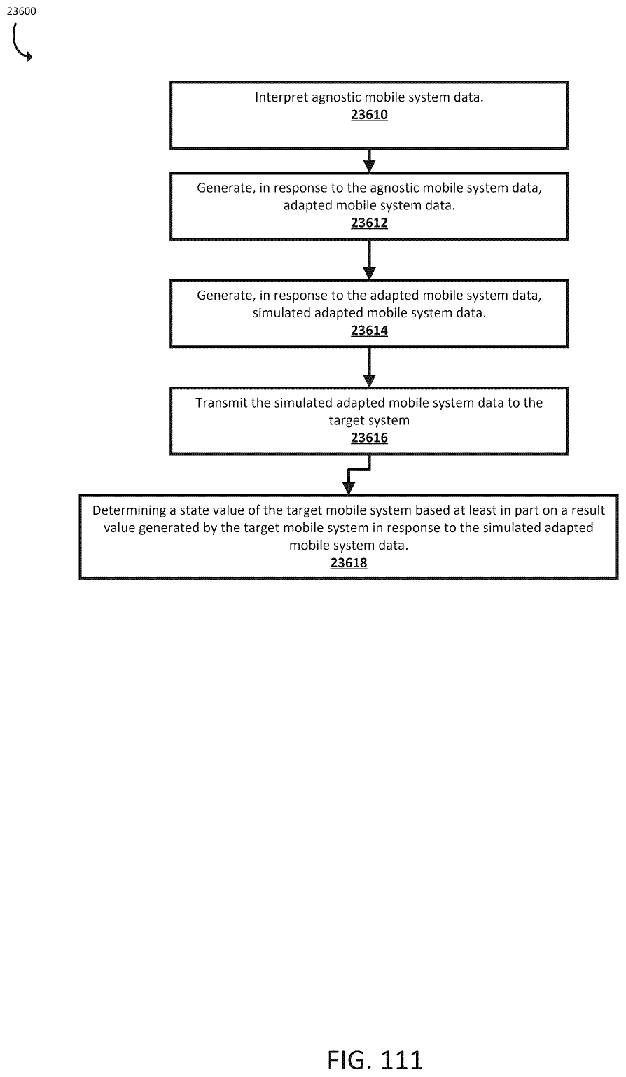

Shown in FIG. 111 is a method 23600, in accordance with the disclosure herein, for testing a target mobile system 21210 (FIG. 87) and/or components 21222 (FIG. 87) thereof. The method 23600 may be performed by the apparatus 23400 (FIGS. 109 and 110) and/or any other computing device disclosed herein. The method 23600 includes interpreting 23610 agnostic mobile system data 23412 comprising a test instruction 23413; and generating 23612, in response to the agnostic mobile system data 23412, adapted mobile system data 23416. The adapted mobile system data 23416 may include at least a portion of the agnostic mobile system data 23412 configured for a target mobile system 21210. The method 23600 may further include generating 23614, in response to the adapted mobile system data 23416, simulated adapted mobile system data 23420 that includes data simulating a mobile system component 21222 in response to the adapted mobile system data 23416; transmitting 23616 the simulated adapted mobile system data 23420 to the target mobile system 21210; and determining 23618 a state value 23426 of the target mobile system based at least in part on a result value 23428 generated by the target mobile system 21210 in response to the simulated adapted mobile system data 23420.

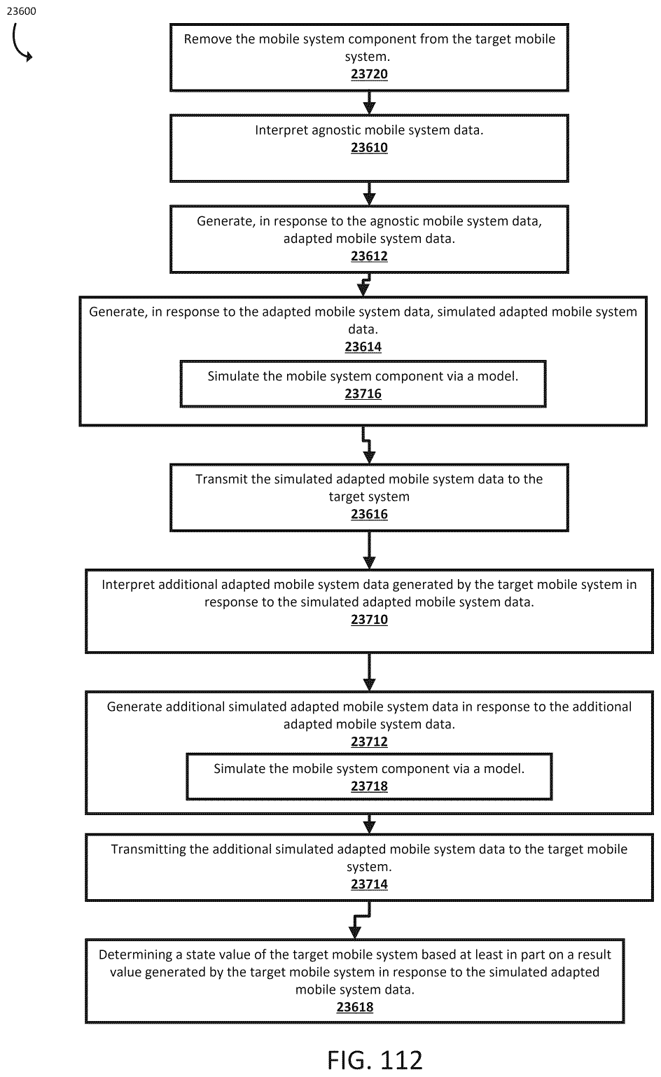

As illustrated in FIG. 112, the method 23600 may further include interpreting 23710 additional adapted mobile system data 23510 generated by the target mobile system 21210 in response to the simulated adapted mobile system data 23420; and generating 23712, in response to the additional adapted mobile system data 23510, additional simulated adapted mobile system data 23512. The additional simulated mobile system data 23512 may include data simulating a response of the mobile system component 21222 to the additional adapted mobile system data 23510. The method 23600 may further include transmitting 23714 the additional simulated adapted mobile system data 23512 to the target mobile system 21210.

In embodiments, generating 23612 the simulated adapted mobile system data 23420 and/or generating 23712 the additional simulated adapted mobile system data 23512, may include simulating 23716 and/or 23718, via a model 23514, the mobile system component 21222.

In embodiment, the method 23600 may further include removing 23720 the mobile system component 21222 from the target mobile system 21210 prior to generating the simulated adapted mobile system data 23512.

An example embodiment of the present disclosure, utilizing one or more aspects as set forth preceding, includes a diagnostic use case.

An example diagnostic use case (e.g., reference FIG. 98 and the related description) includes diagnosing one or more vehicle components at a repair shop by a technician. The vehicle technician may use a mobile diagnostic device to identify a state value of a first component of a first vehicle and use the same diagnostic device to identify another state value of another component of another vehicle of a different make, model, and/or year from the first vehicle.

Another example diagnostic use case (e.g., reference FIG. 98 and the related description) includes diagnosing a vehicle component remotely by a technician, wherein the vehicle is located in its owner's garage and/or at a location outside of a repair shop or assembly line, e.g., a vehicle broken down on the side of the road. In embodiments, a mobile interface device may be integrated into the vehicle and in communication with a remote workstation via a backend server. A technician may use the remote workstation to accesses state values of various components of the vehicle and/or use the server to assist in determining a state value of the vehicle and/or a component thereof. For example, the remote technician may instruct an application running on the workstation to inspect the vehicle's fuel system. The vehicle may send data back to the server, which the server may analyze to determine that a fuel pump in the vehicle is malfunctioning. The server may then send a message to the workstation indicating that the fuel pump is a cause of the vehicle not working.

Another example diagnostic use case (e.g., reference FIG. 106 and the related description) includes diagnosing a vehicle broken down in a network dead zone, e.g., in a dessert. A technician may initiate a connection between the mobile interface device and the mobile system, wherein the mobile interface device initiates the collection of adapted data from the mobile system for analysis by a diagnostic circuit of the mobile system interface device. In other words, the adapted data from the mobile system is analyzed locally by the mobile system interface devices, as opposed to being send to a backend server.

Embodiments of the mobile interface device, e.g., 21318 (FIG. 88) may include one or more of the circuits of the server 21317 (FIG. 88) and/or the workstation 21312 (FIG. 88), and/or otherwise provide for the same features/functionality of the server 21317 and/or workstation 21312, as disclosed herein. In other words, embodiments of the mobile interface device may provide for all the diagnostic, testing, and/or configuring features, disclosed herein, with or without network, e.g., 21316 (FIG. 88), connectivity.

For example, in embodiments, the mobile interface device 21318 may store and/or execute the same application software as the server 21317 and/or the workstation 21312. In embodiments, the application software may operate in a container within an operating system of the mobile interface device 21318 and/or a secure environment. As will be appreciated, use of the same application software across the mobile interface device 21318, server 21317, and/or workstation 21312 may simplify the management of the application software, to include updating the application software, e.g., a single patch can be used to update the mobile interface device 21318, server 21317, and/or the workstation 21312. Additionally, use of the same application software across the mobile interface device 21318, server 21317, and/or workstation 21312 may improve security by limiting the number of vulnerabilities to a single application, as opposed to having to track potential vulnerabilities across multiple distinct applications.

Another example embodiment of the present disclosure, utilizing one or more aspects as set forth preceding, includes a test use case.

An example testing use case (e.g., reference FIG. 101 and the related description) includes testing of a vehicle and/or its components on an assembly line. A technician may connect a mobile interface device to an engine control unit where a backend server pushes agnostic commands to the mobile interface device where the agnostic commands correspond to a test of a generic engine, e.g., “test to see if the engine's governor prevents exceeding a maximum RPMs”. The agnostic commands may be translated/converted by the mobile interface device into adapted commands which are then passed to the engine control unit which then performs a simulated test of running an engine (for which the engine control unit is designed for) up to its maximum RPMS. Adapted data from the engine control unit may be reported back to the mobile interface device translated to agnostic data, which is then passed back to the server. The server may then analyze the agnostic data to determine results of test which may then be passed back to the mobile system interface device (for display to a technician) and/or sent to a database for storage. The technician may then use the same mobile interface device to test an engine control unit for a different type of engine.

In embodiments, a record, e.g., historical data, of any data collected and/or transmitted to the mobile system may be stored in a memory device forming part of a server, e.g., server 21212, the remote computing device 21216, and/or onboard the mobile system 21210. In embodiments, this historical data may be used by a diagnostic circuit, testing circuit, and/or a technician when diagnosing and/or testing the mobile system, as described herein. In embodiments, the historical data may be used for cross type analysis, e.g., across vehicles of the same and/or different types, such as in a fleet of vehicles. In embodiments, the diagnostic circuit and/or testing circuit, as described herein, may detect one or more outliers that may trigger the investigation of system and/or conditions associated with the one or more outliers. Embodiments of the diagnostic circuit and/or testing circuit may use the detection of outliers to identify/determine condition/event signatures that may provide for future preemptive detection of warning signs that may be used to preemptively detect underlying problems with a mobile system.

Certain further embodiments are set forth following, to illustrate certain aspects and capabilities of the disclosure herein. In certain embodiments, a mobile system interfaces with a vehicle, or a portion of a vehicle, providing the capability to test, diagnose, verify, perform service operations, or the like, for the vehicle and/or a portion of the vehicle, including providing full capability when connectivity to the cloud is unavailable or not desirable. The example mobile system may be embodied, in whole or part, by any components, controllers, systems, circuits, or the like as set forth herein. In certain embodiments, and without limitation, the mobile system may be embodied, in whole or part, by controllers such as those depicted in FIGS. 106, 109, 110, or portions thereof. The example mobile system includes support for cloud based features, that may normally operate in the cloud and interact with the vehicle through various avenues such as set forth herein, including via a transmitter on the vehicle communicating through a transmitter, OTA client, transceiver/modem, or the like. Cloud based features may include long processing (e.g., longitudinal diagnostics, machine learning improved algorithms, etc.), supporting data storage (e.g., moving historical data from the vehicle to the cloud), operating certain types of processing that are heavier on processing resources than ordinarily available on the vehicle (e.g., statistical analysis, heuristics, pattern recognition operations, etc.), operation of a digital twin of the vehicle, etc. The example mobile system may include any one or more, or all, of these cloud based features, depending upon the reason for the mobile system and the circumstances for the particular usage of the mobile system.

Example and non-limiting mobile systems include a service tool (e.g., utilized by a service technician to perform service, validate service, and/or return the vehicle to an operating state at the completion of service operations); a manufacturing tool (e.g., to test the vehicle or a component thereof, to install applications on the vehicle, and/or to set calibrations or trims for the vehicle); a dealer tool (e.g., to install and/or test certain features or options, to set calibrations for any reason applicable to a dealer, body builder, aftermarket installer, or the like); and/or a remote support tool (e.g., allowing a service technician accessing the vehicle in a remote location and/or with unavailable or intermittent cloud access to perform fully available service operations). The mobile system may include any cloud based feature, and/or may further include features to simulate, replace, and/or obviate (collectively referred to herein as “SOV”) any vehicle component—for example the mobile system may be capable to provide messages to the in-vehicle network in place of any end point on the vehicle to allow the remainder of the vehicle components to operate as if the SOV vehicle component were present. The mobile system may SOV a specific component or end point, such as a sensor, an ECU, an actuator, or the like, and/or may SOV the entire vehicle except for the specific component of the vehicle that is being tested, diagnosed, verified, calibrated, etc. A few non-limiting examples are provided for illustration: 1) a mobile system operating as a remote service tool, allowing the operator to simulate all cloud based features to support the vehicle, where the mobile system connects to an external communications controller of the vehicle via wireless, Bluetooth, and/or utilizing a hardware port (e.g., an OBD port, dedicated service port, etc.), and where the mobile system may additionally or alternatively SOV certain features of the vehicle (e.g., to allow testing of powertrain controls or responses without the vehicle having to physically move); 2) a mobile system operating as a manufacturing service or testing tool, that simulates the entire vehicle except for an ECU to be tested (e.g., a prime mover ECU, for example to confirm proper operations of the powertrain and/or prime mover controls), where the mobile system hosts the ECU to be plugged into the manufacturing tool; 3) a mobile system operating as a manufacturing service or testing tool, that simulates a portion of the vehicle at a particular stage of manufacturing operations (e.g., using SOV replacement for those end points of the vehicle that are not installed yet, for example to configure and/or test the end points that have been installed); and/or 4) a mobile system operating as a configuration tool, for example allowing dealers, aftermarket providers, body builders, or the like, to install or calibrate features, to confirm the components and configuration installed on the vehicle, etc., in a controlled manner that has all applicable security and permissions in place.

The utilization of a mobile system allows for the vehicle to be tested, diagnosed, configured, or the like, in any location where cloud access may be limited, intermittent, unavailable, or undesirable (e.g., to limit security risks and isolate the vehicle until the service is complete). In certain embodiments, the mobile system may store data in response to operations with the vehicle, and provide that information to the cloud services applicable to the vehicle at a later time (e.g., preserving parameters such as utilization, historical data that may be utilized in diagnostics, iterative improvement and/or machine learning operations, protecting data for utilization in warranty determinations, etc.). In certain embodiments, an operator may set parameters for components that will be SOVd by the mobile system, select components that will be SOVd through a graphical user interface (e.g., a schematic map of the vehicle, and selected end points, or all end points), the mobile system may select components that will be SOVd automatically (e.g., performing a specific test or diagnostic may include automatically doing an SOV operation for selected components), and/or the mobile system may automatically or heuristically perform an SOV operation for certain components (e.g., to isolate failures, to execute a fault tree analysis, to simulate end points that appear to be missing or have lost connectivity, etc.).

A number of example and non-limiting embodiments of a system are described following, where the system may include a test rig, diagnostic rig, service rig, manufacturing rig, or the like. Aspects of the example system may be embodied by any aspects of the present disclosure, including without limitation any controller, circuit, computing device, or the like, as set forth herein.

A first example system includes a tester for computer-readable instructions on the vehicle, with off-vehicle aspects operating on the cloud in communication with the vehicle, and/or operating on a local device (e.g., reference mobile systems and/or MSE aspects of the present disclosure), with on-vehicle aspects operating on the vehicle in communication with the tester and/or the cloud. In certain embodiments, one or more hardware aspects of the vehicle may be utilized as installed on the vehicle, and/or emulated by the tester, allowing for testing of the computer-readable instructions on the vehicle at any stage of manufacture, with any device separated from the rest of the vehicle, and/or during any service operations. In certain embodiments, computing devices and/or computer-readable instruction components of the vehicle may also be emulated, for example allowing a single controller, group of controllers, application, flow, or other aspect of the vehicle to be tested separately from the remainder of the vehicle.

A second example system includes a tester for computer-readable instructions on the vehicle, with off-vehicle aspects operating on the cloud in communication with the vehicle, and/or operating on a local device (e.g., reference mobile systems and/or MSE aspects of the present disclosure), with all on-vehicle aspects also performed on the tester and/or a separate testing computing device in communication with the tester. In certain embodiments, one or more hardware aspects of the vehicle, and/or executable instructions on the vehicle, may be emulated by the tester or separate computing device, and/or executable instructions may be literally present on the tester or separate computing device. Accordingly, any computing device, circuit, segment of executable instructions, controller, application, flow, etc., may be tested literally in the manner as present on the vehicle, allowing for testing of on-vehicle computer-readable instructions in a protected and rapid development environment that realistically simulates outcomes as they would be experienced on the full vehicle.

One or more certain further aspects of the example systems, apparatuses, and methods are described following, any one or more of which may be incorporated in certain embodiments.

An example system may include a server and a mobile system interface device. The server is structured to interpret agnostic mobile system data. The mobile system interface device is structured to: interpret adapted mobile system data from one or more endpoints of one or more network zones of a mobile system; generate the agnostic mobile system data based at least in part on the adapted mobile system data; and transmit the agnostic mobile system data to the server. In certain aspects, the adapted mobile system data is diagnostic data. In certain aspects, the system further includes a system test circuit structured to determine, based at least in part on the agnostic mobile system data, a state value of the mobile system. The mobile system interface device is further structured to transmit the state value to the server. In certain aspects, the system test circuit is further structured to determine the state value via machine learning. In certain aspects, the server is further structured to transmit the state value to a remote diagnostic device. In certain aspects, the server includes a cloud-based server. In certain aspects, the server includes a local server. In certain aspects the local server is a tool locally connected though a hard connection, e.g., ethernet, CAN, etc., and/or a wireless connection, e.g., WiFi, Bluetooth, etc. In certain aspects, the state value incudes at least one of: an engine system state value; a driving system state value; a fuel system state value; an electrical system state value; a transmission system state value; an accessory for the mobile system state value; or an infotainment system state value. In certain aspects, the server is further structured to: generate additional agnostic mobile system data; and transmit the additional agnostic mobile system data to the mobile system interface device. The mobile system interface device is further structured to: interpret the additional agnostic mobile system data; generate additional adapted mobile system data responsive to the additional agnostic mobile system data; and transmit the additional adapted mobile system data to at least one of the one or more endpoints of the one or more network zones of the mobile system. In certain aspects, the additional agnostic mobile system data defines, at least in part, an agnostic mobile system command value; and the additional adapted mobile system data defines, at least in part, an adapted mobile system command value corresponding to the agnostic mobile system command value. In certain aspects, the adapted mobile system command value is for at least one of: an engine system; a driving system; a fuel system; an electrical system; a transmission system; an accessory for the mobile system; or an infotainment system. In certain aspects, the mobile system interface device is structured to generate the adapted mobile system data based at least in part on the agnostic mobile system command value. In certain aspects, the adapted mobile system data is diagnostic data. In certain aspects, the additional agnostic mobile system data defines, at least in part, a test of one or more components of the mobile system. In certain aspects, each of the one or more components relates to at least one of: an engine system; a driving system; a fuel system; an electrical system; a transmission system; an accessory for the mobile system; or an infotainment system. In certain aspects, the mobile system interface device is further structured to generate the agnostic mobile system data such that the agnostic mobile system data corresponds to a redacted version of the adapted mobile system data. In certain aspects, the redacted version of the adapted mobile system data includes at least one of: data excluding a value for an actuator signaling protocol of the mobile system; data excluding a memory address corresponding to a component of the mobile system; data excluding a metadata value associated with at least a portion of the adapted mobile system data; data having a reduced resolution relative to the adapted mobile system data; or a down-sampled version of at least a portion of the adapted mobile system data. In certain aspects, the mobile system interface device is further structured to: de-duplicate a plurality of external data requests, wherein generation of the agnostic mobile system data is based at least in part on the de-duplicated data requests. In certain aspects, the mobile system interface device is further structured to de-duplicate at least a portion of the agnostic mobile system data before transmitting the agnostic mobile system data. In certain aspects, the mobile system interface device is further structured to store at least a portion of the agnostic mobile system data before transmitting the agnostic mobile system data. In certain aspects, the mobile system interface device is further structured to de-duplicate the at least a portion of the agnostic mobile system data before storing the at least a portion of the agnostic mobile system data. In certain aspects, the mobile system is a vehicle. In certain aspects, the vehicle is at least one of: a car; a truck; an aircraft; a ship; an underwater craft; an industrial vehicle; or a space craft. In certain aspects, the mobile system is a drone.

An example method includes: interpreting adapted mobile system data from one or more endpoints of one or more network zones of a mobile system; generating agnostic system data based at least in part on the adapted mobile system data; transmitting the agnostic system data to an external device; and determining, based at least in part on the agnostic system data, a state value of the mobile system. In certain aspects, the state value is transmitted to the external device with the agnostic system data. In certain aspects, the state value is transmitted to the mobile system from the external device. In certain aspects, transmitting the state value includes transmitting the state value to the mobile system. In certain aspects, transmitting the state value includes transmitting the state value to a remote diagnostic device. In certain aspects, the state value is for at least one of: an engine system; a driving system; a fuel system; an electrical system; a transmission system; an accessory for the mobile system; or an infotainment system. In certain aspects, the method further includes generating additional agnostic mobile system data; transmitting the additional agnostic mobile system data to the mobile system; generating additional adapted mobile system data responsive to the additional agnostic mobile system data; and transmitting the additional adapted mobile system data to the external device. In certain aspects, the additional agnostic mobile system data defines, at least in part, an agnostic mobile system command value; and the additional adapted mobile system data defines, at least in part, an adapted mobile system command value corresponding to the agnostic mobile system command value. In certain aspects, the method further includes actuating, based at least in part on the adapted mobile system command value, an actuator for at least one of: an engine system; a driving system; a fuel system; an electrical system; a transmission system; an accessory for the mobile system; or an infotainment system. In certain aspects, the method further includes: generating the adapted mobile system data via one or more endpoints of one or more network zones of the mobile system; adjusting the adapted mobile system data via a converged network device of the mobile system; and transmitting the adjusted adapted mobile system data to the external device. In certain aspects, adjusting includes at least one operation selected from the operations consisting of: changing a resolution of at least a portion of the adapted mobile system data; or changing a parameter name for at least a portion of the adapted mobile system data. In certain aspects, adjusting the adapted mobile system data includes at least one of: translating the adapted mobile system data from a first communication protocol to a second communication protocol; up-sampling a parameter value of a component of the mobile system; or down-sampling a parameter value of a component of the mobile system. In certain aspects, determining the state value of the mobile system is based at least in part on a machine learning operation.

Another example system includes a server structured to: interpret agnostic mobile system data; and transmit the agnostic mobile system data to a mobile system interface device. The mobile system interface device is structured to: generate adapted mobile system data responsive to the agnostic mobile system data; and implement at least one of a test or a diagnostic on a mobile system in response to the adapted mobile system data. In certain aspects, the mobile system interface device is positioned on the server. In certain aspects, the mobile system interface device is positioned on the mobile system. In certain aspects, the mobile system interface device is positioned on at least one of a tool or a test rig. In certain aspects, the adapted mobile system data includes a data collection instruction; and the mobile system interface device is further structured to: receive adapted test data from end points of at least one network zone of the mobile system in response to the adapted mobile system data; convert at least a portion of the adapted test data into agnostic test data; and transmit the agnostic test data to the server. In certain aspects, the adapted mobile system data includes an agnostic mobile system command value; and the mobile system interface device is further structured to: convert at least a portion of the agnostic mobile system command value into adapted commands for the mobile system; and provide commands to end points of at least one network zone of the mobile system in response to the adapted commands for the mobile system. In certain aspects, the adapted commands each include at least one command selected from the commands consisting of: a data collection command; a data provision command; or an actuator command. Embodiments of the actuator command may refer to any specific type of actuator disclosed herein. As will be understood, vehicle functions, applications, and/or flows may act as an actuator (e.g., command the engine to 1000 RPM for five (5) minutes, where the engine control system may act as the actuator, but multiple individual hardware actuators may be involved).

Another example method includes: interpreting, via a server, agnostic mobile system data; transmitting, via the server, the agnostic mobile system data to a mobile system interface device; generating, via the mobile system interface device, adapted mobile system data responsive to the agnostic mobile system data; and implementing, via the mobile system interface device, at least one of a test or a diagnostic on a mobile system in response to the adapted mobile system data. In certain aspects, the mobile system interface device is positioned on the server. In certain aspects, the mobile system interface device is positioned on the mobile system. In certain aspects, the mobile system interface device is positioned on at least one of a tool or a test rig. In certain aspects, the adapted mobile system data incudes a data collection instruction; and the method further includes: receiving, via the mobile system interface, adapted test data from end points of at least one network zone of the mobile system in response to the adapted mobile system data; converting, via the mobile system interface device, at least a portion of the adapted test data into agnostic test data; and transmitting, via the mobile system interface device, the agnostic test data to the server. In certain aspects, the adapted mobile system data includes an agnostic mobile system command value; and the method further includes: converting, via the mobile system interface device, at least a portion of the agnostic mobile system command value into adapted commands for the mobile system; and providing, via the mobile system interface device, commands to end points of at least one network zone of the mobile system in response to the adapted commands for the mobile system. In certain aspects, the adapted commands each include at least one command selected from the commands consisting of: a data collection command; a data provision command; or an actuator command.

Another example apparatus, includes an agnostic input circuit, a mobile translation circuit, a mobile interface circuit, and a diagnostic circuit. The agnostic input circuit is structured to interpret agnostic mobile system data including at least one of a test instruction, a diagnostic instruction, or a data collection instruction. In embodiments, the test instruction may include commands, data to be collected, formatting, units, instructions where to send data, etc. The mobile translation circuit is structured to generate adapted mobile system data in response to the agnostic mobile system data, the adapted mobile system data including at least a portion of the agnostic mobile system data configured for a target mobile system. The mobile interface circuit is structured to transmit the adapted mobile system data to the target mobile system. The diagnostic circuit is structured to determine a state value of the mobile system based, at least in part, on a result value from the target mobile system. In certain aspects, the agnostic mobile system data includes the test instruction, and the result value includes data collected on the target mobile system in response to a test performed in response to the test instruction. In certain aspects, the agnostic mobile system data includes the diagnostic instruction, and the result value includes data collected on the target mobile system in response to a diagnostic performed in response to the diagnostic instruction. In certain aspects, the agnostic mobile system data includes the data collection instruction, and the result value includes data collected on the target mobile system in response to a data collection operation performed in response to the data collection instruction. In certain aspects, the diagnostic circuit is further structured to transmit at least one of the state value or the result value to a cloud-based server. In certain aspects, the diagnostic circuit is further structured to store the at least one of the state value or the result value in response to a transmission delay value. In certain aspects, the transmission delay value includes an indication that transmission to the cloud-based server is not available. In certain aspects, the transmission delay value includes an indication that a predetermined transmission delay time has not fully elapsed. Embodiments may provide for periodic transmission of data, (e.g., holding of the data until a specified time (e.g., 5:00 pm on Tuesday), etc.). In certain aspects, the transmission delay value includes an indication that a transmission event has not occurred. For example, embodiments of the system may hold the data from transmission for a particular and/or selected reason. In embodiments, the event may be a request from a server, a determined value from a test (e.g., that a failure is present, that additional data need to be collected, etc.), a request event from a user to send the data etc. In certain aspects, the adapted mobile system data is configured in response to an end point arrangement of the target mobile system. In certain aspects, the adapted mobile system data is configured in response to an end point identification scheme of the target mobile system. In certain aspects, the adapted mobile system data is configured in response to a parameter identification scheme of the target mobile system. In certain aspects, the adapted mobile system data is configured in response to a data availability description of the target mobile system.

Another example method includes: interpreting, via an agnostic input circuit, agnostic mobile system data including at least one of a test instruction, a diagnostic instruction, or a data collection instruction; generating, via a mobile translation circuit, adapted mobile system data in response to the agnostic mobile system data, the adapted mobile system data including at least a portion of the agnostic mobile system data configured for a target mobile system; transmitting, via a mobile interface circuit, the adapted mobile system data to the target mobile system; and determining, via a diagnostic circuit, a state value of the mobile system based, at least in part, on a result value from the target mobile system. In certain aspects, the agnostic mobile system data includes the test instruction; and the result value includes data collected on the target mobile system in response to a test performed in response to the test instruction. In certain aspects, the agnostic mobile system data includes the diagnostic instruction; and the result value includes data collected on the target mobile system in response to a diagnostic performed in response to the diagnostic instruction. In certain aspects, the agnostic mobile system data includes the data collection instruction; and the result value includes data collected on the target mobile system in response to a data collection operation performed in response to the data collection instruction. In certain aspects, the method further includes transmitting, via the diagnostic circuit, at least one of the state value or the result value to a cloud-based server. In certain aspects, the method further includes storing, via the diagnostic circuit, the at least one of the state value or the result value in response to a transmission delay value. In certain aspects, the transmission delay value includes an indication that transmission to the cloud-based server is not available. In certain aspects the transmission delay value includes an indication that a predetermined transmission delay time has not fully elapsed. In certain aspects, the transmission delay value includes an indication that a transmission event has not occurred. In certain aspects, the method further includes configuring, via the mobile translation circuit, the adapted mobile system data in response to an end point arrangement of the target mobile system. In certain aspects, the method further includes configuring, via the mobile translation circuit, the adapted mobile system data in response to an end point identification scheme of the target mobile system. In certain aspects, the method further includes configuring, via the mobile translation circuit, the adapted mobile system data in response to a parameter identification scheme of the target mobile system. In certain aspects, the method further includes configuring, via the mobile translation circuit, the adapted mobile system data in response to a data availability description of the target mobile system.

Another example apparatus includes an agnostic input circuit, a mobile translation circuit, a component simulation circuit, a mobile interface circuit, and a testing circuit. The agnostic input circuit is structured to interpret agnostic mobile system data including a test instruction. The mobile translation circuit is structured to generate adapted mobile system data in response to the agnostic mobile system data, the adapted mobile system data including at least a portion of the agnostic mobile system data configured for a target mobile system. The component simulation circuit is structured to generate, in response to the adapted mobile system data, simulated adapted mobile system data including data simulating a mobile system component in response to the adapted mobile system data. The mobile interface circuit is structured to transmit the simulated adapted mobile system data to the target mobile system. The testing circuit is structured to determine a state value of the target mobile system based at least in part on a result value generated by the target mobile system in response to the simulated adapted mobile system data. In certain aspects, the mobile system interface circuit is further structured to interpret additional adapted mobile system data generated by the target mobile system in response to the simulated adapted mobile system data, the component simulation circuit is structured to generate additional simulated adapted mobile system data in response to the additional adapted mobile system data, the additional simulated mobile system data including data simulating a response of the mobile system component to the additional adapted mobile system data; and the mobile interface circuit is further structured to transmit the additional simulated adapted mobile system data to the target mobile system. In certain aspects, the simulated adapted mobile system data corresponds to a simulated state of the mobile system component. In certain aspects, the simulated state corresponds to at least one of: a simulated environmental condition experienced by the mobile system component; or a simulated load experienced by the mobile system component. In certain aspects, the mobile system component is a component of the target mobile system. In certain aspects, the mobile system component is a prospective component of the target mobile system. In certain aspects, the component simulation circuit is further structured to generate the simulated adapted mobile system data based at least in part on a model of the mobile system component. In certain aspects, the mobile system component forms part of at least one of: an electrical system of the target mobile system; an engine of the target mobile system; an infotainment system of the target mobile system; or a power steering system of the target mobile system.

Another example method includes: interpreting, via an agnostic input circuit, agnostic mobile system data including a test instruction; generating, via a mobile translation circuit and in response to the agnostic mobile system data, adapted mobile system data including at least a portion of the agnostic mobile system data configured for a target mobile system; generating, via a component simulation circuit and in response to the adapted mobile system data, simulated adapted mobile system data including data simulating a mobile system component in response to the adapted mobile system data; transmitting, via a mobile interface circuit, the simulated adapted mobile system data to the target mobile system; and determining, via a testing circuit, a state value of the target mobile system based at least in part on a result value generated by the target mobile system in response to the simulated adapted mobile system data. In certain aspects, the method further includes: interpreting, via the mobile system interface circuit, additional adapted mobile system data generated by the target mobile system in response to the simulated adapted mobile system data; generating, via the component simulation circuit and in response to the additional adapted mobile system data, additional simulated adapted mobile system data, the additional simulated mobile system data including data simulating a response of the mobile system component to the additional adapted mobile system data; and transmitting, via the mobile interface circuit, the additional simulated adapted mobile system data to the target mobile system. In certain aspects, the simulated adapted mobile system data corresponds to a simulated state of the mobile system component. In certain aspects, the simulated state corresponds to at least one of: a simulated environmental condition experienced by the mobile system component; or a simulated load experienced by the mobile system component. In certain aspects, the mobile system component is a component of the target mobile system. In certain aspects, the mobile system component is a prospective component of the target mobile system. In certain aspects, the simulated adapted mobile system data includes simulating, via a model, the mobile system component. In certain aspects, the mobile system component forms part of at least one of: an electrical system of the target mobile system; an engine of the target mobile system; an infotainment system of the target mobile system; or a power steering system of the target mobile system. In certain aspects, the method further includes removing the mobile system component from the target mobile system prior to generating the simulated adapted mobile system data.

Another example system includes: a target mobile system having a mobile system component; and a testing apparatus. The testing apparatus is structured to: interpret agnostic mobile system data including a test instruction; generate adapted mobile system data including at least a portion of the agnostic mobile system data configured for the target mobile system; in response to the adapted mobile system data, generate simulated adapted mobile system data including data simulating the mobile system component in response to the adapted mobile system data; transmit the simulated adapted mobile system data to the target mobile system as part of a test of the target mobile system data, wherein the test is based at least in part on the test instruction; and determine a state value of the target mobile system based at least in part on a result value generated by the target mobile system in response to the simulated adapted mobile system data. In certain aspects, testing apparatus is further structured to: interpret additional adapted mobile system data generated by the target mobile system in response to the simulated adapted mobile system data; generate additional simulated adapted mobile system data in response to the additional adapted mobile system data, the additional simulated mobile system data including data simulating a response of the mobile system component to the additional adapted mobile system data; and transmit the additional simulated adapted mobile system data to the target mobile system. In certain aspects, the simulated adapted mobile system data corresponds to a simulated state of the mobile system component. In certain aspects, the simulated state corresponds to at least one of: a simulated environmental condition experienced by the mobile system component; or a simulated load experienced by the mobile system component. In certain aspects, the system further includes a test server, and the testing apparatus is further structured to determine the state value of the target mobile system by transmitting the result value to the test server. The test server is structured to: determine the state value via analyzing the result value; and transmit the state value to the testing apparatus. In certain aspects, the mobile system component forms part of at least one of: an electrical system of the target mobile system; an engine system of the target mobile system; an infotainment system of the target mobile system; or a power steering system of the target mobile system. In certain aspects, the mobile system component forms part of at least one of: a driving system; a fuel system; a transmission system; an accessory for the mobile system; or an infotainment system. In certain aspects, the mobile system component is a controller of the mobile system. In certain aspects, the test includes at least one of: a diagnostic operation; a test operation; or a data collection operation.

The methods and systems described herein may be deployed in part or in whole through a machine having a computer, computing device, processor, circuit, and/or server that executes computer-readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer-readable medium, whereupon the computer performs operations of the computing device upon executing the instructions. In certain embodiments, such instructions themselves include a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects including a part of one of a first computing device, and some aspects including a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer-readable instructions on a server, client, firewall, gateway, hub, router, or other such computer and/or networking hardware. The computer-readable instructions may be associated with a server that may include a file server, print server, domain server, internet server, intranet server and other variants such as secondary server, host server, distributed server and the like. The server may include one or more of memories, processors, computer-readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer-readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer-readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are intended to fall within the scope of the present disclosure.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A system comprising:
an interface circuit structured to translate between:
adapted vehicle diagnostic data, generated from a vehicle, and agnostic vehicle diagnostic data, used offboard the vehicle; and
agnostic vehicle diagnostic command values, generated offboard the vehicle, and adapted vehicle diagnostic command values, executed against the vehicle;
an agnostic data processing circuit structured to interpret the agnostic vehicle diagnostic data;
an agnostic data provisioning circuit structured to transmit the agnostic vehicle diagnostic command values to the interface circuit;
a user interface circuit structured to:
generate a graphical user interface;
interpret a user input command value entered by a user via the graphical user interface; and
display a state value for the vehicle; and
a diagnostic circuit structured to:
generate, based at least in part on the user input command value, a first agnostic vehicle diagnostic command value that is translated by the interface circuit into a first adapted vehicle diagnostic command value;
generate, based at least in part on a first portion of the adapted vehicle diagnostic data translated from a first portion of the adapted vehicle diagnostic data generated from the vehicle in response to execution of the first adapted vehicle diagnostic command value against the vehicle, a second agnostic vehicle diagnostic command value that is translated by the interface circuit into a second adapted vehicle diagnostic command value; and
determine, based at least in part on a second portion of the agnostic vehicle diagnostic data translated from a second portion of the adapted vehicle diagnostic data generated from the vehicle in response to execution of the second agnostic vehicle diagnostic command value against the vehicle, the state value for the vehicle.

2. The system of claim 1, wherein:
the diagnostic circuit is further structured to generate a message value based at least in part on the first portion of the agnostic vehicle diagnostic data;
the graphical user interface is structured to:
display the message value; and
interpret another user input command value corresponding to the message value; and
the diagnostic circuit is further structured to generate the second agnostic vehicle diagnostic command value based at least in part on the another user input command value.

3. The system of claim 2, wherein the diagnostic circuit comprises:
a machine learning circuit structured to determine the state value based at least in part on the first portion of the agnostic vehicle diagnostic data and the second portion of the agnostic vehicle diagnostic data.

4. The system of claim 3, wherein the machine learning circuit is further structured to determine the state value further based in part on at least one of the user input command value and the another user input command value.

5. The system of claim 3, wherein the machine learning circuit is further structured to determine the second agnostic vehicle diagnostic command value based at based at least in part on the first portion of the agnostic vehicle diagnostic data and the second portion of the agnostic vehicle diagnostic data.

6. The system of claim 5, wherein the machine learning circuit is further structured to determine the second agnostic vehicle diagnostic command value further based in part on at least one of the user input command value and the another user input command value.

7. The system of claim 3 further comprising:
a database that stores data indicative of relationships between state values and known conditions of vehicles, wherein the known conditions of vehicles correspond to known states of agnostic vehicle diagnostic data; and
wherein the machine learning circuit is further structured to determine the state value based at least in part on the data stored in the database.

8. The system of claim 1, wherein the agnostic vehicle diagnostic data corresponds to at least one of:
an engine system;
a driving system;
a fuel system;
an electrical system;
a transmission system;
an accessory for the vehicle; or
an infotainment system.

9. The system of claim 1, wherein the vehicle is at least one of:
a car;
a truck;
an aircraft;
a ship;
an underwater craft;
an industrial vehicle; or
a space craft.

10. The system of claim 1, wherein the vehicle is a drone.

11. A method comprising:
generating a graphical user interface;
interpreting a user input command value entered by a user via the graphical user interface;
generating, in response to the user input command value, a first agnostic vehicle diagnostic command value;
translating, via an interface circuit, the first agnostic vehicle diagnostic command value to a first adapted vehicle diagnostic command value;
interpreting first adapted vehicle diagnostic data generated in response to executing the first adapted vehicle diagnostic command value against a vehicle;
translating, via the interface circuit, the first adapted vehicle diagnostic data to first agnostic vehicle diagnostic data;
generating a second agnostic vehicle diagnostic command value based at least in part on the first adapted vehicle diagnostic data;
translating, via the interface circuit, the second agnostic vehicle diagnostic command value to a second adapted vehicle diagnostic command value;
interpreting second adapted vehicle diagnostic data generated in response to executing the second adapted vehicle diagnostic command value against the vehicle;
translating, via the interface circuit, the second adapted vehicle diagnostic data to second agnostic vehicle diagnostic data;
generating a state value for the vehicle based at least in part on the second adapted vehicle diagnostic data; and
displaying the state value in the graphical user interface.

12. The method of claim 11 further comprising:
generating a message value based at least in part on the first agnostic vehicle diagnostic data;
displaying the message value via the graphical user interface;
interpreting another user input command value entered by the user via the graphical user interface; and
wherein generating the second agnostic vehicle diagnostic command value is further based at least in part on the another user input command value.

13. The method of claim 11, wherein determining the state value comprises:
processing the first agnostic vehicle diagnostic data and the second agnostic vehicle diagnostic data with a machine learning model.

14. The method of claim 13, wherein determining the state value further comprises:
processing at least one of the user input command value or the another user input command value with the machine learning model.

15. The method of claim 13, wherein generating a second agnostic vehicle diagnostic command value comprises:
processing the first agnostic vehicle diagnostic data and the second agnostic vehicle diagnostic data with the machine learning model.

16. The method of claim 15, wherein generating a second agnostic vehicle diagnostic command value comprises:
processing the user input command value and the another user input command value with the machine learning model.

17. The method of claim 13 further comprising:
accessing a database that stores data indicative of relationships between state values and known conditions of vehicles, wherein the known conditions of vehicles correspond to known states of agnostic vehicle diagnostic data; and
processing the data stored in the database with the machine learning model;
wherein determining the state value is further based at least in part on the processing of the data stored in the database with the machine learning model.

18. The method of claim 11, wherein at least one of the first agnostic vehicle diagnostic data or the second agnostic vehicle diagnostic data corresponds to at least one of:
an engine system;
a driving system;
a fuel system;
an electrical system;
a transmission system;
an accessory for the vehicle; or
an infotainment system.

19. The method of claim 11, wherein the vehicle is at least one of:
a car;
a truck;
an aircraft;
a ship;
an underwater craft;
an industrial vehicle; or
a space craft.

20. The method of claim 11, wherein the vehicle is a drone.

21. A apparatus comprising:
an agnostic data processing circuit structured to interpret agnostic vehicle diagnostic data translated by an interface circuit from adapted vehicle diagnostic data;
an agnostic data provisioning circuit structured to transmit agnostic vehicle diagnostic command values to the interface circuit for translation into adapted vehicle diagnostic command values;
a user interface circuit structured to:
generate a graphical user interface;
interpret a user input command value entered by a user via the graphical user interface; and
display a state value for a vehicle; and
a diagnostic circuit structured to:
generate, based at least in part on the user input command value, a first agnostic vehicle diagnostic command value that is translated by the interface circuit into a first adapted vehicle diagnostic command value;
generate, based at least in part on a first portion of the adapted vehicle diagnostic data translated from a first portion of the adapted vehicle diagnostic data generated from the vehicle in response to execution of the first adapted vehicle diagnostic command value against the vehicle, a second agnostic vehicle diagnostic command value that is translated by the interface circuit into a second adapted vehicle diagnostic command value; and
determine, based at least in part on a second portion of the agnostic vehicle diagnostic data translated from a second portion of the adapted vehicle diagnostic data generated from the vehicle in response to execution of the second agnostic vehicle diagnostic command value against the vehicle, the state value for the vehicle.

22. The apparatus of claim 21, wherein:
the diagnostic circuit is further structured to generate a message value based at least in part on the first portion of the agnostic vehicle diagnostic data;
the graphical user interface is structured to:
display the message value; and
interpret another user input command value corresponding to the message value; and
the diagnostic circuit is further structured to generate the second agnostic vehicle diagnostic command value based at least in part on the another user input command value.

23. The apparatus of claim 22, wherein the diagnostic circuit comprises:
a machine learning circuit structured to determine the state value based at least in part on the first portion of the agnostic vehicle diagnostic data and the second portion of the agnostic vehicle diagnostic data.

24. The apparatus of claim 21, wherein the agnostic vehicle diagnostic data corresponds to at least one of:
an engine system;
a driving system;
a fuel system;
an electrical system;
a transmission system;
an accessory for the vehicle; or
an infotainment system.

25. The apparatus of claim 21, wherein the vehicle is at least one of:
a car;
a truck;
an aircraft;
a ship;
an underwater craft;
an industrial vehicle; or
a space craft.
